(19) United States
(12) Patent Application Publication
(10) Pub. No.: US 2026/0012305 A1
(43) Pub. Date: Jan. 8, 2026

(54) ENHANCED LONG RANGE (ELR)-MARK SEQUENCE DESIGN

(71) Applicant: QUALCOMM Incorporated, San Diego, CA (US)

(72) Inventors: Lin YANG, San Diego, CA (US); Bin TIAN, San Diego, CA (US); Tzu-Hsuan CHOU, San Diego, CA (US); Youhan KIM, Saratoga, CA (US)

(21) Appl. No.: 19/250,948

(22) Filed: Jun. 26, 2025

Related U.S. Application Data
(60) Provisional application No. 63/668,723, filed on Jul. 8, 2024.

(51) Int. Cl. H04L 5/00

(52) U.S. Cl. CPC H04L 5/0044

(57) ABSTRACT

This disclosure provides methods, components, devices and systems for enhanced long range (ELR) mark sequence design. Some aspects more specifically relate to mechanisms according to which devices may support a set of ELR sequences associated with relatively low peak-to-average-power ratios (PAPRs) and usable to convey information that a receiving device may use to determine whether to perform an early drop of a received ELR physical layer (PHY) protocol data unit (PPDU). In some examples, various devices may support a set of ELR sequences with each ELR sequence of the set indicative of a respective basic service set (BSS) color value. In such examples, a quantity of the set of ELR sequences may correspond to a quantity of available BSS color values and a length of each ELR sequence within the set may correspond to a quantity of used tones within a set of ELR symbols.

### CROSS REFERENCES

The present application for patent claims benefit of U.S. Provisional Patent Application No. 63/668,723 by YANG et al., entitled “ENHANCED LONG RANGE (ELR)-MARK SEQUENCE DESIGN,” filed Jul. 8, 2024, assigned to the assignee hereof, and expressly incorporated herein.

### TECHNICAL FIELD

This disclosure relates generally to wireless communication and, more specifically, to enhanced long range (ELR)-mark sequence design.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a wireless communication device. The wireless communication device may include a processing system that includes processor circuitry and memory circuitry that stores code. The processing system may be configured to cause the wireless communication device to transmit, via a set of multiple enhanced long range (ELR) symbols within a preamble portion of a physical layer (PHY) protocol data unit (PPDU), an ELR sequence from a set of multiple ELR sequences, where the ELR sequence is indicative of a basic service set (BSS) color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The processing system may be further configured to cause the wireless communication device to transmit, via a set of multiple ELR data symbols within a data portion of the PPDU, a data payload associated with the BSS color value.

Another innovative aspect of the subject matter described in this disclosure can be implemented in a method for wireless communication by or at wireless communication device. The method may include transmitting, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The method may further include transmitting, via a set of multiple ELR data symbols within a data portion of the PPDU, a data payload associated with the BSS color value.

Another innovative aspect of the subject matter described in this disclosure can be implemented in a wireless communication device. The wireless communication device may include means for transmitting, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The wireless communication device may further include means for transmitting, via a set of multiple ELR data symbols within a data portion of the PPDU, a data payload associated with the BSS color value.

Another innovative aspect of the subject matter described in this disclosure can be implemented in a non-transitory computer-readable medium storing code for wireless communication by a wireless communication device. The code may include instructions executable by one or more processors to transmit, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The code may further include instructions executable by one or more processors to transmit, via a set of multiple ELR data symbols within a data portion of the PPDU, a data payload associated with the BSS color value.

In some implementations of the method, wireless communication devices, and non-transitory computer-readable medium described herein, the set of multiple ELR symbols includes two ELR symbols, the ELR sequence may be a length-96 ELR sequence, and a first ELR symbol of the two ELR symbols may be associated with a first half of the length-96 ELR sequence and a second ELR symbol of the two ELR symbols may be associated with a second half of the length-96 ELR sequence. In some implementations of the method, wireless communication devices, and non-transitory computer-readable medium described herein, the set of multiple ELR sequences may be associated with a Hadamard expansion of a subset of a Hadamard matrix with an order of 48.

In some implementations of the method, wireless communication devices, and non-transitory computer-readable medium described herein, each BSS color value of the set of multiple BSS color values may be directly mapped to a respective index of the set of multiple ELR sequences.

Another innovative aspect of the subject matter described in this disclosure can be implemented in a wireless communication device. The wireless communication device may include a processing system that includes processor circuitry and memory circuitry that stores code. The processing system may be configured to cause the wireless communication device to receive, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The processing system may be further configured to cause the wireless communication device to selectively receive at least a portion of a remainder of the PPDU after the set of multiple ELR symbols in accordance with the BSS color value indicated by the ELR sequence.

Another innovative aspect of the subject matter described in this disclosure can be implemented in a method for wireless communication by or at wireless communication device. The method may include receiving, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The method may further include selectively receiving at least a portion of a remainder of the PPDU after the set of multiple ELR symbols in accordance with the BSS color value indicated by the ELR sequence.

Another innovative aspect of the subject matter described in this disclosure can be implemented in a wireless communication device. The wireless communication device may include means for receiving, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The wireless communication device may further include means for selectively receiving at least a portion of a remainder of the PPDU after the set of multiple ELR symbols in accordance with the BSS color value indicated by the ELR sequence.

Another innovative aspect of the subject matter described in this disclosure can be implemented in a non-transitory computer-readable medium storing code for wireless communication by a wireless communication device. The code may include instructions executable by one or more processors to receive, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The code may further include instructions executable by one or more processors to selectively receive at least a portion of a remainder of the PPDU after the set of multiple ELR symbols in accordance with the BSS color value indicated by the ELR sequence.

In some implementations of the method, wireless communication devices, and non-transitory computer-readable medium described herein, selectively receiving at least the portion of the remainder of the PPDU after the set of multiple ELR symbols may include operations, features, means, or instructions for receiving at least the portion of the remainder of the PPDU in accordance with a BSS associated with the wireless communication device corresponding to the BSS color value indicated by the ELR sequence or refraining from receiving the remainder of the PPDU in accordance with the BSS associated with the wireless communication device corresponding to a different BSS color value than the BSS color value indicated by the ELR sequence.

In some implementations of the method, wireless communication devices, and non-transitory computer-readable medium described herein, the set of multiple ELR symbols includes two ELR symbols, the ELR sequence may be a length-96 ELR sequence, and a first ELR symbol of the two ELR symbols may be associated with a first half of the length-96 ELR sequence and a second ELR symbol of the two ELR symbols may be associated with a second half of the length-96 ELR sequence. In some implementations of the method, wireless communication devices, and non-transitory computer-readable medium described herein, the set of multiple ELR sequences may be associated with a Hadamard expansion of a subset of a Hadamard matrix with an order of 48.

In some implementations of the method, wireless communication devices, and non-transitory computer-readable medium described herein, each BSS color value of the set of multiple BSS color values may be directly mapped to a respective index of the set of multiple ELR sequences.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows an example enhanced long range (ELR) PPDU format that supports ELR-mark sequence design.

FIG. 5 shows an example signaling diagram that supports ELR-mark sequence design.

FIG. 6 shows an example sequence selection scheme that supports ELR-mark sequence design.

FIG. 7 shows an example tone mapping scheme that supports ELR-mark sequence design.

FIG. 8 shows an example transmission scheme associated with a set of ELR data symbols that supports peak-to-average-power ratio (PAPR) reduction for ELR data.

FIG. 9 shows a block diagram of an example wireless communication device that supports ELR-mark sequence design.

FIGS. 10 and 11 show flowcharts illustrating example processes performable by or at a wireless communication device that supports ELR-mark sequence design.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, a wireless communication device may transmit a physical layer (PHY) protocol data unit (PPDU) to an intended receiver. The PPDU may include a preamble portion and a data portion. One or more select fields of the preamble portion may indicate one or more of a format, a version, or a mode associated with the PPDU. The data portion may carry a data payload in accordance with the indicated format, version, or mode. The wireless communication device, which may be an access point (AP) or a station (STA), may generate and transmit the PPDU in accordance with one of various formats. For example, and depending on a capability of the wireless communication device, the wireless communication device may transmit the PPDU in accordance with an extremely high throughput (EHT) format or an ultra-high reliability (UHR) format, among other examples.

In some networks, a wireless communication device may support enhanced long range (ELR) transmissions (which may be equivalently referred to herein as “extended” long range transmissions), which may extend a coverage associated with the wireless communication device. ELR transmissions may be associated with a dedicated PPDU format to facilitate use of a relatively higher transmit power or to otherwise increase a range of the PPDU. By way of the greater range provided by ELR transmissions, a relatively large quantity of devices within a network may “hear” (such as detect) an ELR PPDU, including both devices relatively near to a transmitting device and devices relatively far from the transmitting device. To avoid causing unnecessary power consumption due to PPDU parsing at “overhearing” devices that are not the intended receiver, the transmitting device may include information relatively early within a PPDU (such as within a preamble portion) to facilitate an “early drop” of the PPDU at unintended receivers. For example, the transmitting device may indicate information via a set of ELR symbols, which may include ELR-mark (or, equivalently, “ELR-MARK”) symbols or other symbols associated with “marking” a PPDU as an ELR PPDU, and a receiving device may use the indicated information to determine whether to continue parsing the PPDU. Some networks, however, may lack mechanisms according to which such information can be efficiently or reliably conveyed (such as while also satisfying one or more target communication metrics). Thus, some networks may benefit from additional ELR signaling mechanisms to efficiently and reliably facilitate an “early drop” of a PPDU.

Various aspects relate generally to ELR sequence designs that enable efficient and reliable communication of information via a set of ELR symbols of an ELR PPDU. Some aspects more specifically relate to mechanisms according to which wireless communication devices may support a set of ELR sequences (such as ELR-mark sequences, which may be equivalently referred to or understood as “ELR-MARK sequences”) associated with relatively low peak-to-average-power ratios (PAPRs) and usable to efficiently and unambiguously convey information that a receiving device may use to determine whether to perform an early drop of a received ELR PPDU. In some examples, various wireless communication devices may support (such as identify, select, store, maintain, determine, generate, calculate, or otherwise ascertain) a set of ELR sequences with each ELR sequence of the set indicative of a respective basic service set (BSS) color value. In other words, each ELR sequence of the set of ELR sequences may correspond to a respective BSS color value. In such examples, a quantity of the set of ELR sequences may correspond to (such as be equal to) a quantity of available BSS color values and a length of each ELR sequence within the set may correspond to (such as be equal to) a quantity of used tones within the ELR symbols. As described herein, “used tones” may be tones that carry an ELR sequence and may include data tones, pilot tones, extra (channel estimation) tones, or any combination thereof. The quantity of used tones, which may include tones of two ELR symbols, may be 96 tones, 104 tones, or 112 tones.

In examples in which the quantity of used tones is 104 tones, the set of ELR sequences may be derived from a binary complementary sequence pair (such as a Golay complementary sequence pair). In such examples, the set of ELR sequences may be associated at least in part with a Golay-Hadamard matrix, the Golay-Hadamard matrix being constructed by non-transposed circulant shifted versions of the pair of binary complementary sequences and transposed circulant shifted versions of the pair of binary complementary sequences. The binary complementary sequence pair may be a pair of length-26 sequences or a pair of length-52 sequences. In examples in which the binary complementary sequence pair is a pair of length-26 sequences, the set of ELR sequences may be associated with a Hadamard expansion of a subset of the Golay-Hadamard matrix. In examples in which the binary complementary sequence pair is a pair of length-52 sequences, the set of ELR sequences may be a subset of the Golay-Hadamard matrix (without further Hadamard expansion).

In examples in which the quantity of used tones is 96 tones, the set of ELR sequences may be associated at least in part with a Hadamard matrix with an order of (96×96) or (48×48), or a subset thereof. For example, the set of ELR sequences may be selected from a (96×96) Hadamard (H96) matrix. By way of further example, the set of ELR sequences may be generated in accordance with a Hadamard expansion of a subset of a (48×48) Hadamard (H48) matrix. Such a subset of an H48 matrix may be, for example, a (32×48) matrix. In examples in which the set of ELR sequences are generated according to an expansion (such as a Hadamard expansion) of a (32×48) matrix, the set of ELR sequences may be associated with a (64×96) matrix. The (64×96) matrix may be a matrix with 64 rows and 96 columns, with each row being a respective ELR sequence and corresponding to a respective BSS color, and with each column corresponding to a respective tone of the 96 used tones. The H96 matrix or the H48 matrix may be generated directly via a software command or may be constructed in accordance with multiple Golay pairs through a Goethals-Seidel array. In examples in which an H96 matrix is used, the multiple Golay pairs may include a Golay 8 pair and a Golay 16 pair. In examples in which an H48 matrix is used, the multiple Golay pairs may include a Golay 4 pair and a Golay 8 pair.

In examples in which the quantity of used tones is 112 tones, the set of ELR sequences may be length-104 ELR sequences plus padding tones (such as 4 padding tones in each of the two ELR symbols) or may be associated at least in part with a Hadamard matrix with an order of (56×56). In examples in which the set of ELR sequences is associated with the (56×56) Hadamard (H56) matrix, the H56 matrix may be constructed in accordance with multiple Golay pairs through a Goethals-Seidel array. Such multiple Golay pairs may include a Golay 4 pair and a Golay 10 pair. The set of ELR sequences may be generated in accordance with a Hadamard expansion of a subset of the H56 matrix.

Particular aspects of the subject matter described in this disclosure can be implemented to realize one or more of the following potential advantages. In some examples, by transmitting an ELR sequence that corresponds to a specific BSS, a receiving device may selectively parse a remainder of the PPDU after the set of ELR symbols in accordance with whether the receiving device has a matching BSS. For example, if the receiving device does not have a matching BSS with the BSS conveyed by the ELR sequence, the receiving device may select, detect, determine, identify, or ascertain that the PPDU is likely intended for a different device and terminate a parsing procedure accordingly. In accordance with facilitating such an “early drop” at one or more unintended receiving devices, the unintended receiving devices may save power (which may increase battery life) or use now-available processing or RF circuitry for one or more other tasks (which may increase processing speed and enhance a user experience), or both. Further, in accordance with the described procedures for generating various types and lengths of sequence sets, various wireless communication devices may efficiently use a quantity of ELR sequences equal to a quantity of possible BSS color values with lengths adapted to a quantity of tones carrying the ELR sequence. The described procedures also may provide ELR sequences having relatively low PAPRs. By achieving a relatively low PAPR in an ELR sequence transmission, various wireless communication devices may experience greater power amplifier efficiency and avoid or reduce both in-band and out-of-band distortion, which may result in greater communication reliability throughout a network. Such greater communication reliability may further support higher data rates, greater network throughput, greater spectral efficiency, and greater network capacity, among other benefits.

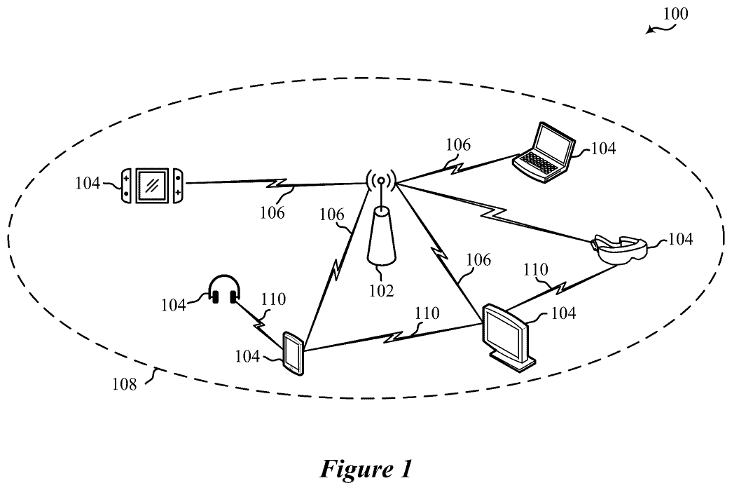

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHZ, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 megahertz (MHz)-7.125 GHZ), FR2 (24.25 GHz-52.6 GHZ), FR3 (7.125 GHZ-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHZ, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHZ bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHZ, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting UHR communications or communication according to the IEEE 802.11bn standard amendment can be configured to operate, monitor, contend and communicate using multiple primary 20 MHZ channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In accordance with some example implementations, one or more APs 102 or one or more STAs 104, or any combination thereof, may support mechanisms to leverage a set of sequences associated with relatively low PAPRs to convey information that a receiving device may use to determine whether to perform an early drop of a received PPDU. Such sequences may be ELR sequences and such a PPDU may be an ELR PPDU (such as a PPDU associated with an ELR format). In some implementations, each sequence of the set of sequences may correspond to a respective BSS color value of a set of (possible or available) BSS color values. Accordingly, in such implementations, a quantity of the set of sequences may be equal to a quantity of the (possible or available) BSS color values. Further, in some implementations, each sequence of the set of sequences may have a length that depends on a quantity of tones used to convey that sequence. For example, each sequence of the set of sequences may have a length of 96, 104, or 112, among other examples. The set of sequences may be generated, formed, identified, selected, or otherwise determined in accordance with one or more of various ways depending on the length of each of the sequences.

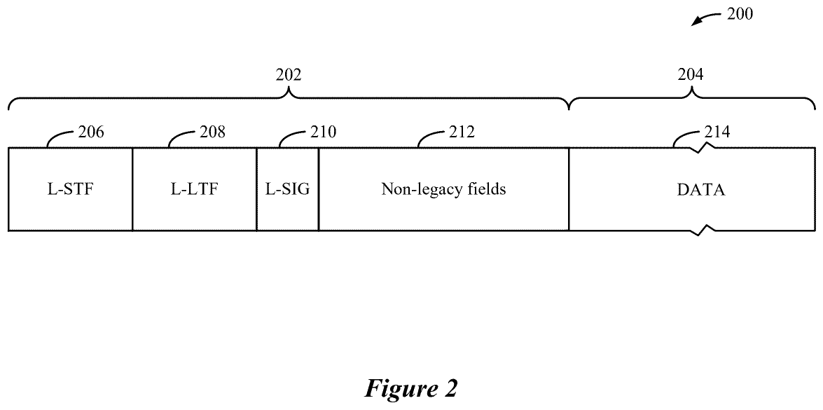

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (QBPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, the one or more non-legacy fields 212 may include a U-SIG field, an ELR field (such as an ELR-mark field) including one or more ELR symbols (such as one or more ELR-mark symbols), an ELR-STF (which may sometimes be referred to as an ELR-STF field), an ELR-LTF (which may sometimes be referred to as an ELR-LTF field), and an ELR-SIG field. In such implementations, the data field 214 may be an example of an ELR-data field. A transmitting device, such as an AP 102 or a STA 104, may generate the PDU 200 to include one or more of the U-SIG field, the ELR field, the ELR-STF field, the ELR-LTF field, and the ELR-SIG field in association with formatting the PDU 200 in accordance with an ELR format, such as an ELR PPDU format.

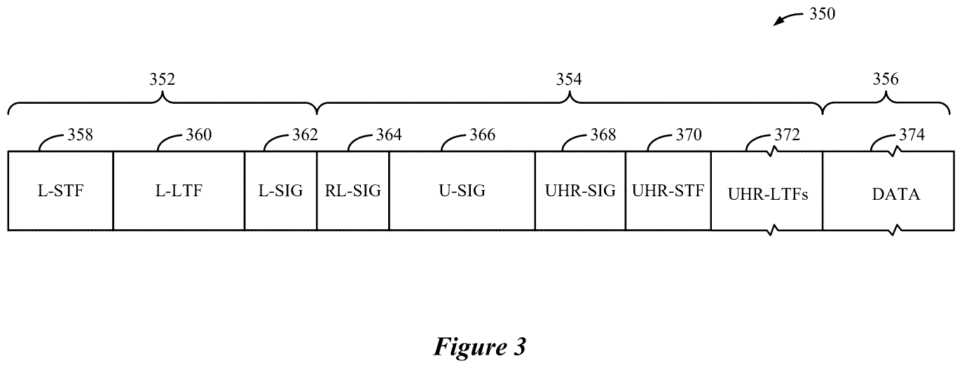

FIG. 3 shows an example PPDU 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field (referred to herein as “U-SIG 366”) and a UHR signal field (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field (referred to herein as “UHR-STF 370,” although it may be structured as, and carry version-dependent information for, other wireless communication protocol versions beyond UHR) and one or more additional long training fields (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (such as STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHZ, 80 MHZ, 160 MHZ, and 320 MHZ bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal QAM) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

To support increased range or rate-over-range, a STA 104 and an AP 102 may support ELR PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (such as a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (such as a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (such as APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, among other examples), enhancing roaming or other mobility operations, multi-AP coordination, and generally facilitating network management or optimizing network connections or characteristics to, for example, increase throughput or capacity, reduce latency or otherwise enhance user experience.

In some aspects, a wireless communication device (such as an AP 102 or a STA 104) may use the PPDU 350 in accordance with employing a UHR format, such as a UHR PPDU format, and may use a different PPDU in accordance with employing other formats, such as an EHT PPDU format or an ELR PPDU format. In some aspects, the wireless communication device may indicate a format of a PPDU via a PHY version identifier subfield of a U-SIG field, such as the U-SIG 366. For example, in some implementations, a first codepoint (such as a “0” value as denoted by, for example, “000” codepoint) of the PHY version identifier subfield may indicate that the PPDU 350 is associated with the EHT format. A second codepoint (such as a “1” value as denoted by, for example, a “001” codepoint) of the PHY version identifier subfield may indicate that a PPDU is associated with a UHR format. In some aspects, the second codepoint may indicate that the PPDU is associated with a UHR format or an ELR format. Alternatively, a third codepoint (such as a “2” value as denoted by, for example, a “010” codepoint, or such as a “7” value as denoted by, for example, a “111” codepoint) of the PHY version identifier subfield may indicate that the PPDU is associated with an ELR format.

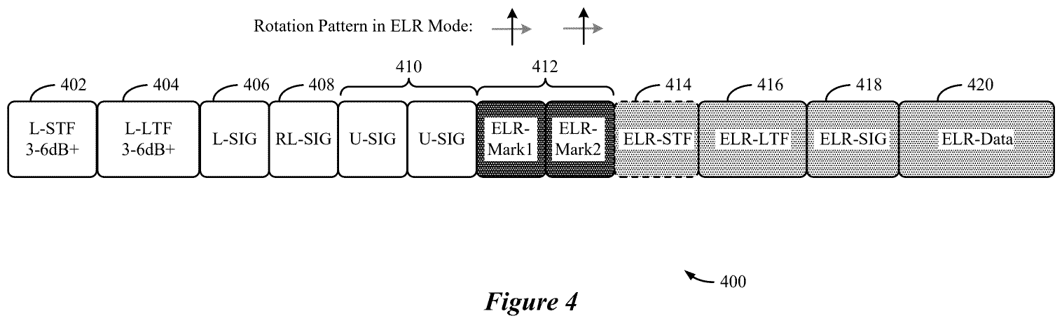

FIG. 4 shows an example ELR PPDU format 400 that supports ELR-mark sequence design. The ELR PPDU format 400 may be an example PPDU format that supports or is otherwise associated with ELR communication. For example, a wireless communication device participating in ELR communication may generate and transmit, or receive and parse, a PPDU in accordance with the ELR PPDU format 400.

In accordance with the ELR PPDU format 400, a PPDU may include an L-STF 402 (which may be power boosted by approximately 3-6 decibels (dB)), an L-LTF 404 (which may be power boosted by approximately 3-6 dB), an L-SIG field 406, an RL-SIG field 408, a U-SIG field 410 (which may include multiple symbols, such as two symbols), an ELR field 412 (such as an ELR-mark field) including a set of ELR symbols (such as ELR-mark symbols, such as two ELR-mark symbols), an ELR-STF field 414 (which may be absent in some implementations), an ELR-LTF field 416, an ELR-SIG field 418, and an ELR data field 420. The ELR-STF field 414 may include one or multiple ELR-STF symbols. The ELR-LTF field 416 may include one or multiple ELR-LTF symbols. The set of ELR symbols of the ELR field 412 may be associated with a rotation pattern in an ELR mode.

In some implementations, the ELR-STF may have same length as UHR DL OFDMA with four RU52 (such as a total length or duration of 4 microseconds (μs) long in accordance with a periodicity of 0.8 us with 5 periods), plus further 3 dB boosting. In some implementations, the ELR-LTF may have a total length or duration of 12.8 us plus guard intervals (GIs) with 3 dB boosting, or may have a total length or duration of 25.6 us plus GIs with or without power boosting. In some implementations, an ELR PPDU may have a fixed/single mode of LTF+GI, such as one of 2×-LTF+1.6 μs GI, 4×-LTF+0.8 μs GI, or 4×-LTF+1.6 μs GI. Without counting one or more GIs, 2×-LTF may have a length or duration of 6.4 us and 4×-LTF may have a length or duration of 12.8 μs. Thus, a 12.8 μs ELR-LTF may be one 4×-LTF or two 2×-LTFs. A 25.6 μs ELR-LTF may be two 4×-LTFs or four 2×-LTFs.

In some implementations, a transmitting device may modulate the set of ELR symbols of the ELR field 412 using a same modulation scheme or a same pattern of modulation schemes. In other words, the two ELR symbols of the ELR field 412 may have a same modulation or a same pattern of modulations. In some examples, the transmitting device may use BPSK on a first ELR symbol and BPSK on a second ELR symbol. In some other examples, the transmitting device may use QBPSK on a first ELR symbol and QBPSK on a second ELR symbol.

Additionally, or alternatively, the transmitting device may use a hybrid modulation scheme, such as hybrid BPSK/QBPSK, each on a partial set of tones. In some examples, the transmitting device may modulate each ELR symbol using hybrid BPSK/QBPSK by using BPSK/QBPSK on alternating tones (such that a first tone is associated with BPSK, a second (next) tone is associated with QBPSK, a third (further next) tone is associated with BPSK, and so on). In some other examples, the transmitting device may modulate each ELR symbol using hybrid BPSK/QBPSK by using BPSK on a first (contiguous) half of a set of tones and using QBPSK on a second (contiguous) half of the set of tones. In some other examples, the transmitting device may modulate each ELR symbol using hybrid BPSK/QBPSK on sub-groups of tones. For example, the transmitting device may modulate each ELR symbol using QBPSK for a first set of tones within that ELR symbol and using BPSK for a second set of tones within that ELR symbol. By way of further example, the transmitting device may modulate each ELR symbol using hybrid BPSK/QBPSK on sub-groups of tones by using BPSK on a first (contiguous) one-eighth of a set of tones and using QBPSK on a second (contiguous) one-eighth of the set of tones, further using BPSK on a third (contiguous) one-eighth of the set of tones, and so on. QBPSK may be equal to, understood as, or otherwise associated with BPSK with a 90-degree rotation. A hybrid BPSK/QBPSK modulation scheme may be understood as or referred to herein as a patten of modulation schemes.

In some other implementations, a transmitting device may modulate the set of ELR symbols of the ELR field 412 using different modulation schemes or different patterns of modulation schemes. In other words, the two ELR symbols of the ELR field 412 may have different modulations or different patterns of modulations. In some examples, the transmitting device may use BPSK on a first ELR symbol and QBPSK on a second ELR symbol. In some other examples, the transmitting device may use QBPSK on a first ELR symbol and BPSK on a second ELR symbol. In some aspects, the transmitting device and a receiving device may use the different modulation schemes or different patterns of modulation schemes across the set of ELR symbols (such as across the two ELR symbols) to reduce false alarms (such as to enable the receiving device to accurately ascertain whether the PPDU is an ELR PPDU or a non-ELR PPDU). As used herein, a “false alarm” herein may be understood as a scenario in which a receiving device parses a PPDU in accordance with incorrectly determining that the received PPDU is an ELR PPDU, or vice versa.

In examples in which the ELR-SIG field 418 is after the ELR-LTF field 416, a receiving device (such as an ELR STA) may be expected to wait for a relatively long time to determine whether the receiving device is an intended receiver of a detected PPDU. To reduce or mitigate this issue, various wireless communication devices may support one or more signaling mechanisms according to which the wireless communication devices may enable or facilitate an “early drop” of the detected PPDU by carrying, conveying, providing, or otherwise (directly or indirectly) indicating a BSS color value via the ELR field 412. For example, wireless communication devices may transmit or receive an ELR sequence, such as an ELR-mark sequence, via the ELR symbols of the ELR field 412 and may support a mapping between different BSS color values and different ELR sequences. In such examples, an ELR sequence may correspond to a specific BSS color value. Accordingly, a receiving device may selectively receive at least a portion of a remainder of a detected PPDU in accordance with whether a BSS color value indicated by a received ELR sequence corresponds to a BSS associated with the receiving device.

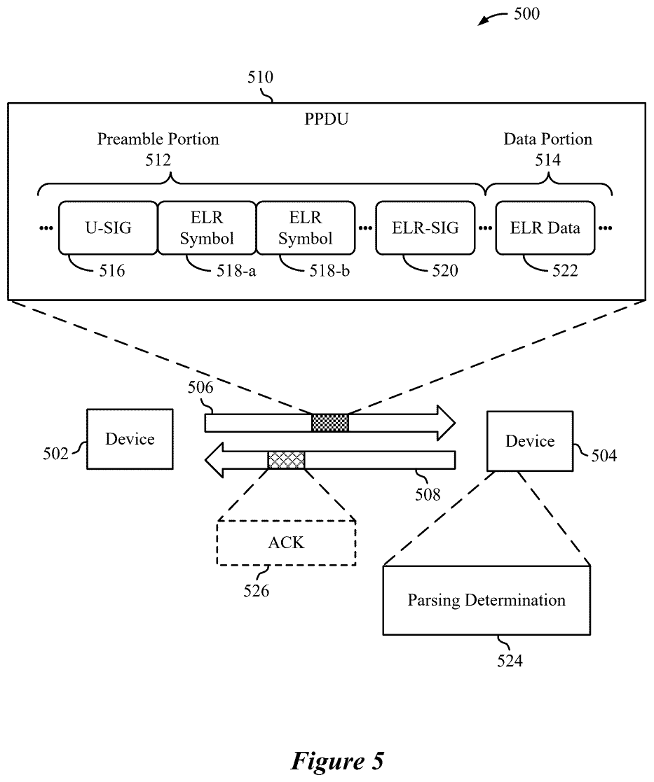

FIG. 5 shows an example signaling diagram 500 that supports ELR-mark sequence design. The signaling diagram 500 illustrates communication between a wireless communication device 502 and a wireless communication device 504 via a communication link 506 and a communication link 508. The wireless communication device 502 may be an example of a STA 104 or an AP 102, such as a STA 104 or an AP 102 as illustrated by and described with reference to FIG. 1. The wireless communication device 504 may be an example of a STA 104 or an AP 102, such as a STA 104 or an AP 102 as illustrated by and described with reference to FIG. 1. Generally, the wireless communication device 502 may be understood or function as a transmitting device and the wireless communication device 504 may be understood or function as a receiving device.

For example, the wireless communication device 502 may transmit, via the communication link 506, a PPDU 510 and the wireless communication device 504 may receive, via the communication link 506, the PPDU 510. In some aspects, the PPDU 510 may be associated with an ELR format, such as the ELR PPDU format 400 as illustrated by and described with reference to FIG. 4. In examples in which the PPDU 510 is associated with the ELR PPDU format 400, a preamble portion 512 of the PPDU 510 may include a U-SIG field 516, an ELR field (such as an ELR-mark field) including an ELR symbol 518-a and an ELR symbol 518-b, and an ELR-SIG field 520, among other fields (as illustrated by and described with reference to FIG. 4). The preamble portion 512 may be understood or referred to herein as an ELR preamble. A data portion 514 of the PPDU 510 may include an ELR data field 522, among other potential data fields.

In some implementations, the wireless communication device 504 may receive and parse at least a portion of the PPDU 510 and, in accordance with parsing the portion of the PPDU 510, may perform a parsing determination 524. In accordance with the parsing determination 524, the wireless communication device 504 may select, determine, calculate, identify, or otherwise ascertain whether to continue parsing the PPDU 510 or to drop (and not parse) a remainder of the PPDU 510. Thus, the parsing determination 524 performed by the wireless communication device 504 may be equivalently referred to as a mode classification, a mode detection, a parsing decision, a parsing selection, a parsing calculation, or a parsing identification, among other examples. In examples in which the wireless communication device 504 drops a remainder of the PPDU 510 in accordance with the parsing determination 524, the wireless communication device 504 may be understood as performing an “early drop” of the PPDU 510, which may save power and processing resources at the wireless communication device 504.

The wireless communication device 504 may drop a remainder of the PPDU 510 in association with selecting, determining, identifying, calculating, or otherwise ascertaining that the wireless communication device 504 is not an intended receiver of the PPDU 510, that the wireless communication device 504 is not associated with a same BSS as an intended receiver of the PPDU 510, or that the wireless communication device 504 is a non-ELR-capable device (and therefore not capable of parsing the PPDU 510, if the PPDU 510 is associated with an ELR format). Alternatively, the wireless communication device 504 may continue parsing (at least a portion of) the PPDU 510 in association with selecting, determining, identifying, calculating, or otherwise ascertaining that the wireless communication device 504 is an intended receiver of the PPDU 510, that the wireless communication device 504 is associated with a same BSS as an intended receiver of the PPDU 510, or that the wireless communication device 504 is an ELR-capable device (and therefore is capable of parsing the PPDU 510, if the PPDU 510 is associated with an ELR format). If the wireless communication device 504 is the intended receiver and successfully parses the PPDU 510, the wireless communication device 504 may transmit, to the wireless communication device 502 via the communication link 508, an acknowledgment (ACK) 526. The ACK 526 may be a block ACK (BA) frame, among other example feedback frames.

The wireless communication device 502 and the wireless communication device 504 may use any one or more of the U-SIG field 516, the ELR symbol 518-a and the ELR symbol 518-b, and the ELR-SIG field 520 to facilitate or enable the parsing determination 524 at the wireless communication device 504. In some implementations, for example, the wireless communication device 502 and the wireless communication device 504 may use the ELR symbol 518-a and the ELR symbol 518-b (or, generally, a set of ELR symbols, such as a set of ELR-mark symbols) to facilitate or enable the parsing determination 524 at the wireless communication device 504. For example, the wireless communication device 502 and the wireless communication device 504 may communicate (such as transmit or receive) a sequence (which may be referred to herein as an ELR sequence, such as an ELR-mark sequence) via the ELR symbol 518-a and the ELR symbol 518-b and may use the sequence to convey information. Such information may be known at both the wireless communication device 502 and the wireless communication device 504 to facilitate an early drop, such as information indicative of a BSS (via a BSS color value) associated with PPDU 510.

For example, the wireless communication device 502 and the wireless communication device 504 may support and leverage a mapping between BSSs (such as BSS color values) and ELR sequences. In accordance with the mapping, each BSS (such as each BSS color value) may correspond to a respective ELR sequence. Accordingly, the wireless communication device 502 may select an ELR sequence that corresponds to a BSS associated with the wireless communication device 502 and may transmit the selected ELR sequence via the ELR symbol 518-a and the ELR symbol 518-b. The wireless communication device 504 may receive the ELR sequence via the ELR symbol 518-a and the ELR symbol 518-b and may perform a correlation between the received ELR sequence and an ELR sequence that corresponds to a BSS associated with the wireless communication device 504.

If the correlation satisfies a threshold correlation level, the wireless communication device 504 may measure, determine, identify, select, or ascertain that the two ELR sequences are the same and, accordingly, that a transmitter of the PPDU 510 (the wireless communication device 502) is within or associated with a same BSS as the wireless communication device 504. In such examples, the wireless communication device 504 may continue parsing at least another portion of the PPDU 510. Alternatively, if the correlation fails to satisfy a threshold correlation level, the wireless communication device 504 may measure, determine, identify, select, or ascertain that the two ELR-mark sequences are different and, accordingly, that a transmitter of the PPDU 510 (the wireless communication device 502) is within or associated with a different BSS as compared to the wireless communication device 504. In such examples, the wireless communication device 504 may drop the remainder of the PPDU 510.

Additionally, or alternatively, the wireless communication device 502 and the wireless communication device 504 may use one or more subfields or subfield interpretations of the ELR-SIG field 520 to facilitate or enable the parsing determination 524 at the wireless communication device 504. For example, the wireless communication device 502 may include, within the ELR-SIG field 520, one or both of a BSS color subfield or a STA identifier subfield. The BSS color subfield may indicate a BSS color value that corresponds to a BSS of the wireless communication device 502. The STA identifier subfield may indicate an intended receiver of the PPDU 510. The wireless communication device 504 may select, identify, determine, or otherwise ascertain whether the wireless communication device 504 is the intended receiver in accordance with one or both of the BSS color subfield or the STA identifier and may selectively parse a remainder of the PPDU 510 that follows the ELR-SIG field 520 (such as the ELR data field 522) accordingly.

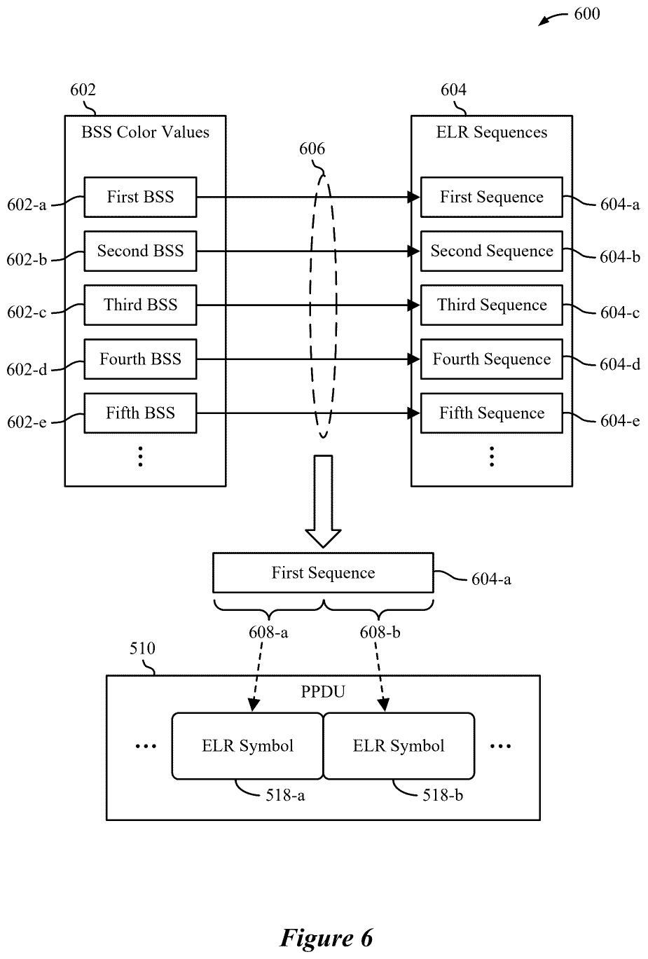

FIG. 6 shows an example sequence selection scheme 600 that supports ELR-mark sequence design. For example, the wireless communication device 502 may employ the sequence selection scheme 600 to select a sequence, such as an ELR sequence, to apply across (and transmit via) the ELR symbol 518-a and the ELR symbol 518-b of the PPDU 510. In some implementations, to facilitate a mutual understanding of the sequence selection scheme 600, the wireless communication device 502 and the wireless communication device 504 may use a mapping 606 between a set of BSSs 602 (such as a set of BSS color values) and a set of sequences 604 (such as a set of ELR sequences). The wireless communication device 502 and the wireless communication device 504 may exchange (such as transmit or receive) signaling indicative of the mapping 606, may retrieve the mapping 606 from one or more respective memories (such as in accordance with a standards specification or a network specification), or may receive the mapping 606 from another network node or entity (such as a central controller).

A sequence that the wireless communication device 502 applies to the ELR symbol 518-a and the ELR symbol 518-b, which may be referred to as an ELR-mark, may identify an ELR packet. In some aspects, the wireless communication device 502 may use a sequence for the ELR symbol 518-a and the ELR symbol 518-b that is known to the wireless communication device 504 (to facilitate use of the sequence to identify the ELR packet). Additionally, in some aspects, the wireless communication device 504 may use the known sequence to boost channel estimation or time/frequency/phase tracking, among other examples. In some aspects, the set of ELR symbols across which the wireless communication device 502 transmits a sequence (such as an ELR-mark sequence) may include two signature symbols (to facilitate a target channel gain, such as an approximately 6+dB gain).

In some implementations, the sequence that the wireless communication device 502 uses for the ELR-mark may carry additional information, such as information indicative of a BSS color or identifier, which is known at both the wireless communication device 502 and the wireless communication device 504 to accommodate an early drop of the PPDU 510. For example, an ELR AP/STA with a relatively low PD sensitivity may detect (potentially many) false alarm packets, even potentially from far away OBSS STAs. Thus, using a sequence that corresponds to a BSS color may enable receiving devices to correlate with a received ELR sequence, which may enable a receiving device to select, identify, decide, or otherwise determine whether the received packet is an ELR packet and whether the received packet is associated with a same BSS as the receiving device (both of which may enable or facilitate a receiving device to drop off and save power if the packet is an unintended packet).

In some examples, the ELR symbol 518-a and the ELR symbol 518-b (the two signature symbols) may be present within a legacy preamble portion and a tone plan of the ELR symbol 518-a and the ELR symbol 518-b may follow a one-times (1×) tone plan for 20 MHZ (such that the ELR symbol 518-a and the ELR symbol 518-b may be composed of two 1×OFDM symbols), which may have 48 data tones and 4 pilot tones (plus 4 extra tones in each symbol, in some examples). In other words, the ELR symbol 518-a and the ELR symbol 518-b may each be associated with (such as include) 48 data tones, 4 pilot tones, and (optionally) 4 extra tones. In some aspects, the 4 pilot tones in each of the ELR symbol 518-a and the ELR symbol 518-b may be associated with pilot tone values corresponding to the preamble, may be associated with LTF values at pilot tones, or may carry additional information. In examples in which the ELR symbols include dedicated pilot tones, the ELR symbols may use same pilot locations and pilot values as in an EHT-SIG field or a UHR-SIG field and an ELR sequence may have a length of 96 or 104 to fill in 96 tones (48 data tones*2 symbols, if not using the 4 extra tones at the edge of each symbol) or to fill in 104 tones (52 data tones*2 symbols, if using all valid data tones including the 4 extra tones at the edge of each symbol). In such examples, the dedicated pilot tones may be located at tone indices of [−21, −7, 7, 21] and may have values equal to (−1)*[1, 1, 1, −1] (which may be equivalently denoted as values of [−1, −1, −1, 1]) in each ELR symbol. Each ELR symbol may have a duration of 4 μs, which may include 3.2 μs+a GI of 0.8 μs.

In some examples, the ELR symbol 518-a and the ELR symbol 518-b may exclude (such as be absent of) dedicated pilot tones. In such examples, a tone plan of each of the ELR symbol 518-a and the ELR symbol 518-b may include data tones and exclude dedicated pilot tones (such that any pilot tones or pilot tone indices may be used to carry other information, such as an ELR sequence). Accordingly, any tone can be or function as a pilot tone and the pilot may be part of the ELR sequence. In some such examples, the ELR sequence may have a length of 104 to fill in 104 tones (52 tones*2 symbols, if not using the 4 extra tones at the edge of each symbol). In some other such examples, the ELR sequence may have a length of 112 to fill in 112 tones (56 tones*2 symbols, if using the 4 extra tones at the edge of each ELR symbol). In examples in which 4 extra tones are used at the edge of each ELR symbol, a length-104 ELR sequence may be applied to 104 tones with padding values added for the 8 extra tones (the 4 extra tones in each of the two ELR symbols). Alternatively, a length-112 ELR sequence may be applied to the 112 tones.

The ELR symbol 518-a and the ELR symbol 518-b may each include one or more (such as 4) extra tones (such as tones [−28, −27, 27, 28] in each ELR symbol), which may be extra channel estimation tones in L-SIG and RL-SIG that are not power boosted. The wireless communication device 502 and the wireless communication device 504 may use the extra tones to carry the ELR sequence (in examples in which such extra tones are power on) or may refrain from using the extra tones to carry the ELR sequence (in examples in which such extra tones are power off). In examples in which the 4 extra tones are not used for carrying an ELR sequence, a total number of occupied (such as used) tones in each of the ELR symbol 518-a and the ELR symbol 518-b may be equal to 48 or 52 (depending on whether pilot tones are used to carry the ELR sequence). In such examples, the wireless communication device 502 may apply a power boosting of 10*log₁₀(56/52) to the ELR symbols (or a portion thereof) with respect to U-SIG tones (which may use or occupy 56 tones).

In examples in which the 4 extra tones are used for carrying an ELR sequence, a total quantity of occupied (such as used) tones in each of the ELR symbol 518-a and the ELR symbol 518-b may be equal to 52 or 56 (depending on whether pilot tones are used to carry the ELR sequence). In some examples, the wireless communication device 502 may apply a same power scaling to the ELR symbols (or a portion thereof) as applied to the U-SIG field 516. In other words, the wireless communication device 502 may refrain from applying power boosting on the ELR symbols. In some examples (as an alternative to using 56 tones in each ELR symbol to carry an ELR sequence), and if the 4 extra tones are included/used in each ELR symbol, the wireless communication device 502 and the wireless communication device 504 may use a length-104 sequence to fill in 52 tones in each ELR symbol and may include padding values to fill in (such as map to) the 4 extra tones in each ELR symbol (for lower PAPR).

To enable an ELR sequence to carry BSS-identifying information (such as an indication of a BSS color value) via the ELR symbol 518-a and the ELR symbol 518-b, the wireless communication device 502 and the wireless communication device 504 may employ the mapping 606 between the set of BSSs 602 and the set of sequences 604. For example, in accordance with the mapping 606, each device having its own BSS color knows, determines, identifies, selects, or otherwise ascertains what its ELR sequence is. Accordingly, each device may use a known, determined, identified, selected, or ascertained ELR sequence for determining a sequence match in ELR detection (as part of, for example, a parsing determination 524).

In some implementations, the wireless communication device 502 and the wireless communication device 504 may use the mapping 606 to map 6-bit BSS color values to 64 different sequences on the tones that are used to carry the ELR sequence. In other words, the 64 possible or available values from the 6-bit BSS color may be mapped one-on-one to 64 orthogonal sequences. In accordance with the mapping 606, each BSS of the set of BSSs 602 may map to a respective sequence from the set of 64 ELR sequences. For example, a first BSS 602-a (such as a first BSS color) may correspond to a first sequence 604-a, a second BSS 602-b (such as a second BSS color) may correspond to a second sequence 604-b, a third BSS 602-c (such as a third BSS color) may correspond to a third sequence 604-c, a fourth BSS 602-d (such as a fourth BSS color) may correspond to a fourth sequence 604-d, a fifth BSS 602-c (such as a fifth BSS color) may correspond to a fifth sequence 604-c, and so on.

The mapping 606 between BSS colors and sequences may take one or more of various forms. In some examples, each BSS color value may be directly mapped to a row or column sequence index of the set of sequences 604. In such examples, the wireless communication device 502 and the wireless communication device 504 may avoid maintaining or updating a mapping table between BSS color values and sequences, as each BSS color value directly and statically corresponds to a respective sequence of the set of sequences 604. In some other examples, each BSS color value may be mapped to an ordered sequence index in accordance with PAPR values. For example, the first BSS 602-a may correspond to a lowest PAPR value, the second BSS 602-b may correspond to a second lowest PAPR value, and so on. In such examples, the mapping 606 may include a mapping table for BSS color and sequence index mapping, as each BSS color value indirectly maps to a respective sequence of the set of sequences 604 in accordance with a PAPR value associated with that sequence. For example, if the first sequence 604-a is associated with the lowest PAPR value of the set of sequences 604 (for a given set of one or more ELR symbols), the mapping 606 (via a stored or maintained mapping table) may indicate that the first BSS 602-a corresponds to the first sequence 604-a.

In some implementations, the set of sequences 604 may have zero or a relatively low amount of cross-correlation between sequences corresponding different BSSs of the set of BSSs 602 (such as between sequences corresponding to different BSS color values), which may reduce a false alarm from OBSS packets. In some examples, the wireless communication device 502 and the wireless communication device 504 may select low/zero correlation sequences or orthogonal sequences with an order of 48/96, 52/104, or 56/112. In other words, the wireless communication device 502 and the wireless communication device 504 may select low/zero correlation sequences or orthogonal sequences with an order (such as a length) of 48, 52, 56, 96, 104, or 112 for ELR sequences. For example, the wireless communication device 502 and the wireless communication device 504 may select, generate, determine, calculate, or identify the set of sequences 604 as columns or rows from a Hadamard matrix, as orthogonal sequences constructed in accordance with (such as using) Golay complementary sequences/pairs, or as orthogonal sequences generated by LTF sequence with different cyclic shift delays, among other examples.

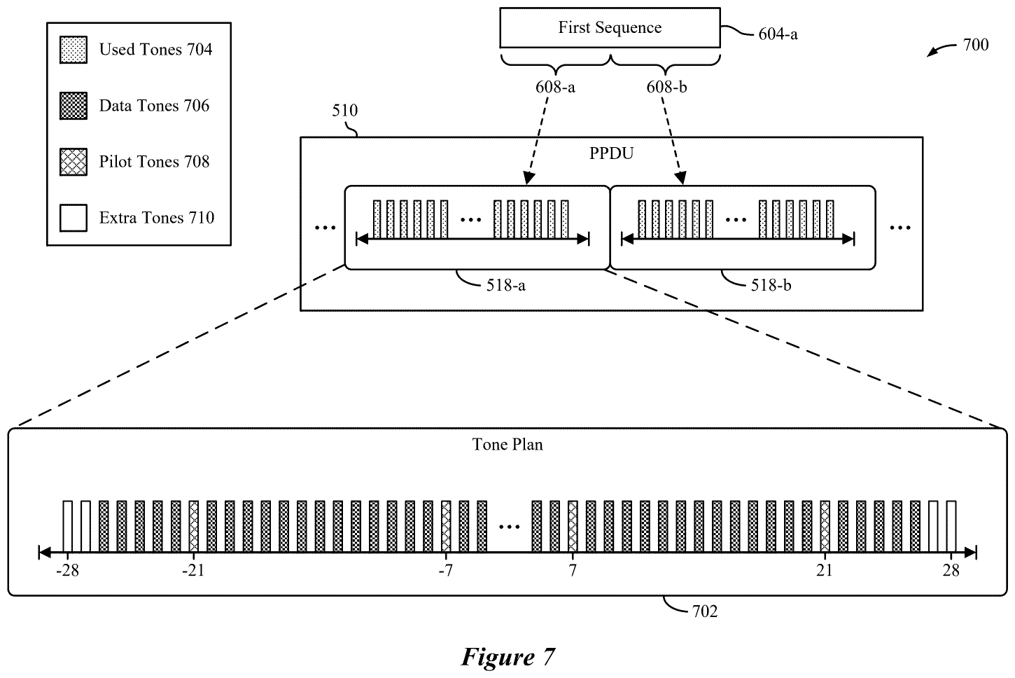

The wireless communication device 502 and the wireless communication device 504 may identify, calculate, generate, select, determine, or otherwise ascertain the set of sequences 604 in accordance with a quantity of possible BSS color values (such as a quantity of BSSs within the set of BSSs 602) and in accordance with a quantity of used tones within the ELR symbol 518-a and the ELR symbol 518-b. For example, a quantity of ELR sequences within the set of sequences 604 may be associated with the quantity of possible BSS color values and a length of each ELR sequence may be associated with the quantity of used tones within the ELR symbol 518-a and the ELR symbol 518-b. Additional details related to such a determination of the set of sequences 604 are illustrated and described herein, including by and with reference to FIG. 7.

In some implementations, the wireless communication device 502 may select to transmit the first sequence 604-a via the ELR symbol 518-a and the ELR symbol 518-b in association with the wireless communication device 502 being associated with the first BSS 602-a. For example, because the wireless communication device 502 belongs to the first BSS 602-a, the wireless communication device 502 may transmit the first sequence 604-a via the ELR symbol 518-a and the ELR symbol 518-b to convey, to the wireless communication device 504, that the PPDU 510 is associated with the first BSS 602-a (via an indirectly indicated BSS color value, such as a BSS color value indicated by or otherwise corresponding to the first sequence 604-a via the mapping 606). The wireless communication device 502 may include a first portion 608-a (such as a first half, such as a first/initial set of values) of the first sequence 604-a in the ELR symbol 518-a and may include a second portion 608-b (such as a second half, such as a second/final set of values) of the first sequence 604-a in the ELR symbol 518-b.

The wireless communication device 504 may selectively parse a remainder of the PPDU 510 in accordance with a correlation level with the first sequence 604-a. For example, if the wireless communication device 504 is also associated with the first BSS 602-a, the wireless communication device 504 may perform a correlation between the sequence received via the ELR symbols and the first sequence 604-a that corresponds to the first BSS 602-a. In examples in which the received sequence is also the first sequence 604-a, the wireless communication device 504 may determine that the two sequences satisfy a threshold correlation level and the wireless communication device 504 may continue parsing the PPDU 510. Alternatively, if the wireless communication device 504 is associated with the second BSS 602-b, the wireless communication device 504 may attempt to correlate the received sequence (the first sequence 604-a) with the second sequence 604-b. In such examples, the wireless communication device 504 may determine that the two sequences fail to satisfy a threshold correlation level and the wireless communication device 504 may drop a remainder of the PPDU 510 accordingly.

FIG. 7 shows an example sequence application scheme 700 that supports ELR-mark sequence design. For example, the wireless communication device 502 may employ the sequence application scheme 700 to map or apply a sequence, such as an ELR sequence, to the ELR symbol 518-a and the ELR symbol 518-b of the PPDU 510. In accordance with the example of the sequence application scheme 700, the wireless communication device 502 and the wireless communication device 504 may apply the first sequence 604-a (an ELR sequence, such as an ELR-mark sequence) to one or both of the ELR symbol 518-a and the ELR symbol 518-b in accordance with a tone plan 702 associated with one or both of the ELR symbol 518-a and the ELR symbol 518-b.

For example, in accordance with the tone plan 702 associated with the ELR symbol 518-a and the ELR symbol 518-b, the wireless communication device 502 and the wireless communication device 504 may apply the first sequence 604-a to a set of used tones 704. As described herein, used tones 704 may be understood as tones that carry or are otherwise occupied by an ELR sequence, such as the first sequence 604-a. The used tones 704 may include any tones that carry an ELR sequence, such as data tones 706, pilot tones 708, extra tones 710, or any combination thereof. In some aspects, each of the ELR symbol 518-a and the ELR symbol 518-b may include 48 data tones 706, 4 pilot tones 708, and 4 extra tones 710. The pilot tones 708 may be located at tone indices of [−21, −7, 7, 21] and the extra tones 710 may be located at tone indices of [−28, −27, 27, 28] in each ELR symbol. The remainder of the tones with powered on (such as with power on) in each ELR symbol may be data tones 706. In some deployments, the ELR symbol 518-a and the ELR symbol 518-b may exclude extra tones 710 (such that tone plans for the ELR symbol 518-a and the ELR symbol 518-b may not include tone indices of [−28, −27, 27, 28]). In some examples, each of the ELR symbol 518-a and the ELR symbol 518-b may include one or more edge tones and one or more direct current (DC) tones, which may function as null tones.

In some implementations, the set of sequences 604 from which the wireless communication device 502 selects the first sequence 604-a may be associated with a quantity of the used tones 704 and a quantity of available or possible BSS color values. For example, the set of sequences 604 may include length-104 sequences in implementations in which the used tones 704 include data tones 706 and pilot tones 708 and exclude extra tones 710 or in implementations in which the used tones 704 include data tones 706 and extra tones 710 and exclude pilot tones 708. Alternatively, the set of sequences 604 may include length-96 sequences in implementations in which the used tones 704 include data tones 706 and exclude pilot tones 708 and extra tones 710 (such as when dedicated pilots are transmitted and when the ELR-mark does not use the 4 extra tones 710 in each ELR symbol). The wireless communication device 502 and the wireless communication device 504 may identify, calculate, generate, select, determine, or otherwise ascertain the set of sequences 604 in one or more of various manners, each of which is at least partially associated with the quantity of the used tones 704 and the quantity of available or possible BSS color values.

In examples in which length-104 ELR sequences and 64 BSS color values are used, the set of sequences 604 may include 64 orthogonal sequences of length-104, which may be constructed in accordance with a binary complementary sequence pair of length-26 or length-52. An example of a binary complementary sequence pair may be a Golay pair, which also may be referred to herein as a Golay complementary sequence pair. A Golay complementary sequence pair of length-26 may be referred to as a Golay 26 pair of two sequences (A26, B26). A Golay complementary sequence pair of length-52 may be referred to as a Golay 52 pair of two sequences (A52, B52). In some aspects, a Golay pair for length-52 may be associated with (such as generated based on) a Golay 26 pair. For example, A52=[A26 B26] and B52=[A26−B26]. A primitive (such as baseline or initial) Golay 26 pair may be defined in accordance with Equations 1 and 2, shown below.

$$A26\_p = [ \begin{matrix}1 & 1 & 1 & 1 & - 1 & 1 & 1 & - 1 & - 1 & 1 & - 1 & 1 & - 1 & 1 & - 1 & - 1 & 1 & - 1 & 1 & 1 & 1 & - 1 & - 1 & 1 & 1 & 1\end{matrix} ] \qquad ( 1 )$$

$$B26\_p = [ \begin{matrix}1 & 1 & 1 & 1 & - 1 & 1 & 1 & - 1 & - 1 & 1 & - 1 & 1 & 1 & 1 & 1 & 1 & - 1 & 1 & - 1 & - 1 & - 1 & 1 & 1 & - 1 & - 1 & - 1\end{matrix} ] \qquad ( 2 )$$

In some aspects, Golay pairs may have several equivalent pairs generated by various operations. Such operations may include an interchanging of sequences, a reversing of sequences, a changing of a sign of sequences, or a changing of a sign of alternate entries in both sequences, among other examples. Accordingly, different variants of the primitive Golay 26 pair may be generated in accordance with applying one or more of such various operations. In some examples, a specific Golay pair (such as either a Golay 26 pair or a Golay 52 pair) used to generate the set of sequences 604 may be selected in accordance that specific Golay pair offering a PAPR that satisfies a target PAPR (or offering a PAPR that is otherwise relatively low compared to PAPRs of other Golay pairs) when applied to one or both of the ELR symbol 518-a or the ELR symbol 518-b.

In implementations in which the 64 orthogonal sequences of length-104 are associated with (such as derived from) a Golay 26 pair, a device may use the selected Golay 26 pair (such as a chosen (A26, B26)) to construct (such as generate, determine, identify, select, calculate, or otherwise ascertain) a Golay-Hadamard matrix (of order 52×52) in accordance with Equation 3 or 4, shown below. A Golay-Hadamard matrix may be denoted herein as a “GH” matrix.

$$G H = [ \begin{matrix}A & B \\ {B}^{T} & - {A}^{T}\end{matrix} ] \qquad ( 3 )$$

$$GH = [ \begin{matrix}A & B \\ - {B}^{T} & {A}^{T}\end{matrix} ] \qquad ( 4 )$$

A and B may be circulant matrices based on shifted versions of A26 and B26, respectively. In other words, A may be a circulant matrix associated with a shifted version of A26 and B may be a circulant matrix associated with a shifted version of B26. For example, A and B may be defined in accordance with Equations 5 and 6, shown below.

$$A = circulant ( A 26 , 1 ) \qquad ( 5 )$$

$$B = circulant ( B 26 , 1 ) \qquad ( 6 )$$

The device may select 32 out of the 52 row or column vectors in the GH matrix (in accordance with using each row vector or each column vector as a sequence to fill in 52 tones in an ELR-mark symbol). In some implementations, the selected subset of row or column vectors (such as the selected 32 out of the 52 row or column vectors) may correspond to sequences that offer or provide a relatively lowest PAPR when applied to one or both of the ELR symbol 518-a or the ELR symbol 518-b. In other words, the selected 32 row or column vectors may correspond to sequences that provide the 32 lowest PAPR values of the 52 total row or column vectors of the GH matrix. The device may select 32 row or column vectors in accordance with 32 being one-half of 64 (such as one-half of the quantity of BSS color values).

The device may save the selected 32 row or column vectors to form a subblock of the GH matrix, which may be denoted as a GHs matrix. The GHs matrix may be of order (32×52) and may be defined in accordance with Equation 7 or 8 (in accordance with whether row or column vectors are selected from the GH matrix), shown below.

$${GH}_{s} = [ selected rows ] \qquad ( 7 )$$

$${GH}_{s} = {[ selected columns ]}^{T} \qquad ( 8 )$$

The device may form (such as generate) a new matrix with orthogonal rows as a Hadamard matrix with an order of (64×104) in accordance with (such as using) the GHs matrix. A Hadamard matrix may be denoted herein as an “H” matrix. To form or generate a Hadamard matrix, the device may perform a Hadamard expansion. In some aspects, each row of the H matrix may correspond to an ELR-mark sequence. In other words, each row of the H matrix may be an ELR-mark sequence. Accordingly, the rows of the H matrix may correspond to the sequences of the set of sequences 604. The H matrix may be formed or generated in accordance with Equation 9, shown below. The device may map each row of the H matrix to a respective BSS color value.

$$H = [ \begin{matrix}{GH}_{s} & {GH}_{s} \\ {GH}_{s} & - {GH}_{s}\end{matrix} ] \qquad ( 9 )$$

In implementations in which the 64 orthogonal sequences of length-104 are associated with (such as derived from) a Golay 52 pair, a device may use the selected Golay 52 pair (such as a chosen (A52, B52)) to construct a GH matrix (of order 104×104) in accordance with Equation 3 or 4, shown above, but with A and B being circulant matrix based on shifted versions of A52 and B52, respectively. In other words, A may be a circulant matrix associated with a shifted version of A52 and B may be a circulant matrix associated with a shifted version of B52. For example, A and B may be defined in accordance with Equations 10 and 11, shown below.

$$A = circulant ( A 52 , 1 ) \qquad ( 10 )$$

$$B = circulant ( B 52 , 1 ) \qquad ( 11 )$$

The device may select 64 out of the 104 row or column vectors in the GH matrix (in accordance with using each row vector or each column vector as a sequence to fill in 52*2 tones in two ELR-mark symbols, and in accordance with the quantity of BSS color values being equal to 64). In some implementations, the selected subset of row or column vectors (such as the selected 64 out of the 104 row or column vectors) may correspond to sequences that offer or provide a relatively lowest PAPR when applied to both of the ELR symbol 518-a and the ELR symbol 518-b. In other words, the selected 64 row or column vectors may correspond to sequences that provide the 64 lowest PAPR values of the 104 total row or column vectors of the GH matrix.

The device may form a new matrix as the selected subset of the GH matrix and may map each row of the new matrix (having an order of 64×104) to a respective BSS color value. In other words, the selected 64 length-104 row or column vectors of the GH matrix may be or correspond to the ELR-mark sequences, each of which maps to a different BSS color value.

Various examples of 64 length-104 ELR sequences are illustrated in table format below. In each of Tables 1-3, shown below, each value of “1” or “−1” corresponds to a value applied to a given (corresponding) tone. Tables 1-2 illustrate example sequence sets in implementations in which ELR-mark symbols are transmitted without dedicated pilots. Table 1 illustrates an example sequence set in implementations in which the 4 extra tones 710 are not used in ELR-mark transmissions. For each sequence illustrated in Table 1, the first or initial 52 elements or values may be applied to 52 used tones 704 in the ELR symbol 518-a and the second or final 52 elements or values may be applied to 52 used tones 704 in the ELR symbol 518-b. The sequences illustrated in Table I may be sequences generated or derived in accordance with a primitive Golay 26 pair. Other sequences may be generated or derived in accordance with one or more variants (such as transformations) of the primitive Golay 26 pair.

Table 2 illustrates an example sequence set in examples in which the 4 extra tones 710 are used in each ELR symbol in ELR-mark transmissions (to align the ELR symbols with, for example, other SIG field symbols). Thus, the sequences of Table 2 may have a length of 112 tones, with 8 tones of the 112 tones (4 tones in each of the 2 ELR symbols) corresponding to the extra tones 710 (at tone indices of [−28, −27, 27, 28] in each ELR symbol). In such examples, the ELR sequences may be generated to have a length of 104 tones, and 8 tone values of “1” or “−1” (or any combination thereof) may be added to each of the length-104 ELR sequences to correspond to the tone indices of the extra tones 710. In some aspects, a device may select a permutation of tone values for the extra tones 710 (out of 16 possible options for the 4 tones in each ELR symbol) in accordance with a PAPR target, constraint, or condition. For example, the device may select the permutation of tone values for the extra tones 710 that leads to or is otherwise associated with a relatively lowest PAPR. The device may select a respective permutation of tone values for the extra tones 710 for each ELR sequence (as the tone values that lead to a lowest PAPR may depend on the other tone values in each given ELR sequence).

Table 3 illustrates an example sequence set in implementations in which ELR-mark symbols are transmitted with dedicated pilots. In such implementations, a length-104 sequence is applied to 104 tones, including 52 data tones*2 symbols by using a complete set of valid data tones 706 (including 4 extra tones 710 at the edge of each ELR symbol). For each sequence illustrated in Table 3, the first or initial 52 elements or values may be applied to 52 used tones 704 in the ELR symbol 518-a and the second or final 52 elements or values may be applied to 52 used tones 704 in the ELR symbol 518-b, skipping pilot tone indices (which may have values to match the pilot tone locations and values as in an EHT-SIG field or a UHR SIG field).

TABLE 1
ELR-mark Sequences of Length-104 Assuming Not Using Extra
Tones in ELR-Mark Transmission and without Dedicated Pilots

| Index | ELR Sequence |
|---|---|
| 1 | 1, 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, 1, −1, −1, 1, 1, 1, −1, 1, −1, −1, 1, −1, 1, −1, 1, −1, −1, 1, 1, −1, |
| | 1, 1, 1, 1, 1, 1, 1, 1, −1, 1, 1, −1, −1, 1, −1, 1, 1, 1, 1, 1, −1, 1, −1, −1, −1, 1, 1, −1, −1, −1 |
| 2 | 1, 1, 1, 1, −1, −1, 1, 1, 1, −1, 1, −1, −1, 1, −1, 1, −1, 1, −1, −1, 1, 1, −1, 1, 1, 1, −1, 1, 1, 1, 1, −1, 1, 1, −1, −1, 1, −1, |
| | 1, 1, 1, 1, 1, −1, 1, −1, −1, −1, 1, 1, −1, −1, 1, 1, 1, 1, −1, −1, 1, 1, 1, −1, 1, −1, −1, 1, −1, 1, −1, 1, −1, −1, 1, 1, −1, |
| | 1, 1, 1, −1, 1, 1, 1, 1, −1, 1, 1, −1, −1, 1, −1, 1, 1, 1, 1, 1, −1, 1, −1, −1, −1, 1, 1, −1, −1 |
| 3 | 1, 1, 1, 1, 1, −1, −1, 1, 1, 1, −1, 1, −1, −1, 1, −1, 1, −1, 1, −1, −1, 1, 1, −1, 1, 1, −1, −1, 1, 1, 1, 1, −1, 1, 1, −1, −1, 1, −1, |
| | 1, 1, 1, 1, 1, −1, 1, −1, −1, −1, 1, 1, −1, 1, 1, 1, 1, 1, −1, −1, 1, 1, 1, −1, 1, −1, −1, 1, −1, 1, −1, 1, −1, −1, 1, 1, −1, |
| | 1, 1, −1, −1, 1, 1, 1, 1, −1, 1, 1, −1, −1, 1, −1, 1, 1, 1, 1, 1, −1, 1, −1, −1, −1, 1, 1, −1 |
| 4 | 1, −1, 1, 1, 1, 1, 1, 1, 1, −1, −1, 1, 1, 1, −1, 1, −1, −1, 1, −1, 1, −1, 1, −1, −1, 1, −1, 1, 1, −1, −1, −1, 1, 1, 1, 1, −1, 1, 1, −1, |
| | −1, 1, −1, 1, 1, 1, 1, 1, −1, 1, −1, −1, 1, −1, 1, 1, 1, 1, 1, 1, 1, −1, −1, 1, 1, 1, −1, 1, −1, −1, 1, −1, 1, −1, 1, −1, −1, 1, −1, |
| | 1, 1, −1, −1, −1, 1, 1, 1, 1, −1, 1, 1, −1, −1, 1, −1, 1, 1, 1, 1, 1, −1, 1, −1, −1 |
| 5 | −1, 1, −1, −1, 1, 1, −1, 1, 1, 1, 1, 1, 1, 1, −1, −1, 1, 1, 1, −1, 1, −1, −1, 1, −1, 1, 1, −1, 1, −1, −1, −1, 1, 1, −1, −1, −1, |
| | 1, 1, 1, 1, −1, 1, 1, −1, −1, 1, −1, 1, 1, 1, 1, −1, 1, −1, −1, 1, 1, −1, 1, 1, 1, 1, 1, 1, 1, −1, −1, 1, 1, 1, −1, 1, −1, −1, 1, −1, |
| | 1, 1, 1, −1, 1, −1, −1, −1, 1, 1, −1, −1, −1, 1, 1, 1, 1, −1, 1, 1, −1, −1, 1, −1, 1, 1, 1, 1 |
| 6 | −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, −1, −1, |
| | 1, 1, 1, 1, −1, 1, 1, −1, −1, 1, −1, 1, 1, −1, 1, −1, 1, −1, −1, 1, 1, −1, 1, 1, 1, 1, 1, 1, 1, −1, −1, 1, 1, 1, −1, 1, −1, −1, |
| | 1, 1, 1, 1, −1, 1, −1, −1, −1, 1, 1, −1, −1, −1, 1, 1, 1, 1, −1, 1, 1, −1, −1, 1, −1, 1, 1 |
| 7 | 1, −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, −1, |
| | −1, 1, 1, 1, 1, −1, 1, 1, −1, −1, 1, −1, 1, 1, −1, 1, −1, 1, −1, −1, 1, 1, −1, 1, 1, 1, 1, 1, 1, 1, −1, −1, 1, 1, 1, −1, 1, −1, −1, |
| | 1, 1, 1, 1, −1, 1, −1, −1, −1, 1, 1, −1, −1, −1, 1, 1, 1, 1, −1, 1, 1, −1, −1, 1, −1, 1 |
| 8 | −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, −1, 1, 1, −1, −1, |
| | −1, 1, 1, 1, 1, −1, 1, 1, −1, −1, 1, −1, −1, 1, −1, 1, −1, 1, −1, −1, 1, 1, −1, 1, 1, 1, 1, 1, 1, 1, −1, −1, 1, 1, 1, −1, 1, −1, |
| | 1, 1, 1, 1, 1, −1, 1, −1, −1, −1, 1, 1, −1, −1, −1, 1, 1, 1, 1, −1, 1, 1, −1, −1, 1, −1 |
| 9 | −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, −1, 1, 1, −1, |
| | −1, −1, 1, 1, 1, 1, −1, 1, 1, −1, −1, 1, −1, −1, 1, −1, 1, −1, 1, −1, −1, 1, 1, −1, 1, 1, 1, 1, 1, 1, 1, −1, −1, 1, 1, 1, −1, 1, −1, |
| | 1, 1, 1, 1, 1, −1, 1, −1, −1, −1, 1, 1, −1, −1, −1, 1, 1, 1, 1, −1, 1, 1, −1, −1, 1 |
| 10 | 1, −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, −1, |
| | 1, 1, −1, −1, −1, 1, 1, 1, 1, −1, 1, 1, −1, −1, 1, −1, −1, 1, −1, 1, −1, 1, −1, −1, 1, 1, −1, 1, 1, 1, 1, 1, 1, 1, −1, −1, |
| | 1, 1, 1, −1, 1, −1, 1, 1, 1, 1, 1, −1, 1, −1, −1, −1, 1, 1, −1, −1, −1, 1, 1, 1, 1, −1, 1, 1, −1, −1 |
| 11 | 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, 1, −1, −1, 1, 1, 1, −1, 1, −1, −1, 1, −1, 1, −1, 1, −1, −1, 1, 1, −1, |
| | 1, 1, 1, 1, 1, 1, 1, 1, −1, 1, 1, −1, −1, 1, −1, 1, 1, 1, 1, 1, −1, 1, −1, −1, −1, 1, 1, −1, −1, −1, 1, 1 |
| 12 | 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, 1, −1, −1, 1, 1, 1, −1, 1, −1, −1, 1, −1, 1, −1, 1, −1, −1, 1, 1, −1, |
| | 1, 1, 1, 1, 1, 1, 1, 1, −1, 1, 1, −1, −1, 1, −1, 1, 1, 1, 1, 1, −1, 1, −1, −1, −1, 1, 1, −1, −1, −1, 1 |
| 13 | 1, −1, −1, −1, 1, 1, −1, −1, −1, 1, −1, 1, 1, 1, 1, 1, −1, 1, −1, −1, 1, 1, −1, 1, 1, 1, −1, −1, −1, −1, −1, 1, −1, −1, 1, 1, −1, |
| | 1, −1, 1, −1, 1, 1, −1, 1, −1, −1, −1, 1, 1, −1, −1, 1, −1, −1, −1, 1, 1, −1, −1, −1, 1, −1, 1, 1, 1, 1, 1, −1, 1, −1, −1, |
| | 1, 1, −1, 1, 1, 1, −1, −1, −1, −1, −1, 1, −1, −1, 1, 1, −1, 1, −1, 1, −1, 1, 1, −1, 1, −1, −1, −1, 1, 1, −1, −1 |
| 14 | 1, 1, −1, −1, −1, 1, 1, −1, −1, −1, 1, −1, 1, 1, 1, 1, 1, −1, 1, −1, −1, 1, 1, −1, 1, 1, −1, −1, −1, −1, −1, −1, 1, −1, −1, 1, 1, −1, |
| | 1, −1, 1, −1, 1, 1, −1, 1, −1, −1, −1, 1, 1, −1, 1, 1, −1, −1, −1, 1, 1, −1, −1, −1, 1, −1, 1, 1, 1, 1, 1, −1, 1, −1, −1, 1, 1, −1, |
| | 1, 1, −1, −1, −1, −1, −1, −1, 1, −1, −1, 1, 1, −1, 1, −1, 1, −1, 1, 1, −1, 1, −1, −1, −1, 1, 1, −1 |
| 15 | 1, 1, 1, −1, −1, −1, 1, 1, −1, −1, −1, 1, −1, 1, 1, 1, 1, 1, −1, 1, −1, −1, 1, 1, −1, 1, −1, −1, −1, −1, −1, −1, −1, 1, −1, −1, |
| | 1, 1, −1, 1, −1, 1, −1, 1, 1, −1, 1, −1, −1, −1, 1, 1, 1, 1, 1, −1, −1, −1, 1, 1, −1, −1, −1, 1, −1, 1, 1, 1, 1, 1, −1, 1, −1, −1, |
| | 1, 1, −1, 1, −1, −1, −1, −1, −1, −1, −1, 1, −1, −1, 1, 1, −1, 1, −1, 1, −1, 1, 1, −1, 1, −1, −1, −1, 1, 1 |
| 16 | −1, 1, 1, 1, 1, −1, −1, −1, 1, 1, −1, −1, −1, 1, −1, 1, 1, 1, 1, 1, −1, 1, −1, −1, 1, 1, 1, 1, −1, −1, −1, −1, −1, −1, −1, 1, −1, −1, |
| | 1, 1, −1, 1, −1, 1, −1, 1, 1, −1, 1, −1, −1, −1, −1, 1, 1, 1, 1, −1, −1, −1, 1, 1, −1, −1, −1, 1, −1, 1, 1, 1, 1, 1, −1, 1, −1, −1, |
| | 1, 1, 1, 1, −1, −1, −1, −1, −1, −1, −1, 1, −1, −1, 1, 1, −1, 1, −1, 1, −1, 1, 1, −1, 1, −1, −1, −1 |
| 17 | 1, −1, 1, 1, 1, 1, −1, −1, −1, 1, 1, −1, −1, −1, 1, −1, 1, 1, 1, 1, 1, −1, 1, −1, −1, 1, −1, 1, 1, −1, −1, −1, −1, −1, −1, −1, 1, −1, |
| | −1, 1, 1, −1, 1, −1, 1, −1, 1, 1, −1, 1, −1, −1, 1, −1, 1, 1, 1, 1, −1, −1, −1, 1, 1, −1, −1, −1, 1, −1, 1, 1, 1, 1, 1, −1, 1, −1, |
| | −1, 1, −1, 1, 1, −1, −1, −1, −1, −1, −1, −1, 1, −1, −1, 1, 1, −1, 1, −1, 1, −1, 1, 1, −1, 1, −1, −1 |
| 18 | 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, −1, −1, |
| | 1, −1, −1, 1, 1, −1, 1, −1, 1, −1, 1, 1, −1, 1, −1, 1, 1, −1, 1, 1, 1, 1, −1, −1, −1, 1, 1, −1, −1, −1, 1, −1, 1, 1, 1, 1, 1, −1, |
| | 1, −1, −1, −1, −1, 1, 1, −1, −1, −1, −1, −1, −1, −1, 1, −1, −1, 1, 1, −1, 1, −1, 1, −1, 1, 1, −1, 1, −1 |
| 19 | −1, 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, −1, |
| | −1, 1, −1, −1, 1, 1, −1, 1, −1, 1, −1, 1, 1, −1, 1, −1, 1, 1, −1, 1, 1, 1, 1, −1, −1, −1, 1, 1, −1, −1, −1, 1, −1, |
| | 1, 1, 1, 1, 1, −1, 1, −1, −1, −1, −1, 1, 1, −1, −1, −1, −1, −1, −1, −1, 1, −1, −1, 1, 1, −1, 1, −1, 1, −1, 1, 1, −1, 1 |
| 20 | −1, 1, −1, −1, 1, 1, −1, 1, 1, 1, 1, −1, −1, −1, 1, 1, −1, −1, −1, 1, −1, 1, 1, 1, 1, 1, 1, −1, 1, −1, −1, −1, 1, 1, −1, −1, −1, −1, |
| | −1, −1, −1, 1, −1, −1, 1, 1, −1, 1, −1, 1, −1, 1, −1, 1, −1, −1, 1, 1, −1, 1, 1, 1, 1, −1, −1, −1, 1, 1, −1, −1, −1, 1, −1, |
| | 1, 1, 1, 1, 1, 1, −1, 1, −1, −1, −1, 1, 1, −1, −1, −1, −1, −1, −1, −1, 1, −1, −1, 1, 1, −1, 1, −1, 1, −1, 1 |
| 21 | 1, −1, 1, −1, −1, 1, 1, −1, 1, 1, 1, 1, −1, −1, −1, 1, 1, −1, −1, −1, 1, −1, 1, 1, 1, 1, 1, 1, −1, 1, −1, −1, −1, 1, 1, −1, −1, −1, |
| | −1, −1, −1, −1, 1, −1, −1, 1, 1, −1, 1, −1, 1, −1, 1, −1, 1, −1, −1, 1, 1, −1, 1, 1, 1, 1, −1, −1, −1, 1, 1, −1, −1, −1, 1, −1, |
| | 1, 1, 1, 1, 1, 1, −1, 1, −1, −1, −1, 1, 1, −1, −1, −1, −1, −1, −1, −1, 1, −1, −1, 1, 1, −1, 1, −1, 1, −1 |
| 22 | 1, 1, −1, 1, −1, −1, 1, 1, −1, 1, 1, 1, 1, −1, −1, −1, 1, 1, −1, −1, −1, 1, −1, 1, 1, 1, −1, 1, 1, −1, 1, −1, −1, −1, 1, 1, −1, −1, |
| | −1, −1, −1, −1, −1, 1, −1, −1, 1, 1, −1, 1, −1, 1, 1, 1, −1, 1, −1, −1, 1, 1, −1, 1, 1, 1, 1, −1, −1, −1, 1, 1, −1, −1, −1, 1, −1, |
| | 1, 1, 1, −1, 1, 1, −1, 1, −1, −1, −1, 1, 1, −1, −1, −1, −1, −1, −1, −1, 1, −1, −1, 1, 1, −1, 1, −1, 1 |
| 23 | 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, 1, 1, −1, |
| | −1, −1, −1, −1, −1, −1, 1, −1, −1, 1, 1, −1, 1, 1, 1, 1, 1, −1, 1, −1, −1, 1, 1, −1, 1, 1, 1, 1, −1, −1, −1, 1, 1, −1, −1, −1, |
| | 1, −1, 1, −1, 1, −1, 1, 1, −1, 1, −1, −1, −1, 1, 1, −1, −1, −1, −1, −1, −1, −1, 1, −1, −1, 1, 1, −1, 1 |
| 24 | 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, −1, 1, 1, 1, 1, 1, −1, 1, −1, −1, 1, 1, −1, 1, 1, 1, 1, −1, −1, −1, 1, 1, −1, |
| | −1, −1, 1, −1, 1, −1, 1, −1, 1, 1, −1, 1, −1, −1, −1, 1, 1, −1, −1, −1, −1, −1, −1, −1, 1, −1, −1, 1, 1, −1 |
| 25 | −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, −1, 1, 1, 1, 1, 1, −1, 1, −1, −1, 1, 1, −1, 1, 1, 1, 1, −1, −1, −1, 1, 1, −1, |
| | −1, −1, 1, −1, 1, −1, 1, −1, 1, 1, −1, 1, −1, −1, −1, 1, 1, −1, −1, −1, −1, −1, −1, −1, 1, −1, −1, 1, 1 |
| 26 | 1, −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, −1, 1, 1, 1, 1, 1, −1, 1, −1, −1, 1, 1, −1, 1, 1, 1, 1, −1, −1, −1, 1, 1, −1, |
| | −1, −1, 1, −1, 1, −1, 1, −1, 1, 1, −1, 1, −1, −1, −1, 1, 1, −1, −1, −1, −1, −1, −1, −1, 1, −1, −1, 1 |
| 27 | −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, 1, −1, −1, |
| | −1, 1, 1, −1, −1, −1, −1, −1, −1, −1, 1, −1, −1, −1, 1, −1, 1, 1, 1, 1, 1, −1, 1, −1, −1, 1, 1, −1, 1, 1, 1, 1, −1, −1, −1, |
| | 1, 1, −1, −1, 1, 1, −1, 1, −1, 1, −1, 1, 1, −1, 1, −1, −1, −1, 1, 1, −1, −1, −1, −1, −1, −1, −1, 1, −1, −1 |
| 28 | −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, 1, −1, |
| | −1, −1, 1, 1, −1, −1, −1, −1, −1, −1, −1, 1, −1, −1, −1, 1, −1, 1, 1, 1, 1, 1, −1, 1, −1, −1, 1, 1, −1, 1, 1, 1, 1, −1, −1, −1, |
| | 1, 1, −1, −1, 1, 1, −1, 1, −1, 1, −1, 1, 1, −1, 1, −1, −1, −1, 1, 1, −1, −1, −1, −1, −1, −1, −1, 1, −1 |
| 29 | −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, |
| | 1, −1, −1, −1, 1, 1, −1, −1, −1, −1, −1, −1, −1, 1, −1, −1, −1, 1, −1, 1, 1, 1, 1, 1, −1, 1, −1, −1, 1, 1, −1, 1, 1, 1, 1, −1, −1, |
| | −1, 1, 1, −1, −1, 1, 1, −1, 1, −1, 1, −1, 1, 1, −1, 1, −1, −1, −1, 1, 1, −1, −1, −1, −1, −1, −1, −1, 1 |
| 30 | −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, 1, −1, |
| | 1, 1, −1, 1, −1, −1, −1, 1, 1, −1, −1, −1, −1, −1, −1, 1, 1, −1, −1, −1, 1, −1, 1, 1, 1, 1, 1, −1, 1, −1, −1, 1, 1, −1, |
| | 1, 1, 1, 1, −1, −1, −1, −1, 1, −1, −1, 1, 1, −1, 1, −1, 1, −1, 1, 1, −1, 1, −1, −1, −1, 1, 1, −1, −1, −1, −1, −1 |
| 31 | −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, |
| | 1, −1, 1, 1, −1, 1, −1, −1, −1, 1, 1, −1, −1, −1, −1, −1, −1, 1, 1, −1, −1, −1, 1, −1, 1, 1, 1, 1, 1, −1, 1, −1, −1, 1, 1, −1, |
| | 1, 1, 1, 1, −1, −1, −1, −1, 1, −1, −1, 1, 1, −1, 1, −1, 1, −1, 1, 1, −1, 1, −1, −1, −1, 1, 1, −1, −1, −1, −1 |
| 32 | −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, |
| | 1, −1, 1, 1, −1, 1, −1, −1, −1, 1, 1, −1, −1, −1, −1, −1, −1, 1, 1, −1, −1, −1, 1, −1, 1, 1, 1, 1, 1, −1, 1, −1, −1, 1, 1, −1, |
| | 1, 1, 1, 1, −1, −1, −1, −1, 1, −1, −1, 1, 1, −1, 1, −1, 1, −1, 1, 1, −1, 1, −1, −1, −1, 1, 1, −1, −1, −1 |
| 33 | 1, 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, −1, −1, −1, 1, 1, −1, −1, −1, 1, −1, 1, 1, −1, 1, −1, 1, −1, 1, 1, −1, −1, |
| | 1, −1, −1, −1, −1, −1, −1, −1, −1, 1, −1, −1, 1, 1, −1, 1, −1, −1, −1, −1, −1, 1, −1, 1, 1, 1, −1, −1, 1, 1, 1 |
| 34 | 1, 1, 1, 1, −1, −1, 1, 1, 1, −1, 1, −1, −1, 1, −1, 1, −1, 1, −1, −1, 1, 1, −1, 1, 1, 1, −1, 1, 1, 1, 1, −1, 1, 1, −1, −1, 1, −1, |
| | 1, 1, 1, 1, 1, −1, 1, −1, −1, −1, 1, 1, −1, −1, −1, −1, −1, −1, 1, 1, −1, −1, −1, 1, −1, 1, 1, −1, 1, −1, 1, −1, 1, 1, −1, −1, |
| | 1, 1, −1, −1, −1, 1, −1, −1, −1, −1, 1, −1, −1, 1, 1, −1, 1, −1, −1, −1, −1, −1, 1, −1, 1, 1, 1, −1, −1, 1, 1 |
| 35 | 1, 1, 1, 1, 1, −1, −1, 1, 1, 1, −1, 1, −1, −1, 1, −1, 1, −1, 1, −1, −1, 1, 1, −1, 1, 1, −1, −1, 1, 1, 1, 1, −1, 1, 1, −1, −1, 1, −1, |
| | 1, 1, 1, 1, 1, −1, 1, −1, −1, −1, 1, 1, −1, −1, −1, −1, −1, −1, 1, 1, −1, −1, −1, 1, −1, 1, 1, −1, 1, −1, 1, −1, 1, 1, −1, −1, |
| | 1, −1, −1, 1, 1, −1, −1, −1, −1, 1, −1, −1, 1, 1, −1, 1, −1, −1, −1, −1, −1, 1, −1, 1, 1, 1, −1, −1, 1 |
| 36 | 1, −1, 1, 1, 1, 1, 1, 1, 1, −1, −1, 1, 1, 1, −1, 1, −1, −1, 1, −1, 1, −1, 1, −1, −1, 1, −1, 1, 1, −1, −1, −1, 1, 1, 1, 1, −1, 1, 1, −1, |
| | −1, 1, −1, 1, 1, 1, 1, 1, −1, 1, −1, −1, −1, 1, −1, −1, −1, −1, −1, −1, −1, 1, 1, −1, −1, −1, 1, −1, 1, 1, −1, 1, −1, 1, −1, |
| | 1, 1, −1, 1, −1, −1, 1, 1, 1, −1, −1, −1, −1, 1, −1, −1, 1, 1, −1, 1, −1, −1, −1, −1, −1, 1, −1, 1, 1 |
| 37 | −1, 1, −1, −1, 1, 1, −1, 1, 1, 1, 1, 1, 1, 1, −1, −1, 1, 1, 1, −1, 1, −1, −1, 1, −1, 1, 1, −1, 1, −1, −1, −1, 1, 1, −1, −1, −1, |
| | 1, 1, 1, 1, −1, 1, 1, −1, −1, 1, −1, 1, 1, 1, 1, 1, −1, 1, 1, −1, −1, 1, −1, −1, −1, −1, −1, −1, −1, 1, 1, −1, −1, −1, 1, −1, |
| | 1, 1, −1, 1, −1, −1, 1, −1, 1, 1, 1, −1, −1, 1, 1, 1, −1, −1, −1, −1, 1, −1, −1, 1, 1, −1, 1, −1, −1, −1, −1 |
| 38 | −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, −1, −1, |
| | 1, 1, 1, 1, −1, 1, 1, −1, −1, 1, −1, 1, 1, 1, −1, 1, −1, 1, 1, −1, −1, 1, −1, −1, −1, −1, −1, −1, −1, 1, 1, −1, −1, −1, 1, −1, |
| | 1, 1, −1, −1, −1, −1, 1, −1, 1, 1, 1, −1, −1, 1, 1, 1, −1, −1, −1, −1, 1, −1, −1, 1, 1, −1, 1, −1, −1 |
| 39 | 1, −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, −1, |
| | −1, 1, 1, 1, 1, −1, 1, 1, −1, −1, 1, −1, 1, −1, 1, −1, 1, −1, 1, 1, −1, −1, 1, −1, −1, −1, −1, −1, −1, −1, 1, 1, −1, −1, −1, |
| | 1, −1, 1, 1, −1, −1, −1, −1, 1, −1, 1, 1, 1, −1, −1, 1, 1, 1, −1, −1, −1, −1, 1, −1, −1, 1, 1, −1, 1, −1 |
| 40 | −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, −1, −1, 1, 1, −1, −1 |
| | −1, 1, 1, 1, 1, −1, 1, 1, −1, −1, 1, −1, 1, −1, 1, −1, 1, −1, 1, 1, −1, −1, 1, −1, −1, −1, −1, −1, −1, −1, 1, 1, −1, −1, −1, |
| | 1, −1, 1, −1, −1, −1, −1, −1, 1, −1, 1, 1, 1, −1, −1, 1, 1, 1, −1, −1, −1, −1, 1, −1, −1, 1, 1, −1, 1 |
| 41 | −1, −1, 1, −1, 1, −1, 1, −1, −1, 1, 1, −1, 1, 1, 1, 1, 1, 1, 1, −1, 1, 1, 1, −1, 1, −1, 1, 1, 1, 1, 1, −1, 1, −1, −1, −1, 1, 1, −1, |
| | −1, −1, 1, 1, 1, 1, −1, 1, 1, −1, −1, 1, 1, 1, −1, 1, −1, 1, −1, 1, 1, −1, −1, 1, −1, −1, −1, −1, −1, −1, −1, 1, 1, −1, −1, −1, |
| | 1, −1, 1, −1, −1, −1, −1, −1, 1, −1, 1, 1, 1, −1, −1, 1, 1, 1, −1, −1, −1, −1, 1, −1, −1, 1, 1, −1 |
| 42 | 1, −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, −1, |
| | 1, 1, −1, −1, −1, 1, 1, 1, 1, −1, 1, 1, −1, −1, −1, 1, 1, −1, 1, −1, 1, −1, 1, 1, −1, −1, 1, −1, −1, −1, −1, −1, −1, −1, 1, 1, −1, |
| | −1, −1, 1, −1, 1, −1, −1, −1, −1, −1, 1, −1, 1, 1, 1, −1, −1, 1, 1, 1, −1, −1, −1, −1, 1, −1, −1, 1, 1 |
| 43 | 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, −1, 1, 1, −1, −1, −1, 1, −1, 1, 1, −1, 1, −1, 1, −1, 1, 1, −1, −1, 1, −1, |
| | −1, −1, −1, −1, −1, −1, −1, 1, −1, −1, 1, 1, −1, 1, −1, −1, −1, −1, −1, 1, −1, 1, 1, 1, −1, −1, 1, 1, 1, −1, −1 |
| 44 | 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, −1, −1, 1, 1, −1, −1, −1, 1, −1, 1, 1, −1, 1, −1, 1, −1, 1, 1, −1, −1, |
| | 1, 1, −1, −1, −1, −1, −1, −1, −1, −1, 1, −1, −1, 1, 1, −1, 1, −1, −1, −1, −1, −1, 1, −1, 1, 1, 1, −1, −1, 1, 1, 1, −1 |
| 45 | 1, −1, −1, −1, 1, 1, −1, −1, −1, 1, −1, 1, 1, 1, 1, 1, −1, 1, −1, −1, 1, 1, −1, 1, 1, 1, −1, −1, −1, −1, −1, 1, −1, −1, 1, 1, −1, |
| | 1, −1, 1, −1, 1, 1, −1, 1, −1, −1, −1, 1, 1, −1, −1, −1, 1, 1, 1, −1, −1, 1, 1, 1, −1, 1, −1, −1, −1, −1, −1, 1, −1, 1, 1, −1, −1, |
| | 1, −1, −1, −1, 1, 1, 1, 1, 1, −1, 1, 1, −1, −1, 1, −1, 1, −1, 1, −1, −1, 1, −1, 1, 1, 1, −1, −1, 1, 1 |
| 46 | 1, 1, −1, −1, −1, 1, 1, −1, −1, −1, 1, −1, 1, 1, 1, 1, 1, −1, 1, −1, −1, 1, 1, −1, 1, 1, −1, −1, −1, −1, −1, −1, 1, −1, −1, 1, 1, −1, |
| | 1, −1, 1, −1, 1, 1, −1, 1, −1, −1, −1, 1, 1, −1, −1, −1, 1, 1, 1, −1, −1, 1, 1, 1, −1, 1, −1, −1, −1, −1, −1, 1, −1, 1, 1, −1, −1, |
| | 1, −1, −1, 1, 1, 1, 1, 1, 1, −1, 1, 1, −1, −1, 1, −1, 1, −1, 1, −1, −1, 1, −1, 1, 1, 1, −1, −1, 1 |
| 47 | 1, 1, 1, −1, −1, −1, 1, 1, −1, −1, −1, 1, −1, 1, 1, 1, 1, 1, −1, 1, −1, −1, 1, 1, −1, 1, −1, −1, −1, −1, −1, −1, −1, 1, −1, −1, |
| | 1, 1, −1, 1, −1, 1, −1, 1, 1, −1, 1, −1, −1, −1, 1, 1, −1, −1, −1, 1, 1, 1, −1, −1, 1, 1, 1, −1, 1, −1, −1, −1, −1, −1, 1, −1, |
| | 1, 1, −1, −1, 1, −1, 1, 1, 1, 1, 1, 1, 1, −1, 1, 1, −1, −1, 1, −1, 1, −1, 1, −1, −1, 1, −1, 1, 1, 1, −1, −1 |
| 48 | −1, 1, 1, 1, 1, −1, −1, −1, 1, 1, −1, −1, −1, 1, −1, 1, 1, 1, 1, 1, −1, 1, −1, −1, 1, 1, 1, 1, −1, −1, −1, −1, −1, −1, −1, 1, −1, −1, |
| | 1, 1, −1, 1, −1, 1, −1, 1, 1, −1, 1, −1, −1, −1, 1, −1, −1, −1, −1, 1, 1, 1, −1, −1, 1, 1, 1, −1, 1, −1, −1, −1, −1, −1, 1, −1, |
| | 1, 1, −1, −1, −1, −1, 1, 1, 1, 1, 1, 1, 1, −1, 1, 1, −1, −1, 1, −1, 1, −1, 1, −1, −1, 1, −1, 1, 1, 1 |
| 49 | 1, −1, 1, 1, 1, 1, −1, −1, −1, 1, 1, −1, −1, −1, 1, −1, 1, 1, 1, 1, 1, −1, 1, −1, −1, 1, −1, 1, 1, −1, −1, −1, −1, −1, −1, −1, 1, −1, |
| | −1, 1, 1, −1, 1, −1, 1, −1, 1, 1, −1, 1, −1, −1, −1, 1, −1, −1, −1, −1, 1, 1, 1, −1, −1, 1, 1, 1, −1, 1, −1, −1, −1, −1, −1, |
| | 1, −1, 1, 1, −1, 1, −1, −1, 1, 1, 1, 1, 1, 1, 1, −1, 1, 1, −1, −1, 1, −1, 1, −1, 1, −1, −1, 1, −1, 1, 1 |
| 50 | 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, −1, −1, |
| | 1, −1, −1, 1, 1, −1, 1, −1, 1, −1, 1, 1, −1, 1, −1, −1, −1, 1, −1, −1, −1, −1, 1, 1, 1, −1, −1, 1, 1, 1, −1, 1, −1, −1, −1, −1, |
| | −1, 1, −1, 1, 1, 1, 1, −1, −1, 1, 1, 1, 1, 1, 1, 1, −1, 1, 1, −1, −1, 1, −1, 1, −1, 1, −1, −1, 1, −1, 1 |
| 51 | −1, 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, −1, |
| | −1, 1, −1, −1, 1, 1, −1, 1, −1, 1, −1, 1, 1, −1, 1, 1, −1, −1, 1, −1, −1, −1, −1, 1, 1, 1, −1, −1, 1, 1, 1, −1, 1, −1, −1, −1, −1, |
| | −1, 1, −1, 1, 1, 1, 1, −1, −1, 1, 1, 1, 1, 1, 1, 1, −1, 1, 1, −1, −1, 1, −1, 1, −1, 1, −1, −1, 1, −1 |
| 52 | −1, 1, −1, −1, 1, 1, −1, 1, 1, 1, 1, −1, −1, −1, 1, 1, −1, −1, −1, 1, −1, 1, 1, 1, 1, 1, 1, −1, 1, −1, −1, −1, 1, 1, −1, −1, −1, −1, |
| | −1, −1, −1, 1, −1, −1, 1, 1, −1, 1, −1, 1, −1, 1, 1, −1, 1, 1, −1, −1, 1, −1, −1, −1, −1, 1, 1, 1, −1, −1, 1, 1, 1, −1, 1, −1, −1, |
| | −1, −1, −1, −1, 1, −1, 1, 1, 1, −1, −1, 1, 1, 1, 1, 1, 1, 1, −1, 1, 1, −1, −1, 1, −1, 1, −1, 1, −1 |
| 53 | 1, −1, 1, −1, −1, 1, 1, −1, 1, 1, 1, 1, −1, −1, −1, 1, 1, −1, −1, −1, 1, −1, 1, 1, 1, 1, 1, 1, −1, 1, −1, −1, −1, 1, 1, −1, −1, −1, |
| | −1, −1, −1, −1, 1, −1, −1, 1, 1, −1, 1, −1, 1, −1, −1, 1, −1, 1, 1, −1, −1, 1, −1, −1, −1, −1, 1, 1, 1, −1, −1, 1, 1, 1, −1, |
| | 1, −1, −1, −1, −1, −1, −1, 1, −1, 1, 1, 1, −1, −1, 1, 1, 1, 1, 1, 1, 1, −1, 1, 1, −1, −1, 1, −1, 1, −1, 1 |
| 54 | 1, 1, −1, 1, −1, −1, 1, 1, −1, 1, 1, 1, 1, −1, −1, −1, 1, 1, −1, −1, −1, 1, −1, 1, 1, 1, −1, 1, 1, −1, 1, −1, −1, −1, 1, 1, −1, −1, |
| | −1, −1, −1, −1, −1, 1, −1, −1, 1, 1, −1, 1, −1, 1, −1, −1, 1, −1, 1, 1, −1, −1, 1, −1, −1, −1, −1, 1, 1, 1, −1, −1, 1, 1, 1, −1, |
| | 1, 1, −1, −1, −1, 1, −1, −1, 1, −1, 1, 1, 1, −1, −1, 1, 1, 1, 1, 1, 1, 1, −1, 1, 1, −1, −1, 1, −1, 1, −1 |
| 55 | 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, 1, 1, −1, |
| | −1, −1, −1, −1, −1, −1, 1, −1, −1, 1, 1, −1, 1, −1, −1, −1, −1, 1, −1, 1, 1, −1, −1, 1, −1, −1, −1, −1, 1, 1, 1, −1, −1, |
| | 1, 1, 1, −1, 1, −1, 1, −1, 1, −1, −1, 1, −1, 1, 1, 1, −1, −1, 1, 1, 1, 1, 1, 1, 1, −1, 1, 1, −1, −1, 1, −1 |
| 56 | 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, −1, −1, −1, −1, −1, −1, 1, −1, 1, 1, −1, −1, 1, −1, −1, −1, −1, 1, 1, 1, −1, |
| | −1, 1, 1, 1, −1, 1, −1, 1, −1, 1, −1, −1, 1, −1, 1, 1, 1, −1, −1, 1, 1, 1, 1, 1, 1, 1, −1, 1, 1, −1, −1, 1 |
| 57 | −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, 1, −1, −1, −1, −1, −1, 1, −1, 1, 1, −1, −1, 1, −1, −1, −1, −1, 1, 1, 1, −1, −1, |
| | 1, 1, 1, −1, 1, −1, 1, −1, 1, −1, −1, 1, −1, 1, 1, 1, −1, −1, 1, 1, 1, 1, 1, 1, 1, −1, 1, 1, −1, −1 |
| 58 | 1, −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, −1, 1, −1, −1, −1, −1, −1, 1, −1, 1, 1, −1, −1, 1, −1, −1, −1, −1, 1, 1, 1, −1, |
| | −1, 1, 1, 1, −1, 1, −1, 1, −1, 1, −1, −1, 1, −1, 1, 1, 1, −1, −1, 1, 1, 1, 1, 1, 1, 1, −1, 1, 1, −1 |
| 59 | −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, 1, −1, −1, |
| | −1, 1, 1, −1, −1, −1, −1, −1, −1, −1, 1, −1, −1, 1, −1, 1, −1, −1, −1, −1, −1, 1, −1, 1, 1, −1, −1, 1, −1, −1, −1, −1, |
| | 1, 1, 1, −1, −1, 1, 1, −1, −1, 1, −1, 1, −1, 1, −1, −1, 1, −1, 1, 1, 1, −1, −1, 1, 1, 1, 1, 1, 1, 1, −1, 1, 1 |
| 60 | −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, 1, −1, |
| | −1, −1, 1, 1, −1, −1, −1, −1, −1, −1, −1, 1, −1, 1, 1, −1, 1, −1, −1, −1, −1, −1, 1, −1, 1, 1, −1, −1, 1, −1, −1, −1, −1, |
| | 1, 1, 1, −1, −1, 1, 1, −1, −1, 1, −1, 1, −1, 1, −1, −1, 1, −1, 1, 1, 1, −1, −1, 1, 1, 1, 1, 1, 1, 1, −1, 1 |
| 61 | −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, |
| | 1, −1, −1, −1, 1, 1, −1, −1, −1, −1, −1, −1, −1, 1, 1, 1, 1, −1, 1, −1, −1, −1, −1, −1, 1, −1, 1, 1, −1, −1, 1, −1, −1, −1, −1, |
| | 1, 1, 1, −1, −1, 1, 1, −1, −1, 1, −1, 1, −1, 1, −1, −1, 1, −1, 1, 1, 1, −1, −1, 1, 1, 1, 1, 1, 1, 1, −1 |
| 62 | −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, 1, −1, |
| | 1, 1, −1, 1, −1, −1, −1, 1, 1, −1, −1, −1, −1, −1, 1, −1, −1, 1, 1, 1, −1, 1, −1, −1, −1, −1, −1, 1, −1, 1, 1, −1, −1, 1, −1, −1, |
| | −1, −1, 1, 1, 1, 1, −1, 1, 1, −1, −1, 1, −1, 1, −1, 1, −1, −1, 1, −1, 1, 1, 1, −1, −1, 1, 1, 1, 1, 1 |
| 63 | −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, |
| | 1, −1, 1, 1, −1, 1, −1, −1, −1, 1, 1, −1, −1, −1, −1, 1, 1, −1, −1, 1, 1, 1, −1, 1, −1, −1, −1, −1, −1, 1, −1, 1, 1, −1, −1, |
| | 1, −1, −1, −1, −1, 1, 1, 1, 1, −1, 1, 1, −1, −1, 1, −1, 1, −1, 1, −1, −1, 1, −1, 1, 1, 1, −1, −1, 1, 1, 1, 1 |
| 64 | −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, |
| | 1, −1, 1, 1, −1, 1, −1, −1, −1, 1, 1, −1, −1, −1, 1, 1, 1, −1, −1, 1, 1, 1, −1, 1, −1, −1, −1, −1, −1, 1, −1, 1, 1, −1, −1, 1, −1, |
| | −1, −1, −1, 1, 1, 1, 1, −1, 1, 1, −1, −1, 1, −1, 1, −1, 1, −1, −1, 1, −1, 1, 1, 1, −1, −1, 1, 1, 1 |

TABLE 2
ELR-mark Sequences of Length-104 Using Extra Tones in ELR-Mark Transmission and without Dedicated Pilots

| Index | ELR Sequence |
|---|---|
| 1 | −1, 1, 1, 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, −1, 1, −1, 1, 1, 1, 1, −1, −1, 1, 1, 1, −1, 1, −1, −1, 1, −1, 1, −1, 1, −1, −1, |
| | 1, 1, −1, 1, 1, 1, 1, 1, 1, 1, 1, −1, 1, 1, −1, −1, 1, −1, 1, 1, 1, 1, 1, −1, 1, −1, −1, −1, 1, 1, −1, −1, −1, −1, 1 |
| 2 | 1, −1, 1, 1, 1, 1, −1, −1, 1, 1, 1, −1, 1, −1, −1, 1, −1, 1, −1, 1, −1, −1, 1, 1, −1, 1, 1, 1, −1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, −1, 1, 1, 1, 1, −1, −1, 1, 1, 1, −1, 1, −1, −1, 1, −1, 1, −1, 1, −1, −1, |
| | 1, 1, −1, 1, 1, 1, −1, 1, 1, 1, 1, −1, 1, 1, −1, −1, 1, −1, 1, 1, 1, 1, 1, −1, 1, −1, −1, −1, 1, 1, −1, −1, −1, 1 |
| 3 | 1, 1, 1, 1, 1, 1, 1, −1, −1, 1, 1, 1, −1, 1, −1, −1, 1, −1, 1, −1, 1, −1, −1, 1, 1, −1, 1, 1, −1, −1, 1, 1, 1, 1, −1, 1, 1, −1, −1, |
| | 1, −1, 1, 1, 1, 1, 1, −1, 1, −1, −1, −1, 1, 1, −1, −1, 1, 1, 1, 1, 1, 1, 1, 1, −1, −1, 1, 1, 1, −1, 1, −1, −1, 1, −1, 1, −1, 1, −1, |
| | −1, 1, 1, −1, 1, 1, −1, −1, 1, 1, 1, 1, −1, 1, 1, −1, −1, 1, −1, 1, 1, 1, 1, 1, −1, 1, −1, −1, −1, 1, 1, −1, −1, 1 |
| 4 | −1, 1, 1, −1, 1, 1, 1, 1, 1, 1, 1, −1, −1, 1, 1, 1, −1, 1, −1, −1, 1, −1, 1, −1, 1, −1, −1, 1, −1, 1, 1, −1, −1, −1, 1, 1, 1, 1, −1, |
| | 1, 1, −1, −1, 1, −1, 1, 1, 1, 1, 1, −1, 1, −1, −1, 1, 1, −1, 1, 1, −1, 1, 1, 1, 1, 1, 1, 1, −1, −1, 1, 1, 1, −1, 1, −1, −1, 1, −1, |
| | 1, −1, 1, −1, −1, 1, −1, 1, 1, −1, −1, −1, 1, 1, 1, 1, −1, 1, 1, −1, −1, 1, −1, 1, 1, 1, 1, 1, −1, 1, −1, −1, 1, 1 |
| 5 | −1, 1, −1, 1, −1, −1, 1, 1, −1, 1, 1, 1, 1, 1, 1, 1, −1, −1, 1, 1, 1, −1, 1, −1, −1, 1, −1, 1, 1, −1, 1, −1, −1, −1, 1, 1, −1, −1, −1, |
| | 1, 1, 1, 1, −1, 1, 1, −1, −1, 1, −1, 1, 1, 1, 1, 1, 1, −1, 1, −1, 1, −1, −1, 1, 1, −1, 1, 1, 1, 1, 1, 1, 1, −1, −1, 1, 1, 1, −1, |
| | 1, −1, −1, 1, −1, 1, 1, −1, 1, −1, −1, −1, 1, 1, −1, −1, −1, 1, 1, 1, 1, −1, 1, 1, −1, −1, 1, −1, 1, 1, 1, 1, 1, 1 |
| 6 | −1, 1, −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, |
| | −1, −1, 1, 1, 1, 1, −1, 1, 1, −1, −1, 1, −1, 1, 1, 1, 1, −1, 1, −1, 1, −1, 1, −1, −1, 1, 1, −1, 1, 1, 1, 1, 1, 1, 1, −1, −1, |
| | 1, 1, 1, −1, 1, −1, −1, 1, 1, 1, 1, −1, 1, −1, −1, −1, 1, 1, −1, −1, −1, 1, 1, 1, 1, −1, 1, 1, −1, −1, 1, −1, 1, 1, 1, 1 |
| 7 | −1, 1, 1, −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, |
| | −1, −1, 1, 1, 1, 1, −1, 1, 1, −1, −1, 1, −1, 1, 1, 1, −1, 1, 1, −1, 1, −1, 1, −1, −1, 1, 1, −1, 1, 1, 1, 1, 1, 1, 1, −1, −1, |
| | 1, 1, 1, −1, 1, −1, −1, 1, 1, 1, 1, −1, 1, −1, −1, −1, 1, 1, −1, −1, −1, 1, 1, 1, 1, −1, 1, 1, −1, −1, 1, −1, 1, 1, 1 |
| 8 | −1, −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, −1, |
| | 1, 1, −1, −1, −1, 1, 1, 1, 1, −1, 1, 1, −1, −1, 1, −1, 1, 1, −1, −1, −1, 1, −1, 1, −1, 1, −1, −1, 1, 1, −1, 1, 1, 1, 1, 1, 1, 1, −1, |
| | −1, 1, 1, 1, −1, 1, −1, 1, 1, 1, 1, 1, −1, 1, −1, −1, −1, 1, 1, −1, −1, −1, 1, 1, 1, 1, −1, 1, 1, −1, −1, 1, −1, 1, 1 |
| 9 | −1, 1, −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, −1, |
| | 1, 1, −1, −1, −1, 1, 1, 1, 1, −1, 1, 1, −1, −1, 1, 1, 1, −1, 1, −1, −1, 1, −1, 1, −1, 1, −1, −1, 1, 1, −1, 1, 1, 1, 1, 1, 1, 1, −1, |
| | −1, 1, 1, 1, −1, 1, −1, 1, 1, 1, 1, 1, −1, 1, −1, −1, −1, 1, 1, −1, −1, −1, 1, 1, 1, 1, −1, 1, 1, −1, −1, 1, 1, 1 |
| 10 | −1, −1, 1, −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, |
| | −1, 1, 1, −1, −1, −1, 1, 1, 1, 1, −1, 1, 1, −1, −1, −1, 1, −1, −1, 1, −1, −1, 1, −1, 1, −1, 1, −1, −1, 1, 1, −1, |
| | 1, 1, 1, 1, 1, 1, 1, −1, −1, 1, 1, 1, −1, 1, −1, 1, 1, 1, 1, 1, −1, 1, −1, −1, −1, 1, 1, −1, −1, −1, 1, 1, 1, 1, −1, 1, 1, −1, −1, |
| | −1, 1 |
| 11 | 1, 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, 1, −1, 1, 1, 1, −1, −1, 1, 1, 1, −1, 1, −1, −1, 1, −1, 1, −1, 1, −1, −1, |
| | 1, 1, −1, 1, 1, 1, 1, 1, 1, 1, 1, −1, 1, 1, −1, −1, 1, −1, 1, 1, 1, 1, 1, −1, 1, −1, −1, −1, 1, 1, −1, −1, −1, 1, 1, 1, −1 |
| 12 | −1, −1, 1, 1, −1, −1, 1, 1, 1, −1, 1, −1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, 1, −1, −1, 1, 1, −1, −1, 1, 1, 1, −1, 1, −1, −1, 1, −1, 1, −1, 1, −1, −1, |
| | 1, 1, −1, 1, 1, 1, 1, 1, 1, 1, 1, −1, 1, 1, −1, −1, 1, −1, 1, 1, 1, 1, 1, −1, 1, −1, −1, −1, 1, 1, −1, −1, −1, 1, 1, 1 |
| 13 | −1, −1, 1, −1, −1, −1, 1, 1, −1, −1, −1, 1, −1, 1, 1, 1, 1, 1, −1, 1, −1, −1, 1, 1, −1, 1, 1, 1, −1, −1, −1, −1, −1, 1, −1, −1, |
| | 1, 1, −1, 1, −1, 1, −1, 1, 1, −1, 1, −1, −1, −1, 1, 1, −1, −1, −1, 1, −1, −1, 1, −1, −1, −1, 1, 1, −1, −1, −1, 1, −1, |
| | 1, 1, 1, 1, 1, −1, 1, −1, −1, 1, 1, −1, 1, 1, 1, −1, −1, −1, −1, −1, 1, −1, −1, 1, 1, −1, 1, −1, 1, −1, 1, 1, −1, 1, −1, −1, −1, |
| | 1, 1, −1, −1, −1, 1 |
| 14 | −1, 1, 1, 1, −1, −1, −1, −1, 1, 1, −1, −1, −1, 1, −1, 1, 1, 1, 1, 1, −1, 1, −1, 1, 1, −1, 1, 1, −1, −1, −1, −1, −1, −1, 1, −1, −1, |
| | 1, 1, −1, 1, −1, 1, −1, 1, 1, −1, 1, −1, −1, −1, 1, 1, −1, 1, −1, −1, 1, 1, 1, −1, −1, −1, 1, 1, −1, −1, −1, 1, −1, |
| | 1, 1, 1, 1, 1, −1, 1, −1, −1, 1, 1, −1, 1, 1, −1, −1, −1, −1, −1, −1, 1, −1, −1, 1, 1, −1, 1, −1, 1, −1, 1, 1, −1, 1, −1, −1, −1, |
| | 1, 1, −1, 1, −1 |
| 15 | −1, −1, 1, 1, 1, −1, −1, −1, 1, 1, −1, −1, −1, 1, −1, 1, 1, 1, 1, 1, −1, 1, −1, −1, 1, 1, −1, 1, −1, −1, −1, −1, −1, −1, −1, 1, −1, |
| | −1, 1, 1, −1, 1, −1, 1, −1, 1, 1, −1, 1, −1, −1, −1, 1, 1, −1, 1, −1, −1, 1, 1, 1, −1, −1, −1, 1, 1, −1, −1, −1, 1, −1, |
| | 1, 1, 1, 1, 1, −1, 1, −1, −1, 1, 1, −1, 1, −1, −1, −1, −1, −1, −1, −1, 1, −1, −1, 1, 1, −1, 1, −1, 1, −1, 1, 1, −1, 1, −1, −1, −1, |
| | 1, 1, −1, 1, |
| 16 | −1, 1, −1, 1, 1, 1, 1, −1, −1, −1, 1, 1, −1, −1, −1, 1, −1, 1, 1, 1, 1, 1, −1, 1, −1, −1, 1, 1, 1, 1, −1, −1, −1, −1, −1, −1, −1, |
| | 1, −1, −1, 1, 1, −1, 1, −1, 1, −1, 1, 1, −1, 1, −1, −1, −1, 1, 1, −1, 1, −1, 1, 1, 1, 1, −1, −1, −1, 1, 1, −1, −1, −1, 1, −1, |
| | 1, 1, 1, 1, 1, −1, 1, −1, −1, 1, 1, 1, 1, −1, −1, −1, −1, −1, −1, −1, 1, −1, −1, 1, 1, −1, 1, −1, 1, −1, 1, 1, −1, 1, −1, −1, −1, |
| | 1, 1 |
| 17 | 1, 1, 1, −1, 1, 1, 1, 1, −1, −1, −1, 1, 1, −1, −1, −1, 1, −1, 1, 1, 1, 1, 1, −1, 1, −1, −1, 1, −1, 1, 1, −1, −1, −1, −1, −1, −1, −1, |
| | 1, −1, −1, 1, 1, −1, 1, −1, 1, −1, 1, 1, −1, 1, −1, −1, 1, 1, 1, 1, 1, −1, 1, 1, 1, 1, −1, −1, −1, 1, 1, −1, −1, −1, 1, −1, |
| | 1, 1, 1, 1, 1, −1, 1, −1, −1, 1, −1, 1, 1, −1, −1, −1, −1, −1, −1, −1, 1, −1, −1, 1, 1, −1, 1, −1, 1, −1, 1, 1, −1, 1, −1, −1, |
| | 1, 1 |
| 18 | −1, −1, 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, |
| | −1, −1, 1, −1, −1, 1, 1, −1, 1, −1, 1, −1, 1, 1, −1, 1, −1, −1, −1, −1, −1, 1, 1, −1, 1, 1, 1, 1, −1, −1, −1, 1, 1, −1, −1, −1, |
| | 1, −1, 1, 1, 1, 1, 1, −1, 1, −1, −1, −1, −1, 1, 1, −1, −1, −1, −1, −1, −1, −1, 1, −1, −1, 1, 1, −1, 1, −1, 1, −1, 1, 1, −1, 1, −1, |
| | −1, −1 |
| 19 | 1, −1, −1, 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, |
| | −1, −1, 1, −1, −1, 1, 1, −1, 1, −1, 1, −1, 1, 1, −1, 1, −1, −1, 1, −1, −1, 1, 1, −1, 1, 1, 1, 1, −1, −1, 1, 1, −1, −1, −1, |
| | 1, −1, 1, 1, 1, 1, 1, −1, 1, −1, −1, −1, −1, 1, 1, −1, −1, −1, −1, −1, −1, −1, 1, −1, −1, 1, 1, −1, 1, −1, 1, −1, 1, 1, −1, 1, −1, |
| | −1 |
| 20 | 1, 1, −1, 1, −1, −1, 1, 1, −1, 1, 1, 1, 1, −1, −1, −1, 1, 1, −1, −1, −1, 1, −1, 1, 1, 1, 1, 1, 1, −1, 1, −1, −1, −1, 1, 1, −1, −1, −1, |
| | −1, −1, −1, −1, 1, −1, −1, −1, 1, 1, −1, 1, −1, 1, −1, 1, 1, −1, 1, 1, −1, 1, −1, −1, 1, 1, −1, 1, 1, 1, 1, −1, −1, −1, 1, 1, −1, −1, |
| | −1, 1, −1, 1, 1, 1, 1, 1, 1, −1, 1, −1, −1, −1, 1, 1, −1, −1, −1, −1, −1, −1, −1, 1, −1, −1, 1, 1, −1, 1, −1, 1, −1, 1, 1, −1 |
| 21 | 1, 1, 1, −1, 1, −1, −1, 1, 1, −1, 1, 1, 1, 1, −1, −1, −1, 1, 1, −1, −1, −1, 1, −1, 1, 1, 1, 1, 1, 1, −1, −1, −1, 1, 1, −1, −1, |
| | −1, −1, −1, −1, −1, 1, −1, −1, 1, 1, −1, 1, −1, 1, −1, −1, 1, 1, 1, 1, −1, 1, −1, −1, 1, 1, −1, 1, 1, 1, 1, −1, −1, −1, 1, 1, −1, |
| | −1, −1, 1, −1, 1, 1, 1, 1, 1, 1, −1, 1, −1, −1, −1, 1, 1, −1, −1, −1, −1, −1, −1, −1, 1, −1, −1, 1, 1, −1, 1, −1, 1, −1, −1, 1 |
| 22 | 1, −1, 1, 1, −1, 1, −1, −1, 1, 1, −1, 1, 1, 1, 1, −1, −1, −1, 1, 1, −1, −1, −1, 1, −1, 1, 1, 1, −1, 1, 1, −1, 1, −1, −1, −1, 1, 1, −1, |
| | −1, −1, −1, −1, −1, −1, 1, −1, −1, 1, 1, −1, 1, −1, 1, −1, 1, 1, −1, 1, 1, −1, 1, −1, −1, 1, 1, −1, 1, 1, 1, 1, −1, −1, −1, |
| | 1, 1, −1, −1, −1, 1, −1, 1, 1, 1, −1, 1, 1, −1, 1, −1, −1, −1, 1, 1, −1, −1, −1, −1, −1, −1, −1, 1, −1, −1, 1, 1, −1, 1, −1, |
| | 1, −1, 1 |
| 23 | 1, −1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, −1, 1, 1, 1, 1, −1, 1, 1, 1, 1, −1, 1, −1, −1, 1, 1, −1, 1, 1, 1, 1, −1, −1, −1, |
| | 1, 1, −1, −1, −1, 1, −1, 1, −1, 1, −1, 1, 1, −1, 1, −1, −1, −1, 1, 1, −1, −1, −1, −1, −1, −1, −1, 1, −1, −1, 1, 1, −1, 1, 1, 1 |
| 24 | −1, 1, 1, 1, 1, 1, 1, −1, 1, −1, −1, 1, 1, −1, 1, 1, 1, 1, −1, −1, −1, 1, 1, −1, −1, −1, 1, −1, 1, −1, 1, 1, −1, 1, −1, −1, −1, |
| | 1, 1, −1, −1, −1, −1, −1, −1, −1, 1, −1, −1, 1, 1, −1, 1, 1, −1, 1, 1, 1, 1, 1, 1, −1, 1, −1, −1, 1, 1, −1, 1, 1, 1, 1, −1, −1, −1, |
| | 1, 1, −1, −1, −1, 1, −1, 1, −1, 1, −1, 1, 1, −1, −1, −1, 1, 1, −1, −1, −1, −1, −1, −1, −1, 1, −1, −1, 1, 1, −1, 1, 1 |
| 25 | −1, 1, −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, |
| | −1, 1, 1, −1, −1, −1, −1, −1, −1, −1, 1, −1, −1, 1, 1, −1, −1, −1, 1, −1, 1, 1, 1, 1, 1, −1, 1, −1, −1, 1, 1, −1, 1, 1, 1, 1, −1, |
| | −1, −1, 1, 1, −1, −1, −1, 1, −1, 1, −1, 1, −1, 1, 1, −1, 1, −1, −1, −1, 1, 1, −1, −1, −1, −1, −1, −1, −1, 1, −1, −1, 1, 1, −1, −1 |
| 26 | −1, −1, 1, −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, |
| | −1, −1, 1, 1, −1, −1, −1, −1, −1, −1, −1, 1, −1, −1, 1, −1, 1, −1, −1, 1, −1, 1, 1, 1, 1, 1, −1, 1, −1, −1, 1, 1, −1, |
| | 1, 1, 1, 1, −1, −1, −1, 1, 1, −1, −1, −1, 1, −1, 1, −1, 1, −1, 1, 1, −1, 1, −1, −1, −1, 1, 1, −1, −1, −1, −1, −1, −1, −1, 1, −1, |
| | −1, 1, −1, 1 |
| 27 | −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, |
| | 1, −1, −1, −1, 1, 1, −1, −1, −1, −1, −1, −1, −1, 1, −1, −1, 1, −1, −1, −1, −1, 1, −1, 1, 1, 1, 1, 1, −1, 1, −1, −1, 1, 1, −1, |
| | 1, 1, 1, 1, −1, −1, −1, 1, 1, −1, −1, 1, 1, −1, 1, −1, 1, −1, 1, 1, −1, 1, −1, −1, −1, 1, 1, −1, −1, −1, −1, −1, −1, −1, 1, −1, |
| | −1, 1, −1 |
| 28 | 1, −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, |
| | 1, −1, −1, −1, 1, 1, −1, −1, −1, −1, −1, −1, −1, 1, −1, 1, −1, 1, −1, −1, −1, 1, −1, 1, 1, 1, 1, 1, −1, 1, −1, −1, 1, 1, −1, |
| | 1, 1, 1, 1, −1, −1, −1, 1, 1, −1, −1, 1, 1, −1, 1, −1, 1, −1, 1, 1, −1, 1, −1, −1, −1, 1, 1, −1, −1, −1, −1, −1, −1, −1, 1, −1, |
| | 1, −1 |
| 29 | 1, −1, −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, |
| | 1, 1, −1, 1, −1, −1, −1, 1, 1, −1, −1, −1, −1, −1, −1, −1, 1, −1, −1, 1, −1, −1, −1, −1, 1, −1, 1, 1, 1, 1, 1, −1, 1, −1, −1, |
| | 1, 1, −1, 1, 1, 1, 1, −1, −1, −1, 1, 1, −1, −1, 1, 1, −1, 1, −1, 1, −1, 1, 1, −1, 1, −1, −1, −1, 1, 1, −1, −1, −1, −1, −1, −1, −1, |
| | 1, −1, −1 |
| 30 | −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, |
| | 1, −1, 1, 1, −1, 1, −1, −1, −1, 1, 1, −1, −1, −1, −1, −1, −1, 1, −1, −1, −1, 1, 1, −1, −1, −1, 1, −1, 1, 1, 1, 1, 1, −1, 1, −1, |
| | −1, 1, 1, −1, 1, 1, 1, 1, −1, −1, −1, −1, 1, −1, −1, 1, 1, −1, 1, −1, 1, −1, 1, 1, −1, 1, −1, −1, −1, 1, 1, −1, −1, −1, −1, −1, |
| | −1, 1 |
| 31 | 1, −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, |
| | 1, −1, 1, −1, 1, 1, −1, 1, −1, −1, −1, 1, 1, −1, −1, −1, −1, −1, 1, 1, −1, −1, −1, 1, 1, −1, −1, −1, 1, −1, 1, 1, 1, 1, 1, −1, |
| | 1, −1, −1, 1, 1, −1, 1, 1, 1, 1, −1, −1, −1, −1, 1, −1, −1, 1, 1, −1, 1, −1, 1, −1, 1, 1, −1, 1, −1, −1, −1, 1, 1, −1, −1, −1, −1, |
| | −1, 1 |
| 32 | 1, 1, −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, |
| | 1, −1, 1, −1, 1, 1, −1, 1, −1, −1, −1, 1, 1, −1, −1, −1, 1, −1, 1, 1, −1, −1, −1, 1, 1, −1, −1, −1, 1, −1, 1, 1, 1, 1, 1, −1, |
| | 1, −1, −1, 1, 1, −1, 1, 1, 1, 1, −1, −1, −1, −1, 1, −1, −1, 1, 1, −1, 1, −1, 1, −1, 1, 1, −1, 1, −1, −1, −1, 1, 1, −1, −1, −1, |
| | 1, −1 |
| 33 | −1, 1, 1, 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, −1, 1, 1, −1, −1, −1, −1, 1, 1, −1, −1, −1, 1, −1, 1, 1, −1, 1, −1, 1, −1, |
| | 1, 1, −1, −1, 1, −1, −1, −1, −1, −1, −1, −1, −1, 1, −1, −1, 1, 1, −1, 1, −1, −1, −1, −1, −1, 1, −1, 1, 1, 1, −1, −1, |
| | 1, 1, 1, 1, −1 |
| 34 | 1, −1, 1, 1, 1, 1, −1, −1, 1, 1, 1, −1, 1, −1, −1, 1, −1, 1, −1, 1, −1, −1, 1, 1, −1, 1, 1, 1, −1, 1, 1, 1, 1, −1, 1, 1, −1, −1, 1, −1, |
| | 1, 1, 1, 1, 1, −1, 1, −1, −1, −1, 1, 1, −1, −1, −1, 1, −1, 1, −1, −1, −1, −1, 1, 1, −1, −1, −1, 1, −1, 1, 1, −1, 1, −1, 1, −1, |
| | 1, 1, −1, −1, 1, −1, −1, −1, 1, −1, −1, −1, −1, 1, −1, −1, 1, 1, −1, 1, −1, −1, −1, −1, −1, 1, −1, 1, 1, 1, −1, −1, 1, 1, 1, −1 |
| 35 | 1, 1, 1, 1, 1, 1, 1, −1, −1, 1, 1, 1, −1, 1, −1, −1, 1, −1, 1, −1, 1, −1, −1, 1, 1, −1, 1, 1, −1, −1, 1, 1, 1, 1, −1, 1, 1, −1, −1, |
| | 1, −1, 1, 1, 1, 1, 1, −1, 1, −1, −1, −1, 1, 1, −1, −1, 1, −1, −1, −1, −1, −1, −1, −1, 1, 1, −1, −1, −1, 1, −1, 1, 1, −1, 1, −1, |
| | 1, −1, 1, 1, −1, −1, 1, −1, −1, 1, 1, −1, −1, −1, −1, 1, −1, −1, 1, 1, −1, 1, −1, −1, −1, −1, −1, 1, −1, 1, 1, 1, −1, −1, |
| | 1, 1, −1 |
| 36 | −1, 1, 1, −1, 1, 1, 1, 1, 1, 1, 1, −1, −1, 1, 1, 1, −1, 1, −1, −1, 1, −1, 1, −1, 1, −1, −1, 1, −1, 1, 1, −1, −1, −1, 1, 1, 1, 1, −1, |
| | 1, 1, −1, −1, 1, −1, 1, 1, 1, 1, 1, −1, 1, −1, −1, 1, 1, 1, −1, −1, 1, −1, −1, −1, −1, −1, −1, −1, 1, 1, −1, −1, −1, 1, −1, |
| | 1, 1, −1, 1, −1, 1, −1, 1, 1, −1, 1, −1, −1, 1, 1, 1, −1, −1, −1, −1, 1, −1, −1, 1, 1, −1, 1, −1, −1, −1, −1, −1, 1, −1, 1, 1, −1, |
| | −1 |
| 37 | −1, 1, −1, 1, −1, −1, 1, 1, −1, 1, 1, 1, 1, 1, 1, 1, −1, −1, 1, 1, 1, −1, 1, −1, −1, 1, −1, 1, 1, −1, 1, −1, −1, −1, 1, 1, −1, −1, −1, |
| | 1, 1, 1, 1, −1, 1, 1, −1, −1, 1, −1, 1, 1, 1, 1, 1, 1, 1, −1, 1, −1, 1, 1, −1, −1, 1, −1, −1, −1, −1, −1, −1, −1, 1, 1, −1, −1, −1, |
| | 1, −1, 1, 1, −1, 1, −1, −1, 1, −1, 1, 1, 1, −1, −1, 1, 1, 1, −1, −1, −1, −1, 1, −1, −1, 1, 1, −1, 1, −1, −1, −1, −1, −1, −1 |
| 38 | −1, 1, −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, |
| | −1, −1, 1, 1, 1, 1, −1, 1, 1, −1, −1, 1, −1, 1, 1, 1, 1, 1, −1, 1, −1, 1, −1, 1, 1, −1, −1, 1, −1, −1, −1, −1, −1, −1, −1, |
| | 1, 1, −1, −1, −1, 1, −1, 1, 1, −1, −1, −1, −1, 1, −1, 1, 1, 1, −1, −1, 1, 1, 1, −1, −1, −1, −1, 1, −1, −1, 1, 1, −1, 1, −1, −1, |
| | −1, −1 |
| 39 | −1, 1, 1, −1, 1, −1, 1, −1, −1, 1, 1, −1, 1, 1, 1, 1, 1, 1, 1, −1, −1, 1, 1, 1, −1, 1, −1, −1, 1, 1, 1, 1, −1, 1, −1, −1, −1, 1, 1, −1, |
| | −1, −1, 1, 1, 1, 1, −1, 1, 1, −1, −1, 1, −1, 1, 1, 1, 1, −1, −1, 1, −1, 1, −1, 1, 1, −1, −1, 1, −1, −1, −1, −1, −1, −1, −1, |
| | 1, 1, −1, −1, −1, 1, −1, 1, 1, −1, −1, −1, −1, 1, −1, 1, 1, 1, −1, −1, 1, 1, 1, −1, −1, −1, −1, 1, −1, −1, 1, 1, −1, 1, −1, −1, |
| | −1 |
| 40 | −1, −1, −1, 1, −1, 1, −1, 1, −1, −1, 1, −1, 1, 1, 1, 1, 1, 1, 1, −1, −1, 1, 1, 1, −1, 1, −1, 1, 1, 1, 1, 1, −1, 1, −1, −1, −1, |
| | 1, 1, −1, −1, −1, 1, 1, 1, 1, −1, 1, 1, −1, −1, 1, −1, 1, 1, 1, 1, 1, −1, 1, −1, 1, −1, 1, 1, −1, −1, 1, −1, −1, −1, −1, −1, −1, |
| | −1, 1, 1, −1, −1, −1, 1, −1, 1, −1, −1, −1, −1, −1, 1, −1, 1, 1, 1, −1, −1, −1, −1, −1, −1, −1, −1, 1, −1, −1, 1, 1, −1, 1, −1, |
| | −1 |
| 41 | −1, 1, −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, −1, |
| | 1, 1, −1, −1, −1, 1, 1, 1, 1, −1, 1, 1, −1, −1, 1, 1, 1, 1, −1, 1, 1, −1, 1, −1, 1, −1, 1, 1, −1, −1, 1, −1, −1, −1, −1, −1, −1, |
| | −1, 1, 1, −1, −1, −1, 1, −1, 1, −1, −1, −1, −1, −1, 1, −1, 1, 1, 1, −1, −1, 1, 1, 1, −1, −1, −1, −1, 1, −1, −1, 1, 1, −1, −1, −1, |
| 42 | −1, −1, 1, −1, −1, 1, −1, 1, −1, 1, −1, −1, 1, 1, −1, 1, 1, 1, 1, 1, 1, 1, −1, −1, 1, 1, 1, −1, 1, −1, 1, 1, 1, 1, 1, −1, 1, −1, −1, |
| | −1, 1, 1, −1, −1, −1, 1, 1, 1, 1, −1, 1, 1, −1, −1, −1, 1, 1, 1, −1, 1, 1, −1, 1, −1, 1, 1, −1, 1, 1, −1, −1, 1, −1, −1, −1, −1, −1, |
| | −1, −1, 1, 1, −1, −1, −1, 1, −1, 1, −1, −1, −1, −1, −1, 1, −1, 1, 1, 1, −1, −1, 1, 1, 1, −1, −1, −1, −1, 1, −1, −1, 1, 1, 1, −1 |
| 43 | 1, 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, 1, −1, −1, −1, −1, 1, 1, −1, −1, −1, 1, −1, 1, 1, −1, 1, −1, 1, −1, |
| | 1, 1, −1, −1, 1, −1, −1, −1, −1, −1, −1, −1, −1, 1, −1, −1, 1, 1, −1, 1, −1, −1, −1, −1, −1, 1, −1, 1, 1, 1, −1, −1, 1, 1, 1, −1, |
| | −1, −1, 1 |
| 44 | −1, −1, 1, 1, −1, −1, 1, 1, 1, −1, 1, −1, −1, 1, −1, 1, −1, 1, −1, −1, 1, 1, −1, 1, 1, 1, 1, 1, 1, 1, 1, −1, 1, 1, −1, −1, 1, −1, |
| | 1, 1, 1, 1, 1, −1, 1, −1, −1, −1, 1, 1, −1, −1, −1, 1, 1, 1, 1, 1, −1, −1, 1, 1, −1, −1, −1, 1, −1, 1, 1, −1, 1, −1, 1, −1, |
| | 1, 1, −1, −1, 1, −1, −1, −1, −1, −1, −1, −1, −1, 1, −1, −1, 1, 1, −1, 1, −1, −1, −1, −1, −1, 1, −1, 1, 1, 1, −1, −1, 1, 1, 1, −1, |
| | −1, −1 |
| 45 | −1, −1, 1, −1, −1, −1, 1, 1, −1, −1, −1, 1, −1, 1, 1, 1, 1, 1, −1, 1, −1, −1, 1, 1, −1, 1, 1, 1, −1, −1, −1, −1, −1, 1, −1, −1, |
| | 1, 1, −1, 1, −1, 1, −1, 1, 1, −1, 1, −1, −1, −1, 1, 1, −1, −1, −1, 1, 1, 1, −1, 1, 1, 1, −1, −1, 1, 1, 1, −1, 1, −1, −1, −1, −1, |
| | −1, 1, −1, 1, 1, −1, −1, 1, −1, −1, −1, 1, 1, 1, 1, 1, −1, 1, 1, −1, −1, 1, −1, 1, −1, 1, −1, −1, 1, −1, 1, 1, 1, −1, −1, |
| | 1, 1, 1, −1 |
| 46 | −1, 1, 1, 1, −1, −1, −1, 1, 1, −1, −1, −1, 1, −1, 1, 1, 1, 1, 1, −1, 1, −1, −1, 1, 1, −1, 1, 1, −1, −1, −1, −1, −1, −1, 1, −1, −1, |
| | 1, 1, −1, 1, −1, 1, −1, 1, 1, −1, 1, −1, −1, −1, 1, 1, −1, 1, −1, 1, −1, −1, −1, 1, 1, 1, −1, −1, 1, 1, 1, −1, 1, −1, −1, −1, −1, |
| | −1, 1, −1, 1, 1, −1, −1, 1, −1, −1, 1, 1, 1, 1, 1, 1, −1, 1, 1, −1, −1, 1, −1, 1, −1, 1, −1, −1, 1, −1, 1, 1, 1, −1, −1, 1, −1, 1 |
| 47 | −1, −1, 1, 1, 1, −1, −1, −1, 1, 1, −1, −1, −1, 1, −1, 1, 1, 1, 1, 1, −1, 1, −1, −1, 1, 1, −1, 1, −1, −1, −1, −1, −1, −1, −1, 1, −1, |
| | −1, 1, 1, −1, 1, −1, 1, −1, 1, 1, −1, 1, −1, −1, −1, 1, 1, −1, 1, 1, 1, −1, −1, −1, 1, 1, 1, −1, −1, 1, 1, 1, −1, 1, −1, −1, −1, |
| | −1, −1, 1, −1, 1, 1, −1, −1, 1, −1, 1, 1, 1, 1, 1, 1, 1, −1, 1, 1, −1, −1, 1, −1, 1, −1, 1, −1, −1, 1, −1, 1, 1, 1, −1, −1, 1, −1 |
| 48 | −1, 1, −1, 1, 1, 1, 1, −1, −1, −1, 1, 1, −1, −1, −1, 1, −1, 1, 1, 1, 1, 1, −1, 1, −1, −1, 1, 1, 1, 1, −1, −1, −1, −1, −1, −1, |
| | 1, −1, −1, 1, 1, −1, 1, −1, 1, −1, 1, 1, −1, 1, −1, −1, −1, 1, 1, 1, −1, 1, −1, −1, −1, −1, 1, 1, 1, −1, −1, 1, 1, 1, −1, 1, −1, |
| | −1, −1, −1, −1, 1, −1, 1, 1, −1, −1, −1, −1, 1, 1, 1, 1, 1, 1, 1, −1, 1, 1, −1, −1, 1, −1, 1, −1, 1, −1, −1, 1, −1, 1, 1, 1, −1, |
| | −1 |
| 49 | 1, 1, 1, −1, 1, 1, 1, 1, −1, −1, −1, 1, 1, −1, −1, −1, 1, −1, 1, 1, 1, 1, 1, −1, 1, −1, −1, 1, −1, 1, 1, −1, −1, −1, −1, −1, −1, −1, |
| | 1, −1, −1, 1, 1, −1, 1, −1, 1, −1, 1, 1, −1, 1, −1, −1, 1, 1, −1, −1, −1, 1, −1, −1, −1, 1, 1, 1, −1, −1, 1, 1, 1, −1, 1, −1, |
| | −1, −1, −1, −1, 1, −1, 1, 1, −1, 1, −1, −1, 1, 1, 1, 1, 1, 1, 1, −1, 1, 1, −1, −1, 1, −1, 1, −1, 1, −1, −1, 1, −1, 1, 1, −1, −1 |
| 50 | −1, −1, 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, |
| | −1, −1, 1, −1, −1, 1, 1, −1, 1, −1, 1, −1, 1, 1, −1, 1, −1, −1, −1, 1, 1, −1, −1, 1, −1, −1, −1, −1, 1, 1, 1, −1, −1, 1, 1, 1, −1, |
| | 1, −1, −1, −1, −1, −1, 1, −1, 1, 1, 1, 1, −1, −1, 1, 1, 1, 1, 1, 1, 1, −1, 1, 1, −1, −1, 1, −1, 1, −1, 1, −1, −1, 1, −1, 1, 1, 1 |
| 51 | 1, −1, −1, 1, 1, −1, 1, 1, 1, 1, −1, −1, −1, 1, 1, −1, −1, −1, 1, −1, 1, 1, 1, 1, 1, −1, 1, −1, −1, −1, −1, 1, 1, −1, −1, −1, −1, −1, |
| | −1, −1, 1, −1, −1, 1, 1, −1, 1, −1, 1, −1, 1, 1, −1, 1, −1, −1, −1, 1, 1, −1, −1, 1, −1, −1, −1, −1, 1, 1, 1, −1, −1, 1, 1, 1, −1, |
| | 1, −1, −1, −1, −1, −1, 1, −1, 1, 1, 1, 1, −1, −1, 1, 1, 1, 1, 1, 1, 1, −1, 1, 1, −1, −1, 1, −1, 1, −1, 1, −1, −1, 1, −1, 1, 1 |
| 52 | 1, 1, −1, 1, −1, −1, 1, 1, −1, 1, 1, 1, 1, −1, −1, −1, 1, 1, −1, −1, −1, 1, −1, 1, 1, 1, 1, 1, 1, −1, 1, −1, −1, −1, 1, 1, −1, −1, −1, |
| | −1, −1, −1, −1, 1, −1, −1, 1, 1, −1, 1, −1, 1, −1, 1, 1, −1, −1, −1, 1, −1, 1, 1, −1, −1, 1, −1, −1, −1, −1, 1, 1, 1, −1, −1, |
| | 1, 1, 1, −1, 1, −1, −1, −1, −1, −1, −1, 1, −1, 1, 1, 1, −1, −1, 1, 1, 1, 1, 1, 1, 1, −1, 1, 1, −1, −1, 1, −1, 1, −1, 1, −1, −1, 1 |
| 53 | 1, 1, 1, −1, 1, −1, −1, 1, 1, −1, 1, 1, 1, 1, −1, −1, −1, 1, 1, −1, −1, −1, 1, −1, 1, 1, 1, 1, 1, 1, −1, 1, −1, −1, −1, 1, 1, −1, −1, |
| | −1, −1, −1, −1, −1, 1, −1, −1, 1, 1, −1, 1, −1, 1, −1, −1, 1, −1, −1, −1, 1, −1, 1, 1, −1, −1, 1, −1, −1, −1, −1, 1, 1, 1, −1, −1, |
| | 1, 1, 1, −1, 1, −1, −1, −1, −1, −1, −1, 1, −1, 1, 1, 1, −1, −1, 1, 1, 1, 1, 1, 1, 1, −1, 1, 1, −1, −1, 1, −1, 1, −1, 1, 1, −1 |
| 54 | 1, −1, 1, 1, −1, 1, −1, −1, 1, 1, −1, 1, 1, 1, 1, −1, −1, −1, 1, 1, −1, −1, −1, 1, −1, 1, 1, 1, −1, 1, 1, −1, 1, −1, −1, −1, 1, 1, −1, |
| | −1, −1, −1, −1, −1, −1, 1, −1, −1, 1, 1, −1, 1, −1, 1, −1, 1, −1, 1, −1, −1, 1, −1, 1, 1, −1, −1, 1, −1, −1, −1, −1, 1, 1, 1, −1, |
| | −1, 1, 1, 1, −1, 1, −1, −1, −1, 1, −1, −1, 1, −1, 1, 1, 1, −1, −1, 1, 1, 1, 1, 1, 1, 1, −1, 1, 1, −1, −1, 1, −1, 1, −1, 1, −1 |
| 55 | 1, −1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, −1, 1, 1, 1, −1, 1, −1, −1, −1, −1, 1, −1, 1, 1, −1, −1, 1, −1, −1, −1, −1, |
| | 1, 1, 1, −1, −1, 1, 1, 1, −1, 1, −1, 1, −1, 1, −1, −1, 1, −1, 1, 1, 1, −1, −1, 1, 1, 1, 1, 1, 1, 1, −1, 1, 1, −1, −1, 1, −1, −1, −1 |
| 56 | −1, 1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, −1, |
| | 1, 1, −1, −1, −1, −1, −1, −1, −1, 1, −1, −1, 1, 1, −1, 1, 1, 1, −1, −1, −1, −1, −1, −1, 1, −1, 1, 1, −1, −1, 1, −1, −1, −1, −1, |
| | 1, 1, 1, −1, −1, 1, 1, 1, −1, 1, −1, 1, −1, 1, −1, −1, 1, −1, 1, 1, 1, −1, −1, 1, 1, 1, 1, 1, 1, 1, −1, 1, 1, −1, −1, 1, −1, −1 |
| 57 | −1, 1, −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, −1, |
| | −1, 1, 1, −1, −1, −1, −1, −1, −1, −1, 1, −1, −1, 1, 1, −1, −1, 1, −1, 1, −1, −1, −1, −1, −1, 1, −1, 1, 1, −1, −1, 1, −1, −1, −1, |
| | −1, 1, 1, 1, −1, −1, 1, 1, 1, −1, 1, −1, 1, −1, 1, −1, −1, 1, −1, 1, 1, 1, −1, −1, 1, 1, 1, 1, 1, 1, 1, −1, 1, 1, −1, −1, 1, 1 |
| 58 | −1, −1, 1, −1, 1, 1, 1, 1, 1, −1, 1, −1, −1, 1, 1, −1, 1, 1, 1, 1, −1, −1, −1, 1, 1, −1, −1, −1, 1, −1, 1, −1, 1, −1, 1, 1, −1, 1, −1, |
| | −1, −1, 1, 1, −1, −1, −1, −1, −1, −1, −1, 1, −1, −1, 1, −1, 1, 1, 1, −1, 1, −1, −1, −1, −1, −1, 1, −1, 1, 1, −1, −1, 1, −1, −1, |
| | −1, −1, 1, 1, 1, −1, −1, 1, 1, 1, −1, 1, −1, 1, −1, 1, −1, −1, 1, −1, 1, 1, 1, −1, −1, 1, 1, 1, 1, 1, 1, 1, −1, 1, 1, −1, 1, −1 |
| 59 | −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, |
| | 1, 1, −1, −1, −1, 1, 1, −1, −1, −1, −1, −1, −1, −1, 1, −1, −1, 1, −1, 1, 1, 1, −1, 1, −1, −1, −1, −1, −1, 1, −1, 1, 1, −1, −1, 1, −1, |
| | −1, −1, −1, 1, 1, 1, −1, −1, 1, 1, −1, −1, 1, −1, 1, −1, 1, −1, −1, 1, −1, 1, 1, 1, −1, −1, 1, 1, 1, 1, 1, 1, 1, −1, 1, 1, −1, 1 |
| 60 | 1, −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, 1, 1, −1, |
| | 1, −1, −1, −1, 1, 1, −1, −1, −1, −1, −1, −1, −1, 1, −1, 1, −1, −1, 1, 1, 1, −1, 1, −1, −1, −1, −1, −1, 1, −1, 1, 1, −1, −1, 1, −1, |
| | −1, −1, −1, 1, 1, 1, −1, −1, 1, 1, −1, −1, 1, −1, 1, −1, 1, −1, −1, 1, −1, 1, 1, 1, −1, −1, 1, 1, 1, 1, 1, 1, 1, −1, 1, −1, 1 |
| 61 | 1, −1, −1, −1, −1, 1, −1, 1, 1, 1, 1, 1, −1, 1, −1, −1, 1, 1, −1, 1, 1, 1, 1, −1, −1, −1, 1, 1, −1, −1, 1, 1, −1, 1, −1, 1, −1, |
| | 1, 1, −1, 1, −1, −1, −1, 1, 1, −1, −1, −1, −1, −1, −1, −1, 1, −1, −1, −1, 1, 1, 1, 1, −1, 1, −1, −1, −1, −1, −1, 1, −1, 1, 1, −1, |
| | −1, 1, −1, −1, −1, −1, 1, 1, 1, −1, −1, 1, 1, −1, −1, 1, −1, 1, −1, 1, −1, −1, 1, −1, 1, 1, 1, −1, −1, 1, 1, 1, 1, 1, 1, 1, −1, |
| | 1, 1 |
| 62 | −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, 1, −1, |
| | 1, −1, 1, 1, −1, 1, −1, −1, −1, 1, 1, −1, −1, −1, −1, −1, −1, 1, 1, 1, 1, −1, −1, 1, 1, 1, −1, 1, −1, −1, −1, −1, −1, 1, −1, |
| | 1, 1, −1, −1, 1, −1, −1, −1, −1, 1, 1, 1, 1, −1, 1, 1, −1, −1, 1, −1, 1, −1, 1, −1, −1, 1, −1, 1, 1, 1, −1, −1, |
| | 1, 1, 1, 1, 1, 1, −1 |
| 63 | 1, −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, |
| | 1, −1, 1, −1, 1, 1, −1, 1, −1, −1, −1, 1, 1, −1, −1, −1, −1, −1, 1, −1, 1, 1, 1, −1, −1, 1, 1, 1, −1, 1, −1, −1, −1, −1, −1, |
| | 1, −1, 1, 1, −1, −1, 1, −1, −1, −1, −1, 1, 1, 1, 1, −1, 1, 1, −1, −1, 1, −1, 1, −1, 1, −1, −1, 1, −1, 1, 1, 1, −1, −1, |
| | 1, 1, 1, 1, 1, −1 |
| 64 | 1, 1, −1, −1, −1, 1, 1, −1, −1, −1, 1, −1, 1, 1, 1, 1, 1, −1, 1, −1, −1, 1, 1, −1, 1, 1, 1, 1, −1, −1, −1, −1, 1, −1, −1, 1, 1, −1, |
| | 1, −1, 1, −1, 1, 1, −1, 1, −1, −1, −1, 1, 1, −1, −1, −1, 1, −1, −1, −1, 1, 1, 1, −1, −1, 1, 1, 1, −1, 1, −1, −1, −1, −1, −1, |
| | 1, −1, 1, 1, −1, −1, 1, −1, −1, −1, −1, 1, 1, 1, 1, −1, 1, 1, −1, −1, 1, −1, 1, −1, 1, −1, −1, 1, −1, 1, 1, 1, −1, −1, 1, 1, 1, −1, |
| | 1 |

TABLE 3
ELR-mark Sequences of Length-104 Using Extra Tones in ELR-Mark Transmission with Dedicated Pilots

| Index | ELR Sequence |
|---|---|
| 1 | −1, 1, −1, 1, −1, −1, −1, 1, 1, −1, −1, −1, −1, −1, −1, −1, 1, 1, 1, 1, −1, 1, 1, −1, −1, 1, −1, −1, 1, −1, −1, 1, 1, −1, |
| | 1, 1, 1, 1, −1, 1, −1, 1, 1, 1, 1, −1, −1, 1, 1, 1, −1, 1, −1, 1, −1, 1, −1, −1, −1, 1, 1, −1, −1, −1, −1, −1, −1, −1, |
| | 1, 1, 1, 1, −1, 1, 1, −1, −1, 1, −1, −1, 1, −1, −1, 1, 1, −1, 1, 1, 1, 1, −1, 1, −1, 1, 1, 1, 1, −1, −1, 1, 1, 1, −1, 1 |
| 2 | 1, −1, 1, −1, 1, −1, −1, −1, 1, 1, −1, −1, −1, −1, −1, −1, −1, 1, 1, 1, 1, −1, 1, 1, −1, −1, 1, −1, −1, 1, −1, −1, 1, 1, −1, |
| | 1, 1, 1, 1, −1, 1, −1, 1, 1, 1, 1, −1, −1, 1, 1, 1, −1, 1, −1, 1, −1, 1, −1, −1, −1, 1, 1, −1, −1, −1, −1, −1, −1, −1, |
| | 1, 1, 1, 1, −1, 1, 1, −1, −1, 1, −1, −1, 1, −1, −1, 1, 1, −1, 1, 1, 1, 1, −1, 1, −1, 1, 1, 1, 1, −1, −1, 1, 1, 1, −1 |
| 3 | −1, 1, −1, 1, −1, 1, −1, −1, −1, 1, 1, −1, −1, −1, −1, −1, −1, −1, 1, 1, 1, 1, −1, 1, 1, −1, −1, 1, −1, −1, 1, −1, −1, 1, 1, −1, |
| | 1, 1, 1, 1, −1, 1, −1, 1, 1, 1, 1, −1, −1, 1, 1, 1, −1, 1, −1, 1, −1, 1, −1, −1, −1, 1, 1, −1, −1, −1, −1, −1, −1, −1, |
| | 1, 1, 1, 1, −1, 1, 1, −1, −1, 1, −1, −1, 1, −1, −1, 1, 1, −1, 1, 1, 1, 1, −1, 1, −1, 1, 1, 1, 1, −1, −1, 1, 1, 1 |
| 4 | −1, 1, 1, −1, −1, 1, −1, 1, −1, 1, −1, −1, −1, 1, 1, −1, −1, −1, −1, −1, −1, −1, 1, 1, 1, 1, −1, 1, 1, 1, −1, 1, −1, −1, 1, −1, −1, |
| | 1, 1, −1, 1, 1, 1, 1, −1, 1, −1, 1, 1, 1, 1, −1, −1, 1, 1, −1, −1, 1, −1, 1, −1, 1, −1, −1, −1, 1, 1, −1, −1, −1, −1, −1, −1, −1, |
| | 1, 1, 1, 1, −1, 1, 1, 1, −1, 1, −1, −1, 1, −1, −1, 1, 1, −1, 1, 1, 1, 1, −1, 1, −1, 1, 1, 1, 1, −1 |
| 5 | 1, 1, −1, 1, 1, −1, −1, 1, −1, 1, −1, 1, −1, −1, −1, 1, 1, −1, −1, −1, −1, −1, −1, −1, 1, 1, 1, −1, −1, 1, 1, 1, −1, 1, −1, −1, |
| | 1, −1, −1, 1, 1, −1, 1, 1, 1, 1, −1, 1, −1, 1, 1, 1, 1, 1, −1, 1, 1, −1, −1, 1, −1, 1, −1, 1, −1, −1, −1, 1, 1, −1, −1, −1, −1, −1, |
| | −1, −1, 1, 1, 1, −1, −1, 1, 1, 1, −1, 1, −1, −1, 1, −1, −1, 1, 1, −1, 1, 1, 1, 1, −1, 1, −1, 1, 1, 1 |
| 6 | 1, 1, 1, −1, 1, 1, −1, −1, 1, −1, 1, −1, 1, −1, −1, −1, 1, 1, −1, −1, −1, −1, −1, −1, −1, 1, 1, 1, −1, −1, 1, 1, 1, −1, 1, −1, −1, |
| | 1, −1, −1, 1, 1, −1, 1, 1, 1, 1, −1, 1, −1, 1, 1, 1, 1, 1, −1, 1, 1, −1, −1, 1, −1, 1, −1, 1, −1, −1, −1, 1, 1, −1, −1, −1, −1, −1, |
| | −1, −1, 1, 1, 1, −1, −1, 1, 1, 1, −1, 1, −1, −1, 1, −1, −1, 1, 1, −1, 1, 1, 1, 1, −1, 1, −1, 1, 1 |
| 7 | 1, 1, 1, 1, −1, 1, 1, −1, −1, 1, −1, 1, −1, 1, −1, −1, −1, 1, 1, −1, −1, −1, −1, −1, −1, −1, 1, 1, 1, −1, −1, 1, 1, 1, −1, 1, −1, −1, |
| | 1, −1, −1, 1, 1, −1, 1, 1, 1, 1, −1, 1, −1, 1, 1, 1, 1, 1, −1, 1, 1, −1, −1, 1, −1, 1, −1, 1, −1, −1, −1, 1, 1, −1, −1, −1, −1, −1, |
| | −1, −1, 1, 1, 1, −1, −1, 1, 1, 1, −1, 1, −1, −1, 1, −1, −1, 1, 1, −1, 1, 1, 1, 1, −1, 1, −1, 1 |
| 8 | −1, 1, 1, 1, 1, −1, 1, 1, −1, −1, 1, −1, 1, −1, 1, −1, −1, −1, 1, 1, −1, −1, −1, −1, −1, −1, 1, 1, 1, 1, −1, −1, 1, 1, 1, −1, 1, −1, |
| | −1, 1, −1, −1, 1, 1, −1, 1, 1, 1, 1, −1, 1, −1, −1, 1, 1, 1, 1, −1, 1, 1, −1, −1, 1, −1, 1, −1, 1, −1, −1, −1, 1, 1, −1, −1, −1, |
| | −1, −1, −1, 1, 1, 1, 1, −1, −1, 1, 1, 1, −1, 1, −1, −1, 1, −1, −1, 1, 1, −1, 1, 1, 1, 1, −1, 1, −1 |
| 9 | −1, −1, 1, 1, 1, 1, −1, 1, 1, −1, −1, 1, −1, 1, −1, 1, −1, −1, −1, 1, 1, −1, −1, −1, −1, −1, −1, 1, 1, 1, 1, −1, −1, 1, 1, 1, −1, |
| | 1, −1, −1, 1, −1, −1, 1, 1, −1, 1, 1, 1, 1, −1, 1, −1, −1, 1, 1, 1, 1, −1, 1, 1, −1, −1, 1, −1, 1, −1, 1, −1, −1, −1, 1, 1, −1, −1, |
| | −1, −1, −1, −1, 1, 1, 1, 1, −1, −1, 1, 1, 1, −1, 1, −1, −1, 1, −1, −1, 1, 1, −1, 1, 1, 1, 1, −1, 1 |
| 10 | −1, −1, −1, 1, 1, 1, 1, −1, 1, 1, −1, −1, 1, −1, 1, −1, 1, −1, −1, −1, 1, 1, −1, −1, −1, −1, 1, −1, 1, 1, 1, 1, −1, −1, 1, 1, 1, −1, |
| | 1, −1, −1, 1, −1, −1, 1, 1, −1, 1, 1, 1, 1, −1, −1, −1, −1, 1, 1, 1, 1, −1, 1, 1, −1, −1, 1, −1, 1, −1, 1, −1, −1, −1, 1, 1, −1, |
| | −1, −1, −1, 1, −1, 1, 1, 1, 1, −1, −1, 1, 1, 1, −1, 1, −1, −1, 1, −1, −1, 1, 1, −1, 1, 1, 1, 1, −1 |
| 11 | −1, −1, −1, −1, −1, −1, −1, 1, 1, 1, 1, −1, 1, 1, −1, −1, 1, −1, 1, −1, 1, −1, −1, −1, 1, 1, 1, 1, 1, −1, 1, −1, 1, 1, 1, 1, −1, −1, |
| | 1, 1, 1, −1, 1, −1, −1, 1, −1, −1, 1, 1, −1, 1, −1, −1, −1, −1, −1, −1, −1, 1, 1, 1, 1, −1, 1, 1, −1, −1, 1, −1, 1, −1, 1, −1, −1, |
| | −1, 1, 1, 1, 1, 1, −1, 1, −1, 1, 1, 1, 1, −1, −1, 1, 1, 1, −1, 1, −1, −1, 1, −1, −1, 1, 1, −1, 1 |
| 12 | 1, 1, −1, −1, −1, −1, −1, −1, −1, 1, 1, 1, 1, −1, 1, 1, −1, −1, 1, −1, 1, −1, 1, −1, −1, −1, −1, 1, 1, 1, 1, −1, 1, −1, |
| | 1, 1, 1, 1, −1, −1, 1, 1, 1, −1, 1, −1, −1, 1, −1, −1, 1, 1, 1, 1, −1, −1, −1, −1, −1, −1, −1, 1, 1, 1, 1, −1, 1, 1, −1, −1, 1, −1, |
| | 1, −1, 1, −1, −1, −1, −1, 1, 1, 1, 1, −1, 1, −1, 1, 1, 1, 1, −1, −1, 1, 1, 1, −1, 1, −1, −1, 1, −1, −1, 1, 1 |
| 13 | −1, −1, 1, 1, −1, −1, −1, −1, −1, −1, −1, 1, 1, 1, 1, −1, 1, 1, −1, −1, 1, −1, 1, −1, 1, −1, 1, 1, −1, 1, 1, 1, 1, −1, 1, −1, |
| | 1, 1, 1, 1, −1, −1, 1, 1, 1, −1, 1, −1, −1, 1, −1, −1, −1, −1, 1, 1, −1, −1, −1, −1, −1, −1, −1, 1, 1, 1, 1, −1, 1, 1, −1, −1, |
| | 1, −1, 1, −1, 1, −1, 1, 1, −1, 1, 1, 1, 1, −1, 1, −1, 1, 1, 1, 1, −1, −1, 1, 1, 1, −1, 1, −1, −1, 1, −1, −1 |
| 14 | −1, −1, −1, 1, 1, −1, −1, −1, −1, −1, −1, −1, 1, 1, 1, 1, −1, 1, 1, −1, −1, 1, −1, 1, −1, 1, −1, 1, 1, −1, 1, 1, 1, 1, −1, 1, −1, |
| | 1, 1, 1, 1, −1, −1, 1, 1, 1, −1, 1, −1, −1, 1, −1, −1, −1, −1, 1, 1, −1, −1, −1, −1, −1, −1, −1, 1, 1, 1, 1, −1, 1, 1, −1, −1, |
| | 1, −1, 1, −1, 1, −1, 1, 1, −1, 1, 1, 1, 1, −1, 1, −1, 1, 1, 1, 1, −1, −1, 1, 1, 1, −1, 1, −1, −1, 1, −1 |
| 15 | 1, −1, −1, −1, 1, 1, −1, −1, −1, −1, −1, −1, −1, 1, 1, 1, 1, −1, 1, 1, −1, −1, 1, −1, 1, −1, −1, −1, 1, 1, −1, 1, 1, 1, 1, −1, 1, −1, |
| | 1, 1, 1, 1, −1, −1, 1, 1, 1, −1, 1, −1, −1, 1, 1, −1, −1, −1, 1, 1, −1, −1, −1, −1, −1, −1, −1, 1, 1, 1, 1, −1, 1, 1, −1, −1, |
| | 1, −1, 1, −1, −1, −1, 1, 1, −1, 1, 1, 1, 1, −1, 1, −1, 1, 1, 1, 1, −1, −1, 1, 1, 1, −1, 1, −1, −1, 1 |
| 16 | −1, 1, −1, −1, −1, 1, 1, −1, −1, −1, −1, −1, −1, −1, 1, 1, 1, 1, −1, 1, 1, −1, −1, 1, −1, 1, 1, −1, −1, 1, 1, −1, 1, 1, 1, 1, −1, |
| | 1, −1, 1, 1, 1, 1, −1, −1, 1, 1, 1, −1, 1, −1, −1, −1, 1, −1, −1, −1, 1, 1, −1, −1, −1, −1, −1, −1, −1, 1, 1, 1, 1, −1, 1, 1, −1, |
| | −1, 1, −1, 1, 1, −1, −1, 1, 1, −1, 1, 1, 1, 1, −1, 1, −1, 1, 1, 1, 1, −1, −1, 1, 1, 1, −1, 1, −1, −1 |
| 17 | 1, 1, −1, 1, −1, −1, −1, 1, 1, −1, −1, −1, −1, 1, −1, 1, −1, −1, −1, −1, 1, −1, −1, 1, 1, −1, 1, −1, 1, −1, −1, 1, 1, −1, |
| | 1, 1, 1, 1, −1, −1, −1, −1, −1, −1, −1, 1, 1, −1, −1, −1, 1, −1, 1, 1, −1, 1, −1, −1, −1, 1, 1, −1, −1, −1, −1, 1, −1, 1, −1, −1, |
| | −1, −1, 1, −1, −1, 1, 1, −1, 1, −1, 1, −1, −1, 1, 1, −1, 1, 1, 1, 1, −1, −1, −1, −1, −1, −1, −1, 1, 1, −1, −1, −1, 1, −1 |
| 18 | −1, 1, 1, −1, 1, −1, −1, −1, 1, 1, −1, −1, −1, −1, 1, −1, 1, −1, −1, −1, −1, 1, −1, −1, 1, 1, −1, 1, −1, 1, −1, −1, 1, 1, −1, |
| | 1, 1, 1, 1, −1, −1, −1, −1, −1, −1, −1, 1, 1, −1, −1, −1, 1, −1, 1, 1, −1, 1, −1, −1, −1, 1, 1, −1, −1, −1, −1, 1, −1, 1, −1, −1, |
| | −1, −1, 1, −1, −1, 1, 1, −1, 1, −1, 1, −1, −1, 1, 1, −1, 1, 1, 1, 1, −1, −1, −1, −1, −1, −1, −1, 1, 1, −1, −1, −1, 1 |
| 19 | 1, −1, 1, 1, −1, 1, −1, −1, −1, 1, 1, −1, −1, −1, −1, 1, −1, 1, −1, −1, −1, −1, 1, −1, −1, 1, 1, −1, 1, −1, 1, −1, −1, 1, 1, −1, |
| | 1, 1, 1, 1, −1, −1, −1, −1, −1, −1, −1, 1, 1, −1, −1, −1, 1, −1, 1, 1, −1, 1, −1, −1, −1, 1, 1, −1, −1, −1, −1, 1, −1, 1, −1, −1, |
| | −1, −1, 1, −1, −1, 1, 1, −1, 1, −1, 1, −1, −1, 1, 1, −1, 1, 1, 1, 1, −1, −1, −1, −1, −1, −1, −1, 1, 1, −1, −1, −1 |
| 20 | 1, −1, −1, 1, 1, −1, 1, 1, −1, 1, −1, −1, −1, 1, 1, −1, −1, −1, −1, 1, −1, 1, −1, −1, −1, −1, 1, −1, −1, −1, 1, −1, 1, −1, 1, −1, −1, |
| | 1, 1, −1, 1, 1, 1, 1, −1, −1, −1, −1, −1, −1, −1, 1, 1, −1, −1, 1, 1, −1, 1, 1, −1, 1, −1, −1, −1, 1, 1, −1, −1, −1, −1, 1, −1, |
| | 1, −1, −1, −1, −1, 1, −1, −1, −1, 1, −1, 1, −1, 1, −1, −1, 1, 1, −1, 1, 1, 1, 1, −1, −1, −1, −1, −1, −1, −1, 1 |
| 21 | −1, 1, −1, −1, 1, 1, −1, 1, 1, −1, 1, −1, −1, −1, 1, 1, −1, −1, −1, −1, 1, −1, 1, −1, −1, −1, 1, 1, −1, −1, −1, 1, −1, 1, −1, 1, −1, |
| | −1, 1, 1, −1, 1, 1, 1, 1, −1, −1, −1, −1, −1, −1, −1, −1, 1, −1, −1, 1, 1, −1, 1, 1, −1, 1, −1, −1, −1, 1, 1, −1, −1, −1, −1, |
| | 1, −1, 1, −1, −1, −1, 1, 1, −1, −1, −1, 1, −1, 1, −1, 1, −1, −1, 1, 1, −1, 1, 1, 1, 1, −1, −1, −1, −1, −1, −1, −1 |
| 22 | −1, −1, −1, −1, 1, −1, −1, 1, 1, −1, 1, 1, −1, 1, −1, −1, −1, 1, 1, −1, −1, −1, −1, 1, −1, 1, −1, −1, −1, 1, 1, −1, −1, −1, 1, −1, |
| | 1, −1, 1, −1, −1, 1, 1, −1, 1, 1, 1, 1, −1, −1, −1, −1, −1, −1, −1, −1, 1, −1, −1, 1, 1, −1, 1, 1, −1, 1, −1, −1, −1, 1, 1, −1, |
| | −1, −1, −1, 1, −1, 1, −1, −1, −1, 1, 1, −1, −1, −1, 1, −1, 1, −1, 1, −1, −1, 1, 1, −1, 1, 1, 1, 1, −1, −1, −1, −1 |
| 23 | 1, −1, −1, −1, −1, 1, −1, −1, 1, 1, −1, 1, 1, −1, 1, −1, −1, −1, 1, 1, −1, −1, −1, −1, 1, −1, −1, −1, −1, −1, 1, 1, −1, −1, −1, |
| | 1, −1, 1, −1, 1, −1, −1, 1, 1, −1, 1, 1, 1, 1, −1, −1, −1, 1, −1, −1, −1, −1, 1, −1, −1, 1, 1, −1, 1, 1, −1, 1, −1, −1, −1, |
| | 1, 1, −1, −1, −1, −1, 1, −1, −1, −1, −1, −1, 1, 1, −1, −1, −1, 1, −1, 1, −1, 1, −1, −1, 1, 1, −1, 1, 1, 1, 1, −1, −1, −1 |
| 24 | −1, 1, −1, −1, −1, −1, 1, −1, −1, 1, 1, −1, 1, 1, −1, 1, −1, −1, −1, 1, 1, −1, −1, −1, −1, 1, −1, −1, −1, −1, −1, 1, 1, −1, −1, −1, |
| | 1, −1, 1, −1, 1, −1, −1, 1, 1, −1, 1, 1, 1, 1, −1, −1, −1, 1, −1, −1, −1, −1, 1, −1, −1, 1, 1, −1, 1, 1, −1, 1, −1, −1, −1, |
| | 1, 1, −1, −1, −1, −1, 1, −1, −1, −1, −1, −1, 1, 1, −1, −1, −1, 1, −1, 1, −1, 1, −1, −1, 1, 1, −1, 1, 1, 1, 1, −1, −1 |
| 25 | 1, −1, 1, −1, −1, −1, −1, 1, −1, −1, 1, 1, −1, 1, 1, −1, 1, −1, −1, −1, 1, 1, −1, −1, −1, −1, −1, −1, −1, −1, −1, −1, 1, 1, −1, −1, |
| | −1, 1, −1, 1, −1, 1, −1, −1, 1, 1, −1, 1, 1, 1, 1, −1, 1, −1, 1, −1, −1, −1, −1, 1, −1, −1, 1, 1, −1, 1, 1, −1, 1, −1, −1, −1, |
| | 1, 1, −1, −1, −1, −1, −1, −1, −1, −1, −1, −1, 1, 1, −1, −1, −1, 1, −1, 1, −1, 1, −1, −1, 1, 1, −1, 1, 1, 1, 1, −1 |
| 26 | −1, −1, 1, −1, 1, −1, −1, −1, −1, 1, −1, −1, 1, 1, −1, 1, 1, −1, 1, −1, −1, −1, 1, 1, −1, −1, 1, −1, −1, −1, −1, −1, −1, −1, |
| | 1, 1, −1, −1, −1, 1, −1, 1, −1, 1, −1, −1, 1, 1, −1, 1, 1, 1, −1, −1, 1, −1, 1, −1, −1, −1, −1, 1, −1, −1, 1, 1, −1, 1, 1, −1, |
| | 1, −1, −1, −1, 1, 1, −1, −1, 1, −1, −1, −1, −1, −1, −1, −1, 1, 1, −1, −1, −1, 1, −1, 1, −1, 1, −1, −1, 1, 1, −1, 1, 1, 1 |
| 27 | −1, −1, −1, 1, −1, 1, −1, −1, −1, −1, 1, −1, −1, 1, 1, −1, 1, 1, −1, 1, 1, −1, −1, −1, 1, 1, −1, 1, 1, −1, −1, −1, −1, −1, −1, −1, |
| | 1, 1, −1, −1, −1, 1, −1, 1, −1, 1, −1, −1, 1, 1, −1, 1, 1, −1, −1, −1, 1, −1, 1, −1, −1, −1, −1, 1, −1, −1, 1, 1, −1, 1, 1, −1, |
| | 1, −1, −1, −1, 1, 1, −1, 1, 1, −1, −1, −1, −1, −1, −1, −1, 1, 1, −1, −1, −1, 1, −1, 1, −1, 1, −1, −1, 1, 1, −1, 1, 1 |
| 28 | −1, −1, −1, −1, 1, −1, 1, −1, −1, −1, −1, 1, −1, −1, 1, 1, −1, 1, 1, −1, 1, −1, −1, −1, 1, 1, 1, 1, 1, −1, −1, −1, −1, −1, −1, −1, |
| | 1, 1, −1, −1, −1, 1, −1, 1, −1, 1, −1, −1, 1, 1, −1, 1, −1, −1, −1, −1, 1, −1, 1, −1, −1, −1, −1, 1, 1, −1, 1, 1, −1, 1, 1, −1, |
| | 1, −1, −1, −1, 1, 1, 1, 1, 1, −1, −1, −1, −1, −1, −1, −1, 1, 1, −1, −1, −1, 1, −1, 1, −1, 1, −1, −1, 1, 1, −1, 1 |
| 29 | 1, −1, −1, −1, −1, 1, −1, 1, −1, −1, −1, −1, 1, −1, −1, 1, 1, −1, 1, 1, −1, 1, −1, −1, −1, 1, 1, 1, 1, 1, −1, −1, −1, −1, −1, −1, −1, |
| | 1, 1, −1, −1, −1, 1, −1, 1, −1, 1, −1, −1, 1, 1, −1, 1, −1, −1, −1, −1, 1, −1, 1, −1, −1, −1, −1, 1, −1, −1, 1, 1, −1, 1, 1, −1, |
| | 1, −1, −1, −1, 1, 1, 1, 1, 1, −1, −1, −1, −1, −1, −1, −1, 1, 1, −1, −1, −1, 1, −1, 1, −1, 1, −1, −1, 1, 1, −1 |
| 30 | −1, 1, 1, −1, −1, −1, −1, 1, −1, 1, −1, −1, −1, −1, 1, −1, −1, 1, 1, −1, 1, 1, −1, 1, −1, −1, 1, −1, 1, 1, 1, 1, −1, −1, −1, −1, −1, |
| | −1, −1, 1, 1, −1, −1, −1, 1, −1, 1, −1, 1, −1, −1, 1, −1, 1, 1, −1, −1, −1, −1, 1, −1, 1, −1, −1, −1, −1, 1, −1, −1, 1, 1, −1, |
| | 1, 1, −1, 1, −1, −1, 1, −1, 1, 1, 1, 1, −1, −1, −1, −1, −1, −1, −1, 1, 1, −1, −1, −1, 1, −1, 1, −1, 1, −1, −1, 1 |
| 31 | −1, 1, −1, −1, −1, 1, 1, −1, −1, −1, −1, 1, −1, 1, −1, −1, −1, −1, 1, −1, −1, 1, 1, −1, 1, 1, 1, −1, −1, 1, 1, −1, 1, 1, 1, 1, −1, |
| | −1, −1, −1, −1, −1, −1, 1, 1, −1, −1, −1, 1, −1, 1, −1, −1, 1, −1, −1, −1, 1, 1, −1, −1, −1, −1, 1, −1, 1, −1, −1, −1, −1, 1, −1, |
| | −1, 1, 1, −1, 1, 1, 1, −1, −1, 1, 1, −1, 1, 1, 1, 1, −1, −1, −1, −1, −1, −1, −1, 1, 1, −1, −1, −1, 1, −1, 1, −1 |
| 32 | 1, −1, 1, −1, −1, −1, 1, 1, −1, −1, −1, −1, 1, −1, 1, −1, −1, −1, −1, 1, −1, −1, 1, 1, −1, −1, 1, 1, −1, |
| | 1, 1, 1, 1, −1, −1, −1, −1, −1, −1, −1, 1, 1, −1, −1, −1, 1, −1, 1, 1, −1, 1, −1, −1, −1, 1, 1, −1, −1, −1, −1, 1, −1, 1, −1, −1, |
| | −1, −1, 1, −1, −1, 1, 1, −1, 1, −1, 1, −1, −1, 1, 1, −1, 1, 1, 1, 1, −1, −1, −1, −1, −1, −1, −1, 1, 1, −1, −1, −1, 1, −1, 1 |
| 33 | −1, 1, −1, 1, −1, −1, −1, 1, 1, −1, −1, −1, −1, −1, −1, −1, 1, 1, 1, 1, −1, 1, 1, −1, −1, 1, −1, −1, 1, −1, −1, 1, 1, −1, |
| | 1, 1, 1, 1, −1, 1, −1, 1, 1, 1, 1, −1, −1, 1, 1, 1, −1, 1, 1, −1, 1, −1, 1, 1, 1, −1, −1, 1, 1, 1, 1, 1, 1, 1, −1, −1, −1, −1, 1, −1, |
| | −1, 1, 1, −1, 1, 1, −1, 1, 1, −1, −1, 1, −1, −1, −1, −1, 1, −1, 1, −1, −1, −1, −1, 1, 1, −1, −1, −1, 1, −1 |
| 34 | 1, −1, 1, −1, 1, −1, −1, −1, 1, 1, −1, −1, −1, −1, −1, −1, −1, 1, 1, 1, 1, −1, 1, 1, −1, −1, 1, −1, −1, 1, −1, −1, 1, 1, −1, |
| | 1, 1, 1, 1, −1, 1, −1, 1, 1, 1, 1, −1, −1, 1, 1, 1, −1, −1, 1, −1, 1, −1, 1, 1, 1, −1, −1, 1, 1, 1, 1, 1, 1, 1, −1, −1, −1, −1, |
| | 1, −1, −1, 1, 1, −1, 1, 1, −1, 1, 1, −1, −1, 1, −1, −1, −1, −1, 1, −1, 1, −1, −1, −1, −1, 1, 1, −1, −1, −1, 1 |
| 35 | −1, 1, −1, 1, −1, 1, −1, −1, −1, 1, 1, −1, −1, −1, −1, −1, −1, −1, 1, 1, 1, 1, −1, 1, 1, −1, −1, 1, −1, −1, 1, −1, −1, 1, 1, −1, |
| | 1, 1, 1, 1, −1, 1, −1, 1, 1, 1, 1, −1, −1, 1, 1, 1, 1, −1, 1, −1, 1, −1, 1, 1, 1, −1, −1, 1, 1, 1, 1, 1, 1, 1, −1, −1, −1, −1, 1, −1, |
| | −1, 1, 1, −1, 1, 1, −1, 1, 1, −1, −1, 1, −1, −1, −1, −1, 1, −1, 1, −1, −1, −1, −1, 1, 1, −1, −1, −1 |
| 36 | −1, 1, 1, −1, −1, 1, −1, 1, −1, 1, −1, −1, −1, 1, 1, −1, −1, −1, −1, −1, −1, −1, 1, 1, 1, 1, −1, 1, 1, 1, −1, 1, −1, −1, 1, −1, −1, |
| | 1, 1, −1, 1, 1, 1, 1, −1, 1, −1, 1, 1, 1, 1, −1, 1, −1, −1, 1, 1, −1, 1, −1, 1, −1, 1, 1, 1, −1, −1, 1, 1, 1, 1, 1, 1, 1, −1, −1, −1, |
| | −1, 1, −1, −1, −1, 1, −1, 1, 1, −1, 1, 1, −1, −1, 1, −1, −1, −1, −1, 1, −1, 1, −1, −1, −1, −1, 1 |
| 37 | 1, 1, −1, 1, 1, −1, −1, 1, −1, 1, −1, 1, −1, −1, −1, 1, 1, −1, −1, −1, −1, −1, −1, −1, 1, 1, 1, −1, −1, 1, 1, 1, −1, 1, −1, −1, |
| | 1, −1, −1, 1, 1, −1, 1, 1, 1, 1, −1, 1, −1, 1, 1, 1, −1, −1, 1, −1, −1, 1, 1, −1, 1, −1, 1, −1, 1, 1, 1, 1, −1, −1, |
| | 1, 1, 1, 1, 1, 1, 1, −1, −1, −1, 1, 1, −1, −1, −1, 1, −1, 1, 1, −1, 1, 1, −1, −1, 1, −1, −1, −1, −1, 1, −1, 1, −1, −1, −1 |
| 38 | 1, 1, 1, −1, 1, 1, −1, −1, 1, −1, 1, −1, 1, −1, −1, −1, 1, 1, −1, −1, −1, −1, −1, −1, −1, 1, 1, 1, −1, −1, 1, 1, 1, −1, 1, −1, −1, |
| | 1, −1, −1, 1, 1, −1, 1, 1, 1, 1, −1, 1, −1, 1, 1, −1, −1, −1, 1, −1, −1, 1, 1, −1, 1, −1, 1, −1, 1, 1, 1, −1, −1, |
| | 1, 1, 1, 1, 1, 1, 1, −1, −1, −1, 1, 1, −1, −1, −1, 1, −1, 1, 1, −1, 1, 1, −1, −1, 1, −1, −1, −1, −1, 1, −1, 1, −1, −1 |
| 39 | 1, 1, 1, 1, −1, 1, 1, −1, −1, 1, −1, 1, −1, 1, −1, −1, −1, 1, 1, −1, −1, −1, −1, −1, −1, −1, 1, 1, 1, −1, −1, 1, 1, 1, −1, 1, −1, −1, |
| | 1, −1, −1, 1, 1, −1, 1, 1, 1, 1, −1, 1, −1, 1, −1, −1, −1, −1, 1, −1, −1, 1, 1, −1, 1, −1, 1, −1, 1, 1, 1, −1, −1, |
| | 1, 1, 1, 1, 1, 1, 1, −1, −1, −1, 1, 1, −1, −1, −1, 1, −1, 1, 1, −1, 1, 1, −1, −1, 1, −1, −1, −1, −1, 1, −1, 1, −1 |
| 40 | −1, 1, 1, 1, 1, −1, 1, 1, −1, −1, 1, −1, 1, −1, 1, −1, −1, −1, 1, 1, −1, −1, −1, −1, −1, −1, 1, 1, 1, 1, −1, −1, 1, 1, 1, −1, −1, |
| | −1, 1, −1, −1, 1, 1, −1, 1, 1, 1, 1, −1, 1, −1, 1, −1, −1, −1, −1, 1, −1, −1, 1, 1, −1, 1, −1, 1, −1, 1, 1, 1, −1, −1, |
| | 1, 1, 1, 1, 1, 1, −1, −1, −1, −1, 1, 1, −1, −1, −1, 1, −1, 1, 1, −1, 1, 1, −1, −1, 1, −1, −1, −1, −1, 1, −1, 1 |
| 41 | −1, −1, 1, 1, 1, 1, −1, 1, 1, −1, −1, 1, −1, 1, −1, 1, −1, −1, −1, 1, 1, −1, −1, −1, −1, −1, −1, 1, 1, 1, 1, −1, −1, 1, 1, 1, −1, |
| | 1, −1, −1, 1, −1, −1, 1, 1, −1, 1, 1, 1, 1, −1, 1, 1, 1, −1, −1, −1, −1, 1, −1, −1, 1, 1, −1, 1, −1, 1, −1, 1, 1, 1, −1, −1, |
| | 1, 1, 1, 1, 1, 1, −1, −1, −1, −1, 1, 1, −1, −1, −1, 1, −1, 1, 1, −1, 1, 1, −1, −1, 1, −1, −1, −1, −1, 1, −1 |
| 42 | −1, −1, −1, 1, 1, 1, 1, −1, 1, 1, −1, −1, 1, −1, 1, −1, 1, −1, −1, −1, 1, 1, −1, −1, −1, −1, 1, −1, 1, 1, 1, 1, −1, −1, 1, 1, 1, −1, |
| | 1, −1, −1, 1, −1, −1, 1, 1, −1, 1, 1, 1, 1, −1, 1, 1, 1, −1, −1, −1, 1, −1, −1, 1, 1, −1, 1, −1, 1, −1, 1, 1, 1, −1, −1, |
| | 1, 1, 1, 1, −1, 1, −1, −1, −1, −1, 1, 1, −1, −1, −1, 1, −1, 1, 1, −1, 1, 1, −1, −1, 1, −1, −1, −1, −1, 1 |
| 43 | −1, −1, −1, −1, −1, −1, −1, 1, 1, 1, 1, −1, 1, 1, −1, −1, 1, −1, 1, −1, 1, −1, −1, −1, 1, 1, 1, 1, 1, −1, 1, −1, 1, 1, 1, 1, −1, −1, |
| | 1, 1, 1, −1, 1, −1, −1, 1, −1, −1, 1, 1, −1, 1, 1, 1, 1, 1, 1, 1, 1, −1, −1, −1, −1, 1, −1, −1, 1, 1, −1, 1, −1, 1, −1, 1, 1, 1, −1, |
| | −1, −1, −1, −1, 1, −1, 1, −1, −1, −1, −1, 1, 1, −1, −1, −1, 1, −1, 1, 1, −1, 1, 1, −1, −1, 1, −1 |
| 44 | 1, 1, −1, −1, −1, −1, −1, −1, −1, 1, 1, 1, 1, −1, 1, 1, −1, −1, 1, −1, 1, −1, 1, −1, −1, −1, −1, 1, 1, 1, 1, −1, 1, −1, |
| | 1, 1, 1, 1, −1, −1, 1, 1, 1, −1, 1, −1, −1, 1, −1, −1, 1, 1, −1, −1, 1, 1, 1, 1, 1, 1, 1, −1, −1, −1, −1, 1, −1, −1, 1, 1, −1, |
| | 1, −1, 1, −1, 1, 1, 1, 1, −1, −1, −1, −1, 1, −1, 1, −1, −1, −1, −1, 1, 1, −1, −1, −1, 1, −1, 1, 1, −1, 1, 1, −1, −1 |
| 45 | −1, −1, 1, 1, −1, −1, −1, −1, −1, −1, −1, 1, 1, 1, 1, −1, 1, 1, −1, −1, 1, −1, 1, −1, 1, −1, 1, 1, −1, 1, 1, 1, 1, −1, 1, −1, |
| | 1, 1, 1, 1, −1, −1, 1, 1, 1, −1, 1, −1, −1, 1, −1, −1, 1, 1, −1, −1, 1, 1, 1, 1, 1, 1, 1, −1, −1, −1, −1, 1, −1, −1, 1, 1, −1, |
| | 1, −1, 1, −1, 1, −1, −1, 1, −1, −1, −1, −1, 1, −1, 1, −1, −1, −1, −1, 1, 1, −1, −1, −1, 1, −1, 1, 1, −1, 1, 1 |
| 46 | −1, −1, −1, 1, 1, −1, −1, −1, −1, −1, −1, −1, 1, 1, 1, 1, −1, 1, 1, −1, −1, 1, −1, 1, −1, 1, −1, 1, 1, −1, 1, 1, 1, 1, −1, 1, −1, |
| | 1, 1, 1, 1, −1, −1, 1, 1, 1, −1, 1, −1, −1, 1, −1, 1, 1, 1, −1, −1, 1, 1, 1, 1, 1, 1, 1, −1, −1, −1, −1, 1, −1, −1, 1, 1, −1, 1, −1, |
| | 1, −1, 1, −1, −1, 1, −1, −1, −1, −1, 1, −1, 1, −1, −1, −1, −1, 1, 1, −1, −1, −1, 1, −1, 1, 1, −1, 1 |
| 47 | 1, −1, −1, −1, 1, 1, −1, −1, −1, −1, −1, −1, −1, 1, 1, 1, 1, −1, 1, 1, −1, −1, 1, −1, 1, −1, −1, −1, 1, 1, −1, 1, 1, 1, 1, −1, 1, −1, |
| | 1, 1, 1, 1, −1, −1, 1, 1, 1, −1, 1, −1, −1, 1, −1, 1, 1, 1, −1, −1, 1, 1, 1, 1, 1, 1, 1, −1, −1, −1, −1, 1, −1, −1, 1, 1, −1, 1, −1, |
| | 1, 1, 1, −1, −1, 1, −1, −1, −1, −1, 1, −1, 1, −1, −1, −1, 1, −1, −1, −1, 1, −1, 1, 1, −1 |
| 48 | −1, 1, −1, −1, −1, 1, 1, −1, −1, −1, −1, −1, −1, −1, 1, 1, 1, 1, −1, 1, 1, −1, −1, 1, −1, 1, 1, −1, −1, 1, 1, −1, 1, 1, 1, 1, −1, |
| | 1, −1, 1, 1, 1, 1, −1, −1, 1, 1, 1, −1, 1, −1, −1, 1, −1, 1, 1, 1, −1, −1, 1, 1, 1, 1, 1, 1, 1, −1, −1, −1, −1, 1, −1, −1, 1, 1, −1, |
| | 1, −1, −1, 1, 1, −1, −1, 1, −1, −1, −1, −1, 1, −1, 1, −1, −1, −1, −1, 1, 1, −1, −1, −1, 1, −1, 1, 1 |
| 49 | 1, 1, −1, 1, −1, −1, −1, 1, 1, −1, −1, −1, −1, 1, −1, 1, −1, −1, −1, −1, 1, −1, −1, 1, 1, −1, 1, −1, 1, −1, −1, 1, 1, −1, |
| | 1, 1, 1, 1, −1, −1, −1, −1, −1, −1, −1, 1, 1, −1, −1, −1, 1, −1, −1, −1, 1, −1, 1, 1, 1, −1, −1, 1, 1, 1, 1, −1, 1, −1, |
| | 1, 1, 1, 1, −1, 1, 1, −1, −1, 1, −1, 1, −1, 1, 1, −1, −1, 1, −1, −1, −1, −1, 1, 1, 1, 1, 1, 1, 1, −1, −1, 1, 1, 1, −1, 1 |
| 50 | −1, 1, 1, −1, 1, −1, −1, −1, 1, 1, −1, −1, −1, −1, 1, −1, 1, −1, −1, −1, −1, 1, −1, −1, 1, 1, −1, 1, −1, 1, −1, −1, 1, 1, −1, |
| | 1, 1, 1, 1, −1, −1, −1, −1, −1, −1, −1, 1, 1, −1, −1, −1, 1, 1, −1, −1, 1, −1, 1, 1, 1, −1, −1, 1, 1, 1, 1, −1, 1, −1, |
| | 1, 1, 1, 1, −1, 1, 1, −1, −1, 1, −1, 1, −1, 1, 1, −1, −1, 1, −1, −1, −1, −1, 1, 1, 1, 1, 1, 1, 1, −1, −1, 1, 1, 1, −1 |
| 51 | 1, −1, 1, 1, −1, 1, −1, −1, −1, 1, 1, −1, −1, −1, −1, 1, −1, 1, −1, −1, −1, −1, 1, −1, −1, 1, 1, −1, 1, −1, 1, −1, −1, 1, 1, −1, |
| | 1, 1, 1, 1, −1, −1, −1, −1, −1, −1, −1, 1, 1, −1, −1, −1, −1, 1, −1, −1, 1, −1, 1, 1, 1, −1, −1, 1, 1, 1, 1, −1, 1, −1, |
| | 1, 1, 1, 1, −1, 1, 1, −1, −1, 1, −1, 1, −1, 1, 1, −1, −1, 1, −1, −1, −1, −1, 1, 1, 1, 1, 1, 1, 1, −1, −1, 1, 1, 1 |
| 52 | 1, −1, −1, 1, 1, −1, 1, 1, −1, 1, −1, −1, −1, 1, 1, −1, −1, −1, −1, 1, −1, 1, −1, −1, −1, −1, 1, −1, −1, −1, 1, −1, 1, −1, 1, −1, −1, |
| | 1, 1, −1, 1, 1, 1, 1, −1, −1, −1, −1, −1, −1, −1, 1, −1, 1, 1, −1, −1, 1, −1, −1, 1, −1, 1, 1, 1, −1, −1, 1, 1, 1, 1, −1, 1, −1, |
| | 1, 1, 1, 1, −1, 1, 1, 1, −1, 1, −1, 1, −1, 1, 1, −1, −1, 1, −1, −1, −1, −1, 1, 1, 1, 1, 1, 1, 1, −1 |
| 53 | −1, 1, −1, −1, 1, 1, −1, 1, 1, −1, 1, −1, −1, −1, 1, 1, −1, −1, −1, −1, 1, −1, 1, −1, −1, −1, 1, 1, −1, −1, −1, 1, −1, 1, −1, 1, −1, |
| | −1, 1, 1, −1, 1, 1, 1, 1, −1, −1, −1, −1, −1, −1, −1, 1, −1, 1, 1, −1, −1, 1, −1, −1, 1, −1, 1, 1, 1, −1, −1, 1, 1, 1, 1, −1, |
| | 1, −1, 1, 1, 1, −1, −1, 1, 1, 1, −1, 1, −1, 1, −1, 1, 1, −1, −1, 1, −1, −1, −1, −1, 1, 1, 1, 1, 1, 1, 1 |
| 54 | −1, −1, −1, −1, 1, −1, −1, 1, 1, −1, 1, 1, −1, 1, −1, −1, −1, 1, 1, −1, −1, −1, −1, 1, −1, 1, −1, −1, −1, 1, 1, −1, −1, −1, 1, −1, |
| | 1, −1, 1, −1, −1, 1, 1, −1, 1, 1, 1, 1, −1, −1, −1, −1, 1, 1, 1, 1, −1, 1, 1, −1, −1, 1, −1, −1, 1, −1, 1, 1, 1, −1, −1, |
| | 1, 1, 1, 1, −1, 1, −1, 1, 1, 1, −1, −1, 1, 1, 1, −1, 1, −1, 1, −1, 1, 1, −1, −1, 1, −1, −1, −1, −1, 1, 1, 1, 1 |
| 55 | 1, −1, −1, −1, −1, 1, −1, −1, 1, 1, −1, 1, 1, −1, 1, −1, −1, −1, 1, 1, −1, −1, −1, −1, 1, −1, −1, −1, −1, −1, 1, 1, −1, −1, −1, |
| | 1, −1, 1, −1, 1, −1, −1, 1, 1, −1, 1, 1, 1, 1, −1, −1, −1, −1, 1, 1, 1, 1, −1, 1, 1, −1, −1, 1, −1, −1, 1, −1, 1, 1, 1, −1, −1, |
| | 1, 1, 1, 1, −1, 1, 1, 1, 1, 1, −1, −1, 1, 1, 1, −1, 1, −1, 1, −1, 1, 1, −1, −1, 1, −1, −1, −1, −1, 1, 1, 1 |
| 56 | −1, 1, −1, −1, −1, −1, 1, −1, −1, 1, 1, −1, 1, 1, −1, 1, −1, −1, −1, 1, 1, −1, −1, −1, −1, 1, −1, −1, −1, −1, −1, 1, 1, −1, −1, −1, |
| | 1, −1, 1, −1, 1, −1, −1, 1, 1, −1, 1, 1, 1, 1, −1, −1, 1, −1, 1, 1, 1, 1, −1, 1, 1, −1, −1, 1, −1, −1, 1, −1, 1, 1, 1, −1, −1, |
| | 1, 1, 1, 1, −1, 1, 1, 1, 1, 1, −1, −1, 1, 1, 1, −1, 1, −1, 1, −1, 1, 1, −1, −1, 1, −1, −1, −1, −1, 1, 1 |
| 57 | 1, −1, 1, −1, −1, −1, −1, 1, −1, −1, 1, 1, −1, 1, 1, −1, 1, −1, −1, −1, 1, 1, −1, −1, −1, −1, −1, −1, −1, −1, −1, −1, 1, 1, −1, −1, |
| | −1, 1, −1, 1, −1, 1, −1, −1, 1, 1, −1, 1, 1, 1, 1, −1, −1, 1, −1, 1, 1, 1, 1, −1, 1, 1, −1, −1, 1, −1, −1, 1, −1, 1, 1, 1, −1, −1, |
| | 1, 1, 1, 1, 1, 1, 1, 1, 1, 1, −1, −1, 1, 1, 1, −1, 1, −1, 1, −1, 1, 1, −1, −1, 1, −1, −1, −1, −1, 1 |
| 58 | −1, −1, 1, −1, 1, −1, −1, −1, −1, 1, −1, −1, 1, 1, −1, 1, 1, −1, 1, −1, −1, −1, 1, 1, −1, −1, 1, −1, −1, −1, −1, −1, −1, −1, |
| | 1, 1, −1, −1, −1, 1, −1, 1, −1, 1, −1, −1, 1, 1, −1, 1, 1, 1, 1, 1, −1, 1, −1, 1, 1, 1, 1, −1, 1, 1, −1, −1, 1, −1, −1, 1, −1, |
| | 1, 1, 1, −1, −1, 1, 1, −1, 1, 1, 1, 1, 1, 1, 1, −1, −1, 1, 1, 1, −1, 1, −1, 1, −1, 1, 1, −1, −1, 1, −1, −1, −1 |
| 59 | −1, −1, −1, 1, −1, 1, −1, −1, −1, −1, 1, −1, −1, 1, 1, −1, 1, 1, −1, 1, −1, −1, −1, 1, 1, −1, 1, 1, −1, −1, −1, −1, −1, −1, −1, |
| | 1, 1, −1, −1, −1, 1, −1, 1, −1, 1, −1, −1, 1, 1, −1, 1, 1, 1, 1, 1, −1, 1, −1, 1, 1, 1, 1, −1, 1, 1, −1, −1, 1, −1, −1, 1, −1, |
| | 1, 1, 1, −1, −1, 1, −1, −1, 1, 1, 1, 1, 1, 1, 1, −1, −1, 1, 1, 1, −1, 1, −1, 1, −1, 1, 1, −1, −1, 1, −1, −1 |
| 60 | −1, −1, −1, −1, 1, −1, 1, −1, −1, −1, −1, 1, −1, −1, 1, 1, −1, 1, 1, −1, 1, −1, −1, −1, 1, 1, 1, 1, 1, −1, −1, −1, −1, −1, −1, −1, |
| | 1, 1, −1, −1, −1, 1, −1, 1, −1, 1, −1, −1, 1, 1, −1, 1, 1, 1, 1, 1, −1, 1, −1, 1, 1, 1, 1, −1, 1, 1, −1, −1, 1, −1, −1, 1, −1, |
| | 1, 1, 1, −1, −1, −1, −1, −1, 1, 1, 1, 1, 1, 1, 1, −1, −1, 1, 1, 1, −1, 1, −1, 1, −1, 1, 1, −1, −1, 1, −1 |
| 61 | 1, −1, −1, −1, −1, 1, −1, 1, −1, −1, −1, −1, 1, −1, −1, 1, 1, −1, 1, 1, −1, 1, −1, −1, −1, 1, 1, 1, 1, 1, −1, −1, −1, −1, −1, −1, −1, |
| | 1, 1, −1, −1, −1, 1, −1, 1, −1, 1, −1, −1, 1, 1, −1, −1, 1, 1, 1, 1, −1, 1, −1, 1, 1, 1, 1, −1, 1, 1, −1, −1, 1, −1, −1, 1, −1, |
| | 1, 1, 1, −1, −1, −1, −1, −1, 1, 1, 1, 1, 1, 1, 1, −1, −1, 1, 1, 1, −1, 1, −1, 1, −1, 1, 1, −1, −1, 1 |
| 62 | −1, 1, 1, −1, −1, −1, −1, 1, −1, 1, −1, −1, −1, −1, 1, −1, −1, 1, 1, −1, 1, 1, −1, 1, −1, −1, 1, −1, 1, 1, 1, 1, −1, −1, −1, −1, −1, |
| | −1, −1, 1, 1, −1, −1, −1, 1, −1, 1, −1, 1, −1, −1, 1, 1, −1, −1, 1, 1, 1, 1, −1, 1, −1, 1, 1, 1, 1, −1, 1, 1, −1, −1, 1, −1, −1, |
| | 1, −1, 1, 1, −1, 1, −1, −1, −1, −1, 1, 1, 1, 1, 1, 1, 1, −1, −1, 1, 1, 1, −1, 1, −1, 1, −1, 1, 1, −1 |
| 63 | −1, 1, −1, −1, −1, 1, 1, −1, −1, −1, −1, 1, −1, 1, −1, −1, −1, −1, 1, −1, −1, 1, 1, −1, 1, 1, 1, −1, −1, 1, 1, −1, 1, 1, 1, 1, −1, |
| | −1, −1, −1, −1, −1, −1, 1, 1, −1, −1, −1, 1, −1, 1, −1, 1, −1, 1, 1, 1, −1, −1, 1, 1, 1, 1, −1, 1, −1, 1, 1, 1, 1, −1, 1, 1, −1, |
| | −1, 1, −1, −1, −1, 1, 1, −1, −1, 1, −1, −1, −1, −1, 1, 1, 1, 1, 1, 1, 1, −1, −1, 1, 1, 1, −1, 1, −1, 1 |
| 64 | 1, −1, 1, −1, −1, −1, 1, 1, −1, −1, −1, −1, 1, −1, 1, −1, −1, −1, −1, 1, −1, −1, 1, 1, −1, 1, −1, 1, −1, −1, 1, 1, −1, |
| | 1, 1, 1, 1, −1, −1, −1, −1, −1, −1, −1, 1, 1, −1, −1, −1, 1, −1, 1, −1, 1, −1, 1, 1, 1, −1, −1, 1, 1, 1, 1, −1, 1, −1, |
| | 1, 1, 1, 1, −1, 1, 1, −1, −1, 1, −1, 1, −1, 1, 1, −1, −1, 1, −1, −1, −1, −1, 1, 1, 1, 1, 1, 1, 1, −1, −1, 1, 1, 1, −1, 1, −1 |

In examples in which length-96 ELR sequences are used (such that a length-96 ELR-mark sequence is applied to each tone in 96 tones=48 data tones*2 symbols) and 64 BSS color values are used, the set of sequences 604 may include 64 orthogonal sequences of length-96, with each sequence of the 64 sequences corresponding to a respective BSS color value of the 64 BSS color values. In some implementations, the set of sequences 604 may be a subset of orthogonal row or column vectors of a Hadamard matrix with an order of (96×96). Such a (96×96) Hadamard matrix may be denoted herein as an H96 matrix. In such implementations, the H96 matrix may be directly calculated or may be constructed in accordance with multiple Golay pairs through an array (such as a Goethals-Seidel array). In some other implementations, the set of sequences 604 may correspond to orthogonal row vectors of a Hadamard matrix with an order of (64×96) that is generated in accordance with a Hadamard matrix with an order of (48×48). Such a (48×48) Hadamard matrix may be denoted herein as an H48 matrix. In some other implementations, the set of sequences 604 may be associated with a Hadamard expansion of (a subset of) an H48 matrix, with the H48 matrix being constructed in accordance with multiple Golay pairs through an array (such as a Goethals-Seidel array).

In implementations in which the set of sequences 604 are selected row or column vectors of an H96 matrix, a device may generate the H96 in various ways. In some examples, the device may generate the H96 matrix using a software command. In some other examples, the device may generate the H96 matrix directly in accordance with multiple binary complementary sequence pairs (such as multiple Golay pairs) and an array (such as a Goethals-Seidel array). For example, the H96 matrix may be constructed based on a Golay 8 pair and a Golay 16 pair (or their equivalent pairs) through a Goethals-Seidel array. An example Golay 8 pair of A8 and B8 and an example Golay 16 pair of A16 and B16 are defined in accordance with Equations 12 and 13, respectively, shown below.

$$Golay 8 pair : A 8 = [ 1 , 1 , 1 , - 1 , 1 , 1 , - 1 , 1 ] ; \qquad ( 12 )$$

$$B 8 = [ 1 , 1 , 1 , - 1 , - 1 , - 1 , 1 , - 1 ] .$$

$$Golay 16 pair : A 16 = [ \begin{matrix}1 & 1 & - 1 & - 1 & - 1 & 1 & - 1 & 1 & 1 & 1 & 1 & 1 & - 1 & 1 & 1 & - 1\end{matrix} ] ; \qquad ( 13 )$$

$$B 16 = [ \begin{matrix}1 & 1 & - 1 & - 1 & - 1 & 1 & - 1 & 1 & - 1 & - 1 & - 1 & - 1 & 1 & - 1 & - 1 & 1\end{matrix} ] .$$

The device may select a Golay 8 pair and a Golay 16 pair, from a set of multiple options for each (each Golay pair being associated with many equivalent pairs generated by various operations), in accordance with a target PAPR (such as a low PAPR). Four complementary sequences of length-24 can be formed by A24=[A8,A16]; B24=[A8, −A16]; C24=[B8,B16]; D24=[B8, −B16]. The order between A8/B8 and A16/B16 may be swapped. The device may construct the H96 matrix in accordance with a Goethals-Seidel array, as defined by Equation 14, shown below, with A, B, C, and D being circulant matrices built from A24, B24, C24, and D24. R may be an example of a back-diagonal identity matrix of order 24.

$$H 96 = [ \begin{matrix}A & BR & CR & DR \\ - BR & A & {D}^{′} R & - {C}^{′} R \\ - CR & - {D}^{′} R & A & {B}^{′} R \\ - DR & {C}^{′} R & - {B}^{′} R & A\end{matrix} ] \qquad ( 14 )$$

The device may select 64 out of the 96 orthogonal row or column vectors in the H96 matrix (in accordance with using each row vector or each column vector as a sequence to fill in 48*2 tones in two ELR-mark symbols). The selected subset of row or column vectors may correspond to sequences that offer or provide a relatively lowest PAPR when applied to one or both of the ELR symbol 518-a or the ELR symbol 518-b. In other words, the selected 64 row or column vectors may correspond to sequences that provide the 64 lowest PAPR values of the 96 total row or column vectors of the H96 matrix.

The device may save the selected 64 row or column vectors to form a new matrix, such as a new Hadamard matrix, with an order of (64×96). Each row of the new matrix (which may be referred to as an H (64×96) matrix) may be a sequence of the set of sequences 604. Accordingly, each row of the H (64×96) matrix may correspond to a respective BSS color value. Such an H (64×96) matrix may be defined in accordance with Equation 15 or 16 (in accordance with whether row or column vectors are selected from the H96 matrix), shown below.

$$H ( 64 \times 96 ) = [ selected 64 rows in H 96 ] \qquad ( 15 )$$

$$H ( 64 \times 96 ) = {[ selected 64 columns in H 96 ]}^{T} \qquad ( 16 )$$

In implementations in which the set of sequences 604 are row vectors of a Hadamard matrix with an order of (64×96) that is generated in accordance with an H48 matrix, a device may generate the H48 matrix and select 32 out of the 48 row or column vectors of the H48 matrix (in accordance with using each row vector or each column vector as a sequence to fill in 48 data tones in an ELR-mark symbol). In some implementations, the selected subset of row or column vectors may correspond to sequences that offer or provide a relatively lowest PAPR when applied to one or both of the ELR symbol 518-a or the ELR symbol 518-b. In other words, the selected 32 row or column vectors may correspond to sequences that provide the 32 lowest PAPR values of the 48 total row or column vectors of the H48 matrix.

The device may save the selected 32 row or column vectors to form a subblock of (such as a subset of) the H48 matrix. Such a subblock of the H48 matrix may be associated with an order of (32×48) and may be denoted as an H48, matrix. The H48, matrix may be defined in accordance with Equation 17 or 18 (in accordance with whether row or column vectors are selected from the H48 matrix), shown below.

$$H {48}_{s} = [ selected rows ] \qquad ( 17 )$$

$$H {48}_{s} = {[ selected columns ]}^{T} \qquad ( 18 )$$

The device may form a new matrix with orthogonal rows as H (64×96) in accordance with (such as using) the H48, matrix. In some implementations, the new H (64×96) matrix may be associated with a Hadamard expansion of the H48, matrix. For example, the H (64×96) matrix may be defined in accordance with Equation 19, shown below. The device may map each row of the H (64×96) matrix to a respective BSS color value.

$$H ( 64 \times 96 ) = [ \begin{matrix}H {48}_{s} & H {48}_{s} \\ H {48}_{s} & - H {48}_{s}\end{matrix} ] \qquad ( 19 )$$

In some aspects, in accordance with using an H48 matrix to derive the H (64×96) matrix, the ELR symbol 518-a and the ELR symbol 518-b may include a same content with a same sign or with a changed sign. In other words, the first portion 608-a and the second portion 608-b of the first sequence 604-a may include same content (with a same or changed sign). In accordance with the ELR symbol 518-a and the ELR symbol 518-b including the same content, the ELR symbol 518-a and the ELR symbol 518-b may be associated with a same PAPR, which may support simplified reception and processing at the wireless communication device 504, among other benefits.

In some implementations, a device may apply a mask (or reverse an applied mask) in accordance with selecting row or column vectors from a Hadamard matrix. For example, the wireless communication device 502 may apply a mask to the first sequence 604-a (in accordance with the first sequence 604-a being selected or derived from a Hadamard matrix) to reduce a PAPR associated with the first sequence 604-a. Such a mask may be, for example, an LTF sequence. The wireless communication device 502 may apply the mask to each ELR-mark symbol (such that a same mask is applied to each ELR-mark symbol, different masks are applied to each ELR-mark symbol, or a single mask is applied across both ELR-mark symbols).

In implementations in which the set of sequences 604 are associated with a Hadamard expansion of an H48 matrix, the H48 matrix being constructed in accordance with multiple Golay pairs through a Goethals-Seidel array, a device may construct the H48 matrix based on a Golay 4 pair and a Golay 8 pair (or their equivalent pairs) through a Goethals-Seidel array. An example Golay 4 pair of A4 and B4 and an example Golay 8 pair of A8 and B8 are defined in accordance with Equations 20 and 21, respectively, shown below.

$$Golay 4 pair : A 4 = [ 1 , 1 , 1 , - 1 ] ; B 4 = [ 1 , 1 , - 1 , 1 ] . \qquad ( 20 )$$

$$Golay 8 pair : A 8 = [ 1 , 1 , 1 , - 1 , 1 , 1 , - 1 , 1 ] ; \qquad ( 21 )$$

$$B 8 = [ 1 , 1 , 1 , - 1 , - 1 , - 1 , 1 , - 1 ] .$$

The device may select a Golay 4 pair and a Golay 8 pair, from a set of multiple options for each (each Golay pair being associated with many equivalent pairs generated by various operations), in accordance with a target PAPR (such as a low PAPR). Four complementary sequences of length-12 can be formed by A12=[A4,A8]; B12=[A4, −A8]; C12=[B4,B8]; D12=[B4, −B8]. The order between A4/B4 and A8/B8 may be swapped. The device may construct the H48 matrix in accordance with a Goethals-Seidel array, as defined by Equation 22, shown below, with A, B, C, and D being circulant matrices built from A12, B12, C12, and D12. R may be an example of a back-diagonal identity matrix of order 12.

$$H 48 = [ \begin{matrix}A & BR & CR & DR \\ - BR & A & {D}^{′} R & - {C}^{′} R \\ - CR & - {D}^{′} R & A & {B}^{′} R \\ - DR & {C}^{′} R & - {B}^{′} R & A\end{matrix} ] \qquad ( 22 )$$

The device may select 32 row or column vectors from the H48 matrix that correspond to sequences that provide the 32 lowest PAPR values of the 48 total row or column vectors of the H48 matrix. The device may save the selected 32 row or column vectors to form a subblock of the H48 matrix. Such a subblock of the H48 matrix may be associated with an order of (32×48) and may be denoted as an H48, matrix. The H48, matrix may be defined in accordance with Equation 23 or 24 (in accordance with whether row or column vectors are selected from the H48 matrix), shown below.

$$H {48}_{s} = [ selected rows ] \qquad ( 23 )$$

$$H {48}_{s} = {[ selected columns ]}^{T} \qquad ( 24 )$$

The device may form a new matrix with orthogonal rows as H (64×96) using the H48, matrix. In some implementations, the new H (64×96) matrix may be associated with a Hadamard expansion of the H48, matrix. For example, the H (64×96) matrix may be defined in accordance with Equation 25, shown below. The device may map each row of the H (64×96) matrix to a respective BSS color value.

$$H ( 64 \times 96 ) = [ \begin{matrix}H {48}_{s} & H {48}_{s} \\ H {48}_{s} & - H {48}_{s}\end{matrix} ] \qquad ( 25 )$$

Various examples of 64 length-96 ELR sequences are illustrated in table format below. In each of Tables 4-6, shown below, each value of “1” or “−1” corresponds to a value applied to a given (corresponding) tone. Tables 4-6 illustrate example sequence sets in implementations in which ELR-mark symbols are transmitted with dedicated pilots and in which extra tones 710 are not used in ELR-mark transmissions. For each sequence illustrated in Tables 4-6, the first or initial 48 elements or values may be applied to 48 used tones 704 in the ELR symbol 518-a and the second or final 48 elements or values may be applied to 48 used tones 704 in the ELR symbol 518-b. In some aspects, a mask, such as an LTF sequence, may be applied on the data tones 706 (the used tones 704) to reduce a PAPR associated with the ELR sequence. The sequences of Table 4 may be generated in accordance with an H96 matrix and the sequences of Table 5 may be generated in accordance with an H48 matrix. The sequences of Table 6 may be generated in accordance with a Hadamard expansion of an H48, matrix, with the H48, matrix being constructed in accordance with multiple Golay pairs (such as a Golay 4 pair and a Golay 8 pair).

TABLE 4
ELR-mark Sequences of Length-96 Not Using Extra Tones in ELR-Mark Transmission and with Dedicated Pilots

| Index | ELR Sequence |
|---|---|
| 1 | 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1 |
| | 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1 |
| | 1, 1, 1, 1 |
| 2 | 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, 1, 1, −1, |
| | −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, 1, 1, −1, −1, |
| | 1, −1, −1, −1, 1, 1, 1, −1, 1, 1, −1, −1, 1, −1, −1, −1, 1, 1, 1, −1, 1 |
| 3 | 1, 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, |
| | 1, 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, |
| | 1, 1, −1, −1, 1, −1, −1, −1, 1, 1, 1, −1, 1, 1, −1, −1, 1, −1, −1, −1, 1, 1, 1, −1 |
| 4 | 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, 1, 1, 1, 1, −1, |
| | 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, 1, 1, 1, 1, −1, |
| | 1, −1, −1, 1, −1, −1, −1, 1, 1, 1, 1, −1, 1, −1, −1, 1, −1, −1, −1, 1, 1, 1 |
| 5 | 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1, 1, 1 |
| 6 | 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1, 1 |
| 7 | 1, 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1 |
| 8 | 1, −1, 1, 1, 1, −1, 1, −1, −1, 1, −1, −1, 1, −1, 1, 1, 1, −1, 1, −1, −1, 1, −1, −1, 1, −1, 1, 1, 1, −1, 1, −1, −1, 1, −1, −1, 1, −1, |
| | 1, 1, 1, −1, 1, −1, −1, 1, −1, −1, 1, −1, 1, 1, 1, −1, 1, −1, −1, 1, −1, −1, 1, −1, 1, 1, 1, −1, 1, −1, −1, 1, −1, −1, 1, −1, |
| | 1, 1, 1, −1, 1, −1, −1, 1, −1, −1, 1, −1, 1, 1, 1, −1, 1, −1, −1, 1, −1, −1 |
| 9 | 1, −1, −1, 1, 1, 1, −1, 1, −1, −1, 1, −1, 1, −1, −1, 1, 1, 1, −1, 1, −1, −1, 1, −1, 1, −1, −1, 1, 1, 1, −1, 1, −1, −1, 1, −1, 1, −1, |
| | −1, 1, 1, 1, −1, 1, −1, −1, 1, −1, 1, −1, −1, 1, 1, 1, −1, 1, −1, −1, 1, −1, 1, −1, −1, 1, 1, 1, −1, 1, −1, −1, 1, −1, 1, −1, −1, |
| | 1, 1, 1, −1, 1, −1, −1, 1, −1, 1, −1, −1, 1, 1, 1, −1, 1, −1, −1, 1, −1 |
| 10 | 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, 1, 1, −1, |
| | −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, 1, 1, −1, −1, |
| | −1, 1, 1, 1, −1, 1, −1, −1, 1, 1, −1, −1, −1, 1, 1, 1, −1, 1, −1, −1, 1 |
| 11 | 1, 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, |
| | 1, 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, |
| | 1, 1, −1, −1, −1, 1, 1, 1, −1, 1, −1, −1, 1, 1, −1, −1, −1, 1, 1, 1, −1, 1, −1, −1 |
| 12 | 1, 1, 1, 1, 1, 1, 1, 1, 1, 1, 1, 1, −1, −1, −1, −1, −1, −1, −1, −1, −1, −1, −1, −1, 1, 1, 1, 1, 1, 1, 1, 1, 1, 1, 1, 1, −1, −1, −1, −1, |
| | −1, −1, −1, −1, −1, −1, −1, −1, 1, 1, 1, 1, 1, 1, 1, 1, 1, 1, 1, 1, −1, −1, −1, −1, −1, −1, −1, −1, −1, −1, −1, −1, |
| | 1, 1, 1, 1, 1, 1, 1, 1, 1, 1, 1, 1, −1, −1, −1, −1, −1, −1, −1, −1, −1, −1, −1, −1 |
| 13 | 1, 1, −1, −1, 1, −1, −1, −1, 1, 1, 1, −1, −1, −1, 1, 1, −1, 1, 1, 1, −1, −1, −1, 1, 1, 1, −1, −1, 1, −1, −1, −1, 1, 1, 1, −1, −1, −1, |
| | 1, 1, −1, 1, 1, 1, −1, −1, −1, 1, 1, 1, −1, −1, 1, −1, −1, −1, 1, 1, 1, −1, −1, −1, 1, 1, −1, 1, 1, 1, −1, −1, −1, 1, 1, 1, −1, −1, |
| | 1, −1, −1, −1, 1, 1, 1, −1, −1, −1, 1, 1, −1, 1, 1, 1, −1, −1, −1, 1 |
| 14 | 1, −1, 1, −1, −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, −1, |
| | 1, −1, 1, 1, −1, 1, 1, 1, −1, −1, −1, 1, −1, 1, −1, −1, 1, −1, −1, −1, 1, 1, 1, −1, 1, −1, 1, 1, −1, 1, 1, 1, −1, −1, −1, 1, −1, |
| | 1, −1, −1, 1, −1, −1, −1, 1, 1, 1, −1, 1, −1, 1, 1, −1, 1, 1, 1, −1, −1, −1 |
| 15 | 1, 1, 1, −1, 1, −1, −1, 1, −1, −1, −1, 1, −1, −1, −1, 1, −1, 1, 1, −1, 1, 1, 1, −1, 1, 1, 1, −1, 1, −1, −1, 1, −1, −1, −1, 1, −1, −1, |
| | −1, 1, −1, 1, 1, −1, 1, 1, 1, −1, 1, 1, 1, −1, 1, −1, −1, 1, −1, −1, −1, 1, −1, −1, −1, 1, −1, 1, 1, −1, 1, 1, 1, −1, 1, 1, 1, −1, |
| | 1, −1, −1, 1, −1, −1, −1, 1, −1, −1, −1, 1, −1, 1, 1, −1, 1, 1, 1, −1 |
| 16 | 1, 1, 1, 1, −1, 1, −1, −1, 1, −1, −1, −1, −1, −1, −1, −1, 1, −1, 1, 1, −1, 1, 1, 1, 1, 1, 1, 1, −1, 1, −1, −1, 1, 1, −1, −1, −1, −1, −1, |
| | −1, −1, 1, −1, 1, 1, −1, 1, 1, 1, 1, 1, 1, 1, −1, 1, −1, −1, 1, −1, −1, −1, −1, −1, −1, −1, 1, −1, 1, 1, −1, |
| | 1, 1, 1, 1, 1, 1, 1, −1, 1, −1, −1, 1, −1, −1, −1, −1, −1, −1, −1, 1, −1, 1, 1, −1, 1, 1, 1 |
| 17 | 1, 1, −1, −1, −1, 1, 1, 1, −1, 1, −1, −1, −1, −1, 1, 1, 1, −1, −1, −1, 1, −1, 1, 1, 1, 1, −1, −1, −1, 1, 1, 1, −1, 1, −1, −1, −1, −1, |
| | 1, 1, 1, −1, −1, −1, 1, −1, 1, 1, 1, 1, −1, −1, −1, 1, 1, 1, −1, 1, −1, −1, −1, −1, 1, 1, 1, −1, −1, −1, 1, −1, 1, 1, 1, 1, −1, −1, |
| | −1, 1, 1, 1, −1, 1, −1, −1, −1, −1, 1, 1, 1, −1, −1, −1, 1, −1, 1, 1 |
| 18 | 1, −1, 1, −1, −1, −1, 1, 1, 1, −1, 1, −1, −1, 1, −1, 1, 1, 1, −1, −1, −1, 1, −1, 1, 1, −1, 1, −1, −1, −1, 1, 1, 1, −1, 1, −1, −1, |
| | 1, −1, 1, 1, 1, −1, −1, −1, 1, −1, 1, 1, −1, 1, −1, −1, −1, 1, 1, 1, −1, 1, −1, −1, 1, −1, 1, 1, 1, −1, −1, −1, 1, −1, 1, 1, −1, |
| | 1, −1, −1, −1, 1, 1, 1, −1, 1, −1, −1, 1, −1, 1, 1, 1, −1, −1, −1, 1, −1, 1 |
| 19 | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1, −1, −1, −1, −1, |
| | −1, −1, −1, −1, −1, −1, −1, −1, 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, |
| | −1, −1, −1, −1, −1, −1, −1, −1, −1, −1, −1, −1, −1, −1, −1, −1, −1 |
| 20 | 1, −1, −1, 1, −1, −1, −1, 1, 1, 1, −1, 1, 1, −1, −1, 1, −1, −1, −1, 1, 1, 1, −1, 1, −1, 1, 1, −1, 1, 1, 1, −1, −1, −1, 1, −1, −1, |
| | 1, 1, −1, 1, 1, 1, −1, −1, −1, 1, −1, 1, −1, −1, 1, −1, −1, −1, 1, 1, 1, −1, 1, 1, −1, −1, 1, −1, −1, −1, 1, 1, 1, −1, 1, −1, |
| | 1, 1, −1, 1, 1, 1, −1, −1, −1, 1, −1, −1, 1, 1, −1, 1, 1, 1, −1, −1, −1, 1, −1 |
| 21 | 1, −1, 1, −1, −1, 1, −1, −1, −1, 1, 1, 1, 1, −1, 1, −1, −1, 1, −1, −1, −1, 1, 1, 1, −1, 1, −1, 1, 1, −1, 1, 1, 1, −1, −1, −1, −1, |
| | 1, −1, 1, 1, −1, 1, 1, 1, −1, −1, −1, 1, −1, 1, −1, −1, 1, −1, −1, −1, 1, 1, 1, 1, −1, 1, −1, −1, 1, −1, −1, −1, 1, 1, 1, −1, |
| | 1, −1, 1, 1, −1, 1, 1, 1, −1, −1, −1, −1, 1, −1, 1, 1, −1, 1, 1, 1, −1, −1, −1 |
| 22 | 1, 1, −1, 1, −1, −1, 1, −1, −1, −1, 1, 1, 1, 1, −1, 1, −1, −1, 1, −1, −1, −1, 1, 1, −1, −1, 1, −1, 1, 1, −1, 1, 1, 1, −1, −1, −1, −1, |
| | 1, −1, 1, 1, −1, 1, 1, 1, −1, −1, 1, 1, −1, 1, −1, −1, 1, −1, −1, −1, 1, 1, 1, 1, −1, 1, −1, −1, 1, −1, −1, −1, 1, 1, −1, −1, |
| | 1, −1, 1, 1, −1, 1, 1, 1, −1, −1, −1, −1, 1, −1, 1, 1, −1, 1, 1, 1, −1, −1 |
| 23 | 1, 1, 1, −1, 1, −1, −1, 1, −1, −1, −1, 1, 1, 1, 1, −1, 1, −1, −1, 1, −1, −1, −1, 1, −1, −1, −1, 1, −1, 1, 1, −1, 1, 1, 1, −1, −1, −1, |
| | −1, 1, −1, 1, 1, −1, 1, 1, 1, −1, 1, 1, 1, −1, 1, −1, −1, 1, −1, −1, −1, 1, 1, 1, 1, −1, 1, −1, −1, 1, −1, −1, −1, 1, −1, −1, −1, |
| | 1, −1, 1, 1, −1, 1, 1, 1, −1, −1, −1, −1, 1, −1, 1, 1, −1, 1, 1, 1, −1 |
| 24 | 1, 1, 1, 1, −1, 1, −1, −1, 1, −1, −1, −1, 1, 1, 1, 1, −1, 1, −1, −1, 1, −1, −1, −1, −1, −1, −1, −1, 1, −1, 1, 1, −1, 1, 1, 1, −1, −1, |
| | −1, −1, 1, −1, 1, 1, −1, 1, 1, 1, 1, 1, 1, 1, −1, 1, −1, −1, 1, −1, −1, −1, 1, 1, 1, 1, −1, 1, −1, −1, 1, −1, −1, −1, −1, −1, −1, |
| | −1, 1, −1, 1, 1, −1, 1, 1, 1, −1, −1, −1, −1, 1, −1, 1, 1, −1, 1, 1, 1 |
| 25 | 1, −1, 1, 1, 1, −1, 1, −1, −1, 1, −1, −1, 1, −1, 1, 1, 1, −1, 1, −1, −1, 1, −1, −1, −1, 1, −1, −1, −1, 1, −1, 1, 1, −1, 1, 1, −1, |
| | 1, −1, −1, −1, 1, −1, 1, 1, −1, 1, 1, 1, −1, 1, 1, 1, −1, 1, −1, −1, 1, −1, −1, 1, −1, 1, 1, 1, −1, 1, −1, −1, 1, −1, −1, −1, |
| | 1, −1, −1, −1, 1, −1, 1, 1, −1, 1, 1, −1, 1, −1, −1, −1, 1, −1, 1, 1, −1, 1, 1 |
| 26 | 1, −1, −1, 1, 1, 1, −1, 1, −1, −1, 1, −1, 1, −1, −1, 1, 1, 1, −1, 1, −1, −1, 1, −1, −1, 1, 1, −1, −1, −1, 1, −1, 1, 1, −1, 1, −1, |
| | 1, 1, −1, −1, −1, 1, −1, 1, 1, −1, 1, 1, −1, −1, 1, 1, 1, −1, 1, −1, −1, 1, −1, 1, −1, −1, 1, 1, 1, −1, 1, −1, −1, 1, −1, −1, |
| | 1, 1, −1, −1, −1, 1, −1, 1, 1, −1, 1, −1, 1, 1, −1, −1, −1, 1, −1, 1, 1, −1, 1 |
| 27 | 1, 1, −1, −1, −1, 1, 1, 1, −1, 1, −1, −1, 1, 1, −1, −1, −1, 1, 1, 1, −1, 1, −1, −1, −1, −1, 1, 1, 1, −1, −1, −1, 1, −1, 1, 1, −1, −1, |
| | 1, 1, 1, −1, −1, −1, 1, −1, 1, 1, 1, 1, −1, −1, −1, 1, 1, 1, −1, 1, −1, −1, 1, 1, −1, −1, −1, 1, 1, 1, −1, 1, −1, −1, −1, −1, |
| | 1, 1, 1, −1, −1, −1, 1, −1, 1, 1, −1, −1, 1, 1, 1, −1, −1, −1, 1, −1, 1, 1 |
| 28 | 1, 1, 1, 1, 1, 1, 1, 1, 1, 1, 1, 1, −1, −1, −1, −1, −1, −1, −1, −1, −1, −1, −1, −1, −1, −1, −1, −1, −1, −1, −1, −1, −1, −1, −1, −1, |
| | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1, −1, −1, −1, |
| | −1, −1, −1, −1, −1, −1, −1, −1, −1, 1, 1, 1, 1, 1, 1, 1, 1, 1, 1, 1, 1 |
| 29 | 1, −1, −1, 1, −1, −1, −1, 1, 1, 1, −1, 1, −1, 1, 1, −1, 1, 1, 1, −1, −1, −1, 1, −1, −1, 1, 1, −1, 1, 1, 1, −1, −1, −1, 1, −1, 1, −1, |
| | −1, 1, −1, −1, −1, 1, 1, 1, −1, 1, 1, −1, −1, 1, −1, −1, −1, 1, 1, 1, −1, 1, −1, 1, 1, −1, 1, 1, 1, −1, −1, −1, 1, −1, −1, |
| | 1, 1, −1, 1, 1, 1, −1, −1, −1, 1, −1, 1, −1, −1, 1, −1, −1, −1, 1, 1, 1, −1, 1 |
| 30 | 1, −1, 1, −1, −1, 1, −1, −1, −1, 1, 1, 1, −1, 1, −1, 1, 1, −1, 1, 1, 1, −1, −1, −1, −1, 1, −1, 1, 1, −1, 1, 1, 1, −1, −1, −1, 1, −1, |
| | 1, −1, −1, 1, −1, −1, −1, 1, 1, 1, 1, −1, 1, −1, −1, 1, −1, −1, −1, 1, 1, 1, −1, 1, −1, 1, 1, −1, 1, 1, 1, −1, −1, −1, −1, 1, −1, |
| | 1, 1, −1, 1, 1, 1, −1, −1, −1, 1, −1, 1, −1, −1, 1, −1, −1, −1, 1, 1, 1 |
| 31 | 1, 1, 1, −1, 1, −1, −1, 1, −1, −1, −1, 1, −1, −1, −1, 1, −1, 1, 1, −1, 1, 1, 1, −1, −1, −1, −1, 1, −1, 1, 1, −1, 1, 1, 1, −1, |
| | 1, 1, 1, −1, 1, −1, −1, 1, −1, −1, −1, 1, 1, 1, 1, −1, 1, −1, −1, 1, −1, −1, −1, 1, −1, −1, −1, 1, −1, 1, 1, −1, 1, 1, 1, −1, −1, |
| | −1, −1, 1, −1, 1, 1, −1, 1, 1, 1, −1, 1, 1, 1, −1, 1, −1, −1, 1, −1, −1, −1, 1 |
| 32 | 1, 1, 1, 1, −1, 1, −1, −1, 1, −1, −1, −1, −1, −1, −1, −1, 1, −1, 1, 1, −1, 1, 1, 1, −1, −1, −1, −1, 1, −1, 1, 1, −1, |
| | 1, 1, 1, 1, 1, 1, 1, −1, 1, −1, −1, 1, −1, −1, −1, 1, 1, 1, 1, −1, 1, −1, −1, 1, −1, −1, −1, −1, −1, −1, −1, 1, −1, 1, 1, −1, |
| | 1, 1, 1, −1, −1, −1, −1, 1, −1, 1, 1, −1, 1, 1, 1, 1, 1, 1, 1, −1, 1, −1, −1, 1, −1, −1, −1 |
| 33 | 1, −1, 1, 1, 1, −1, 1, −1, −1, 1, −1, −1, −1, 1, −1, −1, −1, 1, −1, 1, 1, −1, 1, 1, −1, 1, −1, −1, −1, 1, −1, 1, 1, −1, 1, 1, 1, −1, |
| | 1, 1, 1, −1, 1, −1, −1, 1, −1, −1, 1, −1, 1, 1, 1, −1, 1, −1, −1, 1, −1, −1, −1, 1, −1, −1, −1, 1, −1, 1, 1, −1, 1, 1, −1, 1, −1, |
| | −1, −1, 1, −1, 1, 1, −1, 1, 1, 1, −1, 1, 1, 1, −1, 1, −1, −1, 1, −1, −1 |
| 34 | 1, −1, −1, −1, 1, 1, 1, −1, 1, −1, −1, 1, −1, 1, 1, 1, −1, −1, −1, 1, −1, 1, 1, −1, −1, 1, 1, 1, −1, −1, −1, 1, −1, 1, 1, −1, 1, −1, |
| | −1, −1, 1, 1, 1, −1, 1, −1, −1, 1, 1, −1, −1, −1, 1, 1, 1, −1, 1, −1, −1, 1, −1, 1, 1, 1, −1, −1, −1, 1, −1, 1, 1, −1, −1, |
| | 1, 1, 1, −1, −1, −1, 1, −1, 1, 1, −1, 1, −1, −1, −1, 1, 1, 1, −1, 1, −1, −1, 1 |
| 35 | 1, 1, −1, −1, −1, 1, 1, 1, 1, −1, 1, −1, −1, −1, −1, 1, 1, 1, −1, −1, −1, 1, −1, 1, 1, −1, −1, 1, 1, 1, −1, −1, −1, 1, −1, |
| | 1, 1, 1, 1, −1, −1, −1, 1, 1, 1, −1, 1, −1, −1, 1, 1, −1, −1, −1, 1, 1, 1, −1, 1, −1, −1, −1, −1, 1, 1, 1, −1, −1, −1, 1, −1, |
| | 1, 1, −1, −1, 1, 1, 1, −1, −1, −1, 1, −1, 1, 1, 1, 1, −1, −1, −1, 1, 1, 1, −1, 1, −1, −1 |
| 36 | 1, −1, 1, −1, −1, −1, 1, 1, 1, −1, 1, −1, −1, 1, −1, 1, 1, 1, −1, −1, −1, 1, −1, 1, −1, 1, −1, 1, 1, 1, −1, −1, −1, 1, −1, 1, 1, −1, |
| | 1, −1, −1, −1, 1, 1, 1, −1, 1, −1, 1, −1, 1, −1, −1, −1, 1, 1, 1, −1, 1, −1, −1, 1, −1, 1, 1, 1, −1, −1, −1, 1, −1, 1, −1, 1, −1, |
| | 1, 1, 1, −1, −1, −1, 1, −1, 1, 1, −1, 1, −1, −1, −1, 1, 1, 1, −1, 1, −1 |
| 37 | 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, |
| | 1, 1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, |
| | −1, −1, −1, −1, −1, −1, −1, −1, −1, −1, −1, −1, −1, −1, −1, −1, −1 |
| 38 | 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, 1, 1, −1, |
| | −1, 1, −1, −1, −1, 1, 1, 1, −1, 1, −1, 1, 1, −1, 1, 1, 1, −1, −1, −1, 1, −1, −1, 1, 1, −1, 1, 1, 1, −1, −1, −1, 1, −1, −1, |
| | 1, 1, −1, 1, 1, 1, −1, −1, −1, 1, −1, −1, 1, 1, −1, 1, 1, 1, −1, −1, −1, 1, −1 |
| 39 | 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, 1, 1, 1, 1, −1, |
| | 1, −1, −1, 1, −1, −1, −1, 1, 1, 1, −1, 1, −1, 1, 1, −1, 1, 1, 1, −1, −1, −1, −1, 1, −1, 1, 1, −1, 1, 1, 1, −1, −1, −1, −1, 1, −1, |
| | 1, 1, −1, 1, 1, 1, −1, −1, −1, −1, 1, −1, 1, 1, −1, 1, 1, 1, −1, −1, −1 |
| 40 | 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, −1, −1, 1, −1, 1, 1, −1, 1, 1, 1, −1, −1, −1, −1, 1, −1, 1, 1, −1, 1, 1, 1, −1, −1, |
| | −1, −1, 1, −1, 1, 1, −1, 1, 1, 1, −1, −1, −1, −1, 1, −1, 1, 1, −1, 1, 1, −1, −1 |
| 41 | 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, −1, −1, −1, 1, −1, 1, 1, −1, 1, 1, 1, −1, −1, −1, −1, 1, −1, 1, 1, −1, 1, 1, 1, −1, |
| | −1, −1, −1, 1, −1, 1, 1, −1, 1, 1, 1, −1, −1, −1, −1, 1, −1, 1, 1, −1, 1, 1, 1, −1 |
| 42 | 1, −1, 1, 1, 1, −1, 1, −1, −1, 1, −1, −1, 1, −1, 1, 1, 1, −1, 1, −1, −1, 1, −1, −1, 1, −1, 1, 1, 1, −1, 1, −1, −1, 1, −1, −1, 1, −1, |
| | 1, 1, 1, −1, 1, −1, −1, 1, −1, −1, −1, 1, −1, −1, −1, 1, −1, 1, 1, −1, 1, 1, −1, 1, −1, −1, −1, 1, −1, 1, 1, −1, 1, 1, −1, 1, −1, |
| | −1, −1, 1, −1, 1, 1, −1, 1, 1, −1, 1, −1, −1, −1, 1, −1, 1, 1, −1, 1, 1 |
| 43 | 1, −1, −1, 1, 1, 1, −1, 1, −1, −1, 1, −1, 1, −1, −1, 1, 1, 1, −1, 1, −1, −1, 1, −1, 1, −1, −1, 1, 1, 1, −1, 1, −1, −1, 1, −1, 1, −1, |
| | −1, 1, 1, 1, −1, 1, −1, −1, 1, −1, −1, 1, 1, −1, −1, −1, 1, −1, 1, 1, −1, 1, −1, 1, 1, −1, −1, −1, 1, −1, 1, 1, −1, 1, −1, |
| | 1, 1, −1, −1, −1, 1, −1, 1, 1, −1, 1, −1, 1, 1, −1, −1, −1, 1, −1, 1, 1, −1, 1 |
| 44 | 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, 1, 1, −1, |
| | −1, −1, 1, 1, 1, −1, 1, −1, −1, 1, −1, 1, 1, 1, −1, −1, −1, 1, −1, 1, 1, −1, −1, 1, 1, 1, −1, −1, −1, 1, −1, 1, 1, −1, −1, |
| | 1, 1, 1, −1, −1, −1, 1, −1, 1, 1, −1, −1, 1, 1, 1, −1, −1, −1, 1, −1, 1, 1, −1 |
| 45 | 1, 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, |
| | 1, 1, −1, −1, −1, 1, 1, 1, −1, 1, −1, −1, −1, −1, 1, 1, 1, −1, −1, −1, 1, −1, 1, 1, −1, −1, 1, 1, 1, −1, −1, −1, 1, −1, 1, 1, −1, |
| | −1, 1, 1, 1, −1, −1, −1, 1, −1, 1, 1, −1, −1, 1, 1, 1, −1, −1, −1, 1, −1, 1, 1 |
| 46 | 1, 1, 1, 1, 1, 1, 1, 1, 1, 1, 1, 1, −1, −1, −1, −1, −1, −1, −1, −1, −1, −1, −1, −1, 1, 1, 1, 1, 1, 1, 1, 1, 1, 1, 1, −1, −1, −1, −1, |
| | −1, −1, −1, −1, −1, −1, −1, −1, −1, −1, −1, −1, −1, −1, −1, −1, −1, −1, −1, −1, 1, 1, 1, 1, 1, 1, 1, 1, 1, 1, 1, 1, −1, −1, −1, |
| | −1, −1, −1, −1, −1, −1, −1, −1, −1, 1, 1, 1, 1, 1, 1, 1, 1, 1, 1, 1, 1 |
| 47 | 1, 1, −1, −1, 1, −1, −1, −1, 1, 1, 1, −1, −1, −1, 1, 1, −1, 1, 1, 1, −1, −1, −1, 1, 1, 1, −1, −1, 1, −1, −1, −1, 1, 1, 1, −1, −1, −1, |
| | 1, 1, −1, 1, 1, 1, −1, −1, −1, 1, −1, −1, 1, 1, −1, 1, 1, 1, −1, −1, −1, 1, 1, 1, −1, −1, 1, −1, −1, −1, 1, 1, 1, −1, −1, −1, |
| | 1, 1, −1, 1, 1, 1, −1, −1, −1, 1, 1, 1, −1, −1, 1, −1, −1, −1, 1, 1, 1, −1 |
| 48 | 1, −1, 1, −1, −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, −1, |
| | 1, −1, 1, 1, −1, 1, 1, 1, −1, −1, −1, −1, 1, −1, 1, 1, −1, 1, 1, 1, −1, −1, −1, 1, −1, 1, −1, −1, 1, −1, −1, −1, 1, 1, 1, −1, |
| | 1, −1, 1, 1, −1, 1, 1, 1, −1, −1, −1, 1, −1, 1, −1, −1, 1, −1, −1, −1, 1, 1, 1 |
| 49 | 1, 1, 1, 1, −1, 1, −1, −1, 1, −1, −1, −1, −1, −1, −1, −1, 1, −1, 1, 1, −1, 1, 1, 1, 1, 1, 1, 1, −1, 1, −1, −1, 1, −1, −1, −1, −1, −1, |
| | −1, −1, 1, −1, 1, 1, −1, 1, 1, 1, −1, −1, −1, −1, 1, −1, 1, 1, −1, 1, 1, 1, 1, 1, 1, 1, −1, 1, −1, −1, 1, −1, −1, −1, −1, −1, −1, |
| | −1, 1, −1, 1, 1, −1, 1, 1, 1, 1, 1, 1, 1, −1, 1, −1, −1, 1, −1, −1, −1 |
| 50 | 1, 1, −1, −1, −1, 1, 1, 1, −1, 1, −1, −1, −1, −1, 1, 1, 1, −1, −1, −1, 1, −1, 1, 1, 1, 1, −1, −1, −1, 1, 1, 1, −1, 1, −1, −1, −1, −1, |
| | 1, 1, 1, −1, −1, −1, 1, −1, 1, 1, −1, −1, 1, 1, 1, −1, −1, −1, 1, −1, 1, 1, 1, 1, −1, −1, −1, 1, 1, 1, −1, 1, −1, −1, −1, −1, |
| | 1, 1, 1, −1, −1, −1, 1, −1, 1, 1, 1, 1, −1, −1, −1, 1, 1, 1, −1, 1, −1, −1 |
| 51 | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1, −1, −1, −1, −1, |
| | −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, |
| | 1, 1, 1, 1, 1, 1, 1, 1, 1, 1, 1, 1, 1, 1, 1, 1, 1, 1, 1, 1, 1, 1, 1, 1 |
| 52 | 1, −1, −1, 1, −1, −1, −1, 1, 1, 1, −1, 1, −1, −1, 1, −1, −1, −1, 1, 1, 1, −1, 1, −1, 1, 1, −1, 1, 1, 1, −1, −1, −1, 1, −1, −1, |
| | 1, 1, −1, 1, 1, 1, −1, −1, −1, 1, −1, −1, 1, 1, −1, 1, 1, 1, −1, −1, −1, 1, −1, −1, 1, 1, −1, 1, 1, 1, −1, −1, −1, 1, −1, 1, −1, |
| | −1, 1, −1, −1, −1, 1, 1, 1, −1, 1, 1, −1, −1, 1, −1, −1, −1, 1, 1, 1, −1, 1 |
| 53 | 1, −1, 1, −1, −1, 1, −1, −1, −1, 1, 1, 1, 1, −1, 1, −1, −1, 1, −1, −1, −1, 1, 1, 1, −1, 1, −1, 1, 1, −1, 1, 1, 1, −1, −1, −1, −1, |
| | 1, −1, 1, 1, −1, 1, 1, 1, −1, −1, −1, −1, 1, −1, 1, 1, −1, 1, 1, 1, −1, −1, −1, −1, 1, −1, 1, 1, −1, 1, 1, 1, −1, −1, −1, 1, −1, |
| | 1, −1, −1, 1, −1, −1, −1, 1, 1, 1, 1, −1, 1, −1, −1, 1, −1, −1, −1, 1, 1, 1 |
| 54 | 1, 1, 1, 1, −1, 1, −1, −1, 1, −1, −1, −1, 1, 1, 1, 1, −1, 1, −1, −1, 1, −1, −1, −1, −1, −1, −1, −1, 1, −1, 1, 1, −1, 1, 1, 1, −1, −1, |
| | −1, −1, 1, −1, 1, 1, −1, 1, 1, 1, −1, −1, −1, −1, 1, −1, 1, 1, −1, 1, 1, 1, −1, −1, −1, −1, 1, −1, 1, 1, −1, |
| | 1, 1, 1, 1, 1, 1, 1, −1, 1, −1, −1, 1, −1, −1, −1, 1, 1, 1, 1, −1, 1, −1, −1, 1, −1, −1, −1 |
| 55 | 1, −1, 1, 1, 1, −1, 1, −1, −1, 1, −1, −1, 1, −1, 1, 1, 1, −1, 1, −1, −1, 1, −1, −1, −1, 1, −1, −1, −1, 1, −1, 1, 1, −1, 1, 1, −1, |
| | 1, 1, −1, −1, −1, 1, −1, 1, 1, −1, 1, 1, −1, 1, −1, −1, −1, 1, −1, 1, 1, −1, 1, 1, −1, 1, −1, −1, −1, 1, −1, 1, 1, −1, 1, 1, 1, −1, |
| | 1, 1, 1, −1, 1, −1, −1, 1, −1, −1, 1, −1, 1, 1, 1, −1, 1, −1, −1, 1, −1, −1 |
| 56 | 1, −1, −1, 1, 1, 1, −1, 1, −1, −1, 1, −1, 1, −1, −1, 1, 1, 1, −1, 1, −1, −1, 1, −1, −1, 1, 1, −1, −1, −1, 1, −1, 1, 1, −1, 1, −1, |
| | 1, 1, −1, −1, −1, 1, −1, 1, 1, −1, 1, −1, 1, 1, −1, −1, −1, 1, −1, 1, 1, −1, 1, −1, 1, 1, −1, −1, −1, 1, −1, 1, 1, −1, 1, 1, −1, |
| | −1, 1, 1, 1, −1, 1, −1, −1, 1, −1, 1, −1, −1, 1, 1, 1, −1, 1, −1, −1, 1, −1 |
| 57 | 1, 1, 1, 1, 1, 1, 1, 1, 1, 1, 1, 1, −1, −1, −1, −1, −1, −1, −1, −1, −1, −1, −1, −1, −1, −1, −1, −1, −1, −1, −1, −1, −1, −1, −1, −1, |
| | 1, 1, 1, 1, 1, 1, 1, 1, 1, 1, 1, 1, −1, −1, −1, −1, −1, −1, −1, −1, −1, −1, −1, −1, |
| | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1 |
| 58 | 1, −1, −1, 1, −1, −1, −1, 1, 1, 1, −1, 1, −1, 1, 1, −1, 1, 1, 1, −1, −1, −1, 1, −1, −1, 1, 1, −1, 1, 1, 1, −1, −1, −1, 1, −1, 1, −1, |
| | −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, −1, 1, 1, −1, −1, |
| | 1, −1, −1, −1, 1, 1, 1, −1, 1, −1, 1, 1, −1, 1, 1, 1, −1, −1, −1, 1, −1 |
| 59 | 1, −1, 1, −1, −1, 1, −1, −1, −1, 1, 1, 1, −1, 1, −1, 1, 1, −1, 1, 1, 1, −1, −1, −1, −1, 1, −1, 1, 1, −1, 1, 1, 1, −1, −1, −1, 1, −1, |
| | 1, −1, −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, 1, −1, |
| | 1, −1, −1, 1, −1, −1, −1, 1, 1, 1, −1, 1, −1, 1, 1, −1, 1, 1, 1, −1, −1, −1 |
| 60 | 1, 1, 1, −1, 1, −1, −1, 1, −1, −1, −1, 1, −1, −1, −1, 1, −1, 1, 1, −1, 1, 1, 1, −1, −1, −1, −1, 1, −1, 1, 1, −1, 1, 1, 1, −1, |
| | 1, 1, 1, −1, 1, −1, −1, 1, −1, −1, −1, 1, −1, −1, −1, 1, −1, 1, 1, −1, 1, 1, 1, −1, 1, 1, 1, −1, 1, −1, −1, 1, −1, −1, −1, |
| | 1, 1, 1, 1, −1, 1, −1, −1, 1, −1, −1, −1, 1, −1, −1, −1, 1, −1, 1, 1, −1, 1, 1, 1, −1 |
| 61 | 1, −1, 1, 1, 1, −1, 1, −1, −1, 1, −1, −1, −1, 1, −1, −1, −1, 1, −1, 1, 1, −1, 1, 1, −1, 1, −1, −1, −1, 1, −1, 1, 1, −1, 1, 1, 1, −1, |
| | 1, 1, 1, −1, 1, −1, −1, 1, −1, −1, −1, 1, −1, −1, −1, 1, −1, 1, 1, −1, 1, 1, 1, −1, 1, 1, 1, −1, 1, −1, −1, 1, −1, −1, 1, −1, |
| | 1, 1, 1, −1, 1, −1, −1, 1, −1, −1, −1, 1, −1, −1, −1, 1, −1, 1, 1, −1, 1, 1 |
| 62 | 1, −1, −1, −1, 1, 1, 1, −1, 1, −1, −1, 1, −1, 1, 1, 1, −1, −1, −1, 1, −1, 1, 1, −1, −1, 1, 1, 1, −1, −1, −1, 1, −1, 1, 1, −1, 1, −1, |
| | −1, −1, 1, 1, 1, −1, 1, −1, −1, 1, −1, 1, 1, 1, −1, −1, −1, 1, −1, 1, 1, −1, 1, −1, −1, −1, 1, 1, 1, −1, 1, −1, −1, 1, 1, −1, −1, |
| | −1, 1, 1, 1, −1, 1, −1, −1, 1, −1, 1, 1, 1, −1, −1, −1, 1, −1, 1, 1, −1 |
| 63 | 1, 1, −1, −1, −1, 1, 1, 1, −1, 1, −1, −1, −1, −1, 1, 1, 1, −1, −1, −1, 1, −1, 1, 1, −1, −1, 1, 1, 1, −1, −1, −1, 1, −1, |
| | 1, 1, 1, 1, −1, −1, −1, 1, 1, 1, −1, 1, −1, −1, −1, −1, 1, 1, 1, −1, −1, −1, 1, −1, 1, 1, 1, 1, −1, −1, −1, 1, 1, 1, −1, 1, −1, −1, |
| | 1, 1, −1, −1, −1, 1, 1, 1, −1, 1, −1, −1, −1, −1, 1, 1, 1, −1, −1, −1, 1, −1, 1, 1 |
| 64 | 1, −1, 1, −1, −1, −1, 1, 1, 1, −1, 1, −1, −1, 1, −1, 1, 1, 1, −1, −1, −1, 1, −1, 1, −1, 1, −1, 1, 1, 1, −1, −1, −1, 1, −1, 1, 1, −1, |
| | 1, −1, −1, −1, 1, 1, 1, −1, 1, −1, −1, 1, −1, 1, 1, 1, −1, −1, −1, 1, −1, 1, 1, −1, 1, −1, −1, −1, 1, 1, 1, −1, 1, −1, 1, −1, |
| | 1, −1, −1, −1, 1, 1, 1, −1, 1, −1, −1, 1, −1, 1, 1, 1, −1, −1, −1, 1, −1, 1 |

TABLE 5
ELR-mark Sequences of Length-96 Not Using Extra Tones in ELR-Mark Transmission and with Dedicated Pilots

| Index | ELR Sequence |
|---|---|
| 1 | 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, |
| | 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, |
| | 1, 1, 1, 1 |
| 2 | 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, 1, 1, −1, |
| | −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, 1, 1, −1, −1, |
| | 1, −1, −1, −1, 1, 1, 1, −1, 1, 1, −1, −1, 1, −1, −1, −1, 1, 1, 1, −1, 1 |
| 3 | 1, 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, |
| | 1, 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, |
| | 1, 1, −1, −1, 1, −1, −1, −1, 1, 1, 1, −1, 1, 1, −1, −1, 1, −1, −1, −1, 1, 1, 1, −1 |
| 4 | 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, 1, 1, 1, 1, −1, |
| | 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, 1, 1, 1, 1, −1, |
| | 1, −1, −1, 1, −1, −1, −1, 1, 1, 1, 1, −1, 1, −1, −1, 1, −1, −1, −1, 1, 1, 1 |
| 5 | 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, 1, 1, 1, −1, 1, −1, −1, 1, −1, −1, −1, 1 |
| 6 | 1, −1, 1, 1, 1, −1, 1, −1, −1, 1, −1, −1, 1, −1, 1, 1, 1, −1, 1, −1, −1, 1, −1, −1, 1, −1, 1, 1, 1, −1, 1, −1, −1, 1, −1, −1, 1, −1, |
| | 1, 1, 1, −1, 1, −1, −1, 1, −1, −1, 1, −1, 1, 1, 1, −1, 1, −1, −1, 1, −1, −1, 1, −1, 1, 1, 1, −1, 1, −1, −1, 1, −1, −1, 1, −1, |
| | 1, 1, 1, −1, 1, −1, −1, 1, −1, −1, 1, −1, 1, 1, 1, −1, 1, −1, −1, 1, −1, −1 |
| 7 | 1, −1, −1, 1, 1, 1, −1, 1, −1, −1, 1, −1, 1, −1, −1, 1, 1, 1, −1, 1, −1, −1, 1, −1, 1, −1, −1, 1, 1, 1, −1, 1, −1, −1, 1, −1, 1, −1, |
| | −1, 1, 1, 1, −1, 1, −1, −1, 1, −1, 1, −1, −1, 1, 1, 1, −1, 1, −1, −1, 1, −1, 1, −1, −1, 1, 1, 1, −1, 1, −1, −1, 1, −1, 1, −1, −1, |
| | 1, 1, 1, −1, 1, −1, −1, 1, −1, 1, −1, −1, 1, 1, 1, −1, 1, −1, −1, 1, −1 |
| 8 | 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, 1, 1, −1, |
| | −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, 1, 1, −1, −1, |
| | −1, 1, 1, 1, −1, 1, −1, −1, 1, 1, −1, −1, −1, 1, 1, 1, −1, 1, −1, −1, 1 |
| 9 | 1, 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, |
| | 1, 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, |
| | 1, 1, −1, −1, −1, 1, 1, 1, −1, 1, −1, −1, 1, 1, −1, −1, −1, 1, 1, 1, −1, 1, −1, −1 |
| 10 | 1, 1, 1, 1, 1, 1, 1, 1, 1, 1, 1, 1, −1, −1, −1, −1, −1, −1, −1, −1, −1, −1, −1, −1, 1, 1, 1, 1, 1, 1, 1, 1, 1, 1, 1, 1, −1, −1, −1, −1, |
| | −1, −1, −1, −1, −1, −1, −1, −1, 1, 1, 1, 1, 1, 1, 1, 1, 1, 1, 1, 1, −1, −1, −1, −1, −1, −1, −1, −1, −1, −1, −1, −1, |
| | 1, 1, 1, 1, 1, 1, 1, 1, 1, 1, 1, 1, −1, −1, −1, −1, −1, −1, −1, −1, −1, −1, −1, −1 |
| 11 | 1, 1, −1, −1, 1, −1, −1, −1, 1, 1, 1, −1, −1, −1, 1, 1, −1, 1, 1, 1, −1, −1, −1, 1, 1, 1, −1, −1, 1, −1, −1, −1, 1, 1, 1, −1, −1, −1, |
| | 1, 1, −1, 1, 1, 1, −1, −1, −1, 1, 1, 1, −1, −1, 1, −1, −1, −1, 1, 1, 1, −1, −1, −1, 1, 1, −1, 1, 1, 1, −1, −1, −1, 1, 1, 1, −1, −1, |
| | 1, −1, −1, −1, 1, 1, 1, −1, −1, −1, 1, 1, −1, 1, 1, 1, −1, −1, −1, 1 |
| 12 | 1, −1, 1, −1, −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, −1, |
| | 1, −1, 1, 1, −1, 1, 1, 1, −1, −1, −1, 1, −1, 1, −1, −1, 1, −1, −1, −1, 1, 1, 1, −1, 1, −1, 1, 1, −1, 1, 1, 1, −1, −1, −1, 1, −1, |
| | 1, −1, −1, 1, −1, −1, −1, 1, 1, 1, −1, 1, −1, 1, 1, −1, 1, 1, 1, −1, −1, −1 |
| 13 | 1, 1, 1, −1, 1, −1, −1, 1, −1, −1, −1, 1, −1, −1, −1, 1, −1, 1, 1, −1, 1, 1, 1, −1, 1, 1, 1, −1, 1, −1, −1, 1, −1, −1, −1, 1, −1, −1, |
| | −1, 1, −1, 1, 1, −1, 1, 1, 1, −1, 1, 1, 1, −1, 1, −1, −1, 1, −1, −1, −1, 1, −1, −1, −1, 1, −1, 1, 1, −1, 1, 1, 1, −1, 1, 1, 1, −1, |
| | 1, −1, −1, 1, −1, −1, −1, 1, −1, −1, −1, 1, −1, 1, 1, −1, 1, 1, 1, −1 |
| 14 | 1, 1, 1, 1, −1, 1, −1, −1, 1, −1, −1, −1, −1, −1, −1, −1, 1, −1, 1, 1, −1, 1, 1, 1, 1, 1, 1, 1, −1, 1, −1, −1, 1, −1, −1, −1, −1, −1, |
| | −1, −1, 1, −1, 1, 1, −1, 1, 1, 1, 1, 1, 1, 1, −1, 1, −1, −1, 1, −1, −1, −1, −1, −1, −1, −1, 1, −1, 1, 1, −1, |
| | 1, 1, 1, 1, 1, 1, 1, −1, 1, −1, −1, 1, −1, −1, −1, −1, −1, −1, −1, 1, −1, 1, 1, −1, 1, 1, 1 |
| 15 | 1, 1, −1, −1, −1, 1, 1, 1, −1, 1, −1, −1, −1, −1, 1, 1, 1, −1, −1, −1, 1, −1, 1, 1, 1, 1, −1, −1, −1, 1, 1, 1, −1, 1, −1, −1, −1, −1, |
| | 1, 1, 1, −1, −1, −1, 1, −1, 1, 1, 1, 1, −1, −1, −1, 1, 1, 1, −1, 1, −1, −1, −1, −1, 1, 1, 1, −1, −1, −1, 1, −1, 1, 1, 1, 1, −1, −1, |
| | −1, 1, 1, 1, −1, 1, −1, −1, −1, −1, 1, 1, 1, −1, −1, −1, 1, −1, 1, 1 |
| 16 | 1, −1, 1, −1, −1, −1, 1, 1, 1, −1, 1, −1, −1, 1, −1, 1, 1, 1, −1, −1, −1, 1, −1, 1, 1, −1, 1, −1, −1, −1, 1, 1, 1, −1, 1, −1, −1, |
| | 1, −1, 1, 1, 1, −1, −1, −1, 1, −1, 1, 1, −1, 1, −1, −1, −1, 1, 1, 1, −1, 1, −1, −1, 1, −1, 1, 1, 1, −1, −1, −1, 1, −1, 1, 1, −1, |
| | 1, −1, −1, −1, 1, 1, 1, −1, 1, −1, −1, 1, −1, 1, 1, 1, −1, −1, −1, 1, −1, 1 |
| 17 | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1, −1, −1, −1, −1, |
| | −1, −1, −1, −1, −1, −1, −1, −1, 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, |
| | −1, −1, −1, −1, −1, −1, −1, −1, −1, −1, −1, −1, −1, −1, −1, −1, −1 |
| 18 | 1, −1, −1, 1, −1, −1, −1, 1, 1, 1, −1, 1, 1, −1, −1, 1, −1, −1, −1, 1, 1, 1, −1, 1, −1, 1, 1, −1, 1, 1, 1, −1, −1, −1, 1, −1, −1, |
| | 1, 1, −1, 1, 1, 1, −1, −1, −1, 1, −1, 1, −1, −1, 1, −1, −1, −1, 1, 1, 1, −1, 1, 1, −1, −1, 1, −1, −1, −1, 1, 1, 1, −1, 1, −1, |
| | 1, 1, −1, 1, 1, 1, −1, −1, −1, 1, −1, −1, 1, 1, −1, 1, 1, 1, −1, −1, −1, 1, −1 |
| 19 | 1, −1, 1, −1, −1, 1, −1, −1, −1, 1, 1, 1, 1, −1, 1, −1, −1, 1, −1, −1, −1, 1, 1, 1, −1, 1, −1, 1, 1, −1, 1, 1, 1, −1, −1, −1, −1, |
| | 1, −1, 1, 1, −1, 1, 1, 1, −1, −1, −1, 1, −1, 1, −1, −1, 1, −1, −1, −1, 1, 1, 1, 1, −1, 1, −1, −1, 1, −1, −1, −1, 1, 1, 1, −1, |
| | 1, −1, 1, 1, −1, 1, 1, 1, −1, −1, −1, −1, 1, −1, 1, 1, −1, 1, 1, 1, −1, −1, −1 |
| 20 | 1, 1, −1, 1, −1, −1, 1, −1, −1, −1, 1, 1, 1, 1, −1, 1, −1, −1, 1, −1, −1, −1, 1, 1, −1, −1, 1, −1, 1, 1, −1, 1, 1, 1, −1, −1, −1, −1, |
| | 1, −1, 1, 1, −1, 1, 1, 1, −1, −1, 1, 1, −1, 1, −1, −1, 1, −1, −1, −1, 1, 1, 1, 1, −1, 1, −1, −1, 1, −1, −1, −1, 1, 1, −1, −1, |
| | 1, −1, 1, 1, −1, 1, 1, 1, −1, −1, −1, −1, 1, −1, 1, 1, −1, 1, 1, 1, −1, −1 |
| 21 | 1, 1, 1, 1, −1, 1, −1, −1, 1, −1, −1, −1, 1, 1, 1, 1, −1, 1, −1, −1, 1, −1, −1, −1, −1, −1, −1, −1, 1, −1, 1, 1, −1, 1, 1, 1, −1, −1, |
| | −1, −1, 1, −1, 1, 1, −1, 1, 1, 1, 1, 1, 1, 1, −1, 1, −1, −1, 1, −1, −1, −1, 1, 1, 1, 1, −1, 1, −1, −1, 1, −1, −1, −1, −1, −1, −1, |
| | −1, 1, −1, 1, 1, −1, 1, 1, 1, −1, −1, −1, −1, 1, −1, 1, 1, −1, 1, 1, 1 |
| 22 | 1, −1, 1, 1, 1, −1, 1, −1, −1, 1, −1, −1, 1, −1, 1, 1, 1, −1, 1, −1, −1, 1, −1, −1, −1, 1, −1, −1, −1, 1, −1, 1, 1, −1, 1, 1, −1, |
| | 1, −1, −1, −1, 1, −1, 1, 1, −1, 1, 1, 1, −1, 1, 1, 1, −1, 1, −1, −1, 1, −1, −1, 1, −1, 1, 1, 1, −1, 1, −1, −1, 1, −1, −1, −1, |
| | 1, −1, −1, −1, 1, −1, 1, 1, −1, 1, 1, −1, 1, −1, −1, −1, 1, −1, 1, 1, −1, 1, 1 |
| 23 | 1, −1, −1, 1, 1, 1, −1, 1, −1, −1, 1, −1, 1, −1, −1, 1, 1, 1, −1, 1, −1, −1, 1, −1, −1, 1, 1, −1, −1, −1, 1, −1, 1, 1, −1, 1, −1, |
| | 1, 1, −1, −1, −1, 1, −1, 1, 1, −1, 1, 1, −1, −1, 1, 1, 1, −1, 1, −1, −1, 1, −1, 1, −1, −1, 1, 1, 1, −1, 1, −1, −1, 1, −1, −1, |
| | 1, 1, −1, −1, −1, 1, −1, 1, 1, −1, 1, −1, 1, 1, −1, −1, −1, 1, −1, 1, 1, −1, 1 |
| 24 | 1, 1, −1, −1, −1, 1, 1, 1, −1, 1, −1, −1, 1, 1, −1, −1, −1, 1, 1, 1, −1, 1, −1, −1, −1, −1, 1, 1, 1, −1, −1, −1, 1, −1, 1, 1, −1, −1, |
| | 1, 1, 1, −1, −1, −1, 1, −1, 1, 1, 1, 1, −1, −1, −1, 1, 1, 1, 1, −1, 1, −1, −1, 1, 1, −1, −1, −1, 1, 1, 1, −1, 1, −1, −1, −1, −1, |
| | 1, 1, 1, −1, −1, −1, 1, −1, 1, 1, −1, −1, 1, 1, 1, −1, −1, −1, 1, −1, 1, 1 |
| 25 | 1, 1, 1, 1, 1, 1, 1, 1, 1, 1, 1, 1, −1, −1, −1, −1, −1, −1, −1, −1, −1, −1, −1, −1, −1, −1, −1, −1, −1, −1, −1, −1, −1, −1, −1, −1, |
| | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1, −1, −1, −1, |
| | −1, −1, −1, −1, −1, −1, −1, −1, −1, 1, 1, 1, 1, 1, 1, 1, 1, 1, 1, 1, 1 |
| 26 | 1, −1, −1, 1, −1, −1, −1, 1, 1, 1, −1, 1, −1, 1, 1, −1, 1, 1, 1, −1, −1, −1, 1, −1, −1, 1, 1, −1, 1, 1, 1, −1, −1, −1, 1, −1, 1, −1, |
| | −1, 1, −1, −1, −1, 1, 1, 1, −1, 1, 1, −1, −1, 1, −1, −1, −1, 1, 1, 1, −1, 1, −1, 1, 1, −1, 1, 1, 1, −1, −1, −1, 1, −1, −1, |
| | 1, 1, −1, 1, 1, 1, −1, −1, −1, 1, −1, 1, −1, −1, 1, −1, −1, −1, 1, 1, 1, −1, 1 |
| 27 | 1, −1, 1, −1, −1, 1, −1, −1, −1, 1, 1, 1, −1, 1, −1, 1, 1, −1, 1, 1, 1, −1, −1, −1, −1, 1, −1, 1, 1, −1, 1, 1, 1, −1, −1, −1, 1, −1, |
| | 1, −1, −1, 1, −1, −1, −1, 1, 1, 1, 1, −1, 1, −1, −1, 1, −1, −1, −1, 1, 1, 1, −1, 1, −1, 1, 1, −1, 1, 1, 1, −1, −1, −1, −1, 1, −1, |
| | 1, 1, −1, 1, 1, 1, −1, −1, −1, 1, −1, 1, −1, −1, 1, −1, −1, −1, 1, 1, 1 |
| 28 | 1, 1, 1, 1, −1, 1, −1, −1, 1, −1, −1, −1, −1, −1, −1, −1, 1, −1, 1, 1, −1, 1, 1, 1, 1, −1, −1, −1, −1, 1, −1, 1, 1, −1, |
| | 1, 1, 1, 1, 1, 1, 1, −1, 1, −1, −1, 1, −1, −1, −1, 1, 1, 1, 1, −1, 1, −1, −1, 1, −1, −1, −1, −1, −1, −1, −1, 1, −1, 1, 1, −1, |
| | 1, 1, 1, −1, −1, −1, −1, 1, −1, 1, 1, −1, 1, 1, 1, 1, 1, 1, 1, −1, 1, −1, −1, 1, −1, −1, −1 |
| 29 | 1, −1, 1, 1, 1, −1, 1, −1, −1, 1, −1, −1, −1, 1, −1, −1, −1, 1, −1, 1, 1, −1, 1, 1, −1, 1, −1, −1, −1, 1, −1, 1, 1, −1, 1, 1, 1, −1, |
| | 1, 1, 1, −1, 1, −1, −1, 1, −1, −1, 1, −1, 1, 1, 1, −1, 1, −1, −1, 1, −1, −1, −1, 1, −1, −1, −1, 1, −1, 1, 1, −1, 1, 1, −1, 1, −1, |
| | −1, −1, 1, −1, 1, 1, −1, 1, 1, 1, −1, 1, 1, 1, −1, 1, −1, −1, 1, −1, −1 |
| 30 | 1, −1, −1, −1, 1, 1, 1, −1, 1, −1, −1, 1, −1, 1, 1, 1, −1, −1, −1, 1, −1, 1, 1, −1, −1, 1, 1, 1, −1, −1, −1, 1, −1, 1, 1, −1, 1, −1, |
| | −1, −1, 1, 1, 1, −1, 1, −1, −1, 1, 1, −1, −1, −1, 1, 1, 1, −1, 1, −1, −1, 1, −1, 1, 1, 1, 1, −1, −1, −1, 1, −1, 1, 1, −1, −1, |
| | 1, 1, 1, −1, −1, −1, 1, −1, 1, 1, −1, 1, −1, −1, −1, 1, 1, 1, −1, 1, −1, −1, 1 |
| 31 | 1, 1, −1, −1, −1, 1, 1, 1, −1, 1, −1, −1, −1, −1, 1, 1, 1, −1, −1, −1, 1, −1, 1, 1, −1, −1, 1, 1, 1, −1, −1, 1, −1, |
| | 1, 1, 1, 1, −1, −1, −1, 1, 1, 1, −1, 1, −1, −1, 1, 1, −1, 1, −1, −1, 1, 1, 1, −1, 1, −1, −1, −1, −1, 1, 1, 1, −1, −1, −1, 1, −1, |
| | 1, 1, −1, −1, 1, 1, 1, −1, −1, −1, 1, −1, 1, 1, 1, 1, −1, −1, −1, 1, 1, 1, −1, 1, −1, −1 |
| 32 | 1, −1, 1, −1, −1, −1, 1, 1, 1, −1, 1, −1, −1, 1, −1, 1, 1, 1, −1, −1, −1, 1, −1, 1, −1, 1, −1, 1, 1, 1, −1, −1, −1, 1, −1, 1, 1, −1, |
| | 1, −1, −1, −1, 1, 1, 1, −1, 1, −1, 1, −1, 1, −1, −1, −1, 1, 1, 1, −1, 1, −1, −1, 1, −1, 1, 1, 1, −1, −1, −1, 1, −1, 1, −1, 1, −1, |
| | 1, 1, 1, −1, −1, −1, 1, −1, 1, 1, −1, 1, −1, −1, −1, 1, 1, 1, −1, 1, −1 |
| 33 | 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, 1, |
| | 1, 1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, |
| | −1, −1, −1, −1, −1, −1, −1, −1, −1, −1, −1, −1, −1, −1, −1, −1, −1 |
| 34 | 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, 1, 1, −1, |
| | −1, 1, −1, −1, −1, 1, 1, 1, −1, 1, −1, 1, 1, −1, 1, 1, 1, −1, −1, −1, 1, −1, −1, 1, 1, −1, 1, 1, 1, −1, −1, −1, 1, −1, −1, |
| | 1, 1, −1, 1, 1, 1, −1, −1, −1, 1, −1, −1, 1, 1, −1, 1, 1, 1, −1, −1, −1, 1, −1 |
| 35 | 1, 1, −1, −1, 1, −1, −1, −1, 1, 1, 1, −1, 1, 1, −1, −1, 1, −1, −1, −1, 1, 1, 1, −1, 1, 1, −1, −1, 1, −1, −1, −1, 1, 1, 1, −1, |
| | 1, 1, −1, −1, 1, −1, −1, −1, 1, 1, 1, −1, −1, −1, 1, 1, −1, 1, 1, 1, −1, −1, −1, 1, −1, −1, 1, 1, −1, 1, 1, 1, −1, −1, −1, 1, −1, |
| | −1, 1, 1, −1, 1, 1, 1, −1, −1, −1, 1, −1, −1, 1, 1, −1, 1, 1, 1, −1, −1, −1, 1 |
| 36 | 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, 1, 1, 1, 1, −1, |
| | 1, −1, −1, 1, −1, −1, −1, 1, 1, 1, −1, 1, −1, 1, 1, −1, 1, 1, 1, −1, −1, −1, −1, 1, −1, 1, 1, −1, 1, 1, 1, −1, −1, −1, −1, 1, −1, |
| | 1, 1, −1, 1, 1, 1, −1, −1, −1, −1, 1, −1, 1, 1, −1, 1, 1, 1, −1, −1, −1 |
| 37 | 1, 1, 1, −1, 1, −1, −1, 1, −1, −1, −1, 1, 1, 1, 1, −1, 1, −1, −1, 1, −1, −1, −1, 1, 1, 1, 1, −1, 1, −1, −1, 1, −1, −1, −1, |
| | 1, 1, 1, 1, −1, 1, −1, −1, 1, −1, −1, −1, 1, −1, −1, −1, 1, −1, 1, 1, −1, 1, 1, 1, −1, −1, −1, −1, 1, −1, 1, 1, −1, 1, 1, 1, −1, |
| | −1, −1, −1, 1, −1, 1, 1, −1, 1, 1, 1, −1, −1, −1, −1, 1, −1, 1, 1, −1, 1, 1, 1, −1 |
| 38 | 1, −1, 1, 1, 1, −1, 1, −1, −1, 1, −1, −1, 1, −1, 1, 1, 1, −1, 1, −1, −1, 1, −1, −1, 1, −1, 1, 1, 1, −1, 1, −1, −1, 1, −1, −1, 1, −1, |
| | 1, 1, 1, −1, 1, −1, −1, 1, −1, −1, −1, 1, −1, −1, −1, 1, −1, 1, 1, −1, 1, 1, −1, 1, −1, −1, −1, 1, −1, 1, 1, −1, 1, 1, −1, 1, −1, |
| | −1, −1, 1, −1, 1, 1, −1, 1, 1, −1, 1, −1, −1, −1, 1, −1, 1, 1, −1, 1, 1 |
| 39 | 1, −1, −1, 1, 1, 1, −1, 1, −1, −1, 1, −1, 1, −1, −1, 1, 1, 1, −1, 1, −1, −1, 1, −1, 1, −1, −1, 1, 1, 1, −1, 1, −1, −1, 1, −1, 1, −1, |
| | −1, 1, 1, 1, −1, 1, −1, −1, 1, −1, −1, 1, 1, −1, −1, −1, 1, −1, 1, 1, −1, 1, −1, 1, 1, −1, −1, −1, 1, −1, 1, 1, −1, 1, −1, |
| | 1, 1, −1, −1, −1, 1, −1, 1, 1, −1, 1, −1, 1, 1, −1, −1, −1, 1, −1, 1, 1, −1, 1 |
| 40 | 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, 1, 1, −1, |
| | −1, −1, 1, 1, 1, −1, 1, −1, −1, 1, −1, 1, 1, 1, −1, −1, −1, 1, −1, 1, 1, −1, −1, 1, 1, 1, −1, −1, −1, 1, −1, 1, 1, −1, −1, |
| | 1, 1, 1, −1, −1, −1, 1, −1, 1, 1, −1, −1, 1, 1, 1, −1, −1, −1, 1, −1, 1, 1, −1 |
| 41 | 1, 1, −1, −1, −1, 1, 1, 1, −1, 1, −1, −1, 1, 1, −1, −1, −1, 1, 1, 1, −1, 1, −1, −1, 1, 1, −1, −1, −1, 1, 1, 1, −1, 1, −1, −1, |
| | 1, 1, −1, −1, −1, 1, 1, 1, −1, 1, −1, −1, −1, −1, 1, 1, 1, −1, −1, −1, 1, −1, 1, 1, −1, −1, 1, 1, 1, −1, −1, −1, 1, −1, 1, 1, −1, |
| | −1, 1, 1, 1, −1, −1, −1, 1, −1, 1, 1, −1, −1, 1, 1, 1, −1, −1, −1, 1, −1, 1, 1 |
| 42 | 1, 1, 1, 1, 1, 1, 1, 1, 1, 1, 1, 1, −1, −1, −1, −1, −1, −1, −1, −1, −1, −1, −1, −1, 1, 1, 1, 1, 1, 1, 1, 1, 1, 1, 1, 1, −1, −1, −1, −1, |
| | −1, −1, −1, −1, −1, −1, −1, −1, −1, −1, −1, −1, −1, −1, −1, −1, −1, −1, −1, −1, 1, 1, 1, 1, 1, 1, 1, 1, 1, 1, 1, 1, −1, −1, −1, |
| | −1, −1, −1, −1, −1, −1, −1, −1, −1, 1, 1, 1, 1, 1, 1, 1, 1, 1, 1, 1, 1 |
| 43 | 1, 1, −1, −1, 1, −1, −1, −1, 1, 1, 1, −1, −1, −1, 1, 1, −1, 1, 1, 1, −1, −1, −1, 1, 1, 1, −1, −1, 1, −1, −1, −1, 1, 1, 1, −1, −1, −1, |
| | 1, 1, −1, 1, 1, 1, −1, −1, −1, 1, −1, −1, 1, 1, −1, 1, 1, 1, −1, −1, −1, 1, 1, 1, −1, −1, 1, −1, −1, −1, 1, 1, 1, −1, −1, −1, |
| | 1, 1, −1, 1, 1, 1, −1, −1, −1, 1, 1, 1, −1, −1, 1, −1, −1, −1, 1, 1, 1, −1 |
| 44 | 1, −1, 1, −1, −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, −1, |
| | 1, −1, 1, 1, −1, 1, 1, 1, −1, −1, −1, −1, 1, −1, 1, 1, −1, 1, 1, 1, −1, −1, −1, 1, −1, 1, −1, −1, 1, −1, −1, −1, 1, 1, 1, −1, |
| | 1, −1, 1, 1, −1, 1, 1, 1, −1, −1, −1, 1, −1, 1, −1, −1, 1, −1, −1, −1, 1, 1, 1 |
| 45 | 1, 1, 1, −1, 1, −1, −1, 1, −1, −1, −1, 1, −1, −1, −1, 1, −1, 1, 1, −1, 1, 1, 1, −1, 1, 1, 1, −1, 1, −1, −1, 1, −1, −1, −1, 1, −1, −1, |
| | −1, 1, −1, 1, 1, −1, 1, 1, 1, −1, −1, −1, −1, 1, −1, 1, 1, −1, 1, 1, 1, −1, 1, 1, 1, −1, 1, −1, −1, 1, −1, −1, −1, 1, −1, −1, −1, |
| | 1, −1, 1, 1, −1, 1, 1, 1, −1, 1, 1, 1, −1, 1, −1, −1, 1, −1, −1, −1, 1 |
| 46 | 1, 1, 1, 1, −1, 1, −1, −1, 1, −1, −1, −1, −1, −1, −1, −1, 1, −1, 1, 1, −1, 1, 1, 1, 1, 1, 1, 1, −1, 1, −1, −1, 1, −1, −1, −1, −1, −1, |
| | −1, −1, 1, −1, 1, 1, −1, 1, 1, 1, −1, −1, −1, −1, 1, −1, 1, 1, −1, 1, 1, 1, 1, 1, 1, 1, −1, 1, −1, −1, 1, −1, −1, −1, −1, −1, −1, |
| | −1, 1, −1, 1, 1, −1, 1, 1, 1, 1, 1, 1, 1, −1, 1, −1, −1, 1, −1, −1, −1 |
| 47 | 1, 1, −1, −1, −1, 1, 1, 1, −1, 1, −1, −1, −1, −1, 1, 1, 1, −1, −1, −1, 1, −1, 1, 1, 1, 1, −1, −1, −1, 1, 1, 1, −1, 1, −1, −1, −1, −1, |
| | 1, 1, 1, −1, −1, −1, 1, −1, 1, 1, −1, −1, 1, 1, 1, −1, −1, −1, 1, −1, 1, 1, 1, 1, −1, −1, −1, 1, 1, 1, −1, 1, −1, −1, −1, −1, |
| | 1, 1, 1, −1, −1, −1, 1, −1, 1, 1, 1, 1, −1, −1, −1, 1, 1, 1, −1, 1, −1, −1 |
| 48 | 1, −1, 1, −1, −1, −1, 1, 1, 1, −1, 1, −1, −1, 1, −1, 1, 1, 1, −1, −1, −1, 1, −1, 1, 1, −1, 1, −1, −1, −1, 1, 1, 1, −1, 1, −1, −1, |
| | 1, −1, 1, 1, 1, −1, −1, −1, 1, −1, 1, −1, 1, −1, 1, 1, 1, −1, −1, −1, 1, −1, 1, 1, −1, 1, −1, −1, −1, 1, 1, 1, −1, 1, −1, −1, |
| | 1, −1, 1, 1, 1, −1, −1, −1, 1, −1, 1, 1, −1, 1, −1, −1, −1, 1, 1, 1, −1, 1, −1 |
| 49 | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1, −1, −1, −1, −1, |
| | −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, −1, |
| | 1, 1, 1, 1, 1, 1, 1, 1, 1, 1, 1, 1, 1, 1, 1, 1, 1, 1, 1, 1, 1, 1, 1, 1 |
| 50 | 1, −1, −1, 1, −1, −1, −1, 1, 1, 1, −1, 1, 1, −1, −1, 1, −1, −1, −1, 1, 1, 1, −1, 1, −1, 1, 1, −1, 1, 1, 1, −1, −1, −1, 1, −1, −1, |
| | 1, 1, −1, 1, 1, 1, −1, −1, −1, 1, −1, −1, 1, 1, −1, 1, 1, 1, −1, −1, −1, 1, −1, −1, 1, 1, −1, 1, 1, 1, −1, −1, −1, 1, −1, 1, −1, |
| | −1, 1, −1, −1, −1, 1, 1, 1, −1, 1, 1, −1, −1, 1, −1, −1, −1, 1, 1, 1, −1, 1 |
| 51 | 1, −1, 1, −1, −1, 1, −1, −1, −1, 1, 1, 1, 1, −1, 1, −1, −1, 1, −1, −1, −1, 1, 1, 1, −1, 1, −1, 1, 1, −1, 1, 1, 1, −1, −1, −1, −1, |
| | 1, −1, 1, 1, −1, 1, 1, 1, −1, −1, −1, −1, 1, −1, 1, 1, −1, 1, 1, 1, −1, −1, −1, −1, 1, −1, 1, 1, −1, 1, 1, 1, −1, −1, −1, 1, −1, |
| | 1, −1, −1, 1, −1, −1, −1, 1, 1, 1, 1, −1, 1, −1, −1, 1, −1, −1, −1, 1, 1, 1 |
| 52 | 1, 1, −1, 1, −1, −1, 1, −1, −1, −1, 1, 1, 1, 1, −1, 1, −1, −1, 1, −1, −1, −1, 1, 1, −1, −1, 1, −1, 1, 1, −1, 1, 1, 1, −1, −1, −1, −1, |
| | 1, −1, 1, 1, −1, 1, 1, 1, −1, −1, −1, −1, 1, −1, 1, 1, −1, 1, 1, 1, −1, −1, −1, −1, 1, −1, 1, 1, −1, 1, 1, 1, −1, −1, 1, 1, −1, |
| | 1, −1, −1, 1, −1, −1, −1, 1, 1, 1, 1, −1, 1, −1, −1, 1, −1, −1, −1, 1, 1 |
| 53 | 1, 1, 1, 1, −1, 1, −1, −1, 1, −1, −1, −1, 1, 1, 1, 1, −1, 1, −1, −1, 1, −1, −1, −1, −1, −1, −1, −1, 1, −1, 1, −1, 1, 1, −1, 1, 1, 1, −1, −1, |
| | −1, −1, 1, −1, 1, 1, 1, −1, 1, 1, 1, −1, −1, −1, −1, 1, −1, 1, 1, −1, 1, 1, 1, −1, −1, −1, −1, 1, −1, 1, 1, −1, |
| | 1, 1, 1, 1, 1, 1, 1, −1, 1, −1, −1, 1, −1, −1, −1, 1, 1, 1, 1, −1, 1, −1, −1, 1, −1, −1, −1 |
| 54 | 1, −1, 1, 1, 1, −1, 1, −1, −1, 1, −1, −1, 1, −1, 1, 1, 1, −1, 1, −1, −1, 1, −1, −1, −1, 1, −1, −1, −1, 1, −1, 1, 1, −1, 1, 1, −1, |
| | 1, −1, −1, −1, 1, −1, 1, 1, −1, 1, 1, −1, 1, −1, −1, −1, 1, −1, 1, 1, −1, 1, 1, −1, 1, −1, −1, −1, 1, −1, 1, 1, −1, 1, 1, 1, −1, |
| | 1, 1, 1, −1, 1, −1, −1, 1, −1, −1, 1, −1, 1, 1, 1, −1, 1, −1, −1, 1, −1, −1 |
| 55 | 1, −1, −1, 1, 1, 1, −1, 1, −1, −1, 1, −1, 1, −1, −1, 1, 1, 1, −1, 1, −1, −1, 1, −1, −1, 1, 1, −1, −1, −1, 1, −1, 1, 1, −1, 1, −1, |
| | 1, 1, −1, −1, −1, 1, −1, 1, 1, −1, 1, −1, 1, 1, −1, −1, −1, 1, −1, 1, 1, −1, 1, −1, 1, 1, −1, −1, −1, 1, −1, 1, 1, −1, 1, 1, −1, |
| | −1, 1, 1, 1, −1, 1, −1, −1, 1, −1, 1, −1, −1, 1, 1, 1, −1, 1, −1, −1, 1, −1 |
| 56 | 1, 1, −1, −1, −1, 1, 1, 1, −1, 1, −1, −1, 1, 1, −1, −1, −1, 1, 1, 1, −1, 1, −1, −1, −1, −1, 1, 1, 1, −1, −1, −1, 1, −1, 1, 1, −1, −1, |
| | 1, 1, 1, −1, −1, −1, 1, −1, 1, 1, −1, −1, 1, 1, 1, −1, −1, −1, 1, −1, 1, 1, −1, −1, 1, 1, 1, −1, −1, −1, 1, −1, 1, 1, 1, 1, −1, −1, |
| | −1, 1, 1, 1, −1, 1, −1, −1, 1, 1, −1, −1, −1, 1, 1, 1, −1, 1, −1, −1 |
| 57 | 1, 1, 1, 1, 1, 1, 1, 1, 1, 1, 1, 1, −1, −1, −1, −1, −1, −1, −1, −1, −1, −1, −1, −1, −1, −1, −1, −1, −1, −1, −1, −1, −1, −1, −1, −1, |
| | 1, 1, 1, 1, 1, 1, 1, 1, 1, 1, 1, 1, −1, −1, −1, −1, −1, −1, −1, −1, −1, −1, −1, −1, |
| | 1, 1, 1, 1, 1, 1, 1, 1, 1, 1, 1, 1, 1, 1, 1, 1, 1, 1, 1, 1, 1, 1, 1, 1, −1, −1, −1, −1, −1, −1, −1, −1, −1, −1, −1, −1 |
| 58 | 1, −1, −1, 1, −1, −1, −1, 1, 1, 1, −1, 1, −1, 1, 1, −1, 1, 1, 1, −1, −1, −1, 1, −1, −1, 1, 1, −1, 1, 1, 1, −1, −1, −1, 1, −1, 1, −1, |
| | −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, −1, 1, 1, −1, −1, |
| | 1, −1, −1, −1, 1, 1, 1, −1, 1, −1, 1, 1, −1, 1, 1, 1, −1, −1, −1, 1, −1 |
| 59 | 1, −1, 1, −1, −1, 1, −1, −1, −1, 1, 1, 1, −1, 1, −1, 1, 1, −1, 1, 1, 1, −1, −1, −1, −1, 1, −1, 1, 1, −1, 1, 1, 1, −1, −1, −1, 1, −1, |
| | 1, −1, −1, 1, −1, −1, −1, 1, 1, 1, −1, 1, −1, 1, 1, −1, 1, 1, 1, −1, −1, −1, 1, −1, 1, −1, −1, 1, −1, −1, −1, 1, 1, 1, 1, −1, |
| | 1, −1, −1, 1, −1, −1, −1, 1, 1, 1, −1, 1, −1, 1, 1, −1, 1, 1, 1, −1, −1, −1 |
| 60 | 1, 1, 1, 1, −1, 1, −1, −1, 1, −1, −1, −1, −1, −1, −1, −1, 1, −1, 1, 1, −1, 1, 1, 1, −1, −1, −1, −1, 1, −1, 1, 1, −1, |
| | 1, 1, 1, 1, 1, 1, 1, −1, 1, −1, −1, 1, −1, −1, −1, −1, −1, −1, −1, 1, −1, 1, 1, −1, 1, 1, 1, 1, 1, 1, 1, −1, 1, −1, −1, 1, −1, −1, |
| | −1, 1, 1, 1, 1, −1, 1, −1, −1, 1, −1, −1, −1, −1, −1, −1, −1, 1, −1, 1, 1, −1, 1, 1, 1 |
| 61 | 1, −1, 1, 1, 1, −1, 1, −1, −1, 1, −1, −1, −1, 1, −1, −1, −1, 1, −1, 1, 1, −1, 1, 1, −1, 1, −1, −1, −1, 1, −1, 1, 1, −1, 1, 1, 1, −1, |
| | 1, 1, 1, −1, 1, −1, −1, 1, −1, −1, −1, 1, −1, −1, −1, 1, −1, 1, 1, −1, 1, 1, 1, −1, 1, 1, 1, −1, 1, −1, −1, 1, −1, −1, 1, −1, |
| | 1, 1, 1, −1, 1, −1, −1, 1, −1, −1, −1, 1, −1, −1, −1, 1, −1, 1, 1, −1, 1, 1 |
| 62 | 1, −1, −1, −1, 1, 1, 1, −1, 1, −1, −1, 1, −1, 1, 1, 1, −1, −1, −1, 1, −1, 1, 1, −1, −1, 1, 1, 1, −1, −1, −1, 1, −1, 1, 1, −1, 1, −1, |
| | −1, −1, 1, 1, 1, −1, 1, −1, −1, 1, −1, 1, 1, 1, −1, −1, −1, 1, −1, 1, 1, −1, 1, −1, −1, −1, 1, 1, 1, −1, 1, −1, −1, 1, 1, −1, −1, |
| | −1, 1, 1, 1, −1, 1, −1, −1, 1, −1, 1, 1, 1, −1, −1, −1, 1, −1, 1, 1, −1 |
| 63 | 1, 1, −1, −1, −1, 1, 1, 1, −1, 1, −1, −1, −1, −1, 1, 1, 1, −1, −1, −1, 1, −1, 1, 1, −1, −1, 1, 1, 1, −1, −1, −1, 1, −1, |
| | 1, 1, 1, 1, −1, −1, −1, 1, 1, 1, −1, 1, −1, −1, −1, −1, 1, 1, 1, −1, −1, −1, 1, −1, 1, 1, 1, 1, −1, −1, −1, 1, 1, 1, −1, 1, −1, −1, |
| | 1, 1, −1, −1, −1, 1, 1, 1, −1, 1, −1, −1, −1, −1, 1, 1, 1, −1, −1, −1, 1, −1, 1, 1 |
| 64 | 1, −1, 1, −1, −1, −1, 1, 1, 1, −1, 1, −1, −1, 1, −1, 1, 1, 1, −1, −1, −1, 1, −1, 1, −1, 1, −1, 1, 1, 1, −1, −1, −1, 1, −1, 1, 1, −1, |
| | 1, −1, −1, −1, 1, 1, 1, −1, 1, −1, −1, 1, −1, 1, 1, 1, −1, −1, −1, 1, −1, 1, 1, −1, 1, −1, −1, −1, 1, 1, 1, −1, 1, −1, 1, −1, |
| | 1, −1, −1, −1, 1, 1, 1, −1, 1, −1, −1, 1, −1, 1, 1, 1, −1, −1, −1, 1, −1, 1 |

TABLE 6
ELR-mark Sequences of Length-96 Not Using Extra Tones in ELR-Mark Transmission and with Dedicated Pilots

| Index | ELR Sequence |
|---|---|
| 1 | 1, 1, 1, −1, −1, −1, 1, −1, −1, −1, −1, 1, −1, 1, 1, 1, −1, 1, −1, −1, −1, 1, 1, 1, −1, −1, 1, −1, 1, −1, 1, 1, −1, 1, 1, 1, 1, 1, −1, |
| | 1, 1, −1, 1, 1, −1, 1, 1, 1, 1, 1, 1, −1, −1, −1, 1, −1, −1, −1, −1, 1, −1, 1, 1, 1, −1, 1, −1, −1, −1, 1, 1, 1, −1, −1, 1, −1, |
| | 1, −1, 1, 1, −1, 1, 1, 1, 1, 1, −1, 1, 1, −1, 1, 1, −1, 1, 1, 1 |
| 2 | −1, 1, 1, 1, 1, −1, −1, −1, 1, −1, −1, −1, 1, 1, −1, 1, −1, −1, −1, 1, 1, 1, −1, 1, 1, −1, 1, −1, 1, 1, −1, 1, 1, 1, −1, −1, −1, |
| | 1, 1, −1, 1, 1, −1, 1, 1, 1, 1, 1, −1, 1, 1, 1, 1, −1, −1, −1, 1, −1, −1, −1, 1, 1, −1, 1, −1, −1, −1, 1, 1, 1, −1, 1, 1, −1, 1, −1, |
| | 1, 1, −1, 1, 1, 1, −1, −1, −1, 1, 1, −1, 1, 1, −1, 1, 1, 1, 1, 1 |
| 3 | −1, −1, 1, 1, 1, 1, −1, −1, −1, 1, −1, −1, 1, −1, 1, −1, −1, −1, 1, 1, 1, −1, 1, 1, −1, 1, −1, 1, 1, −1, 1, 1, 1, −1, −1, 1, 1, 1, −1, |
| | 1, 1, −1, 1, 1, 1, 1, 1, −1, −1, −1, 1, 1, 1, 1, −1, −1, −1, 1, −1, −1, 1, −1, 1, −1, −1, −1, 1, 1, 1, −1, 1, 1, −1, 1, −1, |
| | 1, 1, −1, 1, 1, 1, −1, −1, 1, 1, 1, −1, 1, 1, −1, 1, 1, 1, 1, 1, −1 |
| 4 | −1, −1, −1, 1, 1, 1, 1, −1, −1, −1, 1, −1, −1, 1, −1, −1, −1, 1, 1, 1, −1, 1, 1, 1, 1, −1, 1, 1, −1, 1, 1, 1, −1, −1, 1, −1, 1, −1, |
| | 1, 1, −1, 1, 1, 1, 1, 1, −1, 1, −1, −1, −1, 1, 1, 1, 1, −1, −1, −1, 1, −1, −1, 1, −1, −1, −1, 1, 1, 1, −1, 1, 1, 1, 1, −1, 1, 1, −1, |
| | 1, 1, 1, −1, −1, 1, −1, 1, −1, 1, 1, −1, 1, 1, 1, 1, 1, −1, 1 |
| 5 | −1, −1, −1, −1, 1, 1, 1, 1, −1, −1, −1, 1, 1, −1, −1, −1, 1, 1, 1, −1, 1, 1, 1, −1, −1, 1, 1, −1, 1, 1, 1, −1, −1, 1, −1, 1, −1, |
| | 1, 1, −1, 1, 1, 1, 1, 1, −1, 1, 1, −1, −1, −1, −1, 1, 1, 1, 1, −1, −1, −1, 1, 1, −1, −1, −1, 1, 1, 1, −1, 1, 1, 1, −1, −1, 1, 1, −1, |
| | 1, 1, 1, −1, −1, 1, −1, 1, −1, 1, 1, −1, 1, 1, 1, 1, 1, −1, 1, 1 |
| 6 | 1, −1, −1, −1, −1, 1, 1, 1, 1, −1, −1, −1, −1, −1, −1, 1, 1, 1, −1, 1, 1, 1, −1, 1, 1, 1, −1, 1, 1, 1, −1, −1, 1, −1, 1, −1, 1, 1, −1, |
| | 1, 1, 1, 1, 1, −1, 1, 1, −1, 1, −1, −1, −1, −1, 1, 1, 1, 1, −1, −1, −1, −1, −1, −1, 1, 1, 1, −1, 1, 1, 1, −1, 1, 1, 1, −1, |
| | 1, 1, 1, −1, −1, 1, −1, 1, −1, 1, 1, −1, 1, 1, 1, 1, 1, −1, 1, 1, −1 |
| 7 | −1, −1, 1, −1, −1, −1, −1, 1, 1, 1, 1, −1, −1, 1, 1, 1, −1, 1, 1, 1, −1, 1, −1, −1, −1, 1, 1, 1, −1, −1, 1, −1, 1, −1, 1, 1, −1, |
| | 1, 1, 1, 1, 1, −1, 1, 1, −1, 1, 1, −1, −1, 1, −1, −1, −1, −1, 1, 1, 1, 1, −1, −1, 1, 1, 1, −1, 1, 1, 1, −1, 1, −1, −1, −1, |
| | 1, 1, 1, −1, −1, 1, −1, 1, −1, 1, 1, −1, 1, 1, 1, 1, 1, −1, 1, 1, −1, 1, 1 |
| 8 | 1, −1, −1, −1, 1, −1, −1, −1, −1, 1, 1, 1, 1, 1, −1, 1, 1, 1, −1, 1, −1, −1, −1, 1, 1, 1, −1, −1, 1, −1, 1, −1, 1, 1, −1, |
| | 1, 1, 1, 1, 1, −1, 1, 1, −1, 1, 1, −1, 1, 1, −1, −1, −1, 1, −1, −1, −1, −1, 1, 1, 1, 1, 1, −1, 1, 1, 1, −1, 1, −1, −1, −1, |
| | 1, 1, 1, −1, −1, 1, −1, 1, −1, 1, 1, −1, 1, 1, 1, 1, 1, −1, 1, 1, −1, 1, 1, −1, 1 |
| 9 | 1, 1, −1, −1, −1, 1, −1, −1, −1, −1, 1, 1, 1, −1, 1, 1, 1, −1, 1, −1, −1, −1, 1, 1, 1, −1, −1, 1, −1, 1, −1, 1, 1, −1, |
| | 1, 1, 1, 1, 1, −1, 1, 1, −1, 1, 1, −1, 1, 1, 1, 1, −1, −1, −1, 1, −1, −1, −1, −1, 1, 1, 1, −1, 1, 1, 1, −1, 1, −1, −1, −1, |
| | 1, 1, 1, −1, −1, 1, −1, 1, −1, 1, 1, −1, 1, 1, 1, 1, 1, −1, 1, 1, −1, 1, 1, −1, 1, 1 |
| 10 | 1, −1, −1, −1, 1, −1, 1, 1, 1, −1, −1, −1, 1, 1, 1, −1, −1, −1, 1, −1, −1, −1, −1, 1, 1, 1, −1, 1, 1, −1, 1, 1, −1, 1, 1, 1, −1, −1, |
| | 1, −1, −1, 1, −1, 1, −1, 1, 1, −1, 1, −1, −1, −1, 1, −1, 1, 1, 1, −1, −1, −1, 1, 1, 1, −1, −1, −1, 1, −1, −1, −1, −1, 1, 1, 1, −1, |
| | 1, 1, −1, 1, 1, −1, 1, 1, 1, −1, −1, 1, −1, −1, 1, −1, 1, −1, 1, 1, −1 |
| 11 | −1, −1, −1, 1, −1, 1, 1, 1, −1, −1, −1, 1, 1, 1, 1, 1, −1, −1, −1, 1, −1, −1, −1, −1, 1, −1, 1, 1, −1, 1, 1, −1, 1, 1, 1, 1, −1, |
| | 1, −1, −1, 1, −1, 1, −1, 1, 1, −1, −1, −1, −1, −1, 1, −1, 1, 1, 1, −1, −1, −1, 1, 1, 1, 1, 1, −1, −1, −1, 1, −1, −1, −1, −1, |
| | 1, −1, 1, 1, −1, 1, 1, −1, 1, 1, 1, 1, −1, 1, −1, −1, 1, −1, 1, −1, 1, 1, −1, −1 |
| 12 | −1, 1, −1, 1, 1, 1, −1, −1, −1, 1, −1, −1, −1, −1, 1, 1, 1, 1, −1, −1, −1, 1, −1, −1, 1, 1, −1, 1, 1, −1, 1, 1, 1, 1, 1, −1, −1, −1, |
| | −1, 1, −1, 1, 1, −1, −1, −1, 1, −1, 1, −1, 1, 1, 1, −1, −1, −1, 1, −1, −1, −1, −1, 1, 1, 1, 1, −1, −1, −1, 1, −1, −1, 1, 1, −1, |
| | 1, 1, 1, −1, 1, 1, 1, 1, 1, −1, −1, −1, 1, −1, 1, −1, 1, 1, −1, −1, −1, 1 |
| 13 | 1, −1, 1, 1, 1, −1, −1, −1, 1, −1, −1, −1, −1, −1, −1, 1, 1, 1, 1, −1, −1, −1, 1, −1, 1, −1, 1, 1, −1, 1, 1, 1, 1, 1, −1, 1, −1, |
| | 1, −1, 1, −1, 1, 1, −1, −1, −1, 1, −1, 1, −1, 1, 1, 1, −1, −1, −1, 1, −1, −1, −1, −1, −1, −1, 1, 1, 1, 1, −1, −1, −1, 1, −1, |
| | 1, −1, 1, 1, −1, 1, 1, 1, 1, 1, −1, 1, −1, 1, −1, 1, −1, 1, 1, −1, −1, −1, 1, −1 |
| 14 | −1, 1, 1, 1, −1, −1, −1, 1, −1, −1, −1, 1, −1, −1, −1, −1, 1, 1, 1, 1, −1, −1, −1, 1, −1, 1, 1, −1, 1, 1, 1, 1, 1, −1, 1, 1, 1, −1, |
| | 1, −1, 1, 1, −1, −1, −1, 1, −1, −1, −1, 1, 1, 1, −1, −1, −1, 1, −1, −1, −1, −1, 1, −1, −1, −1, −1, 1, 1, 1, 1, −1, −1, −1, 1, −1, |
| | 1, 1, −1, 1, 1, 1, 1, 1, −1, 1, 1, 1, −1, 1, −1, 1, 1, −1, −1, −1, 1, −1, −1 |
| 15 | 1, 1, 1, −1, −1, −1, 1, −1, −1, −1, 1, −1, 1, −1, −1, −1, −1, 1, 1, 1, 1, −1, −1, −1, 1, 1, −1, 1, 1, 1, 1, 1, −1, 1, 1, −1, −1, |
| | 1, −1, 1, 1, −1, −1, −1, 1, −1, −1, 1, 1, 1, 1, −1, −1, −1, 1, −1, −1, −1, 1, −1, 1, −1, −1, −1, −1, 1, 1, 1, 1, −1, −1, −1, |
| | 1, 1, −1, 1, 1, 1, 1, 1, −1, 1, 1, −1, −1, 1, −1, 1, 1, −1, −1, −1, 1, −1, −1, 1 |
| 16 | −1, −1, −1, 1, −1, −1, −1, 1, −1, 1, 1, 1, −1, −1, −1, 1, −1, −1, −1, −1, 1, 1, 1, 1, 1, 1, 1, 1, 1, −1, 1, 1, −1, 1, 1, −1, 1, 1, −1, |
| | −1, −1, 1, −1, −1, 1, −1, 1, −1, −1, −1, −1, 1, −1, −1, −1, 1, −1, 1, 1, 1, −1, −1, −1, 1, −1, −1, −1, −1, |
| | 1, 1, 1, 1, 1, 1, 1, 1, 1, −1, 1, 1, −1, 1, 1, −1, 1, 1, −1, −1, −1, 1, −1, −1, 1, −1, 1, −1 |
| 17 | −1, −1, 1, −1, −1, −1, 1, −1, 1, 1, 1, −1, 1, −1, −1, −1, 1, −1, −1, −1, −1, 1, 1, 1, 1, 1, 1, 1, −1, 1, 1, −1, 1, 1, −1, 1, 1, −1, |
| | −1, −1, 1, −1, −1, 1, −1, 1, −1, 1, −1, −1, 1, −1, −1, −1, 1, −1, 1, 1, 1, −1, 1, −1, −1, −1, 1, −1, −1, −1, −1, |
| | 1, 1, 1, 1, 1, 1, 1, −1, 1, 1, −1, 1, 1, −1, 1, 1, −1, −1, −1, 1, −1, −1, 1, −1, 1, −1, 1 |
| 18 | 1, 1, −1, 1, −1, 1, −1, −1, 1, −1, −1, −1, −1, −1, 1, −1, −1, 1, −1, −1, 1, −1, −1, −1, 1, 1, 1, −1, −1, −1, 1, −1, −1, −1, −1, |
| | 1, 1, 1, −1, −1, −1, 1, −1, 1, 1, 1, −1, 1, 1, 1, −1, 1, −1, 1, −1, −1, 1, −1, −1, −1, −1, −1, 1, −1, −1, 1, −1, −1, 1, −1, −1, |
| | −1, 1, 1, 1, −1, −1, −1, 1, −1, −1, −1, −1, 1, 1, 1, −1, −1, −1, 1, −1, 1, 1, 1, −1, 1 |
| 19 | 1, −1, 1, −1, 1, −1, −1, 1, −1, −1, −1, 1, −1, 1, −1, −1, 1, −1, −1, 1, −1, −1, −1, −1, 1, 1, 1, 1, −1, −1, −1, 1, −1, −1, −1, −1, |
| | 1, −1, −1, −1, 1, −1, 1, 1, 1, −1, 1, 1, 1, −1, 1, −1, 1, −1, −1, 1, −1, −1, −1, 1, −1, 1, −1, −1, 1, −1, −1, 1, −1, −1, −1, −1, |
| | 1, 1, 1, 1, −1, −1, −1, 1, −1, −1, −1, −1, 1, −1, −1, −1, 1, −1, 1, 1, 1, −1, 1, 1 |
| 20 | −1, 1, −1, −1, 1, −1, −1, −1, 1, 1, −1, 1, −1, 1, −1, −1, 1, −1, −1, −1, −1, −1, 1, −1, −1, −1, −1, 1, 1, 1, 1, −1, −1, −1, 1, −1, |
| | −1, 1, −1, 1, 1, 1, −1, 1, 1, 1, −1, −1, −1, 1, −1, −1, 1, −1, −1, −1, 1, 1, −1, 1, −1, 1, −1, −1, 1, −1, −1, −1, −1, −1, 1, −1, |
| | −1, −1, −1, 1, 1, 1, 1, −1, −1, −1, 1, −1, −1, 1, −1, 1, 1, 1, −1, 1, 1, 1, −1, −1 |
| 21 | 1, −1, −1, 1, −1, −1, −1, 1, 1, −1, 1, −1, 1, −1, −1, 1, −1, −1, −1, −1, −1, 1, −1, −1, −1, −1, −1, −1, 1, 1, 1, 1, −1, −1, −1, |
| | 1, 1, −1, 1, 1, 1, −1, 1, 1, 1, −1, −1, −1, 1, −1, −1, 1, −1, −1, −1, 1, 1, −1, 1, −1, 1, −1, −1, 1, −1, −1, −1, −1, −1, 1, −1, |
| | −1, −1, −1, −1, −1, 1, 1, 1, 1, −1, −1, −1, 1, 1, −1, 1, 1, 1, −1, 1, 1, 1, −1, −1, −1 |
| 22 | −1, −1, 1, −1, −1, −1, 1, 1, −1, 1, −1, 1, −1, −1, 1, −1, −1, −1, −1, −1, 1, −1, −1, 1, 1, −1, −1, −1, −1, 1, 1, 1, 1, −1, −1, −1, |
| | −1, 1, 1, 1, −1, 1, 1, 1, −1, −1, −1, 1, −1, −1, 1, −1, −1, −1, 1, 1, −1, 1, −1, 1, −1, −1, 1, −1, −1, −1, −1, −1, 1, −1, −1, |
| | 1, 1, −1, −1, −1, −1, 1, 1, 1, 1, −1, −1, −1, −1, 1, 1, 1, −1, 1, 1, 1, −1, −1, −1, 1 |
| 23 | −1, 1, −1, −1, −1, 1, 1, −1, 1, −1, 1, −1, −1, 1, −1, −1, −1, −1, −1, 1, −1, −1, 1, −1, −1, 1, −1, −1, −1, −1, 1, 1, 1, 1, −1, −1, |
| | 1, 1, 1, −1, 1, 1, 1, −1, −1, −1, 1, −1, −1, 1, −1, −1, 1, 1, 1, −1, 1, −1, 1, −1, −1, 1, −1, −1, −1, −1, −1, 1, −1, −1, 1, −1, |
| | −1, 1, −1, −1, −1, −1, 1, 1, 1, 1, −1, −1, 1, 1, 1, −1, 1, 1, 1, −1, −1, −1, 1, −1 |
| 24 | 1, −1, −1, −1, 1, 1, −1, 1, −1, 1, −1, −1, 1, −1, −1, −1, −1, −1, 1, −1, −1, 1, −1, −1, −1, −1, 1, −1, −1, −1, −1, 1, 1, 1, 1, −1, |
| | 1, 1, −1, 1, 1, 1, −1, −1, −1, 1, −1, 1, 1, −1, −1, −1, 1, 1, −1, 1, −1, 1, −1, −1, 1, −1, −1, −1, −1, −1, 1, −1, −1, 1, −1, −1, |
| | −1, −1, 1, −1, −1, −1, −1, 1, 1, 1, 1, −1, 1, 1, −1, 1, 1, 1, −1, −1, −1, 1, −1, 1 |
| 25 | −1, 1, 1, −1, 1, −1, 1, −1, −1, 1, −1, −1, −1, −1, −1, 1, −1, −1, 1, −1, −1, 1, −1, −1, 1, 1, −1, −1, −1, 1, −1, −1, −1, −1, |
| | 1, 1, 1, 1, 1, −1, −1, −1, 1, −1, 1, 1, 1, −1, −1, 1, 1, −1, 1, −1, 1, −1, −1, 1, −1, −1, −1, −1, −1, 1, −1, −1, 1, −1, −1, 1, −1, |
| | −1, 1, 1, −1, −1, −1, 1, −1, −1, −1, −1, 1, 1, 1, 1, 1, −1, −1, −1, 1, −1, 1, 1, 1, −1 |
| 26 | −1, 1, −1, −1, 1, −1, −1, 1, −1, −1, −1, −1, 1, −1, 1, 1, −1, 1, −1, 1, −1, −1, 1, 1, −1, 1, 1, 1, −1, 1, −1, −1, −1, 1, −1, −1, |
| | 1, 1, 1, 1, −1, −1, −1, 1, −1, −1, −1, −1, −1, 1, −1, −1, 1, −1, −1, 1, −1, −1, −1, −1, 1, −1, 1, 1, −1, 1, −1, 1, −1, −1, |
| | 1, 1, −1, 1, 1, 1, −1, 1, −1, −1, −1, 1, −1, −1, 1, 1, 1, 1, −1, −1, −1, 1, −1, −1, −1, −1 |
| 27 | 1, −1, −1, 1, −1, −1, 1, −1, −1, −1, −1, −1, −1, 1, 1, −1, 1, −1, 1, −1, −1, 1, 1, 1, 1, 1, 1, −1, 1, −1, −1, −1, 1, −1, −1, −1, −1, |
| | 1, 1, 1, 1, −1, −1, −1, 1, −1, −1, −1, 1, −1, −1, 1, −1, −1, 1, −1, −1, −1, −1, −1, −1, 1, 1, −1, 1, −1, 1, −1, −1, |
| | 1, 1, 1, 1, 1, 1, −1, 1, −1, −1, −1, 1, −1, −1, −1, −1, 1, 1, 1, 1, −1, −1, −1, 1, −1, −1, −1 |
| 28 | −1, −1, 1, −1, −1, 1, −1, −1, −1, −1, −1, 1, 1, 1, −1, 1, −1, 1, −1, −1, 1, 1, 1, −1, 1, 1, −1, 1, −1, −1, −1, 1, −1, −1, −1, 1, −1, |
| | −1, 1, 1, 1, 1, −1, −1, −1, 1, −1, −1, −1, −1, 1, −1, −1, 1, −1, −1, −1, −1, −1, 1, 1, 1, −1, 1, −1, 1, −1, −1, 1, 1, 1, −1, |
| | 1, 1, −1, 1, −1, −1, −1, 1, −1, −1, −1, 1, −1, −1, 1, 1, 1, 1, −1, −1, −1, 1, −1, −1 |
| 29 | 1, −1, −1, 1, −1, −1, −1, −1, −1, 1, −1, −1, −1, 1, −1, −1, 1, 1, 1, −1, 1, 1, −1, 1, −1, −1, −1, 1, −1, −1, −1, 1, 1, 1, −1, |
| | −1, −1, −1, 1, 1, 1, 1, −1, −1, −1, 1, 1, −1, −1, 1, −1, −1, −1, −1, −1, 1, −1, −1, −1, 1, −1, 1, −1, −1, 1, 1, 1, −1, 1, 1, −1, |
| | 1, −1, −1, −1, 1, −1, −1, −1, 1, 1, 1, −1, −1, −1, −1, 1, 1, 1, 1, −1, −1, −1, 1 |
| 30 | −1, −1, 1, −1, −1, −1, −1, −1, 1, −1, −1, 1, 1, −1, 1, −1, −1, 1, 1, 1, −1, 1, 1, −1, 1, −1, −1, −1, 1, −1, −1, −1, 1, 1, 1, −1, |
| | 1, −1, −1, −1, −1, 1, 1, 1, 1, −1, −1, −1, −1, −1, 1, −1, −1, −1, −1, −1, 1, −1, −1, 1, 1, −1, 1, −1, −1, 1, 1, 1, −1, 1, 1, −1, |
| | 1, −1, −1, −1, 1, −1, −1, −1, 1, 1, 1, −1, 1, −1, −1, −1, −1, 1, 1, 1, 1, −1, −1, −1 |
| 31 | −1, 1, −1, −1, −1, −1, −1, 1, −1, −1, 1, −1, −1, 1, −1, −1, 1, 1, 1, −1, 1, 1, −1, 1, −1, −1, −1, 1, −1, −1, −1, 1, 1, 1, −1, 1, −1, |
| | 1, −1, −1, −1, −1, 1, 1, 1, 1, −1, −1, −1, 1, −1, −1, −1, −1, −1, 1, −1, −1, 1, −1, −1, 1, −1, 1, 1, 1, −1, 1, 1, −1, 1, −1, |
| | −1, −1, 1, −1, −1, −1, 1, 1, 1, −1, 1, −1, 1, −1, −1, −1, −1, 1, 1, 1, 1, −1, −1 |
| 32 | 1, −1, −1, −1, −1, −1, 1, −1, −1, 1, −1, −1, 1, −1, −1, 1, 1, 1, −1, 1, 1, −1, 1, −1, −1, −1, 1, −1, −1, −1, 1, 1, 1, −1, 1, −1, −1, |
| | −1, 1, −1, −1, −1, −1, 1, 1, 1, 1, −1, 1, −1, −1, −1, −1, −1, 1, −1, −1, 1, −1, −1, 1, −1, −1, 1, 1, 1, −1, 1, 1, −1, 1, −1, −1, |
| | −1, 1, −1, −1, −1, 1, 1, 1, −1, 1, −1, −1, −1, 1, −1, −1, −1, −1, 1, 1, 1, 1, −1 |
| 33 | 1, 1, 1, −1, −1, −1, 1, −1, −1, −1, −1, 1, −1, 1, 1, 1, −1, 1, −1, −1, −1, 1, 1, 1, −1, −1, 1, −1, 1, −1, 1, 1, −1, 1, 1, 1, 1, 1, −1, |
| | 1, 1, −1, 1, 1, −1, 1, 1, 1, −1, −1, −1, 1, 1, 1, −1, 1, 1, 1, 1, −1, 1, −1, −1, −1, 1, −1, 1, 1, 1, −1, −1, −1, 1, 1, −1, 1, −1, |
| | 1, −1, −1, 1, −1, −1, −1, −1, −1, 1, −1, −1, 1, −1, −1, 1, −1, −1, −1 |
| 34 | −1, 1, 1, 1, 1, −1, −1, −1, 1, −1, −1, −1, 1, 1, −1, 1, −1, −1, −1, 1, 1, 1, −1, 1, 1, −1, 1, −1, 1, 1, −1, 1, 1, 1, −1, −1, −1, |
| | 1, 1, −1, 1, 1, −1, 1, 1, 1, 1, 1, 1, −1, −1, −1, −1, 1, 1, 1, −1, 1, 1, 1, −1, −1, 1, −1, 1, 1, 1, −1, −1, −1, 1, −1, −1, 1, −1, |
| | 1, −1, −1, 1, −1, −1, −1, 1, 1, 1, −1, −1, 1, −1, −1, 1, −1, −1, −1, −1, −1 |
| 35 | −1, −1, 1, 1, 1, 1, −1, −1, −1, 1, −1, −1, 1, −1, 1, −1, −1, −1, 1, 1, 1, −1, 1, 1, −1, 1, −1, 1, 1, −1, 1, 1, 1, −1, −1, 1, 1, 1, −1, |
| | 1, 1, −1, 1, 1, 1, 1, 1, −1, 1, 1, −1, −1, −1, −1, 1, 1, 1, −1, 1, 1, −1, 1, −1, 1, 1, 1, −1, −1, −1, 1, −1, −1, 1, −1, 1, −1, −1, |
| | 1, −1, −1, −1, 1, 1, −1, −1, −1, 1, −1, −1, 1, −1, −1, −1, −1, −1, 1 |
| 36 | −1, −1, −1, 1, 1, 1, 1, −1, −1, −1, 1, −1, −1, 1, −1, −1, −1, 1, 1, 1, −1, 1, 1, 1, 1, −1, 1, 1, −1, 1, 1, 1, −1, −1, 1, −1, 1, −1, |
| | 1, 1, −1, 1, 1, 1, 1, 1, −1, 1, 1, 1, 1, −1, −1, −1, −1, 1, 1, 1, −1, 1, 1, −1, 1, 1, 1, −1, −1, −1, 1, −1, −1, −1, −1, 1, −1, −1, |
| | 1, −1, −1, −1, 1, 1, −1, 1, −1, 1, −1, −1, 1, −1, −1, −1, −1, −1, 1, −1 |
| 37 | −1, −1, −1, −1, 1, 1, 1, 1, −1, −1, −1, 1, 1, −1, −1, −1, 1, 1, 1, 1, −1, 1, 1, 1, −1, −1, 1, 1, −1, 1, 1, 1, −1, −1, 1, −1, 1, −1, |
| | 1, 1, −1, 1, 1, 1, 1, 1, −1, 1, 1, 1, 1, 1, 1, −1, −1, −1, −1, 1, 1, 1, 1, −1, −1, 1, 1, 1, −1, −1, −1, 1, −1, −1, −1, 1, 1, −1, −1, |
| | 1, −1, −1, −1, 1, 1, −1, 1, −1, 1, −1, −1, 1, −1, −1, −1, −1, −1, 1, −1, −1 |
| 38 | 1, −1, −1, −1, −1, 1, 1, 1, 1, −1, −1, −1, −1, −1, −1, 1, 1, 1, −1, 1, 1, 1, −1, 1, 1, 1, −1, 1, 1, 1, −1, −1, 1, −1, 1, −1, 1, 1, −1, |
| | 1, 1, 1, 1, 1, −1, 1, 1, −1, −1, 1, 1, 1, 1, −1, −1, −1, −1, 1, 1, 1, 1, 1, 1, −1, −1, −1, 1, −1, −1, −1, 1, −1, −1, −1, 1, −1, −1, |
| | −1, 1, 1, −1, 1, −1, 1, −1, −1, 1, −1, −1, −1, −1, −1, 1, −1, −1, 1 |
| 39 | −1, −1, 1, −1, −1, −1, −1, 1, 1, 1, 1, −1, −1, 1, 1, 1, −1, 1, 1, 1, −1, 1, −1, −1, −1, 1, 1, 1, −1, −1, 1, −1, −1, 1, −1, 1, 1, −1, |
| | 1, 1, 1, 1, 1, −1, 1, 1, −1, 1, 1, 1, 1, −1, 1, 1, 1, 1, −1, −1, −1, −1, 1, 1, −1, −1, −1, 1, −1, −1, −1, 1, −1, 1, 1, 1, −1, −1, |
| | −1, 1, 1, −1, 1, −1, 1, −1, −1, 1, −1, −1, −1, −1, −1, 1, −1, −1, 1, −1, −1 |
| 40 | 1, −1, −1, −1, 1, −1, −1, −1, −1, 1, 1, 1, 1, 1, −1, 1, 1, 1, −1, 1, −1, −1, −1, 1, 1, 1, −1, −1, 1, −1, 1, −1, 1, 1, −1, |
| | 1, 1, 1, 1, 1, −1, 1, 1, −1, 1, 1, −1, 1, −1, 1, 1, 1, −1, 1, 1, 1, 1, −1, −1, −1, −1, −1, 1, −1, −1, −1, 1, −1, 1, 1, 1, −1, −1, |
| | −1, 1, 1, −1, 1, −1, 1, −1, −1, 1, −1, −1, −1, −1, −1, 1, −1, −1, 1, −1, −1, 1, −1 |
| 41 | 1, 1, −1, −1, −1, 1, −1, −1, −1, −1, 1, 1, 1, −1, 1, 1, 1, −1, 1, −1, −1, −1, 1, 1, 1, −1, −1, 1, −1, 1, −1, 1, 1, −1, |
| | 1, 1, 1, 1, 1, −1, 1, 1, −1, 1, 1, −1, 1, 1, −1, −1, 1, 1, 1, −1, 1, 1, 1, 1, −1, −1, −1, 1, −1, −1, −1, 1, −1, 1, 1, 1, −1, −1, −1, |
| | 1, 1, −1, 1, −1, 1, −1, −1, 1, −1, −1, −1, −1, −1, 1, −1, −1, 1, −1, −1, 1, −1, −1 |
| 42 | 1, −1, −1, −1, 1, −1, 1, 1, 1, −1, −1, −1, 1, 1, 1, −1, −1, −1, 1, −1, −1, −1, −1, 1, 1, 1, −1, 1, 1, −1, 1, 1, −1, 1, 1, 1, −1, −1, |
| | 1, −1, −1, 1, −1, 1, −1, 1, 1, −1, −1, 1, 1, 1, −1, 1, −1, −1, −1, 1, 1, 1, −1, −1, −1, 1, 1, 1, −1, 1, 1, 1, 1, −1, −1, −1, 1, −1, |
| | −1, 1, −1, −1, 1, −1, −1, −1, 1, 1, −1, 1, 1, −1, 1, −1, 1, −1, −1, 1 |
| 43 | −1, −1, −1, 1, −1, 1, 1, 1, −1, −1, −1, 1, 1, 1, 1, 1, −1, −1, −1, 1, −1, −1, −1, −1, 1, −1, 1, 1, −1, 1, 1, −1, 1, 1, 1, 1, −1, |
| | 1, −1, −1, 1, −1, 1, −1, 1, 1, −1, −1, 1, 1, 1, −1, 1, −1, −1, −1, 1, 1, 1, −1, −1, −1, −1, −1, 1, 1, 1, −1, 1, 1, 1, 1, −1, 1, −1, |
| | 1, −1, 1, −1, −1, 1, −1, −1, −1, −1, 1, −1, 1, 1, −1, 1, −1, 1, −1, −1, 1, 1 |
| 44 | −1, 1, −1, 1, 1, 1, −1, −1, −1, 1, −1, −1, −1, −1, 1, 1, 1, 1, −1, −1, −1, 1, −1, −1, 1, 1, −1, 1, 1, −1, 1, 1, 1, 1, 1, −1, −1, −1, |
| | 1, −1, 1, −1, 1, 1, −1, −1, −1, 1, 1, −1, 1, −1, −1, −1, 1, 1, 1, −1, 1, 1, 1, 1, −1, −1, −1, −1, 1, 1, 1, −1, 1, 1, −1, −1, 1, −1, |
| | −1, 1, −1, −1, −1, −1, −1, 1, 1, 1, −1, 1, −1, 1, −1, −1, 1, 1, 1, −1 |
| 45 | 1, −1, 1, 1, 1, −1, −1, −1, 1, −1, −1, −1, −1, −1, −1, 1, 1, 1, 1, −1, −1, −1, 1, −1, 1, −1, 1, 1, −1, 1, 1, 1, 1, 1, −1, 1, −1, |
| | 1, −1, 1, −1, 1, 1, −1, −1, −1, 1, −1, −1, 1, −1, −1, −1, 1, 1, 1, −1, 1, 1, 1, 1, 1, 1, −1, −1, −1, −1, 1, 1, 1, −1, 1, −1, 1, −1, |
| | −1, 1, −1, −1, −1, −1, −1, 1, −1, 1, −1, 1, −1, 1, −1, −1, 1, 1, 1, −1, 1 |
| 46 | −1, 1, 1, 1, −1, −1, −1, 1, −1, −1, −1, 1, −1, −1, −1, −1, 1, 1, 1, 1, −1, −1, −1, 1, −1, 1, 1, −1, 1, 1, 1, 1, 1, −1, 1, 1, 1, −1, |
| | 1, −1, 1, 1, −1, −1, −1, 1, −1, −1, 1, −1, −1, −1, 1, 1, 1, −1, 1, 1, 1, −1, 1, 1, 1, 1, −1, −1, −1, −1, 1, 1, 1, −1, 1, −1, −1, |
| | 1, −1, −1, −1, −1, −1, 1, −1, −1, −1, 1, −1, 1, −1, −1, 1, 1, 1, −1, 1, 1 |
| 47 | 1, 1, 1, −1, −1, −1, 1, −1, −1, −1, 1, −1, 1, −1, −1, −1, −1, 1, 1, 1, 1, −1, −1, −1, 1, 1, −1, 1, 1, 1, 1, 1, −1, 1, 1, −1, −1, |
| | 1, −1, 1, 1, −1, −1, −1, 1, −1, −1, 1, −1, −1, −1, 1, 1, 1, −1, 1, 1, 1, −1, 1, −1, 1, 1, 1, 1, −1, −1, −1, −1, 1, 1, 1, −1, −1, |
| | 1, −1, −1, −1, −1, −1, 1, −1, −1, 1, 1, −1, 1, −1, −1, 1, 1, 1, −1, 1, 1, −1 |
| 48 | −1, −1, −1, 1, −1, −1, −1, 1, −1, 1, 1, 1, −1, −1, −1, 1, −1, −1, −1, −1, 1, 1, 1, 1, 1, 1, 1, 1, 1, −1, 1, 1, −1, 1, 1, −1, 1, 1, −1, |
| | −1, −1, 1, −1, −1, 1, −1, 1, −1, 1, 1, 1, −1, 1, 1, 1, −1, 1, −1, −1, −1, 1, 1, 1, −1, 1, 1, 1, 1, −1, −1, −1, −1, −1, −1, −1, −1, |
| | −1, 1, −1, −1, 1, −1, −1, 1, −1, −1, 1, 1, 1, −1, 1, 1, −1, 1, −1, 1 |
| 49 | −1, −1, 1, −1, −1, −1, 1, −1, 1, 1, 1, −1, 1, −1, −1, −1, 1, −1, −1, −1, −1, 1, 1, 1, 1, 1, 1, 1, −1, 1, 1, −1, 1, 1, −1, 1, 1, −1, |
| | −1, −1, 1, −1, −1, 1, −1, 1, −1, 1, 1, 1, −1, 1, 1, 1, −1, 1, −1, −1, −1, 1, −1, 1, 1, 1, −1, 1, 1, 1, 1, −1, −1, −1, −1, −1, −1, |
| | −1, 1, −1, −1, 1, −1, −1, 1, −1, −1, 1, 1, 1, −1, 1, 1, −1, 1, −1, 1, −1 |
| 50 | 1, 1, −1, 1, −1, 1, −1, −1, 1, −1, −1, −1, −1, −1, 1, −1, −1, 1, −1, −1, 1, −1, −1, −1, 1, 1, 1, −1, −1, −1, 1, −1, −1, −1, −1, |
| | 1, 1, 1, −1, −1, −1, 1, −1, 1, 1, 1, −1, 1, −1, −1, 1, −1, 1, −1, 1, 1, −1, 1, 1, 1, 1, 1, −1, 1, 1, −1, 1, 1, −1, 1, 1, 1, −1, −1, |
| | −1, 1, 1, 1, −1, 1, 1, 1, 1, −1, −1, −1, 1, 1, 1, −1, 1, −1, −1, −1, 1, −1 |
| 51 | 1, −1, 1, −1, 1, −1, −1, 1, −1, −1, −1, 1, −1, 1, −1, −1, 1, −1, −1, 1, −1, −1, −1, −1, 1, 1, 1, 1, −1, −1, −1, 1, −1, −1, −1, −1, |
| | 1, −1, −1, −1, 1, −1, 1, 1, 1, −1, 1, 1, −1, 1, −1, 1, −1, 1, 1, −1, 1, 1, 1, −1, 1, −1, 1, 1, −1, 1, 1, −1, 1, 1, 1, 1, −1, −1, −1, |
| | −1, 1, 1, 1, −1, 1, 1, 1, 1, −1, 1, 1, 1, −1, 1, −1, −1, −1, 1, −1, −1 |
| 52 | −1, 1, −1, −1, 1, −1, −1, −1, 1, 1, −1, 1, −1, 1, −1, −1, 1, −1, −1, −1, −1, −1, 1, −1, −1, −1, −1, 1, 1, 1, 1, −1, −1, −1, 1, −1, |
| | −1, 1, −1, 1, 1, 1, −1, 1, 1, 1, −1, −1, 1, −1, 1, 1, −1, 1, 1, 1, −1, −1, 1, −1, 1, −1, 1, 1, −1, 1, 1, 1, 1, 1, −1, 1, 1, 1, 1, −1, |
| | −1, −1, −1, 1, 1, 1, −1, 1, 1, −1, 1, −1, −1, −1, 1, −1, −1, −1, 1, 1 |
| 53 | 1, −1, −1, 1, −1, −1, −1, 1, 1, −1, 1, −1, 1, −1, −1, 1, −1, −1, −1, −1, −1, 1, −1, −1, −1, −1, −1, −1, 1, 1, 1, 1, −1, −1, −1, |
| | 1, 1, −1, 1, 1, 1, −1, 1, 1, 1, −1, −1, −1, −1, 1, 1, −1, 1, 1, 1, −1, −1, 1, −1, 1, −1, 1, 1, −1, 1, 1, 1, 1, 1, −1, |
| | 1, 1, 1, 1, 1, 1, −1, −1, −1, −1, 1, 1, 1, −1, −1, 1, −1, −1, −1, 1, −1, −1, −1, 1, 1, 1 |
| 54 | −1, −1, 1, −1, −1, −1, 1, 1, −1, 1, −1, 1, −1, −1, 1, −1, −1, −1, −1, −1, 1, −1, −1, 1, 1, −1, −1, −1, −1, 1, 1, 1, 1, −1, −1, −1, |
| | −1, 1, 1, 1, −1, 1, 1, 1, −1, −1, −1, 1, 1, 1, −1, 1, 1, 1, −1, −1, 1, −1, 1, −1, 1, 1, −1, 1, 1, 1, 1, 1, −1, 1, 1, −1, −1, |
| | 1, 1, 1, 1, −1, −1, −1, −1, 1, 1, 1, 1, −1, −1, −1, 1, −1, −1, −1, 1, 1, 1, −1 |
| 55 | −1, 1, −1, −1, −1, 1, 1, −1, 1, −1, 1, −1, −1, 1, −1, −1, −1, −1, −1, 1, −1, −1, 1, −1, −1, 1, −1, −1, −1, −1, 1, 1, 1, 1, −1, −1, |
| | 1, 1, 1, −1, 1, 1, 1, −1, −1, −1, 1, −1, 1, −1, 1, 1, 1, −1, −1, 1, −1, 1, −1, 1, 1, −1, 1, 1, 1, 1, 1, −1, 1, 1, −1, 1, 1, −1, |
| | 1, 1, 1, 1, −1, −1, −1, −1, 1, 1, −1, −1, −1, 1, −1, −1, −1, 1, 1, 1, −1, 1 |
| 56 | 1, −1, −1, −1, 1, 1, −1, 1, −1, 1, −1, −1, 1, −1, −1, −1, −1, −1, 1, −1, −1, 1, −1, −1, −1, −1, 1, −1, −1, −1, −1, 1, 1, 1, 1, −1, |
| | 1, 1, −1, 1, 1, 1, −1, −1, −1, 1, −1, 1, −1, 1, 1, 1, −1, −1, 1, −1, 1, −1, 1, 1, −1, 1, 1, 1, 1, 1, −1, 1, 1, −1, 1, 1, 1, 1, −1, |
| | 1, 1, 1, 1, −1, −1, −1, −1, 1, −1, −1, 1, −1, −1, −1, 1, 1, 1, −1, 1, −1 |
| 57 | −1, 1, 1, −1, 1, −1, 1, −1, −1, 1, −1, −1, −1, −1, −1, 1, −1, −1, 1, −1, −1, 1, −1, −1, 1, 1, −1, −1, −1, 1, −1, −1, −1, −1, |
| | 1, 1, 1, 1, 1, −1, −1, −1, 1, −1, 1, 1, 1, −1, 1, −1, −1, 1, −1, 1, −1, 1, 1, −1, 1, 1, 1, 1, 1, −1, 1, 1, −1, 1, 1, −1, 1, 1, −1, |
| | −1, 1, 1, 1, −1, 1, 1, 1, 1, −1, −1, −1, −1, −1, 1, 1, 1, −1, 1, −1, −1, −1, 1 |
| 58 | −1, 1, −1, −1, 1, −1, −1, 1, −1, −1, −1, −1, 1, −1, 1, 1, −1, 1, −1, 1, −1, −1, 1, 1, −1, 1, 1, 1, −1, 1, −1, −1, −1, 1, −1, −1, |
| | 1, 1, 1, 1, −1, −1, −1, 1, −1, −1, −1, −1, 1, −1, 1, 1, −1, 1, 1, −1, 1, 1, 1, 1, −1, 1, −1, −1, 1, −1, 1, −1, 1, 1, −1, −1, 1, −1, |
| | −1, −1, 1, −1, 1, 1, 1, −1, 1, 1, −1, −1, −1, −1, 1, 1, 1, −1, 1, 1, 1, 1 |
| 59 | 1, −1, −1, 1, −1, −1, 1, −1, −1, −1, −1, −1, −1, 1, 1, −1, 1, −1, 1, −1, −1, 1, 1, 1, 1, 1, 1, −1, 1, −1, −1, −1, 1, −1, −1, −1, −1, |
| | 1, 1, 1, 1, −1, −1, −1, 1, −1, −1, −1, −1, 1, 1, −1, 1, 1, −1, 1, 1, 1, 1, 1, 1, −1, −1, 1, −1, 1, −1, 1, 1, −1, −1, −1, −1, −1, |
| | −1, 1, −1, 1, 1, 1, −1, 1, 1, 1, 1, −1, −1, −1, −1, 1, 1, 1, −1, 1, 1, 1 |
| 60 | −1, −1, 1, −1, −1, 1, −1, −1, −1, −1, −1, 1, 1, 1, −1, 1, −1, 1, −1, −1, 1, 1, 1, −1, 1, 1, −1, 1, −1, −1, −1, 1, −1, −1, −1, 1, −1, |
| | −1, 1, 1, 1, 1, −1, −1, −1, 1, −1, −1, 1, 1, −1, 1, 1, −1, 1, 1, 1, 1, 1, −1, −1, −1, 1, −1, 1, −1, 1, 1, −1, −1, −1, 1, −1, −1, |
| | 1, −1, 1, 1, 1, −1, 1, 1, 1, −1, 1, 1, −1, −1, −1, −1, 1, 1, 1, −1, 1, 1 |
| 61 | 1, −1, −1, 1, −1, −1, −1, −1, −1, 1, −1, −1, −1, 1, −1, 1, −1, −1, 1, 1, 1, −1, 1, 1, −1, 1, −1, −1, −1, 1, −1, −1, −1, 1, 1, 1, −1, |
| | −1, −1, −1, 1, 1, 1, 1, −1, −1, −1, 1, −1, 1, 1, −1, 1, 1, 1, 1, 1, −1, 1, 1, 1, −1, 1, −1, 1, 1, −1, −1, −1, 1, −1, −1, 1, −1, |
| | 1, 1, 1, −1, 1, 1, 1, −1, −1, −1, 1, 1, 1, 1, −1, −1, −1, −1, 1, 1, 1, −1 |
| 62 | −1, −1, 1, −1, −1, −1, −1, −1, 1, −1, −1, 1, 1, −1, 1, −1, −1, 1, 1, 1, −1, 1, 1, −1, 1, −1, −1, −1, 1, −1, −1, −1, 1, 1, 1, −1, |
| | 1, −1, −1, −1, −1, 1, 1, 1, 1, −1, −1, −1, 1, 1, −1, 1, 1, 1, 1, 1, −1, 1, 1, −1, −1, 1, −1, 1, 1, −1, −1, −1, 1, −1, −1, 1, −1, |
| | 1, 1, 1, −1, 1, 1, 1, −1, −1, −1, 1, −1, 1, 1, 1, 1, −1, −1, −1, −1, 1, 1, 1 |
| 63 | −1, 1, −1, −1, −1, −1, −1, 1, −1, −1, 1, −1, −1, 1, −1, −1, 1, 1, 1, −1, 1, 1, −1, 1, −1, −1, −1, 1, −1, −1, −1, 1, 1, 1, −1, 1, −1, |
| | 1, −1, −1, −1, −1, 1, 1, 1, 1, −1, −1, 1, −1, 1, 1, 1, 1, 1, −1, 1, 1, −1, 1, 1, −1, 1, 1, −1, −1, −1, 1, −1, −1, 1, −1, |
| | 1, 1, 1, −1, 1, 1, 1, −1, −1, −1, 1, −1, 1, −1, 1, 1, 1, 1, −1, −1, −1, −1, 1, 1 |
| 64 | 1, −1, −1, −1, −1, −1, 1, −1, −1, 1, −1, −1, 1, −1, −1, 1, 1, 1, −1, 1, 1, −1, 1, −1, −1, −1, 1, −1, −1, −1, 1, 1, 1, −1, 1, −1, −1, |
| | −1, 1, −1, −1, −1, −1, 1, 1, 1, 1, −1, −1, 1, 1, 1, 1, 1, −1, 1, 1, −1, 1, 1, −1, 1, 1, −1, −1, −1, 1, −1, −1, 1, −1, 1, 1, 1, −1, |
| | 1, 1, 1, −1, −1, −1, 1, −1, 1, 1, 1, −1, 1, 1, 1, 1, −1, −1, −1, −1, 1 |

In implementations in which 64 length-112 ELR sequences are used, a device may use a length-112 ELR sequence in scenarios without dedicated pilots and with extra tones such that 56 tones in each ELR symbol are used to carry the ELR sequence. The device may select the 64 length-112 ELR sequences from orthogonal row or column vectors in a Hadamard matrix with an order of (112×112), which may be denoted as an H112 matrix. Additionally, or alternatively, the 64 length-112 ELR sequences may be orthogonal row vectors of a Hadamard matrix with an order of (64×112), which may be generated in accordance with a Hadamard expansion of a subset of a Hadamard matrix with an order of (56×56), which may be denoted as an H56 matrix.

The device may generate the H56 matrix based on a Golay 4 pair and a Golay 10 pair (or their equivalent pairs) through a Goethals-Seidel array. An example Golay 4 pair of A4 and B4 and an example Golay 10 pair of A10 and B10 are defined in accordance with Equations 26 and 27, respectively, shown below.

$$Golay 4 pair : A 4 = [ 1 , 1 , 1 , - 1 ] ; B 4 = [ 1 , 1 , - 1 , 1 ] . \qquad ( 26 )$$

$$Golay 10 pair : A 10 = [ \begin{matrix}1 & 1 & - 1 & 1 & - 1 & 1 & - 1 & - 1 & 1 & 1\end{matrix} ] ; \qquad ( 27 )$$

$$B 10 = [ \begin{matrix}1 & 1 & - 1 & 1 & 1 & 1 & 1 & 1 & - 1 & - 1\end{matrix} ] .$$

The device may select a Golay 4 pair and a Golay 10 pair, from a set of multiple options for each (each Golay pair being associated with many equivalent pairs generated by various operations), in accordance with a target PAPR (such as a low PAPR). Four complementary sequences of length-14 can be formed by A14=[A4,A10]; B14=[A4, −A10]; C14=[B4,B10]; D14=[B4, −B10]. The order between A4/B4 and A10/B10 may be swapped. The device may construct the H56 matrix in accordance with a Goethals-Seidel array, as defined by Equation 28, shown below, with A, B, C, and D being circulant matrices built from A14, B14, C14, and D14, respectively. R may be an example of a back-diagonal identity matrix of order 14.

$$H 48 = [ \begin{matrix}A & BR & CR & DR \\ - BR & A & {D}^{′} R & - {C}^{′} R \\ - CR & - {D}^{′} R & A & {B}^{′} R \\ - DR & {C}^{′} R & - {B}^{′} R & A\end{matrix} ] \qquad ( 28 )$$

The device may select 32 row or column vectors from the H56 matrix that correspond to sequences that provide the 32 lowest PAPR values of the 56 total row or column vectors of the H56 matrix. The device may save the selected 32 row or column vectors to form a subblock of the H56 matrix. Such a subblock of the H56 matrix may be associated with an order of (32×56) and may be denoted as an H56, matrix. The H56, matrix may be defined in accordance with Equation 29 or 30 (in accordance with whether row or column vectors are selected from the H56 matrix), shown below.

$$H {56}_{s} = [ selected rows ] \qquad ( 29 )$$

$$H {56}_{s} = {[ selected columns ]}^{T} \qquad ( 30 )$$

The device may form a new matrix with orthogonal rows as H (64×112) using the H56, matrix. In some implementations, the new H (64×112) matrix may be associated with a Hadamard expansion of the H56, matrix. For example, the H (64×112) matrix may be defined in accordance with Equation 31, shown below. The device may map each row of the H (64×112) matrix to a respective BSS color value.

$$H ( 64 \times 112 ) = [ \begin{matrix}H {56}_{s} & H {56}_{s} \\ H {56}_{s} & - H {56}_{s}\end{matrix} ] \qquad ( 31 )$$

An example of 64 length-112 ELR sequences is illustrated in table format below. In Table 7, shown below, each value of “1” or “−1” corresponds to a value applied to a given (corresponding) tone. Table 7 illustrates example sequence sets in implementations in which ELR-mark symbols are transmitted without dedicated pilots and in which extra tones 710 are used in ELR-mark transmissions. For each sequence illustrated in Table 7, the first or initial 56 elements or values may be applied to 56 used tones 704 in the ELR symbol 518-a and the second or final 56 elements or values may be applied to 56 used tones 704 in the ELR symbol 518-b.

TABLE 7
ELR-mark Sequences of Length-112 Using Extra Tones in ELR-Mark Transmission and without Dedicated Pilots

| Index | ELR Sequence |
|---|---|
| 1 | −1, −1, −1, 1, −1, −1, 1, −1, −1, −1, −1, −1, 1, 1, −1, −1, 1, 1, 1, 1, 1, −1, 1, 1, 1, −1, −1, −1, 1, 1, −1, −1, 1, −1, 1, −1, |
| | 1, 1, −1, −1, 1, −1, −1, −1, 1, 1, −1, 1, −1, 1, −1, −1, −1, −1, 1, −1, −1, −1, −1, 1, −1, −1, 1, −1, −1, −1, −1, −1, 1, 1, −1, −1, |
| | 1, 1, 1, 1, 1, −1, 1, 1, 1, −1, −1, −1, 1, 1, −1, −1, 1, −1, 1, −1, 1, 1, −1, −1, 1, −1, −1, −1, 1, 1, −1, 1, −1, 1, −1, −1, |
| | 1, −1, 1, −1 |
| 2 | −1, −1, −1, −1, 1, 1, −1, −1, −1, 1, −1, −1, 1, −1, 1, −1, 1, 1, 1, −1, −1, −1, −1, −1, 1, 1, 1, 1, 1, −1, 1, 1, −1, −1, 1, −1, |
| | 1, 1, −1, −1, 1, −1, −1, 1, −1, −1, −1, −1, 1, −1, −1, −1, 1, 1, −1, 1, −1, −1, −1, −1, 1, 1, −1, −1, −1, 1, −1, −1, 1, −1, 1, −1, |
| | 1, 1, 1, −1, −1, −1, −1, −1, 1, 1, 1, 1, 1, −1, 1, 1, −1, −1, 1, −1, 1, 1, −1, −1, 1, −1, −1, 1, −1, −1, −1, −1, 1, −1, −1, −1, |
| | 1, 1, −1, 1 |
| 3 | 1, −1, −1, −1, −1, −1, 1, 1, −1, −1, −1, 1, −1, −1, 1, 1, 1, −1, −1, −1, −1, −1, 1, 1, 1, 1, 1, −1, 1, 1, −1, −1, 1, −1, 1, |
| | 1, −1, −1, 1, −1, 1, −1, −1, −1, −1, −1, 1, −1, −1, −1, 1, 1, −1, 1, −1, 1, 1, −1, −1, −1, −1, −1, 1, 1, −1, −1, −1, 1, −1, −1, |
| | 1, 1, 1, −1, −1, −1, −1, −1, 1, 1, 1, 1, 1, −1, 1, 1, −1, −1, 1, −1, 1, 1, −1, −1, 1, −1, 1, −1, −1, −1, −1, −1, 1, −1, −1, −1, |
| | 1, 1, −1, 1, −1, 1 |
| 4 | −1, −1, 1, −1, −1, −1, −1, −1, 1, 1, −1, −1, −1, 1, 1, −1, −1, −1, −1, −1, 1, 1, 1, 1, 1, −1, 1, 1, −1, −1, 1, −1, 1, 1, −1, −1, |
| | 1, −1, 1, −1, 1, 1, −1, −1, 1, −1, −1, −1, 1, 1, −1, 1, −1, 1, −1, −1, −1, −1, 1, −1, −1, −1, −1, −1, 1, 1, −1, −1, −1, 1, |
| | 1, −1, −1, −1, −1, −1, 1, 1, 1, 1, 1, −1, 1, 1, −1, −1, 1, −1, 1, 1, −1, −1, 1, −1, 1, −1, 1, 1, −1, −1, 1, −1, −1, −1, 1, 1, −1, |
| | 1, −1, 1, −1, −1 |
| 5 | 1, −1, −1, 1, −1, −1, −1, −1, −1, 1, 1, −1, −1, −1, −1, −1, −1, −1, −1, 1, 1, 1, 1, 1, −1, 1, 1, 1, −1, 1, −1, 1, 1, −1, −1, 1, −1, |
| | 1, −1, 1, 1, −1, −1, 1, −1, −1, −1, 1, 1, −1, 1, −1, 1, −1, −1, −1, 1, −1, −1, 1, −1, −1, −1, −1, −1, 1, 1, −1, −1, −1, −1, −1, |
| | −1, −1, −1, 1, 1, 1, 1, 1, −1, 1, 1, 1, −1, 1, −1, 1, 1, −1, −1, 1, −1, 1, −1, 1, 1, −1, −1, 1, −1, −1, −1, 1, 1, −1, 1, −1, 1, −1, |
| | −1, −1 |
| 6 | −1, 1, −1, −1, 1, −1, −1, −1, −1, −1, 1, 1, −1, −1, −1, −1, −1, −1, 1, 1, 1, 1, 1, −1, 1, 1, 1, −1, 1, −1, 1, 1, −1, −1, 1, −1, |
| | 1, −1, 1, 1, −1, −1, 1, −1, −1, −1, 1, 1, −1, 1, −1, 1, −1, −1, −1, −1, −1, 1, −1, −1, 1, −1, −1, −1, −1, −1, 1, 1, −1, −1, −1, |
| | −1, −1, −1, 1, 1, 1, 1, 1, −1, 1, 1, 1, −1, 1, −1, 1, 1, −1, −1, 1, −1, 1, −1, 1, 1, −1, −1, 1, −1, −1, −1, 1, 1, −1, 1, −1, 1, −1, |
| | −1, −1, −1 |
| 7 | −1, −1, 1, −1, −1, 1, −1, −1, −1, −1, 1, 1, −1, −1, −1, −1, 1, 1, 1, 1, 1, −1, 1, 1, 1, −1, −1, −1, 1, 1, −1, −1, 1, −1, 1, −1, |
| | 1, 1, −1, −1, 1, −1, −1, −1, 1, 1, −1, 1, −1, 1, −1, −1, −1, −1, 1, −1, −1, 1, −1, −1, 1, −1, −1, −1, −1, −1, 1, 1, −1, −1, −1, |
| | −1, 1, 1, 1, 1, 1, −1, 1, 1, 1, −1, −1, −1, 1, 1, −1, −1, 1, −1, 1, −1, 1, 1, −1, −1, 1, −1, −1, 1, 1, −1, 1, −1, 1, −1, −1, |
| | −1, −1, 1 |
| 8 | 1, 1, −1, −1, −1, −1, −1, 1, −1, −1, −1, 1, 1, 1, −1, −1, −1, 1, −1, −1, 1, −1, −1, −1, −1, −1, 1, 1, 1, −1, −1, −1, −1, 1, −1, |
| | 1, −1, 1, 1, −1, −1, −1, −1, 1, 1, −1, −1, 1, −1, 1, −1, 1, 1, 1, −1, −1, 1, 1, 1, −1, −1, −1, −1, −1, 1, −1, −1, −1, 1, 1, 1, −1, |
| | −1, −1, 1, −1, −1, 1, −1, −1, −1, −1, −1, 1, 1, 1, −1, −1, −1, −1, 1, −1, 1, −1, 1, 1, −1, −1, −1, −1, 1, 1, −1, −1, 1, −1, 1, −1, |
| | 1, 1, −1, −1, 1 |
| 9 | −1, −1, −1, −1, 1, −1, −1, −1, 1, 1, 1, 1, 1, −1, −1, 1, 1, −1, −1, −1, 1, −1, −1, 1, −1, −1, −1, −1, −1, −1, 1, −1, 1, −1, 1, 1, −1, |
| | −1, −1, 1, −1, −1, −1, −1, 1, −1, 1, −1, 1, 1, −1, −1, 1, −1, 1, 1, −1, −1, −1, −1, 1, −1, −1, −1, 1, 1, 1, 1, 1, −1, −1, |
| | 1, 1, −1, −1, −1, 1, −1, −1, 1, −1, −1, −1, −1, −1, −1, 1, −1, 1, −1, 1, 1, −1, −1, −1, 1, −1, −1, −1, −1, 1, −1, 1, −1, 1, 1, −1, |
| | −1, 1, −1, 1, 1 |
| 10 | −1, −1, 1, −1, −1, −1, 1, 1, 1, 1, 1, −1, −1, −1, −1, −1, −1, 1, 1, −1, −1, −1, 1, −1, −1, 1, −1, −1, 1, −1, 1, −1, 1, 1, −1, −1, −1, |
| | 1, −1, −1, −1, −1, 1, −1, 1, −1, 1, 1, −1, −1, 1, −1, 1, 1, −1, −1, −1, −1, 1, −1, −1, −1, 1, 1, 1, 1, 1, −1, −1, −1, −1, −1, −1, |
| | 1, 1, −1, −1, −1, 1, −1, −1, 1, −1, −1, 1, −1, 1, −1, 1, 1, −1, −1, −1, 1, −1, −1, −1, −1, 1, −1, 1, −1, 1, 1, −1, −1, 1, −1, |
| | 1, 1, −1, −1 |
| 11 | 1, −1, −1, −1, 1, 1, 1, 1, 1, −1, −1, −1, −1, −1, −1, −1, −1, −1, −1, 1, 1, −1, −1, −1, 1, −1, −1, 1, 1, −1, 1, 1, −1, −1, −1, 1, −1, |
| | −1, −1, −1, 1, −1, 1, −1, 1, 1, −1, −1, 1, −1, 1, 1, −1, −1, 1, −1, 1, −1, −1, −1, 1, 1, 1, 1, 1, −1, −1, −1, −1, −1, −1, −1, −1, |
| | −1, −1, 1, 1, −1, −1, −1, 1, −1, −1, 1, 1, −1, 1, 1, −1, −1, −1, 1, −1, −1, −1, −1, 1, −1, 1, −1, 1, 1, −1, −1, 1, −1, 1, 1, −1, |
| | −1, 1, −1 |
| 12 | −1, −1, 1, 1, 1, 1, 1, −1, −1, −1, −1, −1, 1, −1, −1, 1, −1, −1, −1, −1, −1, 1, 1, −1, −1, −1, 1, −1, 1, 1, −1, −1, −1, 1, −1, −1, |
| | −1, −1, 1, −1, 1, −1, 1, 1, −1, −1, 1, −1, 1, 1, −1, −1, 1, −1, 1, −1, −1, −1, 1, 1, 1, 1, 1, −1, −1, −1, −1, −1, 1, −1, −1, |
| | 1, −1, −1, −1, −1, −1, 1, 1, −1, −1, −1, 1, −1, 1, 1, −1, −1, −1, 1, −1, −1, −1, −1, 1, −1, 1, −1, 1, 1, −1, −1, 1, −1, 1, 1, −1, |
| | −1, 1, −1, 1, −1 |
| 13 | −1, 1, 1, 1, 1, 1, −1, −1, −1, −1, −1, 1, −1, −1, −1, −1, 1, −1, −1, −1, −1, −1, 1, 1, −1, −1, −1, 1, 1, −1, −1, −1, 1, −1, −1, −1, |
| | −1, 1, −1, 1, −1, 1, 1, −1, −1, 1, −1, 1, 1, −1, −1, 1, −1, 1, −1, 1, −1, 1, 1, 1, 1, 1, −1, −1, −1, −1, −1, 1, −1, −1, −1, −1, |
| | 1, −1, −1, −1, −1, −1, 1, 1, −1, −1, −1, 1, 1, −1, −1, −1, 1, −1, −1, −1, −1, 1, −1, 1, −1, 1, 1, −1, −1, 1, −1, 1, 1, −1, −1, |
| | 1, −1, 1, −1, 1 |
| 14 | 1, 1, 1, 1, −1, −1, −1, −1, −1, 1, −1, −1, −1, 1, −1, 1, −1, −1, 1, −1, −1, −1, −1, −1, 1, 1, −1, −1, −1, −1, 1, −1, −1, −1, −1, |
| | 1, −1, 1, −1, 1, 1, −1, −1, 1, −1, 1, 1, −1, −1, 1, −1, 1, −1, 1, 1, −1, 1, 1, 1, 1, −1, −1, −1, −1, −1, 1, −1, −1, −1, 1, −1, |
| | 1, −1, −1, 1, −1, −1, −1, −1, −1, 1, 1, −1, −1, −1, −1, 1, −1, −1, −1, −1, 1, −1, 1, −1, 1, 1, −1, −1, 1, −1, 1, 1, −1, −1, 1, −1, |
| | 1, −1, 1, 1, −1 |
| 15 | 1, 1, 1, −1, −1, −1, −1, −1, 1, −1, −1, −1, 1, 1, −1, −1, 1, −1, −1, 1, −1, −1, −1, −1, −1, 1, 1, −1, −1, 1, −1, −1, −1, −1, 1, −1, |
| | 1, −1, 1, 1, −1, −1, 1, −1, 1, 1, −1, −1, 1, −1, 1, −1, 1, 1, −1, −1, 1, 1, 1, −1, −1, −1, −1, −1, 1, −1, −1, −1, 1, 1, −1, −1, |
| | 1, −1, −1, 1, −1, −1, −1, −1, −1, 1, 1, −1, −1, 1, −1, −1, −1, −1, 1, −1, 1, −1, 1, 1, −1, −1, 1, −1, 1, 1, −1, −1, 1, −1, 1, −1, |
| | 1, 1, −1, −1 |
| 16 | −1, 1, 1, −1, 1, −1, 1, −1, −1, 1, 1, −1, 1, −1, 1, 1, 1, 1, −1, 1, −1, 1, −1, −1, 1, 1, 1, −1, 1, −1, −1, −1, 1, −1, −1, 1, −1, −1, |
| | −1, −1, −1, 1, −1, 1, 1, 1, −1, 1, 1, 1, 1, 1, −1, −1, −1, −1, −1, 1, 1, −1, 1, −1, 1, −1, −1, 1, 1, −1, 1, −1, 1, 1, 1, 1, −1, |
| | 1, −1, 1, −1, −1, 1, 1, 1, −1, 1, −1, −1, −1, 1, −1, −1, 1, −1, −1, −1, −1, −1, 1, −1, 1, 1, 1, −1, 1, 1, 1, 1, 1, −1, −1, −1, −1, −1 |
| 17 | 1, 1, −1, 1, −1, 1, −1, −1, 1, 1, −1, 1, −1, −1, 1, 1, 1, −1, 1, −1, 1, −1, −1, 1, 1, 1, −1, 1, 1, 1, −1, −1, −1, 1, −1, −1, 1, −1, |
| | −1, −1, −1, −1, 1, 1, 1, −1, 1, 1, 1, 1, 1, −1, −1, −1, −1, −1, 1, 1, −1, 1, −1, 1, −1, −1, 1, 1, −1, 1, −1, −1, 1, 1, 1, −1, |
| | 1, −1, 1, −1, −1, 1, 1, 1, −1, 1, 1, 1, −1, −1, −1, 1, −1, −1, 1, −1, −1, −1, −1, −1, 1, 1, 1, −1, 1, 1, 1, 1, 1, −1, −1, −1, −1, −1 |
| 18 | 1, −1, 1, −1, 1, −1, −1, 1, 1, −1, 1, −1, −1, 1, 1, 1, −1, 1, −1, 1, −1, −1, 1, 1, 1, −1, 1, 1, −1, 1, 1, −1, −1, −1, 1, −1, −1, |
| | 1, −1, −1, −1, −1, 1, 1, −1, 1, 1, 1, 1, 1, −1, −1, −1, −1, −1, 1, 1, −1, 1, −1, 1, −1, −1, 1, 1, −1, 1, −1, −1, 1, 1, 1, −1, |
| | 1, −1, 1, −1, −1, 1, 1, 1, −1, 1, 1, −1, 1, 1, −1, −1, −1, 1, −1, −1, 1, −1, −1, −1, −1, 1, 1, −1, 1, 1, 1, 1, 1, −1, −1, −1, −1, |
| | −1, 1 |
| 19 | −1, 1, −1, 1, −1, −1, 1, 1, −1, 1, −1, −1, 1, 1, 1, −1, 1, −1, 1, −1, −1, 1, 1, 1, −1, 1, 1, 1, −1, −1, 1, 1, −1, −1, −1, 1, −1, −1, |
| | 1, −1, −1, −1, 1, −1, 1, 1, 1, 1, 1, −1, −1, −1, −1, −1, 1, 1, −1, 1, −1, 1, −1, −1, 1, 1, −1, 1, −1, −1, 1, 1, 1, −1, 1, −1, |
| | 1, −1, −1, 1, 1, 1, −1, 1, 1, 1, −1, −1, 1, 1, −1, −1, −1, 1, −1, −1, 1, −1, −1, −1, 1, −1, 1, 1, 1, 1, 1, −1, −1, −1, −1, −1, |
| | 1, 1 |
| 20 | 1, −1, 1, −1, −1, 1, 1, −1, 1, −1, −1, 1, 1, −1, −1, 1, −1, 1, −1, −1, 1, 1, 1, −1, 1, 1, 1, 1, −1, −1, −1, 1, 1, −1, −1, −1, 1, −1, |
| | −1, 1, −1, −1, −1, 1, 1, 1, 1, 1, −1, −1, −1, −1, −1, 1, 1, 1, 1, −1, 1, −1, −1, 1, 1, −1, 1, −1, −1, 1, 1, −1, −1, 1, −1, 1, −1, |
| | −1, 1, 1, 1, −1, 1, 1, 1, 1, −1, −1, −1, 1, 1, −1, −1, −1, 1, −1, −1, 1, −1, −1, −1, 1, 1, 1, 1, 1, −1, −1, −1, −1, −1, 1, 1, 1 |
| 21 | 1, −1, −1, 1, 1, −1, 1, −1, −1, 1, 1, −1, 1, −1, −1, 1, −1, −1, 1, 1, 1, −1, 1, 1, 1, 1, −1, 1, −1, −1, −1, −1, −1, 1, 1, −1, −1, −1, |
| | 1, −1, −1, 1, 1, 1, 1, 1, −1, −1, −1, −1, −1, 1, 1, 1, −1, 1, 1, −1, −1, 1, 1, −1, 1, −1, −1, 1, 1, −1, 1, −1, −1, 1, −1, −1, |
| | 1, 1, 1, −1, 1, 1, 1, 1, −1, 1, −1, −1, −1, −1, −1, 1, 1, −1, −1, −1, 1, −1, −1, 1, 1, 1, 1, 1, −1, −1, −1, −1, −1, 1, 1, 1, −1, |
| | 1 |
| 22 | 1, 1, −1, 1, −1, −1, 1, 1, −1, 1, −1, 1, −1, −1, −1, 1, 1, 1, −1, 1, 1, 1, 1, −1, 1, −1, 1, −1, −1, −1, 1, −1, −1, −1, −1, −1, |
| | 1, 1, −1, −1, −1, 1, 1, −1, −1, −1, −1, −1, 1, 1, 1, −1, 1, 1, 1, 1, 1, 1, −1, 1, −1, −1, 1, 1, −1, 1, −1, 1, −1, −1, −1, |
| | 1, 1, 1, −1, 1, 1, 1, 1, −1, 1, −1, 1, −1, −1, −1, 1, −1, −1, −1, −1, −1, 1, 1, −1, −1, −1, 1, 1, −1, −1, −1, −1, −1, 1, 1, 1, −1 |
| | 1, 1, 1, 1 |
| 23 | 1, −1, −1, 1, 1, −1, 1, −1, 1, −1, −1, 1, 1, −1, 1, −1, 1, 1, 1, 1, −1, 1, −1, 1, −1, −1, 1, 1, −1, −1, 1, −1, −1, 1, −1, −1, −1, −1, |
| | −1, 1, 1, −1, −1, −1, −1, 1, 1, 1, −1, 1, 1, 1, 1, 1, −1, −1, 1, −1, −1, 1, 1, −1, 1, −1, 1, −1, −1, 1, 1, −1, 1, −1, |
| | 1, 1, 1, 1, −1, 1, −1, 1, −1, −1, 1, 1, −1, −1, 1, −1, −1, 1, −1, −1, −1, −1, −1, 1, 1, −1, −1, −1, −1, 1, 1, 1, −1, |
| | 1, 1, 1, 1, 1, −1, −1 |
| 24 | 1, −1, −1, 1, −1, 1, −1, 1, 1, 1, 1, −1, 1, 1, −1, −1, 1, 1, −1, 1, −1, 1, −1, −1, 1, 1, −1, 1, 1, −1, −1, −1, 1, −1, −1, −1, −1, −1, |
| | 1, 1, 1, 1, 1, −1, −1, −1, 1, −1, −1, 1, −1, −1, −1, −1, −1, 1, 1, −1, −1, 1, −1, 1, −1, 1, 1, 1, 1, −1, 1, 1, −1, −1, 1, 1, −1, |
| | 1, −1, 1, −1, −1, 1, 1, −1, 1, 1, −1, −1, −1, 1, −1, −1, −1, −1, −1, 1, 1, 1, 1, 1, −1, −1, −1, 1, −1, −1, 1, −1, −1, −1, −1, −1, |
| | 1 |
| 25 | −1, 1, −1, 1, −1, 1, 1, 1, 1, −1, 1, 1, 1, −1, 1, 1, −1, 1, −1, 1, −1, −1, 1, 1, −1, 1, −1, −1, −1, −1, 1, −1, −1, −1, −1, −1, |
| | 1, 1, 1, 1, 1, −1, −1, 1, 1, −1, −1, −1, 1, −1, −1, 1, −1, −1, −1, −1, −1, 1, −1, 1, −1, 1, 1, 1, 1, −1, 1, 1, 1, −1, 1, 1, −1, |
| | 1, −1, 1, −1, −1, 1, 1, −1, 1, −1, −1, −1, −1, 1, −1, −1, −1, −1, −1, 1, 1, 1, 1, 1, −1, −1, 1, 1, −1, −1, −1, 1, −1, −1, 1, −1, |
| | −1, −1, −1 |
| 26 | 1, −1, 1, −1, 1, 1, 1, 1, −1, 1, 1, 1, −1, −1, 1, −1, 1, −1, 1, −1, −1, 1, 1, −1, 1, −1, −1, 1, −1, 1, −1, −1, −1, −1, −1, |
| | 1, 1, 1, 1, 1, −1, −1, −1, −1, 1, 1, −1, −1, −1, 1, −1, −1, 1, −1, −1, −1, 1, −1, 1, −1, 1, 1, 1, 1, −1, 1, 1, 1, −1, −1, 1, −1, |
| | 1, −1, 1, −1, −1, 1, 1, −1, 1, −1, −1, 1, −1, 1, −1, −1, −1, −1, −1, 1, 1, 1, 1, 1, −1, −1, −1, −1, 1, 1, −1, −1, −1, 1, −1, −1, |
| | 1, −1, −1, −1 |
| 27 | −1, 1, −1, 1, 1, 1, 1, −1, 1, 1, 1, −1, −1, 1, −1, 1, −1, 1, −1, −1, 1, 1, −1, 1, −1, −1, 1, 1, 1, −1, −1, −1, −1, −1, |
| | 1, 1, 1, 1, 1, −1, −1, −1, −1, −1, −1, 1, 1, −1, −1, −1, 1, −1, −1, 1, −1, −1, −1, 1, −1, 1, 1, 1, 1, −1, 1, 1, 1, −1, −1, 1, −1, |
| | 1, −1, 1, −1, −1, 1, 1, −1, 1, −1, −1, 1, 1, 1, −1, −1, −1, −1, −1, 1, 1, 1, 1, 1, −1, −1, −1, −1, −1, −1, 1, 1, −1, −1, −1, |
| | 1, −1, −1, 1, −1, −1 |
| 28 | −1, 1, 1, 1, 1, −1, 1, 1, 1, −1, −1, 1, −1, 1, −1, 1, −1, −1, 1, 1, −1, 1, −1, −1, 1, 1, −1, 1, −1, −1, −1, −1, 1, 1, 1, 1, 1, −1, −1, |
| | −1, 1, −1, −1, −1, −1, −1, −1, 1, 1, −1, −1, −1, 1, −1, −1, 1, −1, 1, 1, 1, 1, −1, 1, 1, 1, −1, −1, 1, −1, 1, −1, 1, −1, −1, |
| | 1, 1, −1, 1, −1, −1, 1, 1, −1, 1, −1, −1, −1, −1, 1, 1, 1, 1, 1, −1, −1, −1, 1, −1, −1, −1, −1, −1, −1, 1, 1, −1, −1, −1, 1, −1, |
| | −1, 1 |
| 29 | 1, 1, 1, 1, −1, 1, 1, 1, −1, −1, 1, −1, 1, −1, 1, −1, −1, 1, 1, −1, 1, −1, −1, 1, 1, −1, 1, −1, −1, −1, −1, 1, 1, 1, 1, 1, −1, −1, −1, |
| | 1, −1, −1, 1, −1, −1, −1, −1, −1, 1, 1, −1, −1, −1, 1, −1, −1, 1, 1, 1, 1, −1, 1, 1, 1, −1, −1, 1, −1, 1, −1, 1, −1, −1, 1, 1, −1, |
| | 1, −1, −1, 1, 1, −1, 1, −1, −1, −1, −1, 1, 1, 1, 1, 1, −1, −1, −1, 1, −1, −1, 1, −1, −1, −1, −1, −1, 1, 1, −1, −1, −1, 1, −1, −1 |
| 30 | 1, 1, −1, 1, 1, 1, −1, −1, 1, −1, 1, −1, 1, 1, −1, 1, 1, −1, 1, −1, −1, 1, 1, −1, 1, −1, 1, −1, −1, 1, 1, 1, 1, 1, −1, −1, −1, 1, −1, |
| | −1, −1, −1, −1, −1, 1, −1, −1, −1, −1, −1, 1, 1, −1, −1, −1, 1, 1, 1, −1, 1, 1, 1, −1, −1, 1, −1, 1, −1, 1, 1, −1, 1, 1, −1, |
| | 1, −1, −1, 1, 1, −1, 1, −1, 1, −1, −1, 1, 1, 1, 1, 1, −1, −1, −1, 1, −1, −1, −1, −1, −1, −1, 1, −1, −1, −1, −1, −1, 1, 1, −1, −1, |
| | −1, 1 |
| 31 | −1, 1, 1, 1, −1, −1, 1, −1, 1, −1, 1, 1, 1, 1, 1, −1, 1, −1, −1, 1, 1, −1, 1, −1, 1, −1, −1, 1, 1, 1, 1, 1, −1, −1, −1, 1, −1, −1, −1, |
| | −1, −1, 1, −1, 1, −1, −1, 1, −1, −1, −1, −1, −1, 1, 1, −1, −1, −1, 1, 1, 1, −1, −1, 1, −1, 1, −1, 1, 1, 1, 1, 1, −1, 1, −1, −1, |
| | 1, 1, −1, 1, −1, 1, −1, −1, 1, 1, 1, 1, 1, −1, −1, −1, 1, −1, −1, −1, −1, −1, 1, −1, 1, −1, −1, 1, −1, −1, −1, −1, −1, 1, 1, −1, |
| | −1 |
| 32 | 1, 1, 1, −1, −1, 1, −1, 1, −1, 1, 1, 1, 1, −1, −1, 1, −1, −1, 1, 1, −1, 1, −1, 1, −1, −1, 1, 1, 1, 1, 1, −1, −1, −1, 1, −1, −1, −1, |
| | −1, −1, 1, 1, −1, −1, 1, −1, −1, 1, −1, −1, −1, −1, −1, 1, 1, −1, 1, 1, 1, −1, −1, 1, −1, 1, −1, 1, 1, 1, 1, −1, −1, 1, −1, −1, |
| | 1, 1, −1, 1, −1, 1, −1, −1, 1, 1, 1, 1, 1, −1, −1, −1, 1, −1, −1, −1, −1, −1, 1, 1, −1, −1, 1, −1, −1, 1, −1, −1, −1, −1, −1, |
| | 1, 1, −1 |
| 33 | −1, −1, −1, 1, −1, −1, 1, −1, −1, −1, −1, −1, 1, 1, −1, −1, 1, 1, 1, 1, 1, −1, 1, 1, 1, −1, −1, −1, 1, 1, −1, −1, 1, −1, 1, −1, |
| | 1, 1, −1, −1, 1, −1, −1, −1, 1, 1, −1, 1, −1, 1, −1, −1, −1, −1, 1, −1, 1, 1, 1, −1, 1, 1, −1, 1, 1, 1, 1, 1, −1, −1, 1, 1, −1, −1, |
| | −1, −1, −1, 1, −1, −1, −1, 1, 1, 1, −1, −1, 1, 1, −1, 1, −1, 1, −1, −1, 1, 1, −1, 1, 1, 1, −1, −1, 1, −1, 1, −1, 1, 1, 1, 1, −1, |
| | 1 |
| 34 | −1, −1, −1, −1, 1, 1, −1, −1, −1, 1, −1, −1, 1, −1, 1, −1, 1, 1, 1, −1, −1, −1, −1, −1, 1, 1, 1, 1, 1, −1, 1, 1, −1, −1, 1, −1, |
| | 1, 1, −1, −1, 1, −1, −1, 1, −1, −1, −1, −1, 1, −1, −1, −1, 1, 1, −1, 1, 1, 1, 1, 1, −1, −1, 1, 1, 1, −1, 1, 1, −1, 1, −1, 1, −1, |
| | −1, −1, 1, 1, 1, 1, 1, −1, −1, −1, −1, −1, 1, −1, −1, 1, 1, −1, 1, −1, −1, 1, 1, −1, 1, 1, −1, 1, 1, 1, 1, −1, 1, 1, 1, −1, −1, |
| | 1, −1 |
| 35 | 1, −1, −1, −1, −1, −1, 1, 1, −1, −1, −1, 1, −1, −1, 1, 1, 1, −1, −1, −1, −1, −1, 1, 1, 1, 1, 1, −1, 1, 1, −1, −1, 1, −1, 1, 1, −1, |
| | −1, 1, −1, 1, −1, −1, −1, −1, −1, 1, −1, −1, −1, 1, 1, −1, 1, −1, 1, −1, 1, 1, 1, 1, 1, −1, −1, 1, 1, 1, −1, 1, 1, −1, −1, −1, |
| | 1, 1, 1, 1, 1, −1, −1, −1, −1, −1, 1, −1, −1, 1, 1, −1, 1, −1, −1, 1, 1, −1, 1, −1, 1, 1, 1, 1, 1, −1, 1, 1, 1, −1, −1, 1, −1, |
| | 1, −1 |
| 36 | −1, −1, 1, −1, −1, −1, −1, −1, 1, 1, −1, −1, −1, 1, 1, −1, −1, −1, −1, −1, 1, 1, 1, 1, 1, −1, 1, 1, −1, −1, 1, −1, 1, 1, −1, −1, |
| | 1, −1, 1, −1, 1, 1, −1, −1, 1, −1, −1, −1, 1, 1, −1, 1, −1, 1, −1, −1, 1, 1, −1, 1, 1, 1, 1, 1, −1, −1, 1, 1, 1, −1, −1, |
| | 1, 1, 1, 1, 1, −1, −1, −1, −1, −1, 1, −1, −1, 1, 1, −1, 1, −1, −1, 1, 1, −1, 1, −1, 1, −1, −1, 1, 1, −1, 1, 1, 1, −1, −1, 1, −1, |
| | 1, −1, 1, 1 |
| 37 | 1, −1, −1, 1, −1, −1, −1, −1, −1, 1, 1, −1, −1, −1, −1, −1, −1, −1, −1, 1, 1, 1, 1, 1, −1, 1, 1, 1, −1, 1, −1, 1, 1, −1, −1, 1, −1, |
| | 1, −1, 1, 1, −1, −1, 1, −1, −1, −1, 1, 1, −1, 1, −1, 1, −1, −1, −1, −1, 1, 1, −1, 1, 1, 1, 1, 1, −1, −1, 1, 1, 1, 1, 1, 1, 1, 1, −1, |
| | −1, −1, −1, −1, 1, −1, −1, −1, 1, −1, 1, −1, −1, 1, 1, −1, 1, −1, 1, −1, −1, 1, 1, −1, 1, 1, 1, −1, −1, 1, −1, 1, −1, 1, 1, 1 |
| 38 | −1, 1, −1, −1, 1, −1, −1, −1, −1, −1, 1, 1, −1, −1, −1, −1, −1, −1, 1, 1, 1, 1, 1, −1, 1, 1, 1, −1, 1, −1, 1, 1, −1, −1, 1, −1, |
| | 1, −1, 1, 1, −1, −1, 1, −1, −1, −1, 1, 1, −1, 1, −1, 1, −1, −1, −1, −1, 1, −1, 1, 1, −1, 1, 1, 1, 1, 1, −1, −1, |
| | 1, 1, 1, 1, 1, 1, −1, −1, −1, −1, −1, 1, −1, −1, −1, 1, −1, 1, −1, −1, 1, 1, −1, 1, −1, 1, −1, −1, 1, 1, −1, 1, 1, 1, −1, −1, |
| | 1, −1, 1, −1, 1, 1, 1, 1 |
| 39 | −1, −1, 1, −1, −1, 1, −1, −1, −1, −1, −1, 1, 1, −1, −1, −1, −1, 1, 1, 1, 1, 1, −1, 1, 1, 1, −1, −1, −1, 1, 1, −1, −1, 1, −1, 1, −1, |
| | 1, 1, −1, −1, 1, −1, −1, −1, 1, 1, −1, 1, −1, 1, −1, −1, −1, −1, 1, 1, 1, −1, 1, 1, −1, 1, 1, 1, 1, 1, −1, −1, 1, 1, 1, 1, −1, −1, |
| | −1, −1, −1, 1, −1, −1, −1, 1, 1, 1, −1, −1, 1, 1, −1, 1, −1, 1, −1, −1, 1, 1, −1, 1, 1, 1, −1, −1, 1, −1, 1, −1, 1, 1, 1, 1, −1 |
| 40 | 1, 1, −1, −1, −1, −1, −1, 1, −1, −1, −1, 1, 1, 1, −1, −1, −1, 1, −1, −1, 1, −1, −1, −1, −1, −1, 1, 1, 1, −1, −1, −1, −1, 1, −1, |
| | 1, −1, 1, 1, −1, −1, −1, −1, 1, 1, −1, −1, 1, −1, 1, −1, 1, 1, −1, −1, 1, −1, −1, 1, 1, 1, 1, 1, −1, 1, 1, 1, −1, −1, −1, |
| | 1, 1, 1, −1, 1, 1, −1, 1, 1, 1, 1, 1, −1, −1, −1, 1, 1, 1, 1, −1, 1, −1, 1, −1, −1, 1, 1, 1, 1, −1, −1, 1, 1, −1, 1, −1, 1, −1, −1, |
| | 1, 1, −1 |
| 41 | −1, −1, −1, −1, 1, −1, −1, −1, 1, 1, 1, 1, 1, −1, −1, 1, 1, −1, −1, −1, 1, −1, −1, 1, −1, −1, −1, −1, −1, −1, 1, −1, 1, −1, 1, 1, −1, |
| | −1, −1, 1, −1, −1, −1, −1, 1, −1, 1, −1, 1, 1, −1, −1, 1, −1, 1, 1, 1, 1, 1, 1, −1, 1, 1, 1, −1, −1, −1, −1, −1, 1, 1, −1, −1, |
| | 1, 1, 1, 1, −1, 1, 1, −1, 1, 1, 1, 1, 1, 1, −1, 1, −1, 1, −1, −1, 1, 1, 1, −1, 1, 1, 1, 1, −1, 1, −1, 1, −1, −1, 1, 1, −1, 1, −1, −1 |
| 42 | −1, −1, 1, −1, −1, −1, 1, 1, 1, 1, 1, −1, −1, −1, −1, −1, −1, 1, 1, −1, −1, −1, 1, −1, −1, 1, −1, −1, 1, −1, 1, −1, 1, 1, −1, −1, −1, |
| | 1, −1, −1, −1, −1, 1, −1, 1, −1, 1, 1, −1, −1, 1, −1, 1, 1, −1, −1, 1, 1, −1, 1, 1, 1, −1, −1, −1, −1, −1, 1, 1, 1, 1, 1, 1, −1, |
| | 1, −1, 1, 1, 1, −1, 1, 1, −1, 1, 1, −1, 1, −1, 1, −1, −1, 1, 1, 1, −1, 1, 1, 1, 1, −1, 1, −1, 1, −1, −1, 1, 1, −1, 1, −1, −1, 1, 1 |
| 43 | 1, −1, −1, −1, 1, 1, 1, 1, 1, −1, −1, −1, −1, −1, −1, −1, −1, −1, −1, 1, 1, −1, −1, −1, 1, −1, −1, 1, 1, −1, 1, 1, −1, −1, −1, 1, −1, |
| | −1, −1, −1, 1, −1, 1, −1, 1, 1, −1, −1, 1, −1, 1, 1, −1, −1, 1, −1, −1, 1, 1, 1, −1, −1, −1, −1, −1, |
| | 1, 1, 1, 1, 1, 1, 1, 1, 1, 1, −1, −1, 1, 1, 1, −1, 1, 1, −1, −1, 1, −1, −1, 1, 1, 1, −1, 1, 1, 1, 1, −1, 1, −1, 1, −1, −1, 1, 1, −1, |
| | 1, −1, −1, 1, 1, −1, 1 |
| 44 | −1, −1, 1, 1, 1, 1, 1, −1, −1, −1, −1, −1, 1, −1, −1, 1, −1, −1, −1, −1, −1, 1, 1, −1, −1, −1, 1, −1, 1, 1, −1, −1, −1, 1, −1, −1, |
| | −1, −1, 1, −1, 1, −1, 1, 1, −1, −1, 1, −1, 1, 1, −1, −1, 1, −1, 1, −1, 1, 1, −1, −1, −1, −1, −1, 1, 1, 1, 1, 1, −1, 1, 1, −1, |
| | 1, 1, 1, 1, 1, −1, −1, 1, 1, 1, −1, 1, −1, −1, 1, 1, 1, −1, 1, 1, 1, 1, −1, 1, −1, 1, −1, −1, 1, 1, −1, 1, −1, −1, 1, 1, −1, 1, −1, |
| | 1 |
| 45 | −1, 1, 1, 1, 1, 1, −1, −1, −1, −1, −1, 1, −1, −1, −1, −1, 1, −1, −1, −1, −1, −1, 1, 1, −1, −1, −1, 1, 1, −1, −1, −1, 1, −1, −1, −1, |
| | −1, 1, −1, 1, −1, 1, 1, −1, −1, 1, −1, 1, 1, −1, −1, 1, −1, 1, −1, 1, 1, −1, −1, −1, −1, −1, 1, 1, 1, 1, 1, −1, 1, 1, 1, 1, −1, |
| | 1, 1, 1, 1, 1, −1, −1, 1, 1, 1, −1, −1, 1, 1, 1, −1, 1, 1, 1, 1, −1, 1, −1, 1, −1, −1, 1, 1, −1, 1, −1, −1, 1, 1, −1, 1, −1, 1, −1 |
| 46 | 1, 1, 1, 1, −1, −1, −1, −1, −1, 1, −1, −1, −1, 1, −1, 1, −1, −1, 1, −1, −1, −1, −1, −1, 1, 1, −1, −1, −1, −1, 1, −1, −1, −1, −1, |
| | 1, −1, 1, −1, 1, 1, −1, −1, 1, −1, 1, 1, −1, −1, 1, −1, 1, −1, 1, 1, −1, −1, −1, −1, −1, 1, 1, 1, 1, 1, −1, 1, 1, 1, −1, 1, −1, |
| | 1, 1, −1, 1, 1, 1, 1, 1, −1, −1, 1, 1, 1, 1, −1, 1, 1, 1, 1, −1, 1, −1, 1, −1, −1, 1, 1, −1, 1, −1, −1, 1, 1, −1, 1, −1, 1, −1, −1, |
| | 1 |
| 47 | 1, 1, 1, −1, −1, −1, −1, −1, 1, −1, −1, −1, 1, 1, −1, −1, 1, −1, −1, 1, −1, −1, −1, −1, −1, 1, 1, −1, −1, 1, −1, −1, −1, −1, 1, −1, |
| | 1, −1, 1, 1, −1, −1, 1, −1, 1, 1, −1, −1, 1, −1, 1, −1, 1, 1, −1, −1, −1, −1, −1, 1, 1, 1, 1, 1, −1, 1, 1, 1, −1, −1, 1, 1, −1, |
| | 1, 1, −1, 1, 1, 1, 1, 1, −1, −1, 1, 1, −1, 1, 1, 1, 1, −1, 1, −1, 1, −1, −1, 1, 1, −1, 1, −1, −1, 1, 1, −1, 1, −1, 1, −1, −1, |
| | 1, 1 |
| 48 | −1, 1, 1, −1, 1, −1, 1, −1, −1, 1, 1, −1, 1, −1, 1, 1, 1, 1, −1, 1, −1, 1, −1, −1, 1, 1, 1, −1, 1, −1, −1, −1, 1, −1, −1, 1, −1, −1, |
| | −1, −1, −1, 1, −1, 1, 1, 1, −1, 1, 1, 1, 1, 1, −1, −1, −1, −1, 1, −1, −1, 1, −1, 1, −1, 1, 1, −1, −1, 1, −1, 1, −1, −1, −1, −1, |
| | 1, −1, 1, −1, 1, 1, −1, −1, −1, 1, −1, 1, 1, 1, −1, 1, 1, −1, 1, 1, 1, 1, 1, −1, 1, −1, −1, −1, 1, −1, −1, −1, −1, −1, 1, 1, 1, 1 |
| 49 | 1, 1, −1, 1, −1, 1, −1, −1, 1, 1, −1, 1, −1, −1, 1, 1, 1, −1, 1, −1, 1, −1, −1, 1, 1, 1, −1, 1, 1, 1, −1, −1, −1, 1, −1, −1, 1, −1, |
| | −1, −1, −1, −1, 1, 1, 1, −1, 1, 1, 1, 1, 1, −1, −1, −1, −1, −1, −1, −1, 1, −1, 1, −1, 1, 1, −1, −1, 1, −1, 1, 1, −1, −1, −1, |
| | 1, −1, 1, −1, 1, 1, −1, −1, −1, 1, −1, −1, −1, 1, 1, 1, −1, 1, 1, −1, 1, 1, 1, 1, 1, −1, −1, −1, 1, −1, −1, −1, −1, −1, |
| | 1, 1, 1, 1, 1 |
| 50 | 1, −1, 1, −1, 1, −1, −1, 1, 1, −1, 1, −1, −1, 1, 1, 1, −1, 1, −1, 1, −1, −1, 1, 1, 1, −1, 1, 1, −1, 1, −1, −1, −1, 1, −1, −1, |
| | 1, −1, −1, −1, −1, 1, 1, −1, 1, 1, 1, 1, 1, −1, −1, −1, −1, −1, 1, −1, 1, −1, 1, −1, 1, 1, −1, −1, 1, −1, 1, 1, −1, −1, −1, 1, −1, |
| | 1, −1, 1, 1, −1, −1, −1, 1, −1, −1, 1, −1, −1, 1, 1, 1, −1, 1, 1, −1, 1, 1, 1, 1, −1, −1, 1, −1, −1, −1, −1, −1, 1, 1, 1, 1, 1, −1 |
| 51 | −1, 1, −1, 1, −1, −1, 1, 1, −1, 1, −1, −1, 1, 1, 1, −1, 1, −1, 1, −1, −1, 1, 1, 1, −1, 1, 1, 1, −1, −1, 1, 1, −1, −1, −1, 1, −1, −1, |
| | 1, −1, −1, −1, 1, −1, 1, 1, 1, 1, 1, −1, −1, −1, −1, −1, 1, 1, 1, −1, 1, −1, 1, 1, −1, −1, 1, −1, 1, 1, −1, −1, −1, 1, −1, 1, −1, |
| | 1, 1, −1, −1, −1, 1, −1, −1, −1, 1, 1, −1, −1, 1, 1, 1, −1, 1, 1, −1, 1, 1, 1, −1, 1, −1, −1, −1, −1, −1, 1, 1, 1, 1, 1, −1, −1 |
| 52 | 1, −1, 1, −1, −1, 1, 1, −1, 1, −1, −1, 1, 1, −1, −1, 1, −1, 1, −1, −1, 1, 1, 1, −1, 1, 1, 1, 1, −1, −1, −1, 1, 1, −1, −1, −1, 1, −1, |
| | −1, 1, −1, −1, −1, 1, 1, 1, 1, 1, −1, −1, −1, −1, −1, 1, 1, 1, −1, 1, −1, 1, 1, −1, −1, 1, −1, 1, 1, −1, −1, 1, 1, −1, 1, −1, |
| | 1, 1, −1, −1, −1, 1, −1, −1, −1, −1, 1, 1, 1, −1, −1, 1, 1, 1, −1, 1, 1, −1, 1, 1, 1, −1, −1, −1, −1, −1, 1, 1, 1, 1, 1, −1, −1, |
| | −1 |
| 53 | 1, −1, −1, 1, 1, −1, 1, −1, −1, 1, 1, −1, 1, −1, −1, 1, −1, −1, 1, 1, 1, −1, 1, 1, 1, 1, −1, 1, −1, −1, −1, −1, −1, 1, 1, −1, −1, −1, |
| | 1, −1, −1, 1, 1, 1, 1, 1, −1, −1, −1, −1, −1, 1, 1, 1, −1, 1, −1, 1, 1, −1, −1, 1, −1, 1, 1, −1, −1, 1, −1, 1, 1, −1, 1, 1, −1, −1, |
| | −1, 1, −1, −1, −1, −1, 1, −1, 1, 1, 1, 1, 1, −1, −1, 1, 1, 1, −1, 1, 1, −1, −1, −1, −1, −1, 1, 1, 1, 1, 1, −1, −1, −1, 1, −1 |
| 54 | 1, 1, −1, 1, −1, −1, 1, 1, −1, 1, −1, 1, −1, −1, −1, 1, 1, 1, −1, 1, 1, 1, 1, −1, 1, −1, 1, −1, −1, −1, 1, −1, −1, −1, −1, −1, |
| | 1, 1, −1, −1, −1, 1, 1, −1, −1, −1, −1, −1, 1, 1, 1, −1, 1, 1, 1, 1, −1, −1, 1, −1, 1, 1, −1, −1, 1, −1, 1, −1, 1, 1, 1, −1, −1, |
| | −1, 1, −1, −1, −1, −1, 1, −1, 1, −1, 1, 1, 1, −1, 1, 1, 1, 1, 1, −1, −1, 1, 1, 1, −1, −1, 1, 1, 1, 1, 1, −1, −1, −1, 1, −1, −1, −1, |
| | −1 |
| 55 | 1, −1, −1, 1, 1, −1, 1, −1, 1, −1, −1, 1, 1, −1, 1, −1, 1, 1, 1, 1, −1, 1, −1, 1, −1, −1, 1, 1, −1, −1, 1, −1, −1, 1, −1, −1, −1, −1, |
| | −1, 1, 1, −1, −1, −1, −1, 1, 1, 1, −1, 1, 1, 1, 1, 1, −1, −1, −1, 1, 1, −1, −1, 1, −1, 1, −1, 1, 1, −1, −1, 1, −1, 1, −1, −1, −1, |
| | −1, 1, −1, 1, −1, 1, 1, −1, −1, 1, 1, −1, 1, 1, −1, 1, 1, 1, 1, 1, −1, −1, 1, 1, 1, 1, −1, −1, −1, 1, −1, −1, −1, −1, −1, 1, 1 |
| 56 | 1, −1, −1, 1, −1, 1, −1, 1, 1, 1, 1, −1, 1, 1, −1, −1, 1, 1, −1, 1, −1, 1, −1, −1, 1, 1, −1, 1, 1, −1, −1, −1, 1, −1, −1, −1, −1, −1, |
| | 1, 1, 1, 1, 1, −1, −1, −1, 1, −1, −1, 1, −1, −1, −1, −1, −1, 1, −1, 1, 1, −1, 1, −1, 1, −1, −1, −1, −1, 1, −1, −1, 1, 1, −1, −1, |
| | 1, −1, 1, −1, 1, 1, −1, −1, 1, −1, −1, 1, 1, 1, −1, 1, 1, 1, 1, 1, −1, −1, −1, −1, −1, 1, 1, 1, −1, 1, 1, −1, 1, 1, 1, 1, 1, −1 |
| 57 | −1, 1, −1, 1, −1, 1, 1, 1, 1, −1, 1, 1, 1, −1, 1, 1, −1, 1, −1, 1, −1, −1, 1, 1, −1, 1, −1, −1, −1, −1, 1, −1, −1, −1, −1, −1, |
| | 1, 1, 1, 1, 1, −1, −1, 1, 1, −1, −1, −1, 1, −1, −1, 1, −1, −1, −1, −1, 1, −1, 1, −1, 1, −1, −1, −1, −1, 1, −1, −1, −1, 1, −1, −1, |
| | 1, −1, 1, −1, 1, 1, −1, −1, 1, −1, 1, 1, 1, 1, −1, 1, 1, 1, 1, 1, −1, −1, −1, −1, −1, 1, 1, −1, −1, 1, 1, 1, −1, 1, 1, −1, |
| | 1, 1, 1, 1 |
| 58 | 1, −1, 1, −1, 1, 1, 1, 1, −1, 1, 1, 1, −1, −1, 1, −1, 1, −1, 1, −1, −1, 1, 1, −1, 1, −1, −1, 1, −1, 1, −1, −1, −1, −1, −1, |
| | 1, 1, 1, 1, 1, −1, −1, −1, −1, 1, 1, −1, −1, −1, 1, −1, −1, 1, −1, −1, −1, −1, 1, −1, 1, −1, −1, −1, −1, 1, −1, −1, −1, 1, 1, −1, |
| | 1, −1, 1, −1, 1, 1, −1, −1, 1, −1, 1, 1, −1, 1, −1, 1, 1, 1, 1, 1, −1, −1, −1, −1, −1, 1, 1, 1, 1, −1, −1, 1, 1, 1, −1, 1, 1, −1, |
| | 1, 1, 1 |
| 59 | −1, 1, −1, 1, 1, 1, 1, −1, 1, 1, 1, −1, −1, 1, −1, 1, −1, 1, −1, −1, 1, 1, −1, 1, −1, −1, 1, 1, 1, −1, −1, −1, −1, −1, |
| | 1, 1, 1, 1, 1, −1, −1, −1, −1, −1, −1, 1, 1, −1, −1, −1, 1, −1, −1, 1, −1, −1, 1, −1, 1, −1, −1, −1, −1, 1, −1, −1, −1, 1, 1, −1, |
| | 1, −1, 1, −1, 1, 1, −1, −1, 1, −1, 1, 1, −1, −1, −1, 1, 1, 1, 1, 1, −1, −1, −1, −1, −1, 1, 1, 1, 1, 1, 1, −1, −1, 1, 1, 1, −1, |
| | 1, 1, −1, 1, 1 |
| 60 | −1, 1, 1, 1, 1, −1, 1, 1, 1, −1, 1, 1, 1, 1, −1, 1, −1, −1, 1, 1, −1, 1, −1, −1, 1, 1, 1, 1, −1, 1, 1, 1, 1, −1, −1, |
| | −1, 1, −1, −1, −1, −1, −1, −1, 1, 1, −1, −1, −1, 1, −1, −1, 1, 1, −1, −1, −1, −1, 1, −1, −1, −1, 1, 1, −1, 1, −1, 1, −1, 1, 1, −1, |
| | −1, 1, −1, 1, 1, −1, −1, 1, −1, 1, 1, 1, 1, −1, −1, −1, −1, −1, 1, 1, 1, −1, 1, 1, 1, 1, 1, 1, −1, −1, 1, 1, 1, −1, 1, 1, −1 |
| 61 | 1, 1, 1, 1, −1, 1, 1, 1, −1, −1, 1, −1, 1, −1, 1, −1, −1, 1, 1, −1, 1, −1, −1, 1, 1, −1, 1, −1, −1, −1, −1, 1, 1, 1, 1, 1, −1, −1, −1, |
| | 1, −1, −1, 1, −1, −1, −1, −1, −1, 1, 1, −1, −1, −1, 1, −1, −1, −1, −1, −1, −1, 1, −1, −1, −1, 1, 1, −1, 1, −1, 1, −1, 1, 1, −1, |
| | −1, 1, −1, 1, 1, −1, −1, 1, −1, 1, 1, 1, 1, −1, −1, −1, −1, −1, 1, 1, 1, −1, 1, 1, −1, 1, 1, 1, 1, 1, −1, −1, 1, 1, 1, −1, 1, 1 |
| 62 | 1, 1, −1, 1, 1, 1, −1, −1, 1, −1, 1, −1, 1, 1, −1, 1, 1, −1, 1, −1, −1, 1, 1, −1, 1, −1, 1, −1, −1, 1, 1, 1, 1, 1, −1, −1, −1, 1, −1, |
| | −1, −1, −1, −1, −1, 1, −1, −1, −1, −1, −1, 1, 1, −1, −1, −1, 1, −1, −1, 1, −1, −1, −1, 1, 1, −1, 1, −1, 1, −1, −1, 1, −1, −1, |
| | 1, −1, 1, 1, −1, −1, 1, −1, 1, −1, 1, 1, −1, −1, −1, −1, −1, 1, 1, 1, −1, 1, 1, 1, 1, 1, 1, −1, 1, 1, 1, 1, 1, −1, −1, 1, 1, 1, −1 |
| 63 | −1, 1, 1, 1, −1, −1, 1, −1, 1, −1, 1, 1, 1, 1, 1, −1, 1, −1, −1, 1, 1, −1, 1, −1, 1, −1, −1, 1, 1, 1, 1, 1, −1, −1, −1, 1, −1, −1, −1, |
| | −1, −1, 1, −1, 1, −1, −1, 1, −1, −1, −1, −1, −1, 1, 1, −1, −1, 1, −1, −1, −1, 1, 1, −1, 1, −1, 1, −1, −1, −1, −1, −1, 1, −1, |
| | 1, 1, −1, −1, 1, −1, 1, −1, 1, 1, −1, −1, −1, −1, −1, 1, 1, 1, −1, 1, 1, 1, 1, 1, −1, 1, −1, 1, 1, −1, 1, 1, 1, 1, 1, −1, −1, |
| | 1, 1 |
| 64 | 1, 1, 1, −1, −1, 1, −1, 1, −1, 1, 1, 1, 1, −1, −1, 1, −1, −1, 1, 1, −1, 1, −1, 1, −1, −1, 1, 1, 1, 1, 1, −1, −1, −1, 1, −1, −1, −1, |
| | −1, −1, 1, 1, −1, −1, 1, −1, −1, 1, −1, −1, −1, −1, −1, 1, 1, −1, −1, −1, −1, 1, 1, −1, 1, −1, 1, −1, −1, −1, −1, 1, 1, −1, |
| | 1, 1, −1, −1, 1, −1, 1, −1, 1, 1, −1, −1, −1, −1, −1, 1, 1, 1, −1, 1, 1, 1, 1, 1, −1, −1, 1, 1, −1, 1, 1, −1, 1, 1, 1, 1, 1, −1, −1, |
| | 1 |

In some implementations, one or more wireless communication devices may store one or more sequence sets (such as any one or more of the sequence sets illustrated by Tables 1-7). For example, a wireless communication device may store one or more sets of 64 length-96 sequences, one or more sets of 64 length-104 sequences, one or more sets of 64 length-112 sequences, or any combination thereof. In such implementations, the wireless communication device may retrieve, select, identify, or reference at least one of such sequence sets in accordance with transmitting or receiving an ELR PPDU (including, for example, an ELR-mark sequence). Additionally, or alternatively, one or more wireless communication devices may store one or more matrices associated with generating, selecting, constructing, building, or otherwise determining one or more sequence sets. For example, a wireless communication device may store one or more GHₛ matrices, one or more H48ₛ matrices, one or more H56ₛ matrices, one or more Hadamard expansion matrices, or any combination thereof. In such implementations, the wireless communication device may retrieve, select, identify, or reference at least one of such matrices (which may be understood as submatrices) to generate a sequence set in accordance with transmitting or receiving an ELR PPDU (including, for example, an ELR-mark sequence). The wireless communication device may store one or more submatrices in implementations in which the sequence set is associated with a Hadamard expansion of a matrix or a subset of a matrix. A wireless communication device may store one or more sequence sets or one or more submatrices, or any combination thereof, in one or more memories associated with or otherwise accessible by the wireless communication device, which may include one or more memories located at the wireless communication device or one or more memories located separately from the wireless communication device.

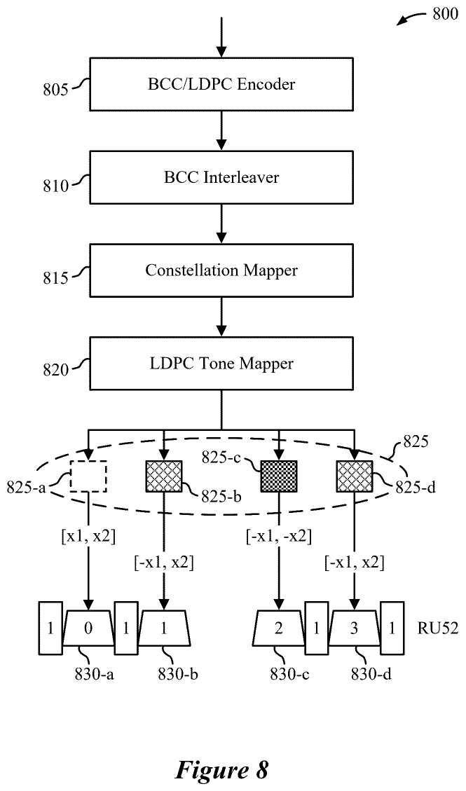

FIG. 8 shows an example transmission scheme 800 associated with a set of ELR data symbols that supports PAPR reduction for ELR data. For example, the wireless communication device 502 may implement the transmission scheme 800 to transmit the data portion 514 of the PPDU 510, which may include an ELR data field 522 (including one or more ELR data symbols). In some aspects, each ELR data symbol may use four-times (4×) RU52 duplication (DUP), with QAM mapping and binary convolutional code (BCC) or low-density parity-check (LDPC) tone mapping on RU52 and duplicating to four RU52.

For example, the wireless communication device 502 may input information (such as a set of bits, such as a set of information bits) into a BCC or LDPC (BCC/LDPC) encoder 805 to perform BCC/LDPC encoding of the information. The wireless communication device 502 may provide an output of the BCC/LDPC encoder 805 to a BCC interleaver 810. The wireless communication device 502 may provide an output of the BCC interleaver 810 to a constellation mapper 815. The constellation mapper 815 may be associated with BPSK or quadrature phase shift keying (QPSK), or any combination thereof. The wireless communication device 502 may provide an output of the constellation mapper 815 to an LDPC tone mapper 820.

The wireless communication device 502 may duplicate the data 4× and, in some implementations, may apply a mask 825 on data tones to reduce a PAPR associated with the duplicated data. The wireless communication device 502 may apply the mask 825 to one or more RUs, such as to one or more of an RU 830-a, an RU 830-b, an RU 830-c, and an RU 830-d. Each of the RU 830-a, the RU 830-b, the RU 830-c, and the RU 830-d may be an example of an RU52 including, for example, 48 data tones. The wireless communication device 502 may apply different types of masks to control the PAPR associated with the duplicated data. In some implementations, the wireless communication device 502 may apply an LTF sequence to the data tones as the mask 825. In some other implementations, the wireless communication device 502 may apply another type of mask 825, such as a mask 825 with relatively low memory demands (which may save memory at the wireless communication device 502). The wireless communication device 502 may apply the mask 825 to data tones, such as exclusively to data tones. For example, the wireless communication device 502 may refrain from applying the mask 825 to pilot tones, leaving the pilots same as in an OFDMA mode.

In some examples, the mask 825 may be associated with multiple “sub-masks,” each sub-mask applied to a respective RU. For example, the mask 825 may be associated with a mask 825-a applied to data tones of the RU 830-a, a mask 825-b applied to data tones of the RU 830-b, a mask 825-c applied to data tones of the RU 830-c, and a mask 825-d applied to data tones of the RU 830-d. Within each RU, a lower 24 data tones (or, generally, any first set of data tones within that RU) may be denoted as x1 and an upper 24 data tones (or, generally, any second set of data tones within that RU) may be denoted as x2. Thus, an (effectively) unmasked or unchanged RU may include data tones denoted as [x1, x2].

In some implementations, for FD 4×RU52 DUP with a PAPR reduction mask, the mask 825 may apply a “1” or a “−1,” or any combination thereof, to each data tone. For example, the mask 825-b and the mask 825-d may be masks denoted as [−x1, x2], meaning that the wireless communication device 502 may multiply the lower 24 data tones of each of the RU 830-b and the RU 830-d by “−1” and leave the upper 24 data tones of each of the RU 830-b and the RU 830-d unchanged. For further example, the mask 825-c may be a mask denoted as [−x1, −x2], meaning that the wireless communication device 502 may multiply both the lower 24 data tones and the upper 24 data tones (such as all data tones) of the RU 830-c by “−1.” The mask 825-a may be a mask denoted as [x1, x2], meaning that the wireless communication device 502 may leave the data tones of the RU 830-a unchanged (such as unmasked). The mask 825 may be denoted as [mask 825-a, mask 825-b, mask 825-c, mask 825-d]. Thus, in accordance with the example illustrated by the transmission scheme 800, the mask 825 may effectively become [1 1−1 1−1−1−1 1], with each “1” or “−1” corresponding to a respective half (or, generally, a set) of contiguous data tones within an RU. In other words, the mask 825 may be understood as an 8-segment mask, with each segment being for a contiguous set of 24 data tones (either a lower or upper half of data tones in each RU52). The mask on each segment may be “1” or “−1.” Generally, the mask 825 may be any 8-segment sequence of “1” or “−1” values without exceeding the scope of the present disclosure, such as [−1 1 1-1 1 1 1 1], among other examples.

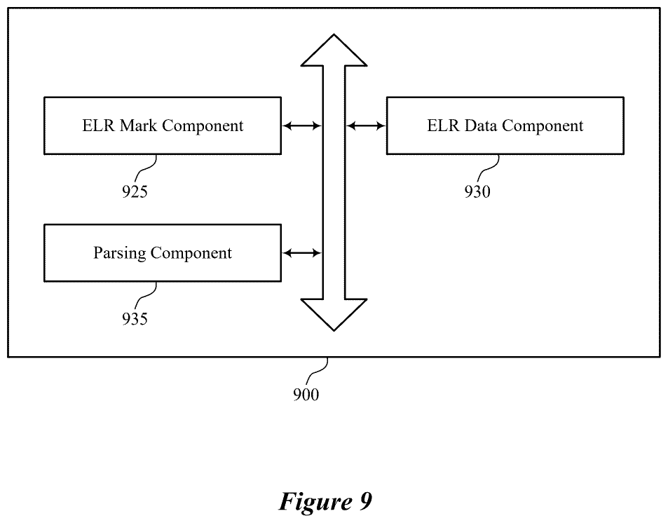

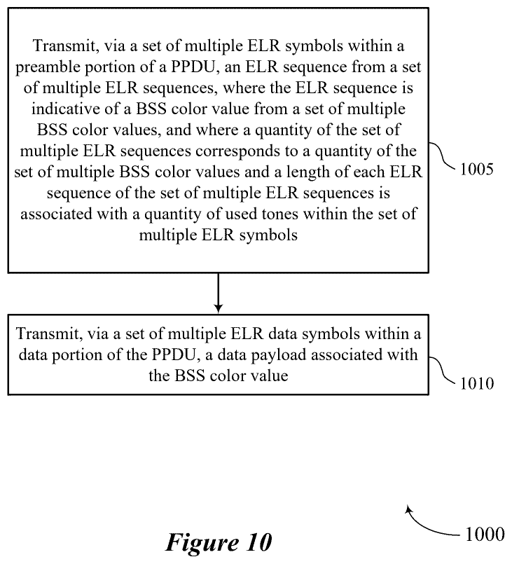

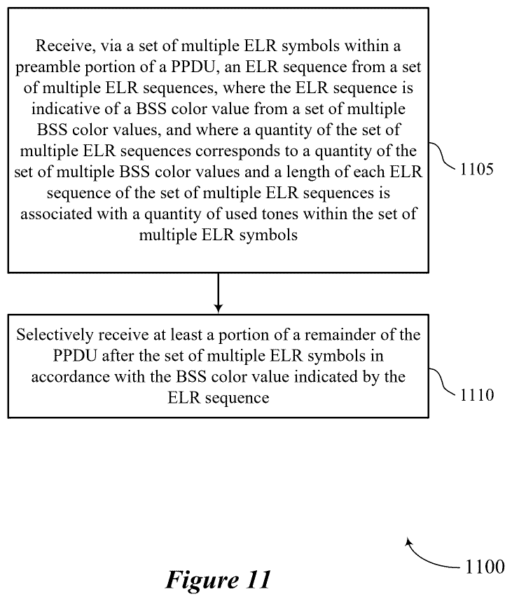

FIG. 9 shows a block diagram of an example wireless communication device 900 that supports ELR-mark sequence design. In some examples, the wireless communication device 900 is configured to perform the processes 1000 and 1100 described with reference to FIGS. 10 and 11, respectively. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in an AP or STA, such as the AP 102 or the STA 104 described with reference to FIG. 1. In some other examples, the wireless communication device 900 can be an AP or STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, that are coupled with the processing system. In some examples, the wireless communication device 900 further includes at least one external network interface coupled with the processing system that enables communication with a core network or backhaul network that enables the wireless communication device 900 to gain access to external networks including the Internet.

The wireless communication device 900 includes an ELR-mark component 925, an ELR data component 930, and a parsing component 935. Portions of one or more of the ELR-mark component 925, the ELR data component 930, and the parsing component 935 may be implemented at least in part in hardware or firmware. For example, one or more of the ELR-mark component 925, the ELR data component 930, and the parsing component 935 may be implemented at least in part by at least a processor or a modem. In some examples, portions of one or more of the ELR-mark component 925, the ELR data component 930, and the parsing component 935 may be implemented at least in part by a processor and software in the form of processor-executable code stored in memory.

The wireless communication device 900 may support wireless communication in accordance with examples as disclosed herein. The ELR-mark component 925 is configurable or configured to transmit, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The ELR data component 930 is configurable or configured to transmit, via a set of multiple ELR data symbols within a data portion of the PPDU, a data payload associated with the BSS color value.

Additionally, or alternatively, the ELR-mark component 925 is configurable or configured to receive, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The parsing component 935 is configurable or configured to selectively receive at least a portion of a remainder of the PPDU after the set of multiple ELR symbols in accordance with the BSS color value indicated by the ELR sequence.

In some examples, to support selectively receiving at least the portion of the remainder of the PPDU after the set of multiple ELR symbols, the parsing component 935 is configurable or configured to receive at least the portion of the remainder of the PPDU in accordance with a BSS associated with the wireless communication device corresponding to the BSS color value indicated by the ELR sequence. In some examples, to support selectively receiving at least the portion of the remainder of the PPDU after the set of multiple ELR symbols, the parsing component 935 is configurable or configured to refrain from receiving the remainder of the PPDU in accordance with the BSS associated with the wireless communication device corresponding to a different BSS color value than the BSS color value indicated by the ELR sequence.

In some examples, the set of multiple ELR symbols includes two ELR symbols. In some examples, the ELR sequence is associated with a Hadamard expansion of a pair of binary complementary sequences. In some examples, a first ELR symbol of the two ELR symbols is associated with a first half of the ELR sequence and a second ELR symbol of the two ELR symbols is associated with a second half of the ELR sequence.

In some examples, the set of multiple ELR sequences is associated with the Hadamard expansion of a subset of a Golay-Hadamard matrix. In some examples, the Golay-Hadamard matrix is associated with non-transposed circulant shifted versions of the pair of binary complementary sequences and transposed circulant shifted versions of the pair of binary complementary sequences.

In some examples, a tone plan of each of the two ELR symbols includes a set of dedicated pilot tones. In some examples, the quantity of used tones within the set of multiple ELR symbols includes a set of data tones in the tone plan and excludes the set of dedicated pilot tones. In some examples, the first ELR symbol includes a first set of dedicated pilot tones located at tone indices of [−21, −7, 7, 21] within the first ELR symbol, the first set of dedicated pilot tones having values equal to (−1)*[1, 1, 1, −1]. In some examples, the second ELR symbol includes a second set of dedicated pilot tones located at tone indices of [−21, −7, 7, 21] within the second ELR symbol, the second set of dedicated pilot tones having values equal to (−1)*[1, 1, 1,−1].

In some examples, a tone plan of each of the two ELR symbols excludes dedicated pilot tones. In some examples, the quantity of used tones within the set of multiple ELR symbols includes a complete set of tones in the tone plan. In some examples, each of the two ELR symbols includes a set of 48 data tones and a set of extra tones. In some examples, the quantity of used tones within the set of multiple ELR symbols is in accordance with each of the two ELR symbols including the set of 48 data tones and the set of extra tones. In some examples, the set of extra tones includes two tones at a beginning of each of the two ELR symbols and two tones at an end of each of the two ELR symbols.

In some examples, the pair of binary complementary sequences is associated with a length of 26. In some examples, the pair of binary complementary sequences includes a primitive pair of binary complementary sequences associated with the length of 26 or a transformation (such as a variant in accordance with one or more of various operations) of the primitive pair of binary complementary sequences associated with the length of 26. In some examples, the Hadamard expansion includes a circulant shift of the pair of binary complementary sequences. In some examples, the pair of binary complementary sequences is a Golay pair of complementary sequences. In some examples, the pair of binary complementary sequences includes length-26 sequences or length-52 sequences. In some examples, the pair of binary complementary sequences satisfies a PAPR threshold.

In some examples, the set of multiple ELR symbols includes two ELR symbols. In some examples, the ELR sequence is a length-96 ELR sequence. In some examples, a first ELR symbol of the two ELR symbols is associated with a first half of the length-96 ELR sequence and a second ELR symbol of the two ELR symbols is associated with a second half of the length-96 ELR sequence. In some examples, the set of multiple ELR sequences is a first subset of a first Hadamard matrix with a first order of 96 or is associated with a Hadamard expansion of a second subset of a second Hadamard matrix with a second order of 48.

In some examples, the first subset of the first Hadamard matrix includes a first subset of row vectors or a first subset of column vectors of the first Hadamard matrix, a first quantity of the first subset of row vectors or a first quantity of the first subset of column vectors associated with the quantity of the set of multiple BSS color values. In some examples, the second subset of the second Hadamard matrix includes a second subset of row vectors or a second subset of column vectors of the second Hadamard matrix, a second quantity of the second subset of row vectors or a second quantity of the second subset of column vectors associated with the quantity of the set of multiple BSS color values.

In some examples, first row vectors of the first subset of row vectors or first column vectors of the first subset of column vectors are associated with relatively lowest PAPRs of the first Hadamard matrix. In some examples, second row vectors of the second subset of row vectors or second column vectors of the second subset of column vectors are associated with relatively lowest PAPRs of the second Hadamard matrix.

In some examples, the first quantity of the first subset of row vectors or the first quantity of the first subset of column vectors is equal to the quantity of the set of multiple BSS color values. In some examples, the second quantity of the second subset of row vectors or the second quantity of the second subset of column vectors is equal to one-half of the quantity of the set of multiple BSS color values.

In some examples, a tone plan of each of the two ELR symbols includes a set of dedicated pilot tones. In some examples, the quantity of used tones within the set of multiple ELR symbols includes a set of data tones in the tone plan and excludes the set of dedicated pilot tones. In some examples, the first ELR symbol includes a first set of dedicated pilot tones located at tone indices of [−21, −7, 7, 21] within the first ELR symbol, the first set of dedicated pilot tones having values equal to (−1)*[1, 1, 1, −1]. In some examples, the second ELR symbol includes a second set of dedicated pilot tones located at tone indices of [−21, −7, 7, 21] within the second ELR symbol, the second set of dedicated pilot tones having values equal to (−1)*[1, 1, 1,−1].

In some examples, the first half of the length-96 ELR sequence is applied to a first set of tones (such as a first set of 48 data tones) associated with the first ELR symbol and the second half of the length-96 ELR sequence is applied to a second set of tones (such as a second set of 48 data tones) associated with the second ELR symbol. In some examples, a mask is applied across the first set of tones and the second set of tones. In some examples, the first set of tones is a first set of data tones, and the second set of tones is a second set of data tones. In some examples, the mask is associated with an LTF sequence. In some examples, each of the first set of (48 data) tones associated with the first ELR symbol and the second set of (48 data) tones associated with the second ELR symbol is modulated using QBPSK.

In some examples, the set of multiple ELR symbols is associated with a same modulation scheme or a same pattern of modulation schemes. In some examples, each of the set of multiple ELR symbols is associated with a different modulation scheme or a different pattern of modulation schemes. In some examples, each BSS color value of the set of multiple BSS color values is directly mapped to a respective index of the set of multiple ELR sequences. In some examples, each BSS color value of the set of multiple BSS color values is indirectly mapped to a respective index of the set of multiple ELR sequences in accordance with PAPRs associated with the set of multiple ELR sequences. In some examples, each of the set of multiple ELR symbols (such as the two ELR symbols) follows a 1× tone plan for 20 MHZ.

In some examples, the set of multiple ELR sequences are associated with a matrix of ELR sequences. In some examples, a size of the matrix of ELR sequences is associated with the quantity of used tones within the set of multiple ELR symbols and the quantity of the set of multiple BSS color values. In some examples, the matrix of ELR sequences is a Hadamard matrix or a subset of a Hadamard matrix. In some examples, a first dimension of the matrix of ELR sequences is equal to the quantity of used tones within the set of multiple ELR symbols and a second dimension of the matrix of ELR sequences is equal to the quantity of the set of multiple BSS color values.

In some examples, an 8-segment mask is applied to data tones associated with the plurality of ELR data symbols. In some examples, each segment of the 8-segment mask is applied to a respective set of data tones of the data tones associated with the plurality of ELR data symbols.

In some examples, the preamble portion of the PPDU includes a U-SIG field prior to the set of multiple ELR symbols. In some examples, the ELR-mark component 925 is configurable or configured to apply a same power scaling to the U-SIG field and to the set of multiple ELR symbols.

FIG. 10 shows a flowchart illustrating an example process 1000 performable by or at a wireless communication device that supports ELR-mark sequence design. The operations of the process 1000 may be implemented by a wireless communication device or its components as described herein. For example, the process 1000 may be performed by a wireless communication device, such as the wireless communication device 900 described with reference to FIG. 9, operating as or within a wireless AP or a wireless STA. In some examples, the process 1000 may be performed by a wireless AP or a wireless STA, such as one of the APs 102 or the STAs 104 described with reference to FIG. 1.

In some examples, in 1005, the wireless communication device may transmit, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The operations of 1005 may be performed in accordance with examples as disclosed herein. In some implementations, aspects of the operations of 1005 may be performed by an ELR-mark component 925 as described with reference to FIG. 9.

In some examples, in 1010, the wireless communication device may transmit, via a set of multiple ELR data symbols within a data portion of the PPDU, a data payload associated with the BSS color value. The operations of 1010 may be performed in accordance with examples as disclosed herein. In some implementations, aspects of the operations of 1010 may be performed by an ELR data component 930 as described with reference to FIG. 9.

FIG. 11 shows a flowchart illustrating an example process 1100 performable by or at a wireless communication device that supports ELR-mark sequence design. The operations of the process 1100 may be implemented by a wireless communication device or its components as described herein. For example, the process 1100 may be performed by a wireless communication device, such as the wireless communication device 900 described with reference to FIG. 9, operating as or within a wireless AP or a wireless STA. In some examples, the process 1100 may be performed by a wireless AP or a wireless STA, such as one of the APs 102 or the STAs 104 described with reference to FIG. 1.

In some examples, in 1105, the wireless communication device may receive, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols. The operations of 1105 may be performed in accordance with examples as disclosed herein. In some implementations, aspects of the operations of 1105 may be performed by an ELR-mark component 925 as described with reference to FIG. 9.

In some examples, in 1110, the wireless communication device may selectively receive at least a portion of a remainder of the PPDU after the set of multiple ELR symbols in accordance with the BSS color value indicated by the ELR sequence. The operations of 1110 may be performed in accordance with examples as disclosed herein. In some implementations, aspects of the operations of 1110 may be performed by a parsing component 935 as described with reference to FIG. 9.

Implementation examples are described in the following numbered clauses:

Clause 1: A method for wireless communication at a wireless communication device, including: transmitting, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols; and transmitting, via a set of multiple ELR data symbols within a data portion of the PPDU, a data payload associated with the BSS color value.

Clause 2: The method of clause 1, where the set of multiple ELR symbols includes two ELR symbols, the ELR sequence is associated with a Hadamard expansion of a pair of binary complementary sequences, and a first ELR symbol of the two ELR symbols is associated with a first half of the ELR sequence and a second ELR symbol of the two ELR symbols is associated with a second half of the ELR sequence.

Clause 3: The method of clause 2, where the set of multiple ELR sequences is associated with the Hadamard expansion of a subset of a Golay-Hadamard matrix, and the Golay-Hadamard matrix is associated with non-transposed circulant shifted versions of the pair of binary complementary sequences and transposed circulant shifted versions of the pair of binary complementary sequences.

Clause 4: The method of any of clauses 2-3, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 5: The method of clause 4, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 6: The method of any of clauses 2-5, where a tone plan of each of the two ELR symbols excludes dedicated pilot tones, and the quantity of used tones within the set of multiple ELR symbols includes a complete set of tones in the tone plan.

Clause 7: The method of any of clauses 2-6, where each of the two ELR symbols includes a set of 48 data tones and a set of extra tones, and the quantity of used tones within the set of multiple ELR symbols is in accordance with each of the two ELR symbols including the set of 48 data tones and the set of extra tones.

Clause 8: The method of clause 7, where the set of extra tones includes two tones at a beginning of each of the two ELR symbols and two tones at an end of each of the two ELR symbols.

Clause 9: The method of any of clauses 2-8, where the pair of binary complementary sequences is associated with a length of 26, and the pair of binary complementary sequences includes a primitive pair of binary complementary sequences associated with the length of 26 or a transformation of the primitive pair of binary complementary sequences associated with the length of 26.

Clause 10: The method of any of clauses 2-9, where the Hadamard expansion includes a circulant shift of the pair of binary complementary sequences.

Clause 11: The method of any of clauses 2-10, where the pair of binary complementary sequences is a Golay pair of complementary sequences.

Clause 12: The method of any of clauses 2-11, where the pair of binary complementary sequences includes length-26 sequences or length-52 sequences.

Clause 13: The method of any of clauses 2-12, where the pair of binary complementary sequences satisfies a PAPR threshold.

Clause 14: The method of any of clauses 1-13, where the set of multiple ELR symbols includes two ELR symbols, the ELR sequence is a length-96 ELR sequence, a first ELR symbol of the two ELR symbols is associated with a first half of the length-96 ELR sequence and a second ELR symbol of the two ELR symbols is associated with a second half of the length-96 ELR sequence, and the set of multiple ELR sequences is a first subset of a first Hadamard matrix with a first order of 96 or is associated with a Hadamard expansion of a second subset of a second Hadamard matrix with a second order of 48.

Clause 15: The method of clause 14, where the first subset of the first Hadamard matrix includes a first subset of row vectors or a first subset of column vectors of the first Hadamard matrix, a first quantity of the first subset of row vectors or a first quantity of the first subset of column vectors associated with the quantity of the set of multiple BSS color values, and the second subset of the second Hadamard matrix includes a second subset of row vectors or a second subset of column vectors of the second Hadamard matrix, a second quantity of the second subset of row vectors or a second quantity of the second subset of column vectors associated with the quantity of the set of multiple BSS color values.

Clause 16: The method of clause 15, where first row vectors of the first subset of row vectors or first column vectors of the first subset of column vectors are associated with relatively lowest PAPRs of the first Hadamard matrix, and second row vectors of the second subset of row vectors or second column vectors of the second subset of column vectors are associated with relatively lowest PAPRs of the second Hadamard matrix.

Clause 17: The method of any of clauses 15-16, where the first quantity of the first subset of row vectors or the first quantity of the first subset of column vectors is equal to the quantity of the set of multiple BSS color values, and the second quantity of the second subset of row vectors or the second quantity of the second subset of column vectors is equal to one-half of the quantity of the set of multiple BSS color values.

Clause 18: The method of any of clauses 14-17, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 19: The method of clause 18, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 20: The method of any of clauses 14-19, where the first half of the length-96 ELR sequence is applied to a first set of tones associated with the first ELR symbol and the second half of the length-96 ELR sequence is applied to a second set of tones associated with the second ELR symbol.

Clause 21: The method of clause 20, where the first set of tones is a first set of data tones, and the second set of tones is a second set of data tones.

Clause 22: The method of any of clauses 1-21, where the set of multiple ELR symbols is associated with a same modulation scheme or a same pattern of modulation schemes, or each of the set of multiple ELR symbols is associated with a different modulation scheme or a different pattern of modulation schemes.

Clause 23: The method of any of clauses 1-22, where each BSS color value of the set of multiple BSS color values is directly mapped to a respective index of the set of multiple ELR sequences, or each BSS color value of the set of multiple BSS color values is indirectly mapped to a respective index of the set of multiple ELR sequences in accordance with PAPRs associated with the set of multiple ELR sequences.

Clause 24: The method of any of clauses 1-23, where the set of multiple ELR sequences are associated with a matrix of ELR sequences, and a size of the matrix of ELR sequences is associated with the quantity of used tones within the set of multiple ELR symbols and the quantity of the set of multiple BSS color values.

Clause 25: The method of clause 24, where the matrix of ELR sequences is a Hadamard matrix or a subset of a Hadamard matrix, and a first dimension of the matrix of ELR sequences is equal to the quantity of used tones within the set of multiple ELR symbols and a second dimension of the matrix of ELR sequences is equal to the quantity of the set of multiple BSS color values.

Clause 26: The method of any of clauses 1-25, where an 8-segment mask is applied to data tones associated with the set of multiple ELR data symbols, each segment of the 8-segment mask being applied to a respective set of data tones of the data tones associated with the set of multiple ELR data symbols.

Clause 27: A method for wireless communication at a wireless communication device, including: receiving, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols; and selectively receiving at least a portion of a remainder of the PPDU after the set of multiple ELR symbols in accordance with the BSS color value indicated by the ELR sequence.

Clause 28: The method of clause 27, where selectively receiving at least the portion of the remainder of the PPDU after the set of multiple ELR symbols includes: receiving at least the portion of the remainder of the PPDU in accordance with a BSS associated with the wireless communication device corresponding to the BSS color value indicated by the ELR sequence; or refraining from receiving the remainder of the PPDU in accordance with the BSS associated with the wireless communication device corresponding to a different BSS color value than the BSS color value indicated by the ELR sequence.

Clause 29: The method of any of clauses 27-28, where the set of multiple ELR symbols includes two ELR symbols, the ELR sequence is associated with a Hadamard expansion of a pair of binary complementary sequences, and a first ELR symbol of the two ELR symbols is associated with a first half of the ELR sequence and a second ELR symbol of the two ELR symbols is associated with a second half of the ELR sequence.

Clause 30: The method of clause 29, where the set of multiple ELR sequences is associated with the Hadamard expansion of a subset of a Golay-Hadamard matrix, and the Golay-Hadamard matrix is associated with non-transposed circulant shifted versions of the pair of binary complementary sequences and transposed circulant shifted versions of the pair of binary complementary sequences.

Clause 31: The method of any of clauses 29-30, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 32: The method of clause 31, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 33: The method of any of clauses 29-32, where a tone plan of each of the two ELR symbols excludes dedicated pilot tones, and the quantity of used tones within the set of multiple ELR symbols includes a complete set of tones in the tone plan.

Clause 34: The method of any of clauses 29-33, where each of the two ELR symbols includes a set of 48 data tones and a set of extra tones, and the quantity of used tones within the set of multiple ELR symbols is in accordance with each of the two ELR symbols including the set of 48 data tones and the set of extra tones.

Clause 35: The method of clause 34, where the set of extra tones includes two tones at a beginning of each of the two ELR symbols and two tones at an end of each of the two ELR symbols.

Clause 36: The method of any of clauses 29-35, where the pair of binary complementary sequences is associated with a length of 26, and the pair of binary complementary sequences includes a primitive pair of binary complementary sequences associated with the length of 26 or a transformation of the primitive pair of binary complementary sequences associated with the length of 26.

Clause 37: The method of any of clauses 29-36, where the Hadamard expansion includes a circulant shift of the pair of binary complementary sequences.

Clause 38: The method of any of clauses 29-37, where the pair of binary complementary sequences is a Golay pair of complementary sequences.

Clause 39: The method of any of clauses 29-38, where the pair of binary complementary sequences includes length-26 sequences or length-52 sequences.

Clause 40: The method of any of clauses 29-39, where the pair of binary complementary sequences satisfies a PAPR threshold.

Clause 41: The method of any of clauses 27-40, where the set of multiple ELR symbols includes two ELR symbols, the ELR sequence is a length-96 ELR sequence, a first ELR symbol of the two ELR symbols is associated with a first half of the length-96 ELR sequence and a second ELR symbol of the two ELR symbols is associated with a second half of the length-96 ELR sequence, and the set of multiple ELR sequences is a first subset of a first Hadamard matrix with a first order of 96 or is associated with a Hadamard expansion of a second subset of a second Hadamard matrix with a second order of 48.

Clause 42: The method of clause 41, where the first subset of the first Hadamard matrix includes a first subset of row vectors or a first subset of column vectors of the first Hadamard matrix, a first quantity of the first subset of row vectors or a first quantity of the first subset of column vectors associated with the quantity of the set of multiple BSS color values, and the second subset of the second Hadamard matrix includes a second subset of row vectors or a second subset of column vectors of the second Hadamard matrix, a second quantity of the second subset of row vectors or a second quantity of the second subset of column vectors associated with the quantity of the set of multiple BSS color values.

Clause 43: The method of clause 42, where first row vectors of the first subset of row vectors or first column vectors of the first subset of column vectors are associated with relatively lowest PAPRs of the first Hadamard matrix, and second row vectors of the second subset of row vectors or second column vectors of the second subset of column vectors are associated with relatively lowest PAPRs of the second Hadamard matrix.

Clause 44: The method of any of clauses 42-43, where the first quantity of the first subset of row vectors or the first quantity of the first subset of column vectors is equal to the quantity of the set of multiple BSS color values, and the second quantity of the second subset of row vectors or the second quantity of the second subset of column vectors is equal to one-half of the quantity of the set of multiple BSS color values.

Clause 45: The method of any of clauses 41-44, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 46: The method of clause 45, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 47: The method of any of clauses 41-46, where the first half of the length-96 ELR sequence is applied to a first set of tones associated with the first ELR symbol and the second half of the length-96 ELR sequence is applied to a second set of tones associated with the second ELR symbol.

Clause 48: The method of clause 47, where the first set of tones is a first set of data tones, and the second set of tones is a second set of data tones.

Clause 49: The method of any of clauses 27-48, where the set of multiple ELR symbols is associated with a same modulation scheme or a same pattern of modulation schemes, or each of the set of multiple ELR symbols is associated with a different modulation scheme or a different pattern of modulation schemes.

Clause 50: The method of any of clauses 27-49, where each BSS color value of the set of multiple BSS color values is directly mapped to a respective index of the set of multiple ELR sequences, or each BSS color value of the set of multiple BSS color values is indirectly mapped to a respective index of the set of multiple ELR sequences in accordance with PAPRs associated with the set of multiple ELR sequences.

Clause 51: The method of any of clauses 27-50, where the set of multiple ELR sequences are associated with a matrix of ELR sequences, and a size of the matrix of ELR sequences is associated with the quantity of used tones within the set of multiple ELR symbols and the quantity of the set of multiple BSS color values.

Clause 52: The method of clause 51, where the matrix of ELR sequences is a Hadamard matrix or a subset of a Hadamard matrix, and a first dimension of the matrix of ELR sequences is equal to the quantity of used tones within the set of multiple ELR symbols and a second dimension of the matrix of ELR sequences is equal to the quantity of the set of multiple BSS color values.

Clause 53: The method of any of clauses 27-52, where an 8-segment mask is applied to data tones associated with the set of multiple ELR data symbols, each segment of the 8-segment mask being applied to a respective set of data tones of the data tones associated with the set of multiple ELR data symbols.

Clause 54: A wireless communication device, including: a processing system that includes processor circuitry and memory circuitry that stores code, the processing system configured to cause the wireless communication device to: transmit, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols; and transmit, via a set of multiple ELR data symbols within a data portion of the PPDU, a data payload associated with the BSS color value.

Clause 55: The wireless communication device of clause 54, where: the set of multiple ELR symbols includes two ELR symbols, the ELR sequence is associated with a Hadamard expansion of a pair of binary complementary sequences, and a first ELR symbol of the two ELR symbols is associated with a first half of the ELR sequence and a second ELR symbol of the two ELR symbols is associated with a second half of the ELR sequence.

Clause 56: The wireless communication device of clause 55, where the set of multiple ELR sequences is associated with the Hadamard expansion of a subset of a Golay-Hadamard matrix, and the Golay-Hadamard matrix is associated with non-transposed circulant shifted versions of the pair of binary complementary sequences and transposed circulant shifted versions of the pair of binary complementary sequences.

Clause 57: The wireless communication device of any of clauses 55-56, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 58: The wireless communication device of clause 57, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 59: The wireless communication device of any of clauses 55-58, where: a tone plan of each of the two ELR symbols excludes dedicated pilot tones, and the quantity of used tones within the set of multiple ELR symbols includes a complete set of tones in the tone plan.

Clause 60: The wireless communication device of any of clauses 55-59, where each of the two ELR symbols includes a set of 48 data tones and a set of extra tones, and the quantity of used tones within the set of multiple ELR symbols is in accordance with each of the two ELR symbols including the set of 48 data tones and the set of extra tones.

Clause 61: The wireless communication device of clause 60, where the set of extra tones includes two tones at a beginning of each of the two ELR symbols and two tones at an end of each of the two ELR symbols.

Clause 62: The wireless communication device of any of clauses 55-61, where the pair of binary complementary sequences is associated with a length of 26, and the pair of binary complementary sequences includes a primitive pair of binary complementary sequences associated with the length of 26 or a transformation of the primitive pair of binary complementary sequences associated with the length of 26.

Clause 63: The wireless communication device of any of clauses 55-62, where the Hadamard expansion includes a circulant shift of the pair of binary complementary sequences.

Clause 64: The wireless communication device of any of clauses 55-63, where the pair of binary complementary sequences is a Golay pair of complementary sequences.

Clause 65: The wireless communication device of any of clauses 55-64, where: the pair of binary complementary sequences includes length-26 sequences or length-52 sequences.

Clause 66: The wireless communication device of any of clauses 55-65, where: the pair of binary complementary sequences satisfies a PAPR threshold.

Clause 67: The wireless communication device of any of clauses 54-66, where: the set of multiple ELR symbols includes two ELR symbols, the ELR sequence is a length-96 ELR sequence, a first ELR symbol of the two ELR symbols is associated with a first half of the length-96 ELR sequence and a second ELR symbol of the two ELR symbols is associated with a second half of the length-96 ELR sequence, and the set of multiple ELR sequences is a first subset of a first Hadamard matrix with a first order of 96 or is associated with a Hadamard expansion of a second subset of a second Hadamard matrix with a second order of 48.

Clause 68: The wireless communication device of clause 67, where the first subset of the first Hadamard matrix includes a first subset of row vectors or a first subset of column vectors of the first Hadamard matrix, a first quantity of the first subset of row vectors or a first quantity of the first subset of column vectors associated with the quantity of the set of multiple BSS color values, and the second subset of the second Hadamard matrix includes a second subset of row vectors or a second subset of column vectors of the second Hadamard matrix, a second quantity of the second subset of row vectors or a second quantity of the second subset of column vectors associated with the quantity of the set of multiple BSS color values.

Clause 69: The wireless communication device of clause 68, where first row vectors of the first subset of row vectors or first column vectors of the first subset of column vectors are associated with relatively lowest PAPRs of the first Hadamard matrix, and second row vectors of the second subset of row vectors or second column vectors of the second subset of column vectors are associated with relatively lowest PAPRs of the second Hadamard matrix.

Clause 70: The wireless communication device of any of clauses 68-69, where the first quantity of the first subset of row vectors or the first quantity of the first subset of column vectors is equal to the quantity of the set of multiple BSS color values, and the second quantity of the second subset of row vectors or the second quantity of the second subset of column vectors is equal to one-half of the quantity of the set of multiple BSS color values.

Clause 71: The wireless communication device of any of clauses 67-70, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 72: The wireless communication device of clause 71, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 73: The wireless communication device of any of clauses 67-72, where the first half of the length-96 ELR sequence is applied to a first set of tones associated with the first ELR symbol and the second half of the length-96 ELR sequence is applied to a second set of tones associated with the second ELR symbol.

Clause 74: The wireless communication device of clause 73, where the first set of tones is a first set of data tones, and the second set of tones is a second set of data tones.

Clause 75: The wireless communication device of any of clauses 54-74, where the set of multiple ELR symbols is associated with a same modulation scheme or a same pattern of modulation schemes, or each of the set of multiple ELR symbols is associated with a different modulation scheme or a different pattern of modulation schemes.

Clause 76: The wireless communication device of any of clauses 54-75, where each BSS color value of the set of multiple BSS color values is directly mapped to a respective index of the set of multiple ELR sequences, or each BSS color value of the set of multiple BSS color values is indirectly mapped to a respective index of the set of multiple ELR sequences in accordance with PAPRs associated with the set of multiple ELR sequences.

Clause 77: The wireless communication device of any of clauses 54-76, where the set of multiple ELR sequences are associated with a matrix of ELR sequences, and a size of the matrix of ELR sequences is associated with the quantity of used tones within the set of multiple ELR symbols and the quantity of the set of multiple BSS color values.

Clause 78: The wireless communication device of clause 77, where the matrix of ELR sequences is a Hadamard matrix or a subset of a Hadamard matrix, and a first dimension of the matrix of ELR sequences is equal to the quantity of used tones within the set of multiple ELR symbols and a second dimension of the matrix of ELR sequences is equal to the quantity of the set of multiple BSS color values.

Clause 79: The wireless communication device of any of clauses 54-78, where an 8-segment mask is applied to data tones associated with the set of multiple ELR data symbols, each segment of the 8-segment mask being applied to a respective set of data tones of the data tones associated with the set of multiple ELR data symbols.

Clause 80: A wireless communication device, including: a processing system that includes processor circuitry and memory circuitry that stores code, the processing system configured to cause the wireless communication device to: receive, via a set of multiple ELR symbols within a preamble portion of a PPDU, an ELR sequence from a set of multiple ELR sequences, where the ELR sequence is indicative of a BSS color value from a set of multiple BSS color values, and where a quantity of the set of multiple ELR sequences corresponds to a quantity of the set of multiple BSS color values and a length of each ELR sequence of the set of multiple ELR sequences is associated with a quantity of used tones within the set of multiple ELR symbols; and selectively receive at least a portion of a remainder of the PPDU after the set of multiple ELR symbols in accordance with the BSS color value indicated by the ELR sequence.

Clause 81: The wireless communication device of clause 80, where, to selectively receive at least the portion of the remainder of the PPDU after the set of multiple ELR symbols, the processing system is configured to cause the wireless communication device to: receive at least the portion of the remainder of the PPDU in accordance with a BSS associated with the wireless communication device corresponding to the BSS color value indicated by the ELR sequence; or refrain from receiving the remainder of the PPDU in accordance with the BSS associated with the wireless communication device corresponding to a different BSS color value than the BSS color value indicated by the ELR sequence.

Clause 82: The wireless communication device of any of clauses 80-81, where: the set of multiple ELR symbols includes two ELR symbols, the ELR sequence is associated with a Hadamard expansion of a pair of binary complementary sequences, and a first ELR symbol of the two ELR symbols is associated with a first half of the ELR sequence and a second ELR symbol of the two ELR symbols is associated with a second half of the ELR sequence.

Clause 83: The wireless communication device of clause 82, where the set of multiple ELR sequences is associated with the Hadamard expansion of a subset of a Golay-Hadamard matrix, and the Golay-Hadamard matrix is associated with non-transposed circulant shifted versions of the pair of binary complementary sequences and transposed circulant shifted versions of the pair of binary complementary sequences.

Clause 84: The wireless communication device of any of clauses 82-83, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 85: The wireless communication device of clause 84, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 86: The wireless communication device of any of clauses 82-85, where: a tone plan of each of the two ELR symbols excludes dedicated pilot tones, and the quantity of used tones within the set of multiple ELR symbols includes a complete set of tones in the tone plan.

Clause 87: The wireless communication device of any of clauses 82-86, where each of the two ELR symbols includes a set of 48 data tones and a set of extra tones, and the quantity of used tones within the set of multiple ELR symbols is in accordance with each of the two ELR symbols including the set of 48 data tones and the set of extra tones.

Clause 88: The wireless communication device of clause 87, where the set of extra tones includes two tones at a beginning of each of the two ELR symbols and two tones at an end of each of the two ELR symbols.

Clause 89: The wireless communication device of any of clauses 82-88, where the pair of binary complementary sequences is associated with a length of 26, and the pair of binary complementary sequences includes a primitive pair of binary complementary sequences associated with the length of 26 or a transformation of the primitive pair of binary complementary sequences associated with the length of 26.

Clause 90: The wireless communication device of any of clauses 82-89, where the Hadamard expansion includes a circulant shift of the pair of binary complementary sequences.

Clause 91: The wireless communication device of any of clauses 82-90, where the pair of binary complementary sequences is a Golay pair of complementary sequences.

Clause 92: The wireless communication device of any of clauses 82-91, where: the pair of binary complementary sequences includes length-26 sequences or length-52 sequences.

Clause 93: The wireless communication device of any of clauses 82-92, where: the pair of binary complementary sequences satisfies a PAPR threshold.

Clause 94: The wireless communication device of any of clauses 80-93, where: the set of multiple ELR symbols includes two ELR symbols, the ELR sequence is a length-96 ELR sequence, a first ELR symbol of the two ELR symbols is associated with a first half of the length-96 ELR sequence and a second ELR symbol of the two ELR symbols is associated with a second half of the length-96 ELR sequence, and the set of multiple ELR sequences is a first subset of a first Hadamard matrix with a first order of 96 or is associated with a Hadamard expansion of a second subset of a second Hadamard matrix with a second order of 48.

Clause 95: The wireless communication device of clause 94, where the first subset of the first Hadamard matrix includes a first subset of row vectors or a first subset of column vectors of the first Hadamard matrix, a first quantity of the first subset of row vectors or a first quantity of the first subset of column vectors associated with the quantity of the set of multiple BSS color values, and the second subset of the second Hadamard matrix includes a second subset of row vectors or a second subset of column vectors of the second Hadamard matrix, a second quantity of the second subset of row vectors or a second quantity of the second subset of column vectors associated with the quantity of the set of multiple BSS color values.

Clause 96: The wireless communication device of clause 95, where first row vectors of the first subset of row vectors or first column vectors of the first subset of column vectors are associated with relatively lowest PAPRs of the first Hadamard matrix, and second row vectors of the second subset of row vectors or second column vectors of the second subset of column vectors are associated with relatively lowest PAPRs of the second Hadamard matrix.

Clause 97: The wireless communication device of any of clauses 95-96, where the first quantity of the first subset of row vectors or the first quantity of the first subset of column vectors is equal to the quantity of the set of multiple BSS color values, and the second quantity of the second subset of row vectors or the second quantity of the second subset of column vectors is equal to one-half of the quantity of the set of multiple BSS color values.

Clause 98: The wireless communication device of any of clauses 94-97, where a tone plan of each of the two ELR symbols includes a set of dedicated pilot tones, and the quantity of used tones within the set of multiple ELR symbols includes a set of data tones in the tone plan and excludes the set of dedicated pilot tones.

Clause 99: The wireless communication device of clause 98, where the first ELR symbol includes a first set of dedicated pilot tones located at tone indices of [−21, −7, 7, 21] within the first ELR symbol, the first set of dedicated pilot tones having values equal to (−1)*[1, 1, 1, −1], and the second ELR symbol includes a second set of dedicated pilot tones located at tone indices of [−21, −7, 7, 21] within the second ELR symbol, the second set of dedicated pilot tones having values equal to (−1)*[1, 1, 1, −1].

Clause 100: The wireless communication device of any of clauses 94-99, where the first half of the length-96 ELR sequence is applied to a first set of tones associated with the first ELR symbol and the second half of the length-96 ELR sequence is applied to a second set of tones associated with the second ELR symbol.

Clause 101: The wireless communication device of clause 100, where the first set of tones is a first set of data tones, and the second set of tones is a second set of data tones.

Clause 102: The wireless communication device of any of clauses 80-101, where the set of multiple ELR symbols is associated with a same modulation scheme or a same pattern of modulation schemes, or each of the set of multiple ELR symbols is associated with a different modulation scheme or a different pattern of modulation schemes.

Clause 103: The wireless communication device of any of clauses 80-102, where each BSS color value of the set of multiple BSS color values is directly mapped to a respective index of the set of multiple ELR sequences, or each BSS color value of the set of multiple BSS color values is indirectly mapped to a respective index of the set of multiple ELR sequences in accordance with PAPRs associated with the set of multiple ELR sequences.

Clause 104: The wireless communication device of any of clauses 80-103, where the set of multiple ELR sequences are associated with a matrix of ELR sequences, and a size of the matrix of ELR sequences is associated with the quantity of used tones within the set of multiple ELR symbols and the quantity of the set of multiple BSS color values.

Clause 105: The wireless communication device of clause 104, where the matrix of ELR sequences is a Hadamard matrix or a subset of a Hadamard matrix, and a first dimension of the matrix of ELR sequences is equal to the quantity of used tones within the set of multiple ELR symbols and a second dimension of the matrix of ELR sequences is equal to the quantity of the set of multiple BSS color values.

Clause 106: The wireless communication device of any of clauses 80-105, where an 8-segment mask is applied to data tones associated with the set of multiple ELR data symbols, each segment of the 8-segment mask being applied to a respective set of data tones of the data tones associated with the set of multiple ELR data symbols.

Clause 107: A wireless communication device for wireless communication, including at least one means for performing a method of any of clauses 1-26.

Clause 108: A non-transitory computer-readable medium storing code for wireless communication, the code including instructions executable by one or more processors to perform a method of any of clauses 1-26.

Clause 109: A wireless communication device for wireless communication, including at least one means for performing a method of any of clauses 27-53.

Clause 110: A non-transitory computer-readable medium storing code for wireless communication, the code including instructions executable by one or more processors to perform a method of any of clauses 27-53.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information) or accessing (such as accessing data stored in memory), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that comprises processor circuitry and memory circuitry that stores code, the processing system configured to cause the wireless communication device to:
transmit, via a plurality of enhanced long range (ELR) symbols within a preamble portion of a physical layer (PHY) protocol data unit (PPDU), an ELR sequence from a plurality of ELR sequences, wherein:
the ELR sequence is indicative of a basic service set (BSS) color value from a plurality of BSS color values,
a quantity of the plurality of ELR sequences corresponds to a quantity of the plurality of BSS color values, and
a length of each ELR sequence of the plurality of ELR sequences is associated with a quantity of used tones within the plurality of ELR symbols; and
transmit, via a plurality of ELR data symbols within a data portion of the PPDU, a data payload associated with the BSS color value.

2. The wireless communication device of claim 1, wherein:
the plurality of ELR symbols comprises two ELR symbols,
the ELR sequence is a length-96 ELR sequence, and
a first ELR symbol of the two ELR symbols is associated with a first half of the length-96 ELR sequence and a second ELR symbol of the two ELR symbols is associated with a second half of the length-96 ELR sequence.

3. The wireless communication device of claim 2, wherein the plurality of ELR sequences is associated with a Hadamard expansion of a subset of a Hadamard matrix with an order of 48.

4. The wireless communication device of claim 3, wherein:
the subset of the Hadamard matrix comprises a subset of row vectors of the Hadamard matrix, a quantity of the subset of row vectors associated with the quantity of the plurality of BSS color values.

5. The wireless communication device of claim 4, wherein:
the quantity of the subset of row vectors is equal to one-half of the quantity of the plurality of BSS color values.

6. The wireless communication device of claim 2, wherein:
a tone plan of each of the two ELR symbols comprises a set of dedicated pilot tones, and
the quantity of used tones within the plurality of ELR symbols comprises a set of data tones in the tone plan and excludes the set of dedicated pilot tones.

7. The wireless communication device of claim 6, wherein:
the first ELR symbol comprises a first set of dedicated pilot tones located at tone indices of [−21, −7, 7, 21] within the first ELR symbol, the first set of dedicated pilot tones having values equal to (−1)*[1, 1, 1, −1], and
the second ELR symbol comprises a second set of dedicated pilot tones located at tone indices of [−21, −7, 7, 21] within the second ELR symbol, the second set of dedicated pilot tones having values equal to (−1)*[1, 1, 1, −1].

8. The wireless communication device of claim 2, wherein:
the first half of the length-96 ELR sequence is applied to a first set of 48 data tones associated with the first ELR symbol and the second half of the length-96 ELR sequence is applied to a second set of 48 data tones associated with the second ELR symbol.

9. The wireless communication device of claim 8, wherein each of the first set of 48 data tones associated with the first ELR symbol and the second set of 48 data tones associated with the second ELR symbol is modulated using quadrature binary phase shift keying (QBPSK).

10. The wireless communication device of claim 2, wherein each of the two ELR symbols follows a one-times (1×) tone plan for 20 megahertz (MHz).

11. The wireless communication device of claim 1, wherein the preamble portion of the PPDU further comprises a universal signal (U-SIG) field prior to the plurality of ELR symbols, and wherein the processing system is configured to cause the wireless communication device to:
apply a same power scaling to the U-SIG field and to the plurality of ELR symbols.

12. A wireless communication device, comprising:
a processing system that comprises processor circuitry and memory circuitry that stores code, the processing system configured to cause the wireless communication device to:
receive, via a plurality of enhanced long range (ELR) symbols within a preamble portion of a physical layer (PHY) protocol data unit (PPDU), an ELR sequence from a plurality of ELR sequences, wherein:
the ELR sequence is indicative of a basic service set (BSS) color value from a plurality of BSS color values,
a quantity of the plurality of ELR sequences corresponds to a quantity of the plurality of BSS color values, and
a length of each ELR sequence of the plurality of ELR sequences is associated with a quantity of used tones within the plurality of ELR symbols; and
selectively receive at least a portion of a remainder of the PPDU after the plurality of ELR symbols in accordance with the BSS color value indicated by the ELR sequence.

13. The wireless communication device of claim 12, wherein, to selectively receive at least the portion of the remainder of the PPDU after the plurality of ELR symbols, the processing system is configured to cause the wireless communication device to:
receive at least the portion of the remainder of the PPDU in accordance with a BSS associated with the wireless communication device corresponding to the BSS color value indicated by the ELR sequence; or
refrain from receiving the remainder of the PPDU in accordance with the BSS associated with the wireless communication device corresponding to a different BSS color value than the BSS color value indicated by the ELR sequence.

14. The wireless communication device of claim 12, wherein:
each BSS color value of the plurality of BSS color values is directly mapped to a respective index of the plurality of ELR sequences.

15. The wireless communication device of claim 12, wherein:
the plurality of ELR sequences are associated with a matrix of ELR sequences, and
a size of the matrix of ELR sequences is associated with the quantity of used tones within the plurality of ELR symbols and the quantity of the plurality of BSS color values.

16. A method for wireless communication at a wireless communication device, comprising:
transmitting, via a plurality of enhanced long range (ELR) symbols within a preamble portion of a physical layer (PHY) protocol data unit (PPDU), an ELR sequence from a plurality of ELR sequences, wherein:
the ELR sequence is indicative of a basic service set (BSS) color value from a plurality of BSS color values,
a quantity of the plurality of ELR sequences corresponds to a quantity of the plurality of BSS color values, and
a length of each ELR sequence of the plurality of ELR sequences is associated with a quantity of used tones within the plurality of ELR symbols; and
transmitting, via a plurality of ELR data symbols within a data portion of the PPDU, a data payload associated with the BSS color value.

17. The method of claim 16, wherein:
the plurality of ELR symbols comprises two ELR symbols,
the ELR sequence is a length-96 ELR sequence, and
a first ELR symbol of the two ELR symbols is associated with a first half of the length-96 ELR sequence and a second ELR symbol of the two ELR symbols is associated with a second half of the length-96 ELR sequence.

18. The method of claim 17, wherein:
a tone plan of each of the two ELR symbols comprises a set of dedicated pilot tones, and
the quantity of used tones within the plurality of ELR symbols comprises a set of data tones in the tone plan and excludes the set of dedicated pilot tones.

19. The method of claim 17, wherein:
the first half of the length-96 ELR sequence is applied to a first set of 48 data tones associated with the first ELR symbol and the second half of the length-96 ELR sequence is applied to a second set of 48 data tones associated with the second ELR symbol.

20. The method of claim 16, wherein:
the plurality of ELR sequences are associated with a matrix of ELR sequences,
a size of the matrix of ELR sequences is associated with the quantity of used tones within the plurality of ELR symbols and the quantity of the plurality of BSS color values, and
a first dimension of the matrix of ELR sequences is equal to the quantity of used tones within the plurality of ELR symbols and a second dimension of the matrix of ELR sequences is equal to the quantity of the plurality of BSS color values.
